(19) United States
(12) Patent Application Publication
(10) Pub. No.: US 2026/0186212 A1
(43) Pub. Date: Jul. 2, 2026

(54) COUPLER WITH FAU FOR INTERFACING AN INTERPOSER AND OPTICAL FIBERS

(71) Applicant: POET Technologies, Inc., Petaluma, CA (US)

(72) Inventors: Suresh Venkatesan, Los Gatos, CA (US); Ma Bo, Petaluma, CA (US); Yong Meng Lee, Petaluma, CA (US); Luis Castillo, Petaluma, CA (US)

(21) Appl. No.: 19/435,230

(22) Filed: Dec. 29, 2025

Related U.S. Application Data
(60) Provisional application No. 63/739,783, filed on Dec. 30, 2024.
(60) Provisional application No. 63/762,164, filed on Feb. 24, 2025.
(60) Provisional application No. 63/825,083, filed on Jun. 17, 2025.

(51) Int. Cl. G02B 6/38

(52) U.S. Cl. CPC G02B 6/3882; G02B 6/3827; G02B 6/3839

(57) ABSTRACT

A coupler facilitates coupling of optical signals from an interposer configured having an optical signal source to one or more optical fiber in an FAU coupled to the coupler. Tongue and groove alignment features formed self-aligned with waveguide cores on the coupler facilitate alignment of waveguide cores on the coupler with waveguide cores on the interposer. FAU alignment aids formed on the coupler facilitate alignment of optical fibers mounted in an FAU to waveguide cores of the coupler. The tongue and groove alignment features and FAU alignment features, among other alignment features, are formed from the core layer of a planar waveguide layer of the coupler. Couplers configured having a cavity enable the coupling of an optical isolator within the waveguide layer of the coupler wherein one or more lens array may be formed in the cavity to couple optical signals across the cavity and the optical isolator.

### CROSS REFERENCE TO RELATED APPLICATIONS

This application claims the benefit of priority to U.S. Provisional Application No. 63/739,783, entitled, “Plug-in Submount on Optical Interposer”, filed Dec. 30, 2024, the entirety of which is incorporated herein by reference. This application also claims the benefit of priority to U.S. Provisional Application No. 63/825,083, entitled, “Fiber Mounting Coupler to PIC”, filed Jun. 17, 2025, the entirety of which is incorporated herein by reference. This application also claims the benefit of priority to U.S. Provisional Application No. 63/762,164, entitled, “3D Printed Reflector Structure in Cavity”, filed Feb. 24, 2025, the entirety of which is incorporated herein by reference.

This application is related to (1) U.S. patent application having docket number, OPE-120, filed Dec. 29, 2025, entitled, “Plug-in Submount on Optical Interposer”; (2) U.S. patent application having docket number, OPE-127, filed Dec. 29, 2025, entitled, “Coupler with v-grooves for interfacing an interposer and optical fibers”; and (3) U.S. patent application having docket number, OPE-129, filed Dec. 29, 2025, entitled, “Coupler with ferrule for interfacing an interposer and optical fibers”; all of which are hereby incorporated by reference in their entirety.

This application is related to (1) U.S. patent application Ser. No. 19/255,852, filed Jun. 30, 2025, entitled, “Self-Aligned Structure and Method on Interposer-based PIC”; (2) U.S. patent application Ser. No. 18/659,265, filed May 9, 2024, entitled, “Structures and Assemblies Having a Lens Array”; (3) U.S. patent application Ser. No. 17/242,580, filed Aug. 5, 2021, entitled, “Loopback Waveguide”; (4) U.S. patent application Ser. No. 18/753,609, filed Jun. 25, 2024, entitled, “Hybrid-integrated Laser Structure”; (5) U.S. patent application Ser. No. 17/962,541, filed Oct. 9, 2022, entitled, “Fiber Block Alignment Structure”; all of which are hereby incorporated by reference in their entirety.

### BACKGROUND

The present invention relates to photonic integrated circuit assemblies and to the methods of formation and use of these assemblies.

Developments in methods of manufacturing of photonic integrated circuits (PICs) have enabled the fabrication and integration of electrical, optoelectrical, and optical devices on the same substrate. In some applications, pre-formed optoelectrical components are integrated within PICs to provide functionality that may not be easily obtainable or available with devices formed directly on or within the substrate.

Unlike purely electrical circuits, photonic integrated circuits require the interconnection of optical waveguides or other optical pathways of optical and optoelectrical devices with optical components or features formed on an interposer, submount, or other form of substrate or carrier, in addition to any electrical interconnectivity that may be required. The diversity in physical sizes and shapes of optical components used in the formation of PICs requires the development and adoption of integration strategies to facilitate the coupling of the optical and the electrical aspects of optoelectrical devices.

The co-packaging of photonic components on a submount or other form of substrate requires the alignment of the optical axes of integrated optical devices to facilitate the transfer of optical signals between optical devices. Alignment strategies must take into account the positioning of the optical axes in relation to mechanical alignment features that may be used to align optical components, and ultimately to anchor the optical components into an assembly.

Integrated sub-assemblies comprising a plurality of optical components, such as lenses, isolators, polarizers, lasers, gain devices, photodiodes, among many other optical components having diverse integration requirements, may be combined with other subassemblies to facilitate formation of larger optical assemblies. The integration of optoelectrical devices having characteristic optical axes, however, requires precise placement and subsequent alignment after placement of optical and electrical features on the device or subassembly to be mounted with optical and electrical features on the substrate to which the device or subassembly is to be mounted. Optical output from an integrated laser die, for example, must align with optical planar waveguides or other optical devices on the substrate to enable effective integration of the laser with the waveguides and other components on the substrate to which the laser is mounted.

Optical subassemblies that can be reliably and repeatedly assembled to form photonic integrated circuits require strategies for the formation and assembly of structures that facilitate alignment of optical components between devices mounted on a common substrate, and between other subassemblies. Pre-testing and pre-characterization of subassemblies prior to integration with other components and other sub-assemblies, enables the integration of these characterized subassemblies at reduced risk of loss to underperforming photonic integrated circuit assemblies that include these subassemblies.

Thus, a need in the art exists for structures and methods that enable the formation of subassemblies having optical components that enable the testing and characterization of these subassemblies prior to integration into larger photonic integrated circuit assemblies. Further economic benefits can be achieved with the use of wafer level processing and methods that utilize passive alignment structures and techniques.

### BRIEF SUMMARY OF EMBODIMENTS

Disclosed herein are embodiments of photonic integrated circuit (PIC) assemblies comprising a coupler assembly and an interposer assembly, embodiments of the coupler assemblies and interposer assemblies of which the PIC assemblies are comprised, and embodiments of couplers and interposers of which the coupler assemblies and interposer assemblies are comprised. Also disclosed herein are methods of formation of embodiments of the PIC assemblies, couplers and coupler assemblies, and the interposer and interposer assemblies.

A coupler, as used in embodiments disclosed herein, is a device that facilitates coupling of one or more optical fibers to all or a portion of a PIC assembly. Embodiments of couplers may include all or a portion of a photonic integrated circuit, and may include features to facilitate alignment of optical fibers to waveguides and other optical propagation pathways on the coupler and may include features to facilitate alignment of waveguides and other optical propagation pathways on the coupler with waveguides and other optical propagation pathways on devices to which the coupler may be coupled in the formation of PIC assemblies.

In some embodiments, as disclosed herein, couplers may be configured having one or more optical isolator to facilitate the coupling of an interposer assembly comprising one or more optical signal sources to one or more optical fiber to enable transmission of optical signals from the optical signal sources to optical fibers further coupled to short- or long-range optical networks, for example. Coupling of the optical signal sources of the interposer assembly to the optical fibers through an optical isolator can reduce or eliminate back reflections into optical signal sources, such as lasers, gain devices, and laser diodes, for example, that could be detrimentally impacted by reflected signals. The elimination or reduction in back reflections in embodiments of couplers configured having optical isolators can lead to improved stability and functionality.

Couplers, and methods of formation of these couplers are disclosed herein comprising at least a cavity receptive to one or more optical isolator, wherein the cavity is configurable with one or more lens array to facilitate the coupling of optical signals from an ingoing side of the cavity, through the optical isolator, to an outgoing side of the cavity. In some embodiments, the one or more cavity formed in the coupler, intersects a planar waveguide formed on a coupler substrate. In such embodiments, lenses of the one or more lens arrays capture divergent optical signals emerging from a waveguide facet formed on the ingoing side of the cavity and focus the captured optical signals onto the facet of a waveguide or spot size converter, for example, formed on the outgoing side of the cavity for further transmission to an optical fiber. Although the formation of the cavity in the coupler enables the insertion of an optical isolator into the planar waveguide structure, the lenses are necessary to overcome the disruption in the waveguide resulting from the formation of the cavity.

In other embodiments, disclosed herein, the one or more cavity formed in the coupler intersects an optical pathway that does not intersect a waveguide, and in such embodiments, lenses of one or more lens arrays may capture optical signals propagating from one or more of an optical device coupled to the lens of the lens array and may focus the captured optical signals onto one more waveguide facet, spot size converter, optical device, and optical fiber. In the absence of an intersected waveguide on the ingoing side of a cavity formed in embodiments of the coupler, optical signals may be free-space coupled from all or a portion of a device, an interposer, and a device mounted or otherwise formed on, or coupled to the interposer, for example, to a lens of a lens array mounted or otherwise formed in a cavity of the coupler. In the absence of an intersected waveguide on the outgoing side of a cavity in embodiments of the coupler, optical signals may be free-space coupled from one or more lens mounted or otherwise formed in a cavity of the coupler to all or a portion of a spot size converter, a device mounted or otherwise formed on, or coupled to the coupler, and an optical fiber, for example.

Embodiments of coupler assemblies are disclosed herein comprising an optical isolator, one or more lens arrays, and a coupler configured for, and receptive to, an optical isolator and the one or more lens arrays. In some embodiments, coupler assemblies may further comprise one or more optical fibers mounted or otherwise formed in all or a portion of the coupler. And in some embodiments, coupler assemblies may further comprise one or more optical devices mounted or otherwise formed on the coupler. In an embodiment of a coupler assembly, one or more semiconductor optical amplifiers, for example, may be mounted or otherwise formed on the coupler.

Embodiments of PIC assemblies comprising a coupler assembly and an interposer assembly are disclosed herein. In some embodiments, interposer assemblies may comprise one or more optical signal sources configured as one or more semiconductor laser, gain device, or light emitting diode, for example. In other embodiments, an interposer assembly may be configured having all or a portion of a photonic integrated circuit coupled to the coupler assembly comprising the one or more cavity, and the one or more optical isolator and one or more lens array mounted or otherwise formed in the cavity. These and other embodiments of PIC assemblies comprising an interposer assembly and a coupler assembly, embodiments of the interposer assemblies and the coupler assemblies of the embodiments of the PIC assemblies, and embodiments of the couplers of the coupler assemblies are further described and disclosed herein.

The alignment of optical features of the coupler assemblies with optical features of the interposer assemblies, and with one or more optical fiber mounted or otherwise formed on the coupler, is facilitated in embodiments with complementary alignment structures formed on, for example, the coupler of the coupler assembly and the interposer of the interposer assembly. In embodiments, one or more tongue-shaped T&G alignment feature formed on an embodiment of a coupler may be coupled to one or more groove-shaped T&G alignment feature formed on an embodiment of an interposer to facilitate alignment of one or more optical features on the coupler with one or more optical features on the interposer. An optical feature may be, for example, a waveguide or other optical pathway.

In some embodiments disclosed herein, T&G alignment features on the coupler are formed in self-alignment with optical features that include waveguide cores, for example, and in self-alignment with other alignment features formed on the coupler that include fiducials, lateral alignment features to facilitate alignment of a fiber attachment unit (FAU) configured having one or more optical fibers on the coupler, and lateral alignment features to facilitate alignment of multi-lens arrays and optical isolators in a cavity formed on the coupler, among other self-alignment alignment features disclosed herein.

### Embodiments of PIC Assemblies

An embodiment of a PIC assembly, disclosed herein, comprises a coupler assembly, an interposer assembly configured to provide one or more optical signal to the coupler assembly, and an FAU configured having one or more optical fiber mounted or otherwise formed on an FAU mounting site on the coupler of the coupler assembly.

Another embodiment of a PIC assembly, disclosed herein, comprises a coupler assembly, an interposer assembly configured to provide one or more optical signals to the coupler assembly, and one or more optical fiber mounted in an FAU on the coupler of the coupler assembly, wherein the coupler is configured having tongue-shaped, T&G lateral alignment aids formed self-aligned with waveguide cores formed on the coupler, and the interposer is configured having complementary groove-shaped, T&G lateral alignment aids formed self-aligned with waveguide cores on the interposer.

In some embodiments of a PIC assembly wherein the coupler is configured having T&G alignment aids, the T&G alignment aids are formed self-aligned with free-space optical pathways formed on the coupler. Free-space coupling, as used herein, refers to the coupling of two optical devices, such as a light source and a detector, for example, in which the optical signals are coupled through the free-space separating the two devices. In contrast, devices may be optically coupled through a waveguide, or through a medium that fills all or a portion of the volume separating the two devices.

An embodiment of a coupler assembly, disclosed herein, comprises a coupler configured having a cavity, two multi-lens arrays, and an optical isolator mounted or otherwise formed in the cavity. A multi-lens array (MLA), as used herein, refers to a substrate upon which one or more lenses are formed that enable the one or more lenses to be simultaneously positioned within the cavity and aligned with features such as an array of planar waveguides, for example, formed on the coupler.

In another embodiment, the one or more lens array may be formed in the cavity using 3D printing methods such as two-photon polymerization (2PP). In an embodiment of a coupler assembly, a coupler is configured having a cavity, an optical isolator mounted or otherwise formed in the cavity, and two arrays of 3D printed lenses formed using two-photon polymerization on the terminal facets of four planar waveguides formed on the wall of the cavity.

In yet another embodiment, the one or more lens array may be formed as a portion of a 3D printed structure in the cavity using 3D printing methods such as two-photon polymerization (2PP). In an embodiment of a coupler assembly, a coupler is configured having a cavity, an optical isolator mounted or otherwise formed in the cavity, and two 3D printed lens array structures formed using two-photon polymerization in the cavity wherein the lens array structures comprise four lenses and a support structure for the four lenses, and wherein the four lenses of the lens array structure are formed in alignment with the terminal facets of four planar waveguides formed on the wall of the cavity. In other embodiments, the lenses of the lens array structures are formed in alignment with optical pathways or optical features formed on the coupler. Lenses formed using two photon polymerization in lens array structures enables increased flexibility in the location and contour of the lenses formed in the structure in comparison to lenses formed by other means.

These and other embodiments, including methods for the formation of the coupler are disclosed. Also disclosed are methods of formation of assemblies comprising the coupler and the means for coupling one or more optical fiber that include one or more of an optical isolator and one or more lens. And yet also disclosed are methods of formation of assemblies comprising the interposer and the coupler, and that optionally include the means for coupling one or more optical fiber to the coupler.

Embodiments disclosed herein pertain to the formation of photonic integrated circuit assemblies. Embodiments include couplers used to facilitate the coupling of one or more optical fiber to a photonic integrated circuit formed on an interposer. Embodiments also include assemblies comprising a coupler and an interposer. Embodiments, disclosed herein, also include assemblies comprising a coupler, an interposer, and an FAU configured having one or more optical fibers wherein the FAU is coupled to an FAU mounting site formed on the coupler. Methods of forming couplers, interposers, and assemblies comprising couplers and interposers, and including an FAU for coupling one or more optical fiber cable are also disclosed.

In an embodiment of a photonic integrated circuit assembly, the assembly comprises an interposer, a coupler, and an FAU coupled to the coupler and configured having one or more optical fiber. In embodiments, the interposer and the coupler are formed from layered structures comprising a planar waveguide layer formed on a base structure, wherein the base structure comprises a substrate and an optional electrical interconnect layer formed on the substrate. Couplers and interposers formed from the same or similar substrate and film structures can greatly increase the compatibility of these devices in the formation of assemblies. The layered structures enable the formation of planar waveguides from the planar waveguide layer that further enables the formation of all or a portion of photonic integrated circuits from the planar waveguides.

Optical devices may be coupled to the interposer, for example, and in some embodiments to planar waveguides formed on the interposer in the formation of all or a portion of a photonic integrated circuit on the interposer. These optical devices may be mounted or otherwise formed on the interposer. In some embodiments, one or more devices may be formed from the planar waveguide layer. In some embodiments, a cavity may be formed in the interposer to accommodate one or more optical device. A cavity formed in the interposer enables the coupling of the optical axis of a device mounted in the cavity with the optical axis of a waveguide, for example, or other optical device intersected by a wall of the cavity.

Optical devices may also be coupled to the coupler, for example, and in some embodiments to planar waveguides formed on the coupler in the formation of all or a portion of a photonic integrated circuit. These optical devices may be mounted or otherwise formed on the coupler. In some embodiments, one or more devices may be formed from the planar waveguide layer of the coupler. As with the interposer, in some embodiments, a cavity may be formed in the coupler to accommodate one or more optical device. A cavity formed in the coupler enables the coupling of the optical axis of a device mounted in the cavity with the optical axis of a waveguide, for example, or other optical device intersected by a wall of the cavity.

In addition to the formation of planar waveguides and devices, for example, from the planar waveguide layer on one or more of the interposer and the coupler, alignment structures may also be formed self-aligned to one or more planar waveguides formed from the planar waveguide layer.

Self-alignment of alignment aids with patterned planar waveguide cores, among other features, may be provided with the use of a same patterned mask layer to form the one or more patterned planar waveguide cores and the one or more alignment features. Self-alignment of alignment features with planar waveguides formed in the interposer, for example, ensures that the spatial positioning of the alignment features is within the resolution of the lithographic technology and patterning processing used in the patterning of the layer that includes the core layer of the patterned planar waveguides.

Alignment structures and features that may be formed self-aligned with the patterned planar waveguide cores include fiducials and a variety of lateral alignment aids as disclosed herein.

In some embodiments of the coupler, one or more cavities may be formed that intersect the waveguide core of one or more waveguides formed from a planar waveguide layer of the coupler to facilitate the inclusion of an optical isolator. Optical isolators enable unidirectional propagation of optical signals, thereby protecting and stabilizing the operation of optical emitting device upstream from the cavity. In these and other embodiments disclosed herein, lenses formed on a substrate singularly or in the form of an array of lenses may be mounted or otherwise formed in the cavity of the coupler to facilitate the focusing of optical signals propagating through the cavity, and to bridge the disruption in the optical pathway caused by the formation of the cavity and the inclusion of an optical isolator in the photonic circuit assembly. In some embodiments, lenses may be formed, for example, using two-photon polymerization. Two-photon polymerization and other means for 3D printing enable the formation of lenses and other optical devices within the cavity formed on the coupler. Alternatively, multi-lens arrays enable the integration of a plurality of lenses with the integration of a single device, to simultaneously accommodate a plurality of optical pathways as described herein. In some embodiments, optical signals may be coupled to a lens or optical isolator in the cavity of the coupler 100 without the one or more waveguides. In such embodiments, disclosed herein, optical signals may be free-space coupled from an interposer or fiber mount to an optical isolator or one or more lens of the coupler.

In some embodiments of assemblies comprising an interposer and a coupler, the PIC assembly may further comprise a means for coupling one or more optical fibers to the coupler. In embodiments disclosed herein, the means for coupling one or more optical fibers is provided using a fiber attachment unit mounted or otherwise formed on an FAU mounting site on the coupler. One or more FAU mounting site may be formed in embodiments of the coupler wherein the coupler may be configured having a lateral alignment aid formed at the opening of the FAU mounting site to facilitate alignment of an FAU and the optical fibers provided thereon with other features formed in self-alignment on the coupler structure.

### BRIEF DESCRIPTION OF THE DRAWINGS

FIG. 1A shows a top-view schematic drawing of an embodiment of a PIC assembly comprising a coupler assembly and an interposer, wherein the coupler assembly is configured having a coupler, two lens arrays and an optical isolator mounted or otherwise formed in a cavity on the coupler, and an FAU configured having four optical fibers.

FIG. 1B shows a top-view schematic drawing of an embodiment of a coupler assembly comprising a coupler configured having four waveguides, and two lens arrays and an optical isolator mounted or otherwise formed in a cavity on the coupler.

FIG. 2A1 shows a top-view schematic drawing of an embodiment of a PIC assembly comprising a coupler assembly, an interposer, and four optical fibers mounted in an FAU on the coupler wherein the coupler assembly is configured having an optical isolator and lenses formed on the facets of planar waveguides intersected by walls of the cavity.

FIG. 2A2 shows a perspective drawing of an embodiment of a PIC assembly having a coupler assembly configured as in FIG. 2A1.

FIG. 2B shows a top-view schematic drawing of an embodiment of a PIC assembly comprising a coupler assembly, an interposer, and four optical fibers mounted in an FAU on the coupler wherein the coupler assembly is configured having an optical isolator and 2PP lens structures formed in the cavity.

FIG. 2C shows a top-view schematic drawing of an embodiment of a PIC assembly comprising a coupler assembly, an interposer, and four optical fibers mounted in an FAU on the coupler wherein the coupler assembly is configured having two MLAs and an optical isolator.

FIG. 3A1 shows an exploded top-view schematic drawing of an embodiment of a coupler assembly comprising a coupler and an FAU wherein the coupler of the coupler assembly is configured having a cavity that intersects planar waveguides formed on the coupler substrate, and the FAU is configured having four optical fibers, and wherein the coupler is further configured having lateral alignment aids formed self-aligned with the planar waveguide cores and wherein the self-aligned lateral alignment aids comprise T&G lateral alignment aids, fiducials, lateral alignment aids formed on the periphery of the cavity, and lateral alignment aids formed on the periphery of the FAU mounting site.

FIG. 3A2 shows a cross-section schematic drawing through Section A-A′ of the embodiment of the coupler assembly shown in FIG. 3A1.

FIG. 3A3 shows a cross-section schematic drawing through Section B-B′ of the embodiment of the coupler assembly shown in FIG. 3A1.

FIG. 3B1 shows an exploded top-view schematic drawing of an embodiment of a coupler assembly comprising a coupler and an FAU wherein the coupler of the coupler assembly is configured having a cavity that enables free-space coupling of optical signals to lenses mounted or otherwise formed in the cavity.

FIG. 3B2 shows a cross-section schematic drawing of the embodiment of the coupler assembly configured as in FIG. 3B1.

FIG. 3C1 shows an exploded top-view schematic drawing of an embodiment of a coupler assembly comprising a coupler and an FAU wherein the coupler of the coupler assembly is configured having a cavity that enables free-space coupling of optical signals from lenses mounted or otherwise formed in the cavity to the terminal facets of the cores of optical fibers mounted in an FAU on the coupler.

FIG. 3C2 shows a cross-section schematic drawing of the embodiment of the coupler assembly configured as in FIG. 3C1.

FIG. 3D1 shows an exploded top-view schematic drawing of an embodiment of a coupler assembly comprising a coupler and an FAU wherein the coupler of the coupler assembly is configured having a cavity that enables free-space coupling of optical signals to lenses mounted or otherwise formed in the cavity and free-space coupling of optical signals from lenses mounted or otherwise formed in the cavity to the terminal facets of the cores of optical fibers mounted in an FAU on the coupler.

FIG. 3D2 shows a cross-section schematic drawing of the embodiment of the coupler assembly configured as in FIG. 3D1.

FIG. 4A shows a top-view schematic drawing of the embodiment of a PIC assembly comprising a coupler assembly and an interposer assembly wherein the interposer assembly is configured having a loopback waveguide.

FIG. 4B shows a cross-section schematic drawing of the embodiment of the PIC assembly shown in FIG. 4A.

FIG. 5A shows an exploded top-view schematic drawing of an embodiment of a PIC assembly comprising an interposer assembly, a coupler assembly, and an FAU fiber mount, wherein the coupler of the coupler assembly is configured having groove-shaped T&G alignment features and fiducials formed self-aligned to the waveguide cores on the coupler, and wherein the interposer assembly is configured having tongue-shaped T&G alignment features and a fiducials formed self-aligned to the waveguide cores on the interposer.

FIG. 5B shows an exploded top-view schematic drawing of a portion of the embodiment of the PIC assembly shown in FIG. 5A that illustrates example points of mechanical contact between the tongue-shaped alignment feature of the interposer and the groove-shaped alignment feature of the coupler in the embodiment.

FIG. 5C shows a top-view schematic drawing of a portion of the embodiment of the PIC assembly shown in FIG. 5A that illustrates example points of mechanical contact between the tongue-shaped alignment feature of the interposer and the groove-shaped alignment feature of the coupler.

FIG. 5D shows an exploded three-dimensional perspective drawing of a portion of the embodiment of the assembly shown in FIG. 5A.

FIG. 6A shows a top-view schematic drawing of the embodiment of the PIC assembly comprising the interposer and coupler of FIG. 5A and shows the section lines A-A′ and B-B′ for the cross-sections illustrated in FIGS. 6B and 6C, respectively.

FIG. 6B shows a cross-sectional schematic drawing of the embodiment of the PIC assembly of FIG. 6A through Section A-A′.

FIG. 6C shows a cross-sectional schematic drawing of the embodiment of the PIC assembly of FIG. 6A through Section B-B′.

FIG. 7A shows an exploded top-view schematic drawing of a portion of another embodiment of a PIC assembly wherein two points of contact are provided between the tongue-shaped alignment features of the interposer and the groove-shaped alignment features of the coupler.

FIG. 7B shows a top-view schematic drawing of the T&G alignment aids on a portion of an embodiment of a PIC assembly.

FIG. 7C shows a top-view schematic drawing of the T&G alignment aids on a portion of another embodiment of a PIC assembly.

FIGS. 8A-8F show top-view schematic drawings of some example configurations of T&G alignment aids that may be used in embodiments of a PIC assembly.

FIG. 9 shows a flowchart for a method of forming embodiments of a PIC assembly comprising a coupler and an interposer, wherein the coupler is configured having one or more contacting locations on a lateral alignment aid formed self-aligned with one or more planar waveguide core of the coupler, and wherein the interposer is configured having one or more contacting locations on a lateral alignment aid formed self-aligned with one or more planar waveguide cores of the interposer.

FIG. 10A shows a cross-sectional schematic drawing of an embodiment of a PIC assembly having a coupler and an interposer after formation of the coupler and the interposer step as in 172-1 of method 172.

FIG. 10B shows a cross-sectional schematic drawing of an embodiment of a PIC assembly comprising a coupler and an interposer after the coupler and interposer are brought into physical contact as in step 172-2 of method 172.

FIG. 11A shows a top-view schematic drawing of an embodiment of an interposer having a first portion of a T&G alignment aid, two fiducials, and four alignment pillars formed in a cavity.

FIG. 11B shows a top-view schematic drawing of an embodiment of a coupler having a second portion of a T&G alignment aid formed to complement the first portion of the T&G alignment aid shown in FIG. 11A two fiducials, lateral alignment aids to facilitate alignment of one or more of an optical isolator and a lens, and lateral alignment aids to facilitate alignment of an FAU, all of which may be formed self-aligned with the planar waveguide shown on the coupler.

FIG. 11C shows a top-view schematic drawing of an embodiment of a PIC assembly comprising the interposer of FIG. 11A and the coupler of FIG. 11B wherein the first portions of the T&G alignment features formed on the interposer are coupled to the second portions of the T&G alignment features formed on the coupler, and wherein the PIC assembly further comprises an FAU configured having an optical fiber.

FIG. 12 shows a method 194 of forming an embodiment of an optical interposer having self-aligned features that include a first portion of a T&G alignment aid, and optionally include one or more fiducials, one or more alignment pillars, and one or more lateral alignment aids.

FIG. 13A shows a schematic cross-sectional drawing of a portion of an embodiment of an interposer having a substrate, an optional electrical interconnect layer, and a first portion of a planar waveguide layer, wherein the first portion of the planar waveguide layer in the embodiment comprises a core layer and a bottom cladding layer.

FIG. 13B shows a schematic cross-sectional drawing of a portion of the embodiment of the interposer of FIG. 13A after formation of a first patterned mask layer and patterning of the core layer of the planar waveguide layer.

FIG. 13C shows a schematic cross-sectional drawing of a portion of the embodiment of the interposer of FIG. 13B after removal of the first patterned mask layer from a first portion of a patterned planar waveguide formed from the first portion of the planar waveguide layer, and after formation of a second portion of the planar waveguide layer comprising a top cladding layer.

FIG. 13D shows a schematic cross-sectional drawing of a portion of the embodiment of the interposer of FIG. 13C after formation of a second patterned mask layer on the top cladding layer.

FIG. 13E shows a schematic cross-sectional drawing of a portion of the embodiment of the interposer of FIG. 13D after formation of a cavity having self-aligned alignment pillars, after formation of a cavity having a fiducial, and after formation of a first portion of a T&G alignment aid.

FIG. 13F shows a schematic cross-sectional drawing of a portion of the embodiment of the interposer of FIG. 13E after formation of a third patterned mask layer and singulation of the interposer die from the host wafer.

FIG. 14 shows a method 195 of forming an embodiment of a coupler having self-aligned features that include a second portion of a T&G alignment aid, and optionally include one or more fiducials, one or more alignment pillars, and one or more lateral alignment aids.

FIGS. 15A1, 15A2, and 15A3 show schematic cross-sectional drawings through Sections A-A′, B-B′ and C-C′, respectively, of portion of an embodiment of a coupler having a substrate, an optional electrical interconnect layer, and a first portion of a planar waveguide layer, wherein the first portion of the planar waveguide layer in the embodiment comprises a core layer and a bottom cladding layer.

FIGS. 15B1, 15B2, and 15B3 show schematic cross-sectional drawings of a portion of the embodiment of the coupler of FIGS. 15A1, 15A2, and 15A3, respectively, after formation of a first patterned mask layer and patterning of the core layer of the planar waveguide layer.

FIGS. 15C1, 15C2, and 15C3 show schematic cross-sectional drawings of a portion of the embodiment of the coupler of FIGS. 15B1, 15B2, and 15B3, respectively, after removal of the first patterned mask layer from a first portion of a patterned planar waveguide formed from the first portion of the patterned planar waveguide layer, and after formation of a second portion of the planar waveguide layer comprising a top cladding layer in the embodiment.

FIGS. 15D1, 15D2, and 15D3 show schematic cross-sectional drawings of a portion of the embodiment of the coupler of FIGS. 15C1, 15C2, and 15C3, respectively, after formation of a second patterned mask layer on the top cladding layer.

FIGS. 15E1, 15E2, and 15E3 show schematic cross-sectional drawings of a portion of the embodiment of the coupler of FIGS. 15D1, 15D2, and 15D3, respectively, after formation of a cavity having a fiducial, and after formation of a second portion of a T&G alignment aid.

FIGS. 15F1, 15F2, and 15F3 show schematic cross-sectional drawing of a portion of the embodiment of the coupler of FIGS. 15E1, 15E2, and 15E3, respectively, after formation of a third patterned mask layer and singulation of the coupler die from the host wafer.

FIG. 16A shows schematic end view drawing of an example of a multi-lens array.

FIG. 16B shows schematic side view drawing of an example of a lens array.

FIG. 16C shows an enlarged schematic cross section drawing of an optical signal propagating through a portion of a planar waveguide and a multi-lens array substrate and lens.

FIG. 17A shows a schematic perspective drawing of a two-photon polymerization apparatus forming a lens on a waveguide facet formed on the wall of a cavity in an embodiment of coupler.

FIGS. 17B1-17B7 show cross-section schematic drawings of in-structure lenses of lens array structures formed using 2PP or other 3D printing method.

FIGS. 18A-18Y show embodiments of coupler assemblies wherein the couplers are configured having a cavity comprising two lens arrays, and further configured having an FAU mounting site.

FIGS. 19A-19T show embodiments of coupler assemblies wherein the couplers are configured having a cavity comprising one lens array, and further configured having an FAU mounting site.

FIG. 20 shows a flowchart for a method of forming embodiments of a coupler, coupler assembly, and PIC assembly wherein the coupler assembly is configured having two lens arrays formed using two-photon polymerization on planar waveguide facets in the cavity.

FIGS. 21A-21F show perspective schematic drawings of embodiments formed in steps in the flowchart of FIG. 20.

FIG. 22 shows a flowchart for a method of forming embodiments of a coupler, coupler assembly, and PIC assembly wherein the coupler assembly is configured having two multi-lens arrays.

FIGS. 23A-23D show perspective schematic drawings of embodiments formed in steps in the flowchart of FIG. 22.

FIG. 24 shows a flowchart for a method of forming embodiments of a coupler, coupler assembly, and PIC assembly wherein the coupler assembly is configured having an ingoing lens array formed on planar waveguide facets in the cavity using two-photon polymerization and an outgoing lens array configured as a multi-lens array.

FIGS. 25A-25E show perspective schematic drawings of embodiments formed in steps in the flowchart of FIG. 24.

FIG. 26 shows a flowchart for a method of forming embodiments of a coupler, coupler assembly, and PIC assembly wherein the coupler assembly is configured having a cavity comprising an ingoing lens array structure and an outgoing lens array structure formed in the cavity using two-photon polymerization.

FIGS. 27A-27F show perspective schematic drawings of embodiments formed in steps in the flowchart of FIG. 26.

FIG. 28 shows a flowchart for a method of forming embodiments of a coupler, coupler assembly, and PIC assembly wherein the coupler assembly is configured having a cavity comprising one lens array structure formed in the cavity using two-photon polymerization, wherein the ingoing optical signals are free-space coupled to the lenses of the 2PP lens structure, and the outgoing optical signals are free-space coupled from the lenses of the lens array structure to an optical isolator and to the terminal facets of the cores of optical fibers mounted in an FAU on the coupler.

FIGS. 29A-29F show perspective schematic drawings of embodiments formed in steps in the flowchart of FIG. 28.

FIG. 30 shows a flowchart for a method of forming embodiments of a coupler, coupler assembly, and PIC assembly wherein the coupler assembly is configured having a cavity comprising one multi-lens array in the cavity, wherein the ingoing optical signals are coupled from ingoing planar waveguide facets to the lenses of the multi-lens array, and the outgoing optical signals are coupled from the lenses of the multi-lens array to facets of outgoing planar waveguides through an optical isolator.

FIGS. 31A-31D show perspective schematic drawings of embodiments formed in steps in the flowchart of FIG. 30.

FIG. 32A shows an exploded top-view schematic drawing of an embodiment of a PIC assembly comprising an interposer assembly and a coupler assembly, wherein the interposer assembly is configured having four optoelectrical devices mounted in cavities formed on an interposer, wherein the coupler assembly is configured having an optical isolator and two multi-lens arrays in a cavity of the coupler, and wherein the interposer assembly and coupler assembly are configured to enable free-space coupling of optical signals from the cavity-mounted emitting devices on the interposer to the cavity-mounted lenses of the coupler.

FIG. 32B shows an exploded top-view schematic drawing of an embodiment of a PIC assembly comprising an interposer assembly and a coupler assembly, wherein the interposer assembly is configured having four optoelectrical devices mounted in cavities formed on the interposer, wherein the coupler assembly is configured having an optical isolator and two 3D printed lens array structures formed in a cavity of the coupler, and wherein the interposer assembly and the coupler assembly are configured to enable free-space coupling of optical signals from the cavity-mounted optoelectrical devices on the interposer to the 3D printed lenses formed in the cavity of the coupler.

FIG. 32C shows a top-view schematic drawing of an embodiment of a PIC assembly comprising an interposer assembly and a coupler assembly, wherein the interposer assembly is configured having four optoelectrical devices mounted in cavities formed on the interposer, wherein the optoelectrical devices are coupled to alignment aids formed self-aligned with T&G alignment features on the interposer, wherein the coupler assembly is configured having an optical isolator and two 3D printed lens structures formed in a cavity of the coupler, and wherein the interposer assembly and coupler assembly are configured to enable free-space coupling of optical signals from the emitting devices on the interposer assembly to the lenses of 3D printed lens array structures formed in the cavity of the coupler. (The emitting devices are shown in dotted lines in the device-mounting cavities on the interposer for clarity.)

FIG. 32D shows a cross-section schematic drawing through Section A-A′ of the embodiment of the assembly shown in FIG. 32C. (The emitting device is shown in dotted lines in the device-mounting cavity on the interposer for clarity.)

FIG. 32E shows a top-view schematic drawing of another embodiment of a PIC assembly comprising an interposer assembly and a coupler assembly, wherein the interposer assembly is configured having four emitting devices mounted as an array in a cavity formed on the interposer, and wherein the coupler assembly is configured as in FIGS. 32B and 32C.

FIGS. 33A-33G show top-view schematic drawings embodiments of a PIC assembly comprising an interposer assembly and a coupler assembly, wherein the interposer assembly is configured having one or more optoelectrical device mounted in one or more cavity on the interposer.

FIG. 33A shows a top-view schematic drawing of an embodiment of a PIC assembly comprising an interposer assembly and a coupler assembly wherein the interposer assembly is configured having four emitting devices and wherein the coupler assembly is configured having an optical isolator and 3D printed on-facet lenses formed on waveguide facets on the ingoing side of the cavity. (The emitting devices are shown in dotted lines in the device-mounting cavities on the interposer for clarity.)

FIG. 33B shows a top-view schematic drawing of an embodiment of a PIC assembly comprising an interposer assembly and a coupler assembly wherein the interposer assembly is configured having four optoelectrical devices each mounted in a cavity and wherein the coupler assembly is configured having an optical isolator and two 3D printed lens array structures formed in a cavity on the coupler.

FIG. 33C shows a top-view schematic drawing of an embodiment of a PIC assembly 101 comprising an interposer assembly and a coupler assembly wherein the interposer assembly is configured having optoelectrical devices of an array of optoelectrical devices each coupled to front and rear gratings on the interposer and wherein the coupler assembly is configured having an optical isolator and two multi-lens arrays mounted in a cavity on the coupler.

FIG. 33D shows a top-view schematic drawing of an embodiment of a PIC assembly comprising an interposer assembly and a coupler assembly wherein the interposer assembly is configured having the optoelectrical device array and front and rear grating structures as in FIG. 33C and is further configured having a 3D printed on-facet lens array in a cavity on the interposer, and wherein the coupler assembly is configured having an optical isolator and a 3D printed on-facet lens array in a cavity on the coupler.

FIG. 33E shows a top-view schematic drawing of an embodiment of a PIC assembly comprising an interposer assembly and a coupler assembly wherein the interposer assembly is configured having four optical emitting devices, each mounted in a cavity, each coupled to a power monitoring device, and each coupled to a front grating device, wherein the interposer assembly is further configured having a 3D printed on-facet lens array in a cavity on the interposer, and wherein the coupler assembly is configured having an optical isolator and a 3D printed on-facet lens array in a cavity on the coupler.

FIG. 33F shows a top-view schematic drawing of an embodiment of a PIC assembly comprising an interposer assembly and a coupler assembly wherein the interposer assembly is configured having an optoelectrical device array comprising four emitting devices each coupled to a power monitoring device.

FIG. 33G shows a top-view schematic drawing of an embodiment of a PIC assembly comprising an interposer assembly and a coupler assembly wherein the interposer assembly is configured having an optoelectrical device array comprising four emitting devices each coupled to a rear grating device further coupled to a power monitoring device, wherein the interposer assembly is further configured having the lenses of a multi-lens array in a cavity on the interposer, and wherein the coupler assembly is configured having an optical isolator and a 3D printed on-facet lens array in a cavity on the coupler.

FIG. 34A shows a top-view schematic drawing of an embodiment of a coupler configured having alignment pillars in device-mounting cavities wherein the alignment pillars are formed self-aligned with waveguide cores formed on the coupler, and formed self-aligned with optical fiber alignment features, tongue shaped alignment aids of T&G alignment features, and fiducials.

FIG. 34B shows a cross-sectional schematic drawing of the embodiment of FIG. 34A.

FIG. 34C shows a top-view schematic drawing of an embodiment of a coupler assembly comprising four optoelectrical devices each mounted in a device-mounting cavity, wherein the coupler is configured having alignment pillars formed self-aligned with waveguide cores (Optoelectrical devices are shown in dotted lines in the device-mounting cavities for clarity.)

FIG. 34D shows a cross-section schematic drawing of the embodiment of the coupler shown in FIG. 34C. (The emitting device is shown in dotted lines in the device-mounting cavity for clarity.)

FIG. 35A shows a top-view schematic drawing of an embodiment of a PIC assembly comprising an interposer assembly and a coupler assembly, wherein the coupler assembly comprises four optical devices each mounted in a device mounting cavity and wherein the interposer assembly is configured having an on-facet lens array in a lens cavity.

FIG. 35B shows a cross-section schematic drawing of the embodiment of the coupler shown in FIG. 35A.

FIG. 35C shows a top-view schematic drawing of an embodiment of a PIC assembly comprising an interposer assembly and a coupler assembly, wherein the interposer assembly is configured having a plurality of hybrid laser structures coupled to a multi-lens array, and wherein the coupler assembly is configured as in FIG. 35A.

FIG. 36A shows a top-view schematic drawing of an embodiment of a coupler assembly comprising a coupler, an optical isolator and two on-facet lens arrays formed in a cavity, wherein waveguides on the coupler are configured having spot size converters, and wherein the device-mounting cavities are formed between the cavity having the optical isolator and the edge of the coupler that couples to an interposer. (The optical devices in the device mounting cavities are shown in dotted lines on the coupler for clarity.)

FIG. 36B shows a cross-section schematic drawing of the embodiment of the coupler assembly shown in FIG. 36A. (The optical device in the device mounting cavity is shown in dotted lines on the coupler for clarity.)

FIG. 36C shows a top-view schematic drawing of an embodiment of a PIC assembly comprising an interposer assembly and a coupler assembly, wherein the coupler assembly is configured as in FIG. 36A, and wherein the interposer assembly is configured having an optoelectrical device array mounted in a cavity formed in the interposer on alignment features formed self-aligned with waveguide cores on the interposer. (The optoelectrical devices in the device mounting cavities are shown in dotted lines in the device-mounting cavities on the coupler and on the interposer for clarity.)

FIG. 36D shows a cross-section schematic drawing of the embodiment of the coupler shown in FIG. 36C. (The optoelectrical devices are shown in dotted lines in the device-mounting cavities on the coupler and on the interposer for clarity.)

FIG. 36E shows a top-view schematic drawing of an embodiment of a PIC assembly comprising an interposer assembly and a coupler assembly, wherein the interposer assembly is configured having a plurality of surface grating devices coupled to the optoelectrical devices of an optoelectrical device array on the interposer, and wherein the optoelectrical devices of the optoelectrical device array are coupled to the lenses of a multi-lens array mounted in a cavity on the interposer, and wherein the coupler assembly is configured as in FIGS. 36A and 36B.

FIG. 36F shows a cross-section schematic drawing of the embodiment of the coupler shown in FIG. 36E. The INSET shows an enlarged perspective drawing of an embodiment of the rear grating structure. (The optoelectrical devices are shown in dotted lines in the device-mounting cavities on the coupler and on the interposer for clarity.)

FIG. 37A shows a top-view schematic drawing of an embodiment of a PIC assembly comprising an interposer assembly and a coupler assembly, wherein the interposer assembly is configured having a loopback waveguide to facilitate vertical alignment of waveguides cores on the coupler with waveguide cores on the interposer, and having T&G alignment aids to facilitate lateral alignment.

FIG. 37B shows a cross-section schematic drawing of the embodiment of FIG. 37A.

FIG. 37C shows a top-view schematic drawing of an embodiment of a PIC assembly comprising an interposer assembly and a coupler assembly, wherein the interposer assembly is configured having a loopback waveguide to facilitate both vertical and lateral alignment of the waveguide cores of the coupler with waveguide cores on the interposer.

FIG. 37D shows a top-view schematic drawing of an embodiment of a PIC assembly comprising an interposer assembly and a coupler assembly, wherein the interposer assembly is configured having a loopback waveguide to facilitate both vertical and lateral alignment of the waveguide cores of the coupler assembly with waveguide cores on the interposer assembly, and wherein the coupler is configured having an optical isolator positioned between two multi-lens arrays.

FIG. 37E shows a top-view schematic drawing of an embodiment of a PIC assembly comprising an interposer assembly and a coupler assembly, wherein the interposer assembly is configured having a loopback waveguide to facilitate vertical alignment of the waveguide cores of the coupler with waveguide cores on the interposer, and wherein the coupler is configured having an optical isolator positioned between two multi-lens arrays.

FIG. 38A shows a top-view schematic drawing of an embodiment of a PIC assembly comprising an interposer assembly and a coupler assembly, wherein the coupler assembly is configured having a fanout waveguide to facilitate alignment of waveguide cores of the interposer having different spacings than the optical fiber cores of optical fibers mounted of the coupler.

FIG. 38B shows an exploded top-view schematic drawing of embodiment of an assembly comprising an interposer assembly and a coupler assembly, wherein the coupler assembly is configured having a fanout waveguide to facilitate alignment of waveguide cores of the interposer having different spacings than the optical fiber cores of the optical fibers on the coupler, and wherein the coupler assembly is further configured having an optical isolator positioned between two multi-lens arrays.

FIG. 39A shows a top-view schematic drawing of an embodiment of a coupler assembly configured having an optical isolator mounted or otherwise formed in a cavity and two ball lens arrays formed in the coupler, wherein the alignment feature for the ball lens arrays in the embodiment are formed self-aligned with waveguide cores of the coupler.

FIG. 39B shows a cross-section schematic drawing through Section A-A′ of the embodiment of FIG. 39A.

FIG. 39C shows a cross-section schematic drawing through Section B-B′ of the embodiment of FIG. 39A.

FIG. 40 shows a top-view schematic drawing of the embodiment of the PIC assembly of FIG. 2C wherein an epoxy or other bonding material is used to bond the T&G alignment features of the interposer and the coupler, to bond the multi-lens arrays and optical isolator to the coupler, and to bond the four optical fibers to the coupler.

FIG. 41A shows a flowchart for a method 176 of forming embodiments of a PIC assembly comprising an interposer and a coupler.

FIG. 41B shows a flowchart for a method 177 of forming embodiments of a PIC assembly comprising an interposer and coupler and optionally further comprising one or more optical fibers.

FIG. 41C shows a flowchart for a method 178 of forming embodiments of a PIC assembly comprising an interposer and coupler, and optionally further comprising one or more optical fiber, wherein the interposer and coupler optionally include one or more of a lateral alignment aid, alignment pillar, and fiducial, among other alignment aids formed self-aligned with one or more planar waveguide core formed on the interposer and coupler, respectively.

FIG. 42 shows a flowchart for a method 180 of forming a PIC assembly comprising an interposer assembly and a coupler assembly.

FIG. 43A shows a schematic perspective drawing of an embodiment of an interposer wafer comprising a plurality of interposers wherein the interposers of the plurality of interposers optionally include a first portion of a T&G lateral alignment feature formed self-aligned with a waveguide core of the interposer.

FIG. 43B shows a schematic perspective drawing of an embodiment of a coupler wafer comprising a plurality of couplers wherein the couplers of the plurality of couplers optionally include a second portion of a T&G lateral alignment aid formed self-aligned with a waveguide core of the coupler.

FIG. 43C shows a schematic perspective drawing of an embodiment of an assembly comprising an interposer from the interposer wafer of FIG. 43A and a coupler from the coupler wafer of FIG. 43B.

Other aspects and features of embodiments will become apparent to those skilled in the art upon review of the following detailed description in conjunction with the accompanying figures.

### DETAILED DESCRIPTION OF EMBODIMENTS

### Definitions

The following terms, phrases, and acronyms, as used throughout this specification and in the accompanying claims, shall be construed to possess the meanings set forth below. This section is provided to clarify the scope of the claimed subject matter and to ensure that the invention is clearly and consistently understood. Where a term is not specifically defined herein, it should be given its ordinary and customary meaning as understood by one of ordinary skill in the art, unless the context clearly indicates otherwise.

An “optical signal”, as used herein, refers to a group of one or more photons of electromagnetic radiation in the visible or near-infrared range of the electromagnetic spectrum that may be used to carry information in one or more of a photonic integrated circuit and an optical network. Commonly used wavelength ranges include the O-band (1260-1360 nm) and C-band (1530-1565 nm), although other wavelength ranges may also be used. An “optical signal”, as used herein, may be modulated or unmodulated.

A “planar waveguide”, as used herein, refers to a signal carrying core and one or more cladding layers surrounding the core. The core layer of a waveguide, formed from a layer having a refractive index higher than the surrounding cladding layers, forms a path for the confinement of optical signals. In embodiments, the signal carrying portion of a waveguide may be a single core surrounded by one or more cladding layers. In some embodiments, a rib waveguide may be used wherein the cladding may not completely surround the waveguide core. In some embodiments, the core layer may comprise a plurality of layers that together form a core layer, wherein the layers in the plurality of core layers may have more than one refractive index. In some embodiments, the core layer may comprise a plurality of cores that together form a signal carrying core of a planar waveguide. For simplicity, in embodiments described herein, the core of the planar waveguide is described as a patterned layer having a higher index of refraction than the surrounding layers. It should be understood, however, that other embodiments having signal carrying layers that are formed using one or more of a rib waveguide core, a core comprised of a plurality of layers, and a core comprised of one or more cores, may be used. The core of a planar waveguide may be formed, for example, from silicon, silicon oxynitride, silicon nitride, silicon oxide, lithium niobate, among other layers. The core of a planar waveguide layer may be formed from a polymer such as, for example, polymethyl methacrylate, polyimide, epoxy-based polymers, perfluorinated polymers, and optical adhesives, and acrylate polymers, among others. Cladding layers may be formed, for example, from one or more films having a lower refractive index than the signal carrying core. Examples of cladding layers are silicon oxide, silicon oxynitride, polymer layers, among others. A top cladding layer, as used herein, refers to a cladding layer having a lower refractive index than that of the core of the planar waveguide, and formed on and coupled to at least the top portion of the core of a planar waveguide but may also include the cladding formed on and coupled to all or a portion of one or both of the sidewalls of the core of the planar waveguide. A bottom cladding layer, as used herein, refers to a cladding layer having a lower refractive index than that of the core of the planar waveguide, and upon which the core layer of a planar waveguide may be formed and coupled to at least the bottom portion of the core of a planar waveguide, and may also include the cladding formed on and coupled to all or a portion of one or both of the sidewalls of the core of the planar waveguide. The term “top cladding” as used herein, refers to the lower refractive index layer formed on or coupled to the boundary of the core layer furthest from the substrate upon which the planar waveguide is formed. And the term “bottom cladding”, as used herein, refers to the lower refractive index layer formed on or coupled to the boundary of the core layer closest to the substrate upon which the planar waveguide is formed.

A “waveguide”, as used herein, refers to a planar waveguide comprising a high refractive index core layer and one or more lower refractive index top, bottom, and side cladding layers. It should be understood that the distal boundaries of the cladding portions of a waveguide may not be well-defined whereas the core layer of a waveguide is typically determined by a lithographic patterning step and a subsequent etch or other film patterning method. A “waveguide core”, as used herein, refers to the high refractive index portion of a planar waveguide as defined by the lithographic patterning and subsequent etch or other film patterning method.

An “optical isolator”, as used herein, refers to a device that allows light to propagate in only one direction while blocking light in the opposite direction. Optical isolators in a photonic integrated circuit prevent reflected optical signals from coupling back into all or a portion of a photonic integrated circuit after these optical signals have propagated through the optical isolator. An optical isolator can protect sensitive components such as lasers and gain devices, for example, from unwanted back-reflections and feedback that can cause instability and degrade performance. An optical isolator can provide unidirectional light transmission and can prevent reflected or scattered light from returning to its source and may be used in embodiments to maintain operational stability of optical emitting devices such as integrated lasers and gain devices, among other optical emitting devices used in photonic integrated circuits. A typical structure for providing unidirectional light transmission that may be used in the O-band range of optical wavelengths (1260-1360 nm), for example, combines a material such as yttrium iron garnet with polarizers or birefringent elements to create directional isolation. Other materials and combinations of materials may also be used in embodiments. Many materials and combinations of materials used in the formation of optical isolators utilized in photonic integrated circuits exploit the magneto-optic effect in which the polarization plane of light is rotated when propagating through a magneto-optic material under the influence of a magnetic field. Magneto-optic materials used in optical isolators typically exhibit strong Faraday rotation and low optical absorption. Other materials that may be used, for example, to form an optical isolator for wavelengths in the O-band include bismuth-doped yttrium iron garnet, cerium-doped yttrium iron garnet, terbium gallium garnet, and terbium-doped silica. Other materials may be used in other wavelength ranges.

A “Lens”, as used herein, refers to an optical device mounted or otherwise formed in all or a portion of an assembly used in the formation of a photonic integrated circuit that may be used to one or more of focus, collimate, and shape the optical mode of optical signals in all or a portion of the photonic integrated circuit. Lenses may be used, for example, in photonic integrated circuits in the form of a planoconvex structure formed on a transparent substrate, for example, a fabricated lens formed using two-photon-polymerization or other form of 3D printing, and a ball lens, among other forms of lenses. Embodiments described herein utilize a variety of lens types to facilitate the propagation of optical signals through all or a portion of photonic integrated circuit assemblies.

“3D printing”, as used herein, refers to a method of forming a mechanical part using an additive manufacturing process, for example, to construct a three-dimensional (3D) physical object by successively adding and fusing material layers using an automated process.

“Two-photon polymerization”, as used herein, refers to a 3D printing microfabrication technique for forming all or a portion of a physical object using a polymerizing precursor material that when exposed to a highly focused optical energy source can result in the polymerization of the precursor to form a solidified layer of the physical object. Herein, the term, “two-photon polymerization” refers to use of one or more processing steps in which the technique or method of using the absorption of two photons by a polymerizing precursor to form all or a portion of a polymerized layer is used. Structures, and assemblies that include these structures, can thusly be formed from the utilization of two-photon polymerization processes. In an embodiment, for example, of a coupler structure comprising a planar waveguide formed on a substrate and a cavity formed in the coupler structure that intersects the planar waveguide core of the planar waveguide layer, and a lens formed on a terminal facet of a planar waveguide core formed in the cavity using two-photon polymerization, the lens may be formed from a cross-linked polymerizable resin. In this and other embodiments disclosed herein, the lens may be formed from the cross-linked polymerized resin. Two-photon polymerization processes are used in commercially available equipment such as the Sonata 1000 series tool manufactured by Vanguard Automation GmbH. Herein, “two-photon polymerization” may be abbreviated to “2PP”.

A “polymerizing precursor”, as used herein, refers to a material having properties such that the absorption of light, typically in the ultraviolet range, leads to cross-linking of molecular bonds within the material. A “polymerizing precursor” may be a photoresist. A “polymerizing precursor” may be all or a portion of a photoinitiator, a photopolymer, a UV-curable resin, among other materials having the property that the absorption of light, typically in the ultraviolet range, can lead to cross-linking of polymeric molecular chains within a light exposed layer. In two-photon polymerization, the UV energy is provided with the absorption of two sub-UV photons per cross-linking event in the material to facilitate localized cross-linking. Unlike an exposure that alters the properties of a layer with a broad exposure, as in photolithography for example, the two-photon polymerization process is a highly localized process occurring within a concentrated volume provided with the aid of a focusing apparatus wherein the polymerization is initiated with the absorption of two sub-UV wavelengths of light to facilitate cross-linking. In an example, the wavelength of light used in the two-photon polymerization process may be in the range of 600-900 nm corresponding to photon energies in the range of 2.06-1.38 eV. The wavelengths in this range of wavelengths are longer than the wavelengths of light used in the ultraviolet polymerization processes, that may be, for example, in the range of 250-400 nm, and smaller (corresponding to photon energies in the range of 4.96-3.10). These ranges provide an example of the wavelengths and corresponding photon energy that may be used in a typical two-photon polymerization process. Excitation energy may also be provided at other wavelengths in the two-photon polymerization processes disclosed herein. With sub-100 nm wavelengths in use in current advanced lithography tools for advanced semiconductor processing, photosensitive materials for processing at these wavelengths are currently available and may be utilized. Although higher resolution is anticipated with smaller wavelengths, however, the optical power sources required may be more costly.

In methods disclosed herein, two-photon polymerization may be used, for example, to provide high resolution lens structures and alignment features, among other features, in combination with other fabrication techniques in the formation of the embodiments disclosed herein. Two-photon polymerization processes leverage the nonlinear optical phenomenon of two-photon absorption to achieve high-resolution, three-dimensional structures. Unlike conventional single-photon polymerization, which relies on linear absorption of light, two-photon polymerization necessitates the simultaneous absorption of two photons by a photosensitive molecule within the focal volume of a tightly focused laser beam. This nonlinear process exhibits a strong intensity dependence, confining the polymerization reaction to a small (sub-diffraction-limited) region.

“Self-alignment”, as used herein, refers to the use of a single patterned mask layer in the patterning of two or more features in a lithography process that is then used in a subsequent etch or patterning process to form the two or more patterned features from the lithographically patterned layer. An alignment feature, for example, is formed self-aligned with a patterned planar waveguide core if the alignment feature and the patterned planar waveguide core are patterned using a same lithographic process to form a patterned mask layer and a same patterning process to pattern the layer or layers underlying the lithographically patterned layer.

A single patterned mask layer may be used in embodiments, for example, to pattern two or more features that include, for example, one or more waveguide core and one or more alignment feature wherein the one or more alignment feature may comprise one or more fiducial, one or more lateral alignment aid, one or more alignment pillar, among other alignment features for which the lithographic registration in alignment of the one or more features is maintained throughout a fabrication process. Methods of maintaining the lithographic registration in subsequent patterning steps are disclosed herein.

In embodiments, a planar waveguide structure that may be used in the formation of one or more of an optical interposer and an optical coupler, for example, comprises a planar waveguide layer formed on a base structure, wherein the base structure further comprises an optional electrical interconnect layer formed on a substrate. In a completed photonic integrated circuit, the planar waveguide layer is a layer, within which optical signals propagate, comprising one or more planar waveguide cores, and one or more of a top, side, and bottom cladding layer surrounding the patterned planar waveguide cores, and optionally comprising one or more other layers including one or more spacer layers, patterned mask layers, buffer layers, and planarization layers, for example, among other layers. The core layer in some embodiments, is a single waveguide layer. In other embodiments, the core layer may be a layered structure of one or more layers that together form a core layer.

Alignment of devices using methods of self-alignment, may be achieved in some embodiments, with the patterning of lateral alignment features using a same lithographic and patterning processes as used to pattern one or more planar waveguide cores of the interposer, for example, and the coupler. Upon patterning of the alignment features and the planar waveguide cores, the patterned mask layer used in the patterning is removed from the planar waveguide cores, but not removed from the alignment features. The still-patterned alignment aids and mask-free patterned planar waveguide cores are then buried in a dielectric layer allowing for the formation of the upper layers of the planar waveguide layer including an upper cladding layer.

After formation of the planar waveguide layer, masked alignment features buried within the planar waveguide layer may be uncovered with the use of a patterned mask layer formed on the planar waveguide layer, coupled with a suitable etch process, to remove the unmasked portions of the planar waveguide layer. The already patterned self-aligned mask layers of the buried alignment features are re-exposed in cavities formed in the planar waveguide layer to enable the formation of the alignment pillars in self-alignment with the patterned planar waveguide cores.

The patterned mask layer used in the formation of a cavity is positioned on the planar waveguide layer, in embodiments, such that upon formation, a wall of the cavity may intersect a patterned planar waveguide core enabling the coupling of optical signals between an optoelectrical device, for example, mounted on the alignment pillars formed within the cavity and the planar waveguide core intersected by the wall of the cavity.

Alignment features include lateral reference structures that facilitate the registration and alignment of optical structures formed from the planar waveguide layer of an optical interposer structure and to the alignment of optical devices and components that are mounted onto the submount or optical interposer. Such alignment features provide improvements in the manufacturability of photonic integrated circuits (PICs) that use mounted optical components and that require alignment with the planar waveguide cores on an optical interposer structure that includes a planar waveguide layer. In some embodiments, alignment pillars formed in a cavity in self-alignment with planar waveguide cores facilitate vertical and lateral alignment of the optical axis of an optoelectrical device, for example, placed in the cavity with the optical axis of the planar waveguide cores intersecting a cavity wall. Optical devices may be, in embodiments, emitting devices, receiving devices, waveguides, and transforming devices, for example, among other devices.

In some embodiments, the alignment features formed in one or more cavities include fiducials and alignment pillars wherein the alignment pillars may be one or more of lateral alignment pillars and vertical alignment pillars formed in self-alignment with one or more planar waveguide cores of a submount. Fiducials, formed self-aligned with the alignment pillars, facilitate accurate placement of mountable devices onto the alignment pillars, for example, using automated pick-and-place apparatus. Electrical contacts formed in the cavities facilitate flip-chip placement and bonding techniques in embodiments. Fiducials are formed in the same cavities with the alignment pillars in some embodiments, and may be formed in different cavities than the alignment pillars in other embodiments. In some embodiments, alignment pillars may be configured as fiducials. Fiducials formed self-aligned with alignment pillars have the same depth of focus to facilitate high accuracy positioning and placement. Precise lateral registration between features is achieved, in embodiments, using a methodology in which a same patterned mask layer is used to pattern all features requiring alignment. The subsequent burial and re-exposure of the patterned mask layer in subsequent processing steps ensures that the precise feature registration provided by the use of the same patterned mask layer is maintained throughout the formation of the submount and the alignment structures provided thereon. The precise lateral registration provided in embodiments is in contrast to methodologies that utilize multiple masking layers in multilayer structures that require re-registration at each masking layer. Multiple masking layers can lead to significant registration errors in overlapped patterns that can lead to the formation of defects and to the creation of excessive variation in the relative alignment of patterns formed on successive layers. The requirement for multilevel registration is eliminated in critical patterning layers within the multilayer planar waveguide layer in embodiments of structures, assemblies, and methods disclosed herein. As used herein, in the context of flip-chip assembly, the pick-and-place machine is the piece of equipment used to perform the highly precise task of picking up the flipped die and placing it onto the substrate's corresponding pads. Therefore, flip-chip is a specific application performed by a pick-and-place process.

An “optical device”, as used herein, may refer to a purely optical device such as a waveguide that does not have an electrical feature and to an optoelectrical device that has both an optical feature and an electrical feature, unless specified otherwise.

An “optical device”, as used herein, refers to a device, for example, such as a waveguide, an optical isolator, a spot size converter, a lens, a grating, an arrayed waveguide, an optical fiber, a ring resonator, among other devices comprising a waveguide through which optical signals may propagate through all or a portion of the device. An “optical device”, as used herein, also refers to an “optoelectrical device” wherein an optoelectrical device refers to a device configured having both an optical feature and an electrical feature, such as a laser, a gain device, a semiconductor optical amplifier, a photodiode, a photodetector, among other optoelectrical devices comprising an optical feature such as waveguide, an optical aperture, among other optical features, and an electrical feature, such as one or more electrical contact to facilitate the creation of an electric field within the device, among other types of electrical features.

As used herein, the term “optical device” may refer to “optical devices” and “optoelectrical devices”.

A “lateral grating”, as used herein, refers to a grating structure formed from all or a portion of the planar waveguide layer wherein the structure of the lateral grating refers to a periodic modulation of the effective refractive index applied to a waveguide, and wherein the periodicity is aligned longitudinally (i.e., along the direction of light propagation), but the structural features responsible for the modulation are located or defined in the transverse lateral dimension (i.e., across the width of the waveguide). A lateral grating is fundamentally a waveguide having periodically modulated sidewalls such that the width of the waveguide, or the refractive index contrast at the sidewall, varies along its length. The primary function of a lateral grating is to provide longitudinal feedback, mode filtering, or lateral coupling.

A lateral grating is structurally defined by a guiding region (the waveguide core), the sidewalls of which exhibit a periodic corrugation in the plane of the layer. This corrugation, as viewed from a top-down perspective, may be formed, for example from a single lithographic and etching step defining the waveguide boundary itself, and resulting in a series of alternating wider and narrower segments of the waveguide core that repeat along the propagation axis with a fixed grating period. The variation in the width of the guiding core along its length generates the required periodic change in the modal effective refractive index in this example. Other methods for providing a periodic change in the modal effective refractive index may also be used in embodiments to achieve the desired optical function, which may be, for example, a wavelength selection device.

A lateral grating, as referred to herein, is distinguished from a planar grating (or top-surface grating) in that the structural corrugation is applied to the lateral boundaries of the waveguide in a lateral grating, rather than to the top surface (the interface between the core and the upper cladding) as in a planar waveguide. By introducing the modulation exclusively via the sidewalls, a lateral grating effectively couples the guided mode to a counter-propagating mode or another adjacent mode, making the lateral grating a highly effective device for achieving wavelength selection when coupled, for example, to a semiconductor gain device in the formation of hybrid laser structures as further described in embodiments disclosed herein. Embodiments disclosed herein are described using lateral grating structure. Lateral grating structures, which may also be described as laterally coupled grating structures, are suited for the formation of wavelength selection devices in self-alignment with the patterned cores of waveguide and in self-alignment with a variety of alignment features formed on an interposer from the planar waveguide layer of the interposer. Other grating structures, such as planar grating structures may also be used in some embodiments disclosed herein configured having a lateral grating structure.

As used herein, “alignment aid” is used interchangeably with “alignment feature”.

As used herein, a “tongue and groove alignment feature”, denoted herein as “T&G alignment feature”, for example, may be an assembly comprising a tongue-shaped alignment feature and a groove-shaped alignment feature. As used herein, a “T&G alignment feature” may also refer to one of a tongue-shaped alignment feature or one of a groove-shaped alignment feature that when combined form a “T&G alignment feature”. Distinctions herein between a T&G alignment feature that is an assembly comprising a tongue-shaped alignment feature and a groove-shaped alignment feature, and a T&G alignment feature that is a component of an assembly may be made with reference to the labels included herein. A “T&G alignment feature 108”, for example, describes a component of a T&G alignment feature assembly formed on a coupler, and a “T&G alignment feature 109” describes a component of a T&G alignment feature assembly formed on an interposer. A “T&G alignment feature” assembly, a “T&G alignment feature union”, and a “T&G alignment feature 111” may comprise “T&G alignment feature 108” and “T&G alignment feature 109” in embodiments.

The acronym “WG”, as used herein, refers to “waveguide”. The acronym “PWG”, as used herein, refers to “planar waveguide”. The acronym “PIC”, as used herein, refers to “photonic integrated circuit”. The acronym “2PP”, as used herein, refers to “two-photon polymerization”. Other acronyms may also be used as noted herein.

Embodiments of assemblies disclosed herein may be used in the formation of PICs and thus the term “PIC” may be used interchangeably with “assembly” in reference to assemblies that utilize embodiments disclosed herein.

In embodiments disclosed herein and having labeled components such as 130-1, the “−1” portion of the label refers to a first instance of the preceding portion of the label. A lens array 130-1, for example, is a first lens array 130. A lens array 130-2, for example, is a second lens array 130. This labeling scheme, in which a number follows a hyphen at the end of a component label in a drawing, is used herein to identify and distinguish between multiple instances of a component in a same drawing.

Embodiments of assemblies disclosed herein include optical fiber mounting strategies that include the mounting of optical fibers in FAUs formed on a coupler to facilitate alignment of one or more optical fibers with waveguide cores or other optical pathways on the coupler.

Various embodiments are described herein with reference to the accompanying drawings that are intended to convey the scope of the invention to those skilled in the art. Accordingly, features and components described in the examples of embodiments described herein may be combined with features and components of other embodiments. The present invention is not limited to the relative sizes and spacings illustrated in the accompanying figures. It should be understood that a “layer” as referenced herein may include a single material layer or a plurality of layers. For example, an “insulating layer” may include a single layer of a specific dielectric material such as silicon oxide, or may include a plurality of layers such as one or more layers of silicon oxide and one or more other layers such as silicon nitride, aluminum nitride, among others. The term “insulating layer” in this example, refers to the functional characteristic layer provided for the purpose of providing the insulation property, and is not limited as such to a single layer of a specific material. Similarly, an electrical interconnect layer, as used herein, refers to a composite layer that includes both the electrically conductive materials for transmitting electrical signals and the intermetal and other layers required to insulate the electrically conductive materials. An electrical interconnect layer, as described herein may therefore include a patterned layer of electrically conducting material such as copper or aluminum as well as the intermetal dielectric material such as silicon dioxide, and spacer layers above and below the electrically conductive materials, for example, among other layers. Additionally, references herein to a layer formed “on” a substrate or other layer may refer to the layer formed directly on the substrate or other layer or on an intervening layer or layers formed on the substrate or other layer.

In some embodiments, the present invention discloses self-alignment features for aligning an interposer, e.g., a first substrate or first component, with a coupler, e.g., a second substrate or second component. The self-alignment features include a first alignment feature formed on the interposer and a second alignment feature formed on the coupler. The self-alignment features are characterized by that when the first and second alignment features are aligned, first and second waveguides carrying optical signals in the interposer and the coupler, respectively, are automatically aligned. An advantage of the self-alignment features is the ease of alignment, since the self-alignment features can be designed for easy alignment, especially in comparison with the alignment of the first and second waveguides.

In theory, to accomplish the self-alignment objective, a first distance or a first orientation between the first alignment feature and the first waveguide in the interposer is exactly related to a second distance or a second orientation between the second alignment feature and the second waveguide in the coupler. The relationship between the first and second distances or orientations is defined in the design of the interposer and the coupler. For example, the first and second waveguides can be separated at a same distance from the first and second alignment features in the interposer and the coupler, respectively. The first and second waveguides can also be oriented at a same orientation of 90 degrees with respect to the first and second alignment features in the interposer and the coupler, e.g., the first and second waveguides are perpendicular to the first and second alignment features with the same separation distances, respectively.

In practice, the distances and orientations have variations or deviations from a design specification.

In some embodiments, the present invention discloses the self-alignment features with low variations or deviations by patterning the alignment feature and the waveguide at a same time using a same mask. As such, the variations or deviations have a lithography accuracy, e.g., the distance and orientation between an alignment feature and a waveguide, e.g., in an interposer or in a coupler, has an accuracy defined by the lithography process, which can be equal or less than 200 nm, equal or less than 100 nm, equal or less than 80 nm, equal or less than 60 nm, equal or less than 40 nm, or equal or less than 20 nm.

In some embodiments, a first distance or a first orientation between a first alignment aid and a first waveguide in an interposer can be within a difference to a design value of equal or less than 200 nm, equal or less than 100 nm, equal or less than 80 nm, equal or less than 60 nm, equal or less than 40 nm, or equal or less than 20 nm.

A second distance or a second orientation between a second alignment aid and a second waveguide in a coupler can be within a difference to a design value of equal or less than 200 nm, equal or less than 100 nm, equal or less than 80 nm, equal or less than 60 nm, equal or less than 40 nm, or equal or less than 20 nm.

A difference between the first and second distances or the first and second orientations can be within a difference to a design value of equal or less than 200 nm, equal or less than 100 nm, equal or less than 80 nm, equal or less than 60 nm, equal or less than 40 nm, or equal or less than 20 nm.

In some embodiments, the alignment feature can be characterized by a contact point on the alignment feature. Thus, a distance or an orientation between an alignment aid and a waveguide can be interpreted as a distance or an orientation between a contact point on an alignment aid and a waveguide.

In some embodiments, the waveguide can be characterized by a core of the waveguide, a position or a point on the waveguide, a position or a point on the core of the waveguide, a facet of the waveguide, a position or a point on the facet of the waveguide.

In some embodiments, the waveguide can be characterized by a direction of an optical signal, such as the optical direction of the optical signal in the waveguide or in the waveguide core. With a waveguide, the optical direction can be the direction of the waveguide or can be the waveguide. Without a waveguide, the optical direction can be the direction of the optical signal, such as the optical direction in the free space with the optical signal generated from a laser, for example.

Thus, a distance or an orientation between an alignment aid and a waveguide can be interpreted as a distance or an orientation between a contact point on an alignment aid and a core of the waveguide, a position or a point on the waveguide, a position or a point on the core of the waveguide, a facet of the waveguide, a position or a point on the facet of the waveguide, or an optical direction of an optical signal.

In some embodiments, the present invention discloses the self-alignment features with an alignment accuracy of low optical loss between the first and second waveguides by patterning the alignment feature and the waveguide at a same time using a same mask. As such, the alignment accuracy value can be defined or characterized by an optical loss of equal or less than 20%, equal or less than 15%, equal or less than 10%, equal or less than 5%, equal or less than 3%, equal or less than 2%, equal or less than 1%, or by an optical loss of equal or less than 5 dB, equal or less than 3 dB, equal or less than 2 dB, equal or less than 1 dB, equal or less than 0.8 dB, equal or less than 0.5 dB.

### EMBODIMENTS

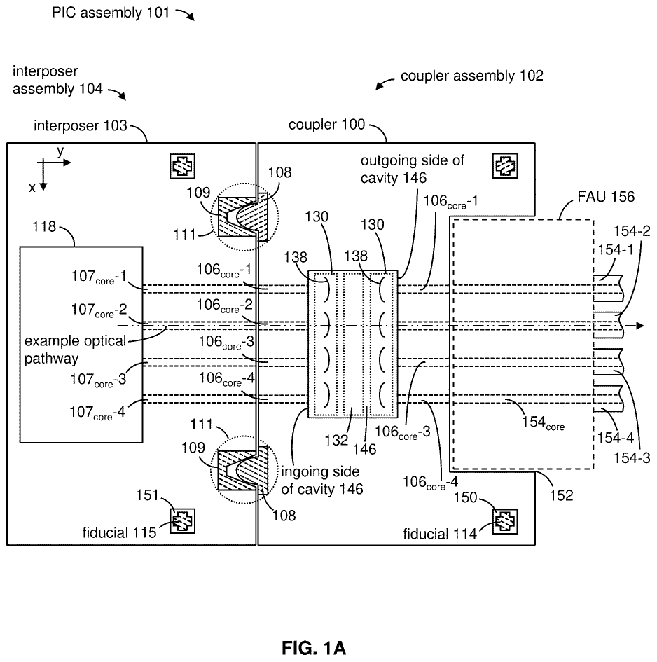

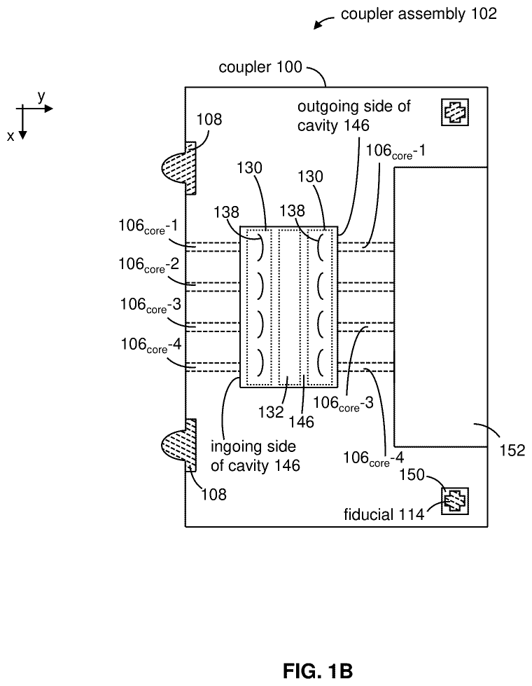

FIG. 1A shows an embodiment of a PIC assembly 101 comprising coupler assembly 102 and interposer assembly 104 wherein the coupler assembly 102, receptive to optical signals from the interposer assembly 104, comprises coupler 100, an optical isolator 132 and two lens arrays 130 mounted or otherwise formed in a cavity 146 on the coupler 100, and wherein the interposer assembly 104, configured to emit one or more optical signals, comprises interposer 103 and PIC 118 formed on the interposer 103.

In embodiments, coupler 100 is configured having an FAU mounting site 152 receptive to FAU 156 having one or more optical fiber 154. The coupler assembly 102 facilitates the coupling of optical signals from the interposer assembly 104 to the optical fibers 154 mounted or otherwise formed on the coupler 100 of the coupler assembly 102. In the embodiment shown in FIG. 1A, the coupler 100 is configured having four cladded waveguide cores 106_{core}-1 to 106_{core}-4, and the FAU is configured having four optical fibers 154-1 to 154-4. In the embodiment, the core of optical fiber 154-1 is shown in alignment with the waveguide core 106_{core}-1 on the coupler 100. The cores of optical fibers 154-2 to 154-4 are correspondingly aligned with the waveguide cores 106_{core}-2 to 106_{core}-4, respectively. Use of the FAU 156 facilitates alignment of the four optical fibers on the FAU with the waveguides on the coupler in a single alignment step.

In embodiments of the coupler assembly 102, the coupler 100 may be configured having one or more FAU mounting site 152 to facilitate the simultaneous alignment and mounting of one or more optical fibers 154.

Embodiments of coupler assembly 102, as illustrated in the embodiment shown in FIG. 1B, comprise the coupler 100 configured having the one or more FAU mounting site 152 and an FAU 156 configured having one or more optical fiber 154 mounted or otherwise formed on the coupler 100, and further comprise optical isolator 132 and one or more lens array 130 formed in a cavity 146 on the coupler 100.

In embodiments, interposer assembly 104 is configured to emit, transmit, pass-through, transfer, generate, radiate, propagate, or otherwise produce one or more optical signal. In embodiments, coupler assembly 102 is configured to be receptive to optical signals provided from the interposer assembly 104, and to couple the optical signals to one or more optical fibers mounted or otherwise formed in FAU 156 on the coupler 100.

In embodiments, optical isolator 102 of coupler assembly 102 facilitates the propagation of optical signals from the interposer assembly 104 to the optical fibers 154 mounted or otherwise formed on the FAU 156 on the coupler 100 while impeding the propagation of reflected optical signals, for example, back to the interposer assembly 104. Optical signals from undesirable back-reflections, for example, can lead to degraded performance or instability, for example, in devices mounted or otherwise formed on the interposer assembly 104 and in some portions of the coupler assembly 102.

Lens arrays 130 comprise one or more lenses 138 and may comprise a mechanical support structure for the lenses.

In embodiments, lenses 138 of lens arrays 130 may be formed from one or more of (1) a 3D printing process on one or more facets of waveguide cores on the wall of cavity 146, (2) a lens array structure in cavity 146 formed using a 3D printing process, and (3) a multi-lens array mounted or otherwise formed in cavity 146, among other methods of forming a lens array 130 of lenses 138 in cavity 146 of coupler 100. In some embodiments, lenses 138 of lens array 130 may be formed from an array of ball lenses mounted or otherwise formed to intercept the waveguide cores 106_{core} of the coupler 100. Embodiments configured having one or more lens array 130 are further disclosed herein.

In embodiments, illustrated for example, in FIGS. 1A and 1B, coupler 100 of the coupler assembly 102 and interposer 103 of the interposer assembly 104 are configured having T&G alignment aids 108,109, respectively, to facilitate alignment of an optical waveguide core 106_{core} or optical pathway (as described herein) on the coupler 100 with an optical waveguide core 107_{core} on the interposer 103. T&G alignment aids 108, formed in self-alignment with the waveguide cores 106_{core} on coupler 100 and T&G alignment aids 109 formed in self-alignment with the waveguide cores 107_{core} on interposer 103, facilitates the coupling and alignment of these self-aligned waveguide cores 106_{core} with waveguide cores 107_{core} formed on the interposer 103 that are formed in self-alignment with mechanical T&G alignment features 109 on the interposer 103.

Self-alignment, as used and as further described herein, refers to the formation of two or more features using a same patterned layer such as, for example, a patterned hard mask layer.

In other embodiments disclosed herein, mechanical alignment features on the coupler 100 may include one or more of one or more of fiducial 114, cavity alignment aids, optical fiber alignment aids, alignment pillars, among other mechanical alignment features, in addition to the one or more T&G alignment aids 108 formed in self-alignment with one or more waveguide cores and, more generally, one or more optical pathways coupled through free-space and coupled through transparent or partially transparent devices such as optical isolator 132 and lenses 138, among other devices.

The formation of mechanical alignment features on the coupler 100, in self-alignment with optical features on the coupler 100, facilitates the coupling of the optical features on the coupler 100 with optical features on the interposer 103 that are formed in self-alignment with mechanical alignment features also formed on the interposer 103, by coupling of the mechanical features of the coupler 100 with the mechanical features of the interposer 103.

In some embodiments, mechanical alignment features may be used, for example, to facilitate alignment of the lenses of a multi-lens array, with the waveguide cores 106_{core} of the coupler 100 using mechanical alignment features formed at the opening of a cavity 146. In some embodiments, mechanical alignment features may be used, for example, to facilitate alignment of the cores of optical fibers 155 with the waveguide cores 106_{core} formed on the coupler using mechanical alignment features formed at the opening of the FAU mounting site 152. And in yet other embodiments, mechanical alignment features may be used, for example, to facilitate alignment of an optical device mounted in a cavity configured having one or more alignment pillars to facilitate alignment of an optical axis of an optical device mounted on the alignment pillars and waveguide cores 106_{core} formed in self-alignment with the alignment pillars formed in the cavity 146.

In FIGS. 1A and 1B, an “ingoing side” of cavity 146 is labeled and refers, herein, to the side of a cavity 146 to first receive the one or more optical signals from the interposer assembly 104. Waveguide cores 106_{core}, if present, may intersect the “ingoing side” of cavity 146. Additionally, an “outgoing side” of cavity 146 is labeled and refers to the side of cavity 146 through which the optical signals are coupled as they exit the cavity 146 on the way to the FAU mounting site 152, and the optical fibers 154 mounted or otherwise formed in the FAU 156 mounted in the mounting site 152.

### Embodiments Having T&G Alignment Features

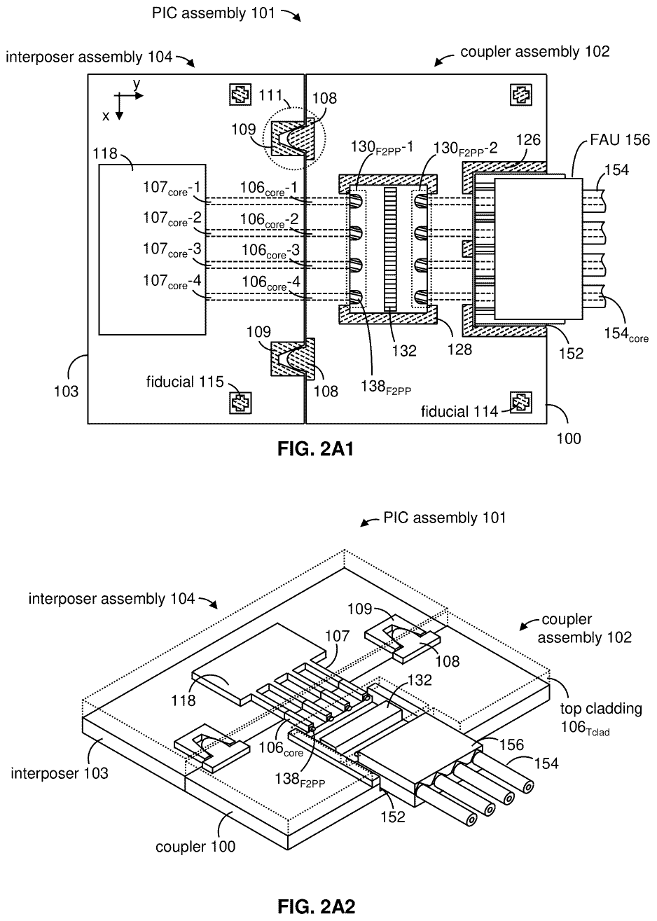

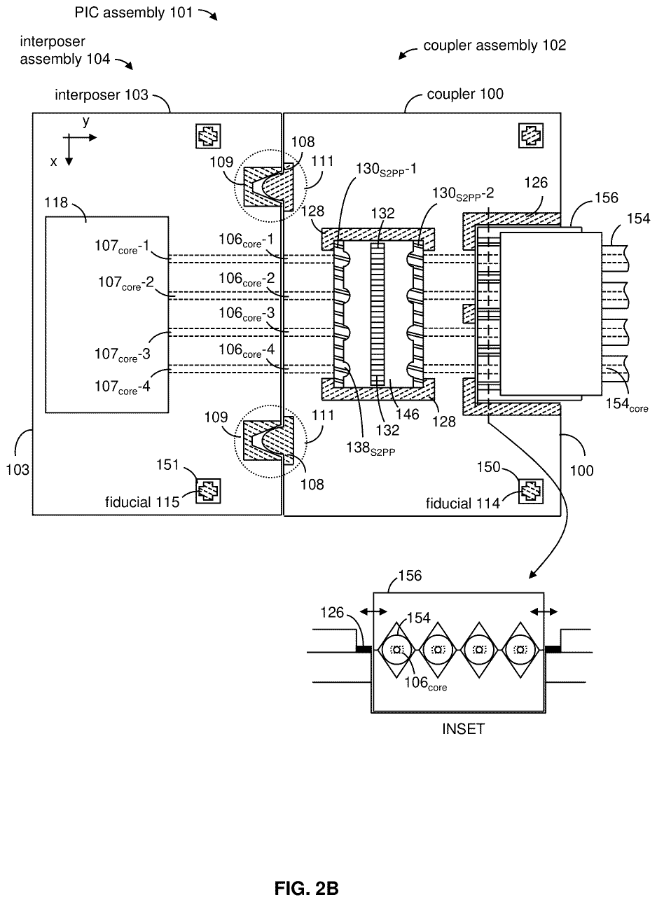

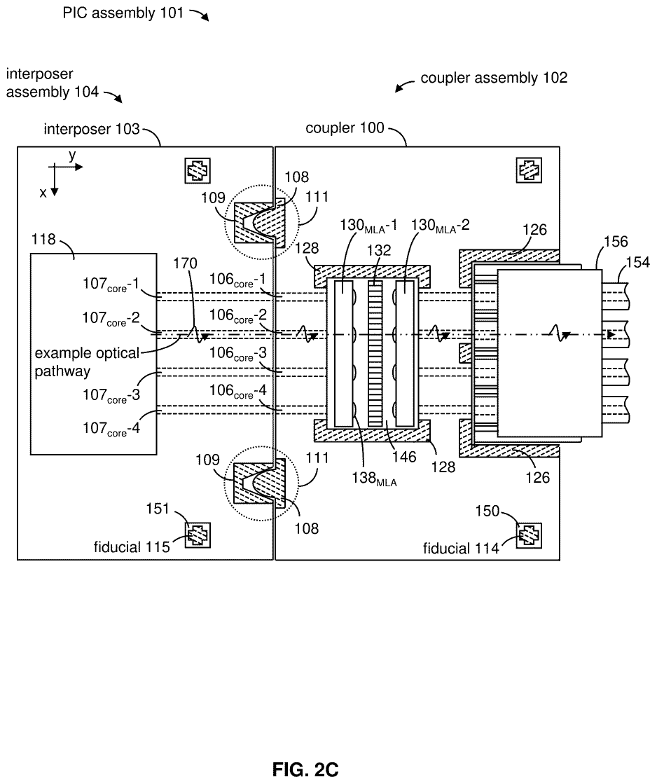

FIGS. 2A1-2C show embodiments of a PIC assembly 101 comprising a coupler assembly 102, an interposer assembly 104, and a plurality of optical fibers 154 mounted in an FAU 156 on the coupler 100 of the coupler assembly 102. In the embodiments shown in FIGS. 2A1-2C, the couplers 100 of the coupler assemblies 102 and the interposers 103 of the interposer assembly 104 are configured having T&G alignment features 108, 109, respectively, that facilitate lateral alignment of optical and mechanical features formed on the coupler 100 with optical and mechanical features formed on the interposer 103.

FIG. 2A1 shows a top-view schematic drawing of an embodiment of a PIC assembly 101 comprising coupler assembly 102, interposer assembly 104, and a plurality of optical fibers 154 mounted in FAU 156 on the coupler 100 of the coupler assembly 102, wherein on-facet lenses 138_{F2PP} are formed in cavity 146 of coupler 100 using two-photon polymerization to form on-facet lens array 130_{F2PP} on the terminal facets of the waveguide cores 106_{core}-1 to 106_{core}-4 of waveguides 106 that are intersected by a wall of cavity 146. A waveguide 106 comprises a waveguide core 106_{core} and the cladding that surrounds the waveguide core 106_{core}.

3D printed lenses formed using two-photon polymerization enable wafer level processing to be utilized in the formation of coupler assemblies 102 comprising one or more lens arrays 130.

The embodiment of the PIC assembly 101 shown in FIG. 2A1 comprises coupler 100 configured having tongue-shaped feature 108 of T&G alignment feature union 111 and interposer 103 configured having groove-shaped feature 109 of T&G alignment feature union 111. The embodiment of the coupler 100 in FIG. 2A1 is further configured having lateral alignment features formed in self-alignment with the T&G alignment feature 108 and the waveguide cores 106_{core} that include FAU alignment features 126, cavity alignment features 128, and fiducials 114. Cavity alignment feature 128 may be used in embodiments, if present, to enable the alignment of one or more of one or more of a multi-lens array 130_{MLA} and optical isolator 132.

Inclusion of one or more of the lateral alignment features 114, 126, 128, is optional. In some embodiments, one or more alignment feature 114, 126, 128, may be included. In other embodiments, coupler 100 may be configured having fiducials 114 formed self-aligned with waveguide cores 106_{core} and T&G alignment features 108. In yet other embodiments, coupler 100 may be configured having one or more of one or more of fiducials 114, FAU alignment aids 126, and isolator cavity alignment aids 128. Other configurations and combinations of the alignment features 114, 126, 128, among other alignment features may be used in embodiments.

FAU alignment aids 126, in the embodiment shown for example in FIG. 2A1, are formed self-aligned from a same lithographic patterning layer as the waveguide cores 106_{core}-1 to 106_{core}-4, fiducials 114, and tongue-shaped T&G alignment features 108 of the coupler 100 to enable positioning of these self-aligned features within the tolerances enabled by the lithographic patterning technique utilized in the formation of the patterned mask layer used to pattern the self-aligned alignment features and waveguide cores 106_{core}. The inclusion of FAU alignment aids 126 at all or a portion of the periphery of an FAU mounting site 152 facilitates alignment of the optical fiber cores 154_{core} of optical fibers 154 mounted in an FAU 156 with the waveguide cores 106_{core}-1 to 106_{core}-4 formed on the coupler 100 configured having the FAU alignment aids 126.

FIG. 2A2 shows a perspective drawing of an embodiment of a PIC assembly 101 comprising interposer assembly 104 and coupler assembly 102, wherein the coupler 100 of the coupler assembly 102 is configured having on-facet lens arrays 130_{F2PP}-1, 130_{F2PP}-2 formed on waveguide facets on the wall of cavity 146 as shown, for example, in the embodiment of the PIC assembly 101 shown in FIG. 2A1. The perspective drawing shows four waveguide cores 106_{core} in the embodiment of the coupler 100 intersected by the walls of cavity 146. The cavity 146 is configured having optical isolator 132 mounted between the on-facet lenses 138_{F2PP} of the on-facet lens arrays 130_{F2PP}-1, 130_{F2PP}-2. T&G alignment features 108 are shown on the coupler 100 coupled to T&G alignment features 109 on the interposer 103. Four optical fibers 154 are shown mounted in FAU 156 on the coupler 100. In the embodiment, interposer assembly 104 comprises interposer 103 configured having PIC 118 coupled through waveguide cores 107_{core} to the waveguide cores 106_{core} of the coupler 100.

The top cladding layer 106_{Tclad} is shown in the perspective drawing of FIG. 2A2, and in numerous other perspective drawings herein, as a transparent layer for clarity, the boundaries of which are shown in dotted lines.

In the embodiments of coupler assembly 102 shown in FIGS. 2A1 and 2A2, walls of cavity 146 intersect the waveguide cores 106_{core} formed on the coupler 100. In such embodiments, optical signals propagating through cavity 146 travel from a first portion of the waveguide core 106 on a first side of cavity 146, the “ingoing side” as labeled in FIGS. 1A and 1B, to a second portion of the waveguide core 106_{core} on the opposite side of cavity 146, the “outgoing side” as labeled in FIGS. 1A and 1B, along the optical pathways through the coupler assembly 102. An example optical pathway of optical signals propagating through the PIC assembly 101 is shown in FIG. 1A. In the embodiment shown in FIG. 1A, optical signals originating in the PIC 118 propagate through one or more waveguide cores 107_{core} of the interposer assembly 104, and are coupled to one or more waveguide cores 106_{core} to cavity 146 on the coupler assembly 102, through the two lens arrays 130 of cavity 146, to one or more waveguide cores 106_{core} coupled to the outgoing side of cavity 146, and to the optical fiber cores 154_{core} or one or more optical fibers 154 mounted or otherwise formed in FAU 156. Optical fibers 154 are shown in the embodiments in FIGS. 2A1 and 2A2.

In other embodiments, optical signals originating from interposer 103 may be free-space coupled from the interposer assembly 104 to lenses 138 of one or more lens arrays 130 mounted or otherwise formed in cavity 146. And in yet other embodiments, optical signals propagating through lenses 138 mounted or otherwise formed in cavity 146 may be free-space coupled to the terminal facets of the cores of optical fibers 154 mounted in FAU 156 on coupler 100. Free-space coupling, as used herein, refers to the coupling of optical signals without propagation through a waveguide 106 or waveguide core 106_{core}, for example. Free-space coupling refers to the propagation of optical signals from, for example, an optical signal source to the lenses 138 mounted or otherwise formed in cavity 146 and from lenses 138 mounted or otherwise formed in cavity 146 to the optical fiber cores 154_{core} of optical fibers 154 mounted or otherwise formed in on FAU 156 on the coupler 100. Lens-to-lens coupling of optical signals from a first lens 138 to a second lens 138 in cavity 146 through optical isolator 132, as referred to herein is considered free-space coupling between the first and second lenses 138.

The embodiment of coupler assembly 102 shown in FIGS. 2A1 and 2A2 is shown configured having two lens arrays 130 in cavity 146 formed using two-photon polymerization on terminal facets of waveguide cores 106_{core} of the coupler 100 to facilitate the insertion of optical isolator 132 into the planar photonic integrated circuit formed, in part, by the waveguides 106. In other embodiments disclosed herein, other means for providing the lenses and lens arrays in cavity 146 are disclosed and may also be used in the formation of embodiments of coupler assembly 102.

FIG. 2B shows a top-view schematic drawing of another embodiment of a PIC assembly 101 comprising coupler assembly 102, interposer assembly 104, and a plurality of optical fibers 154 mounted in FAU 156 on the coupler 100 of the coupler assembly 102, wherein in-structure lenses 138_{S2PP} are formed in cavity 146 of coupler 100 using a 3D printing technique such as two-photon polymerization to form lens array structures 130_{S2PP} in cavity 146. In the embodiment shown in FIG. 2B, in-structure lenses 138_{S2PP} of first and second lens array structures 130_{S2PP}-1, 130_{S2PP}-2, respectively, are formed using two-photon polymerization or other 3D printing technique and are formed in alignment with the terminal facets of the waveguide cores 106_{core}-1 to 106_{core}-4 of waveguides 106 that are intersected by a wall of cavity 146.

3D printed lenses formed using two-photon polymerization enable wafer level processing to be utilized in the formation of coupler assemblies 102 comprising one or more lens array 130 configured as lens array structures 130_{S2PP}.

The embodiment of the PIC assembly 101 shown in FIG. 2B, as in the embodiments shown in FIGS. 2A1 and 2A2, comprises coupler 100 of coupler assembly 102 configured having tongue-shaped feature 108 of T&G feature union 111, interposer 103 of interposer assembly 104 configured having groove-shaped feature 109 of T&G alignment feature union 111, and a plurality of optical fibers 154 mounted in FAU 156 on coupler 100. FAU mounting site 152 on coupler 100 is receptive to the FAU 156 and may be configured having FAU alignment features 126 formed at all or a portion of its periphery to enable alignment of the optical fiber cores 154_{core} of the optical fibers 154 in the FAU 156 with the waveguide cores 106_{core}-1 to 106_{core}-4 of the coupler 100 in the embodiment. In other embodiments, coupler 100 may not have planar waveguides, as described further herein, and the optical fiber cores 154_{core} may be aligned with other optical pathways on the coupler 100.

In the INSET of FIG. 2B, a cross-sectional schematic drawing of an example FAU 156 configured having four optical fibers 154 is shown in an example FAU mounting site 152 for an embodiment of coupler 100 configured having FAU alignment aids 126 formed at the openings of the FAU mounting site 152. In the INSET of FIG. 2B, contact between an outer lateral surface of the FAU 156 with a sidewall of the FAU alignment aid 126 is shown to illustrate how the FAU alignment aid 126 can restrict lateral movement of the FAU 156 resulting in improved lateral alignment of the optical fiber cores 154_{core} of the optical fibers 154 in the FAU 156 with the waveguide cores 106_{core} of the coupler 100. Formation of the FAU alignment aids 126 and the waveguide cores 106_{core} from a same patterned mask layer can lead to improved resolution in the relative positioning of the FAU alignment aids 126 and the waveguide cores 106_{core} in embodiments in which the alignment aids are used to facilitate positioning of the FAU 156, for example, or other component or device onto the coupler 100 using an alignment aid formed self-aligned with the waveguide core 106_{core}.

FIG. 2C shows a top-view schematic drawing of another embodiment of a PIC assembly 101 comprising coupler assembly 102, interposer assembly 104, and a plurality of optical fibers 154 mounted in FAU 156 on the coupler 100 of the coupler assembly 102, wherein MLA lenses 138_{MLA} are mounted or otherwise formed in cavity 146 of coupler 100 using a multi-lens array 130_{MLA}. In the embodiment shown in FIG. 2B, MLA lenses 138_{MLA} are formed on a mountable substrate as further described herein. First and second lens array structures 130_{MLA}-1,130_{MLA}-2, respectively, are configured, in the embodiment, having four MLA lenses 138_{MLA}. Multi-lens arrays 130_{MLA}-1, 130_{MLA}-2, in the embodiment of the coupler assembly 102 shown are mounted in alignment with the terminal facets of the waveguide cores 106_{core}-1 to 106_{core}-4 of waveguides 106 that are intersected by a wall of cavity 146.

The embodiment of the PIC assembly 101 in FIG. 2C comprises a coupler 100 of coupler assembly 102 having tongue-shaped feature 108 of T&G alignment feature union 111 and an interposer 103 of interposer assembly 104 having groove-shaped feature 109 of T&G alignment feature union 111. The combination of the T&G alignment features 108,109 provides a mechanical coupling mechanism to facilitate alignment of optical features of the coupler assembly 102 with optical features of the interposer assembly 104 to which the coupler assembly 102 is coupled to form PIC assembly 101. In embodiments, tongue-shaped feature 108 of the coupler 100 couples to groove-shaped feature 109 of the interposer 103 to facilitate alignment of the waveguides 106_{core}-1 to 106_{core}-4 of the coupler 100 to the waveguides 107_{core}-1 to 107_{core}-4 of the interposer 103.

The embodiments of coupler 100 in FIGS. 2B and 2C, as in the embodiment shown in FIG. 2A1 are further configured having lateral alignment features formed in self-alignment with the T&G alignment feature 108 and the waveguide cores 106_{core} that include FAU alignment features 126, cavity alignment features 128, and fiducials 114. Cavity alignment feature 128 may be used in embodiments, if present, to enable the alignment of one or more of one or more of a multi-lens array 130_{MLA} and optical isolator 132.

Inclusion of one or more of the lateral alignment features 114, 126, 128, is optional. In some embodiments, one or more alignment feature 114, 126, 128, may be included. In other embodiments, coupler 100 may be configured having fiducials 114 formed self-aligned with waveguide cores 106_{core} and T&G alignment features 108. In yet other embodiments, coupler 100 may be configured having one or more of one or more of fiducials 114, FAU alignment aids 126, and isolator cavity alignment aids 128. Other configurations and combinations of the alignment features 114, 126, 128, among other alignment features may be used in embodiments.

In the embodiments shown in FIGS. 2A1-2C, FAU 156 on coupler 100 is configured having four optical fibers 154. In other embodiments, FAU 156 on coupler 100 may be configured having one or more optical fibers 154.

In the embodiment shown in FIG. 2C, T&G alignment feature union 111 comprises tongue-shaped feature 108 on the coupler 100 and groove-shaped feature 109 on the interposer 103. In other embodiments, a groove-shaped T&G alignment feature may be provided on the coupler 100 and a tongue-shaped alignment feature may be provided on the interposer 103.

In yet other embodiments, one or more groove-shaped T&G alignment features may be provided on the coupler 100 and one or more tongue-shaped T&G alignment features may be provided on the interposer 103, and one or more groove-shaped T&G alignment features may be provided on the interposer 103 and one or more tongue-shaped T&G alignment feature may be provided on the coupler 100.

FIG. 2C shows fiducials 114 formed in fiducial cavities 150 on the coupler 100 and fiducials 115 formed in fiducial cavities 151 on the interposer 103. Fiducials 114 are formed from the core layer of the planar waveguide layer used to form the waveguide cores 106_{core} of waveguides 106 formed on the coupler 100, and are formed self-aligned with the waveguide cores 106_{core}-1 to 106_{core}-4 of the coupler 100. Similarly, fiducials 115 are formed from the core layer of the planar waveguide layer used to form the waveguide cores 107_{core} of waveguides 107 formed in the interposer 103, and are formed self-aligned with the waveguide cores 107_{core}-1 to 107_{core}-4 of the interposer 103. Self-alignment of fiducials 114,115 may enable accurate placement using automated (or manual) pick-and-place apparatus for placement of devices onto one or more of the interposer 103 and the coupler 100. In some embodiments, fiducials 114 may be formed in cavity 146 of the coupler 100, or other cavity on the coupler 100. And in some embodiments, fiducials 115 may be formed in a cavity 148 of the interposer 103, or other cavity on the interposer 103.

The embodiment of the coupler 100 in FIG. 2C shows cavity 146 intersecting waveguide cores 106_{core}-1 to 106_{core}-4. In the embodiment, cavity 146 enables the insertion of optical devices into the optical pathway formed by the waveguides 106 that include the waveguide cores 106_{core}-1 to 106_{core}-4.

Interposer assembly 104 of the PIC assembly 101 may include optional PIC 118 comprising one or more optical devices. Optical devices of PIC 118 may include one or more of one or more of a waveguide, an arrayed waveguide, a spot size converter, a laser, a gain device, a light emitting diode, among other types of optical devices used in the fabrication of photonic integrated circuits.

In an example embodiment, optical signals 170 generated in optional PIC 118 of the interposer assembly 104, are coupled through waveguide cores 107_{core}-1 to 107_{core}-4 on interposer 103 to waveguide cores 106_{core}-1 to 106_{core}-4 of coupler 100. Optical signals 170 propagating in waveguide cores 106_{core}-1 to 106_{core}-4 exit waveguide facets formed on the wall of cavity 146 and encounter first multi-lens array 130_{MLA}-1, optical isolator 132, and second multi-lens array 130_{MLA}-2. In the embodiment, the combination of two MLA lenses 138_{MLA} of the multi-lens arrays 130_{MLA} along an optical path, as illustrated in the labeled example optical path, collimates the diverging optical signal from the terminal facet of a waveguide core such as waveguide core 106_{core}-2 as the optical signal 170 propagates through MLA lens 138_{MLA} of the first multi-lens array 130_{MLA}-1, and refocuses or otherwise narrows the optical signal 170 upon propagation through MLA lens 138_{MLA} of the second multi-lens array 130_{MLA}-2 such that a facet of the waveguide core 106_{core} is receptive to the focused optical signal 170 emerging from the MLA lens 138_{MLA} of the second multi-lens array 130_{MLA}-2.

The inclusion of the optical isolator 132 within the optical pathways between the optical signal generating PIC 118 of the interposer assembly 104, is configured in embodiments, to allow unidirectional propagation of optical signals through the optical isolator 132 and to the optical fibers mounted in the FAU 156 and prevent undesirable reflected optical signals from reaching back beyond the optical isolator 132, for example, into the interposer assembly 104.

In embodiments such as the embodiment shown in FIGS. 2A1-2C, coupler 100 enables the formation of coupler assemblies 102 comprising a first lens array that facilitates the collection and collimation of divergent optical signals emerging from terminal facets of a first portion of an array of waveguide cores 106_{core} intersected by a wall of cavity 146, an optical isolator 132 that facilitates isolation of sensitive light emitting devices mounted or otherwise formed upstream of the optical isolator 132, and a second lens array that refocuses the optical signals on the terminal facets of a second portion of the waveguide cores 106_{core} intersected by a wall of cavity 146 whereupon the optical signals are incident on the terminal facets of the optical fiber cores 154_{core} of optical fibers mounted in FAU 156 on the coupler 100 for further propagation through the optical fibers, in for example, a data communications network.

In the following paragraphs, some embodiments of coupler 100 are disclosed. Couplers 100 may be configured in embodiments, for example, to enable coupling of optical signals through one or more waveguides intersected by a wall of cavity 146, and may be configured in other embodiments to enable free-space coupling of optical signals from an optical signal source of the interposer assembly 104, for example, to a lens 138 mounted or otherwise formed in cavity 146. Free-space coupling is enabled in configurations of cavity 146 with openings on one or more of the ingoing side of cavity 146 and the outgoing side of cavity 146. Couplers 100 configured having one or more of waveguide coupling and free-space coupling are disclosed in the following paragraphs.

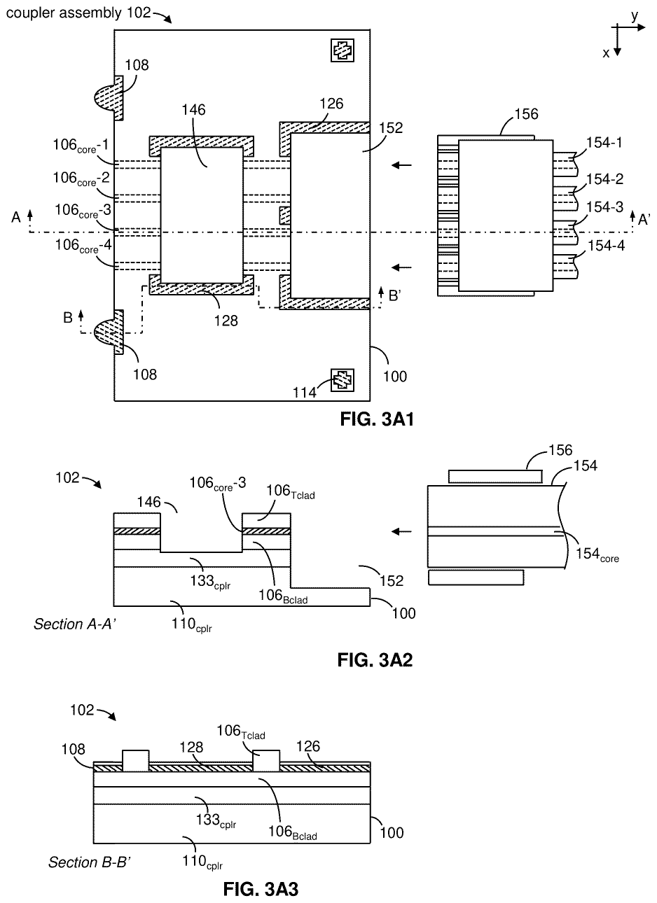

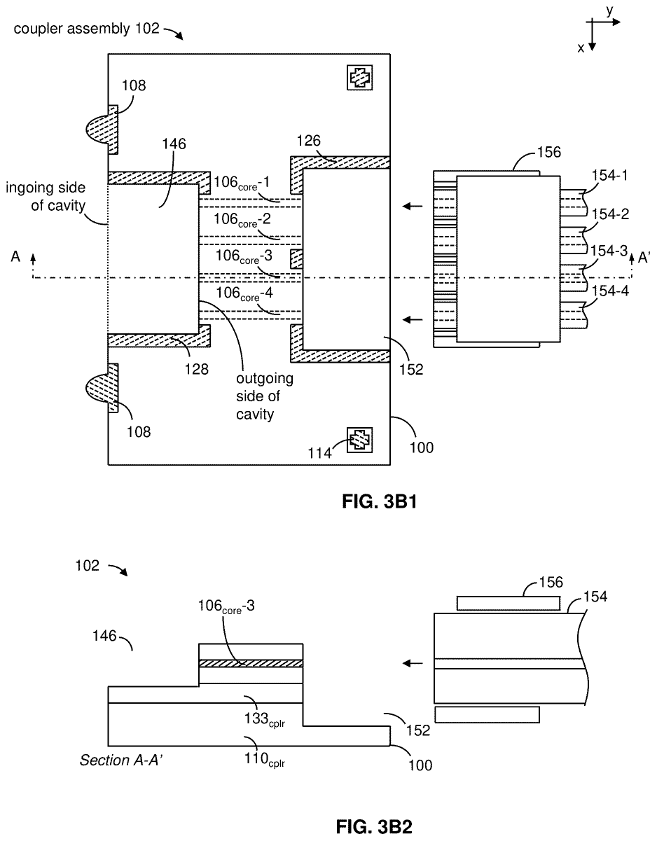

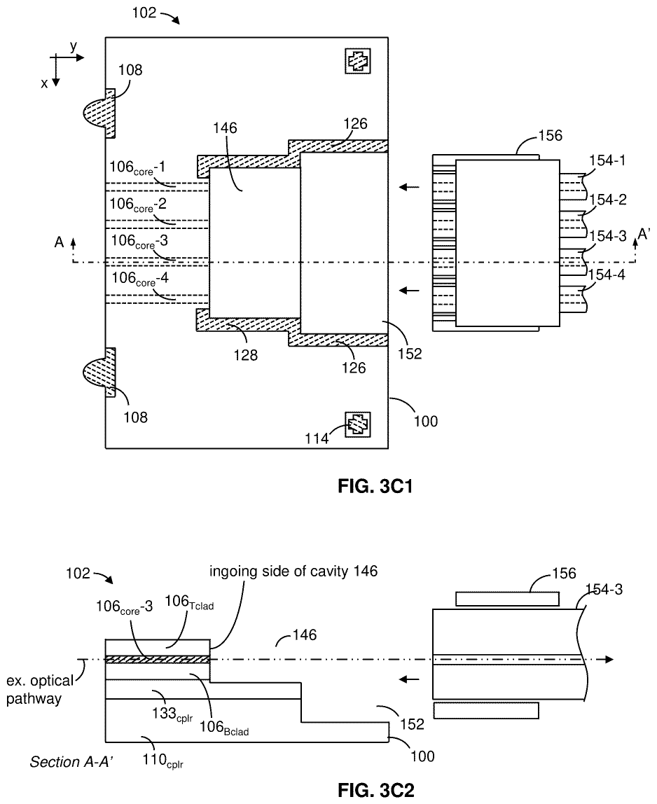

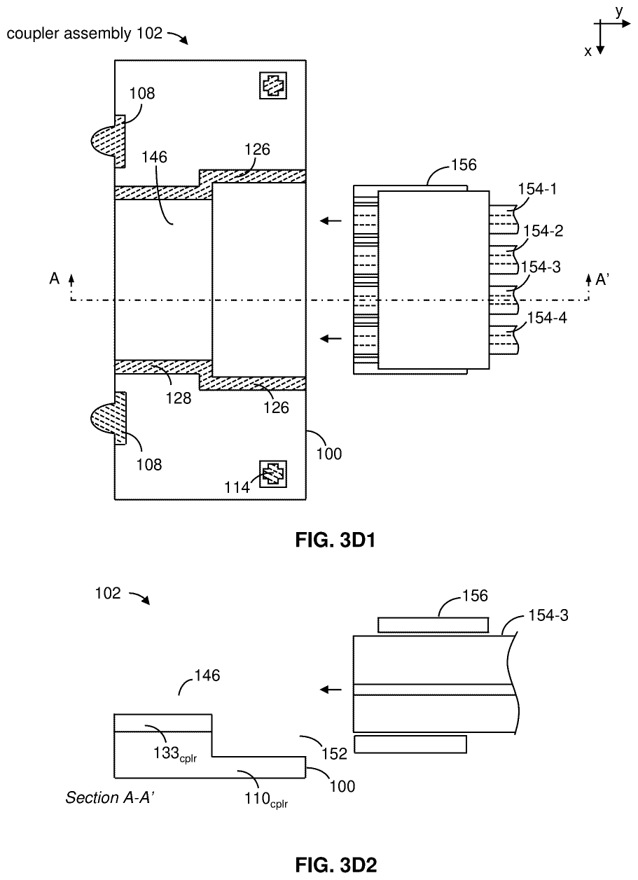

FIGS. 3A1-3A3 show exploded top-view and section-view drawings of an embodiment of coupler 100 for the embodiments of the coupler assemblies 102 shown in FIGS. 2A1 and 2A2 wherein cavity 146 of coupler 100 is configured having waveguide coupling on the ingoing side of cavity 146 and having waveguide coupling on the outgoing side of cavity 146. In the top-view schematic drawing of FIG. 3A1, waveguide cores 106_{core}-1 to 106_{core}-4 are shown having terminal ends formed at the ingoing side of cavity 146 and the outgoing side of cavity 146. The terminal ends, in the embodiment, may result, for example, from the patterning of the cladding and core layers of a planar waveguide layer on the coupler 100 to form the cavity 146. The terminal ends of waveguide cores 106_{core}-3 are further shown in the cross-section drawing of FIG. 3A2 of Section A-A′ shown in FIG. 3A1. Cavity 146 is shown in FIG. 3A2 to extend from the top of the top cladding layer 106_{Tclad}, through the core layer 106_{core}-3 and the bottom cladding layer 106_{Bclad}, to the underlying optional electrical interconnect layer 133_{cplr} formed on the substrate 110_{cplr} in the embodiment. FAU 156 is shown coupled to FAU mounting site 152 wherein the FAU 156 is shown in the cross-section having optical fiber 154-3 and wherein the core 154_{core} of the optical fiber 154-3 is configured to be in alignment with the waveguide core 106_{core}-3 on coupler 100.

The cross-section drawing of FIG. 3A3 shows T&G alignment feature 108, cavity alignment feature 128, and FAU alignment feature 126 formed fully or in part from the core layer of the planar waveguide layer of the coupler 100 in the embodiment. Fiducials 114, not shown in the cross-section drawing of FIG. 3A3 may also be formed fully or in part from the core layer of the planar waveguide layer on the coupler 100.

The embodiment of coupler 100 shown in FIGS. 3A1-3A3, configured having lateral alignment features that include, the FAU alignment features 126, the cavity alignment features 128, the fiducials 114, and the T&G alignment features 108, are formed self-aligned with the waveguide cores 106_{core}-1 to 106_{core}-4.

The embodiment of coupler 100 shown in FIGS. 3A1-3A3 may be used in the formation of embodiments of coupler assemblies 102, and in the formation of PIC assemblies 101 comprising a coupler assembly 102 and an interposer assembly 104.

FIGS. 3B1 and 3B2 show an embodiment of coupler 100 for embodiments of coupler assembly 102 wherein cavity 146 of coupler 100 is configured to enable free-space coupling on the ingoing side of cavity 146 and having waveguide coupling on the outgoing side of cavity 146. Free-space coupling of optical signals from an external optical signal source, such as an optical signal source on interposer assembly 104, to the lenses 138 of a lens array 130 mounted or otherwise formed in cavity 146 is enabled with the open-sided cavity 146 formed at an edge of the coupler 100, as shown, for example, in cross-section drawing A-A′ of FIG. 3B2. The cavity 146 is shown in FIG. 3B2 without a cavity wall on the ingoing side of the cavity 146.

In the top-view schematic drawing of FIG. 3B1, waveguide cores 106_{core}-1 to 106_{core}-4 are shown having terminal ends formed at the outgoing side of cavity 146. The terminal ends, in the embodiment, may result, for example, from the patterning of the cladding and core layers of a planar waveguide layer on the coupler 100 to form the cavity 146. The terminal ends of waveguide cores 106_{core}-3 are further shown in the cross-section of FIG. 3B2.

Cavity 146 is shown in FIG. 3B2, for clarity to extend from the top of the top cladding layer 106_{Tclad}, through the core layer 106_{core}-3 and the bottom cladding layer 106_{Bclad}, to the underlying optional electrical interconnect layer 133_{cplr} formed on the substrate 110_{cplr} in the embodiment. FAU 156 is shown coupled to FAU mounting site 152 wherein the FAU 156 is shown in the cross-section having optical fiber 154-3 and wherein the core 154_{core} of the optical fiber 154-3 is configured to be in alignment with the waveguide core 106_{core}-3 on coupler 100.

In some embodiments, cavity 146 may extend into electrical interconnect layer 133_{cplr}. In other embodiments, cavity 146 may through the electrical interconnect layer 133_{cplr} and into the substrate 110_{cplr}. In these and other embodiments, the depths of the cavity 146 should be sufficient to enable alignment of the waveguide cores 106_{core}, or other optical pathways, with the optical axis of the lenses 138 mounted or otherwise formed in the cavity. The depth of the FAU mounting site 152 should be sufficient to enable alignment of the cores 154_{core} of the optical fibers 154 mounted or otherwise formed in the FAU 156 to be aligned with the waveguide cores 106_{core} or other optical pathways on the coupler 100.

The top-view drawing of FIG. 3B1 shows T&G alignment feature 108, cavity alignment feature 128, and FAU alignment feature 126 formed fully or in part from the core layer of the planar waveguide layer of the coupler 100 shown in the cross-section drawing of FIG. 3B2 in the embodiment. Fiducials 114, also shown in the top-view drawing of FIG. 3B2, may also be formed fully or in part from the core layer of the planar waveguide layer on the coupler 100.

The embodiment of coupler 100 shown in FIGS. 3B1-3B2, configured having lateral alignment features that include, the FAU alignment features 126, the cavity alignment features 128, the fiducials 114, and the T&G alignment features 108, are formed self-aligned with the waveguide cores 106_{core}-1 to 106_{core}-4.

The embodiment of coupler 100 shown in FIGS. 3B1-3B2 may be used in the formation of embodiments of coupler assemblies 102 that facilitate the free-space coupling of optical signals from an optical signal source to the lenses 138 of a lens array 130 formed in cavity 146 of coupler 100. The embodiment of coupler 100 shown in FIGS. 3B1-3B2 may be further used in the formation of PIC assemblies 101 comprising a coupler assembly 102 and an interposer assembly 104, wherein the cavity 146 of coupler 100 is configured to enable free-space coupling of optical signals from the interposer assembly 104 to lenses 138 mounted or otherwise formed in the cavity 146 on the coupler 100.

FIGS. 3C1 and 3C2 show an embodiment of coupler 100 for embodiments of coupler assemblies 102 wherein cavity 146 of coupler 100 is configured having waveguide coupling on the ingoing side of cavity 146 and configured to enable free-space coupling of optical signals from the lenses 138 of a lens array 130 through the outgoing side of cavity 146 to the cores 154_{core} of optical fibers 154 mounted in FAU 156.

In the top-view schematic drawing of FIG. 3C1, waveguide cores 106_{core}-1 to 106_{core}-4 are shown having terminal ends formed at the ingoing side of cavity 146. The ingoing side of the cavity is labeled in the cross-section drawing of FIG. 3C2 from Section A-A′ of FIG. 3C1. The terminal ends of the waveguide cores, in the embodiment, may result, for example, from the patterning of the cladding and core layers of a planar waveguide layer on the coupler 100 to form the cavity 146. The terminal ends of waveguide cores 106_{core}-3 in cavity 146 are further shown in the cross-section of FIG. 3C2.

Free-space coupling of optical signals from lenses 138 of a lens array 130 that may be mounted or otherwise formed in cavity 146 to the terminal facets of optical fiber cores 154_{core} of optical fibers 154 mounted or otherwise formed in FAU 156 is enabled with the opening in the sidewall on the outgoing side of the cavity 146 that faces all or a portion of the terminal ends of the optical fibers 154 mounted in the FAU 156. The section drawing A-A′ of FIG. 3C2 shows the open cavity wall along the optical pathways on the outgoing side of the cavity 146. An example optical pathway is labeled in FIG. 3C2. Optical signals propagating from the terminal facets of the waveguide cores 106_{core} on the ingoing side of cavity 146 have line-of-sight access to the optical fiber cores 154_{core} of optical fibers 154 mounted or otherwise formed in the FAU 156.

The cores 154_{core} of optical fibers 154-1 to 154-4 are shown in the top-view drawing of FIG. 3C1 formed in alignment with waveguide cores 106_{core}-1 to 106_{core}-4, respectively, terminated at the ingoing side of cavity 146. The optical fiber core 154_{core} of the optical fiber 154-3 is shown in the section drawing A-A′ of FIG. 3C2 in alignment with the waveguide core 106_{core}-3 at the ingoing side of cavity 146.

The top-view drawing of FIG. 3C1 shows T&G alignment feature 108, cavity alignment feature 128, and FAU alignment feature 126 formed fully or in part from the core layer of the planar waveguide layer of the coupler 100 shown in the cross-section drawing of FIG. 3C2 in the embodiment. Fiducials 114, shown in the FIG. 3C1, may also be formed fully or in part from the core layer of the planar waveguide layer on the coupler 100.

The embodiment of coupler 100 shown in FIGS. 3C1-3C2, configured having lateral alignment features that include, the FAU alignment features 126, the cavity alignment features 128, the fiducials 114, and the T&G alignment features 108, are formed self-aligned with the waveguide cores 106_{core}-1 to 106_{core}-4.

The embodiment of coupler 100 shown in FIGS. 3C1-3C2 may be used in the formation of embodiments of coupler assemblies 102 that facilitate the coupling of optical signals from an optical signal source to the waveguide cores 106_{core} of the coupler 100, and free-space coupling of the optical signals from lenses 138 of a lens array 130 formed in cavity 146 of coupler 100 to the terminal ends of the cores 154_{core} of optical fibers 154 mounted or otherwise formed in the FAU 156 on the coupler 100. The embodiment of coupler 100 shown in FIGS. 3B1-3B2 may be further used in the formation of PIC assemblies 101 comprising a coupler assembly 102 and an interposer assembly 104, wherein the cavity 146 of coupler 100 is configured to enable free-space coupling of optical signals from the lenses 138 mounted or otherwise formed in the cavity 146 on the coupler 100 to the cores 154_{core} of optical fibers 154 mounted or otherwise formed in FAU 156 on the coupler 100.

FIG. 3D1 shows a top-view schematic drawing of an embodiment of a coupler 100 configured having a cavity 146 formed at an edge of the coupler 100 to enable free-space coupling of optical signals from an emitting device formed, for example, on interposer 103 of PIC assembly 101, to a lens 138 that may be formed or otherwise mounted in the cavity 146 on the coupler 100. Cavity 146 is further configured to enable free-space coupling of optical signals on the outgoing side of cavity 146 from a lens 138 mounted or otherwise formed in cavity 146 to the terminal facets of optical fibers 154 mounted or otherwise formed in FAU 156 on coupler 100.

FIG. 3D2 shows a cross-section schematic drawing through Section A-A′ of the embodiment of the coupler 100 shown in FIG. 3D1. The cross-section shows cavity 146 configured having openings on the ingoing side and the outgoing side to enable free-space coupling of optical signals emerging from an external optical signal source on interposer assembly 104, for example, through one or more lenses 138 mounted or otherwise formed in cavity 146 to the terminal facet of the core of an optical fiber 154 mounted or otherwise formed in a FAU 156 on the coupler 100. FIG. 3D1 shows optical fiber 154-3 of FIG. 3D1 in FAU 156 in the cross-section taken through Section A-A′, to illustrate the cavity 146 in relation to the optical fiber 154-3 to facilitate coupling of optical signals from an emitting device of an interposer assembly 104, for example, through one or more lenses 138 and an optical isolator 132 that may be mounted or otherwise formed in the cavity 146 to the terminal facet of the core of the optical fiber 154 mounted in the FAU 156 on the coupler 100 in the embodiment.

Couplers 100 configured to enable free-space coupling on one or both sides of the cavity 146 provide increased flexibility in the formation of coupler structures that facilitate the coupling of optical signals from an interposer assembly 104 through an optical isolator 132 mounted in a cavity on the coupler 100 to optical fibers 154 mounted in FAU 156 on the coupler 100. Lenses 138, mounted or otherwise formed in cavity 146 on the coupler 100 in this and other embodiments, facilitate the insertion of the optical isolator 132 into the optical pathways by enabling the collection and refocusing of divergent optical signals in the cavity 146 to the facets of optical fibers 154 mounted in the FAU 156.

The top-view drawing of FIG. 3D1 shows T&G alignment feature 108, cavity alignment feature 128, and FAU alignment feature 126 formed fully or in part from the core layer of the planar waveguide layer of the coupler 100 in the embodiment. Fiducials 114, also shown in the top-view drawing of FIG. 3D1, may also be formed fully or in part from the core layer of the planar waveguide layer on the coupler 100.

The embodiment of coupler 100 shown in FIGS. 3D1-3D2, configured having lateral alignment features that include, the FAU alignment features 126, the cavity alignment features 128, the fiducials 114, and the T&G alignment features 108, are formed in self-alignment from a same patterned mask layer as further described herein. In the absence of waveguide cores 106_{core} in the embodiment, the self-aligned features may be used to provide one or more lateral reference for the formation of, for example, a 3D printed in-structure lens array 138_{S2PP}. In an embodiment, a lens array structure may be formed with reference to the cavity alignment feature 128. By referencing the lenses 138_{S2PP} of a 3D printed lens array structure, the lenses 138_{S2PP} may be formed in reference to features such as the FAU 156 and the optical fibers 154 mounted thereon, that are also mounted or otherwise formed in relation to a self-aligned alignment feature. In this example, in-structure lenses 138_{S2PP} that are formed in reference to cavity alignment features 128 may be formed in alignment with the optical fibers 154 mounted in FAU 156 in assemblies for which the FAU is aligned fully or in part using FAU alignment feature 126, in coupler assemblies 102 in which the FAU alignment feature 126 is formed in self-alignment with the cavity alignment feature 128.

The embodiment of coupler 100 shown in FIGS. 3D1-3D2 may be used in the formation of embodiments of coupler assemblies 102 that facilitate the free-space coupling of optical signals from an optical signal source to the lenses 138 of a lens array 130 formed in cavity 146 of coupler 100 and the free space coupling of optical signals from the lenses 138 of a lens array 130 formed in cavity 146 to the terminal facets of the optical fiber cores 154_{core} of optical fibers 154 mounted or otherwise formed in FAU 156. The embodiment of coupler 100 shown in FIGS. 3D1-3D2 may be further used in the formation of PIC assemblies 101 comprising a coupler assembly 102 and an interposer assembly 104, wherein the cavity 146 of coupler 100 is configured to enable free-space coupling of optical signals from the interposer assembly 104 to lenses 138 mounted or otherwise formed in the cavity 146 on the coupler 100, and from lenses 138 mounted or otherwise formed in the cavity 146 to the terminal ends of optical fibers 154 mounted in FAU 156.

In FIGS. 1A1-3D2, embodiments of PIC assemblies 101 comprising interposer 103 and coupler 100 are shown wherein the couplers 100 are configured having cavity 146 to facilitate the insertion of an optical isolator 132 into the optical pathways provided on the coupler 100 to enable the transfer of optical signals from the interposer assembly 104 to optical fibers 154 mounted or otherwise formed in FAU 156 on the coupler 100.

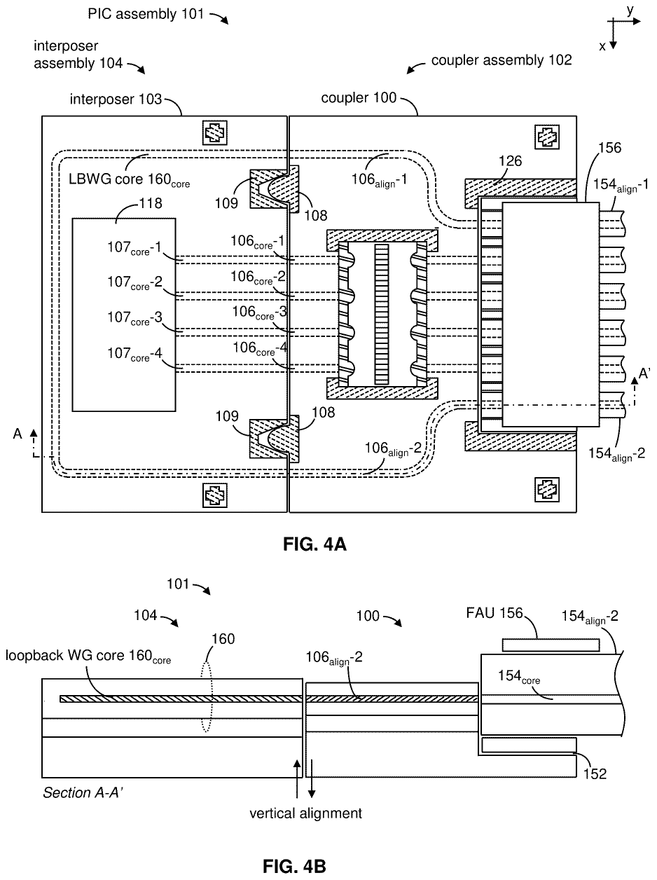

FIGS. 4A and 4B show top-view and cross-section schematic drawings, respectively, of an embodiment of PIC assembly 101 comprising a coupler assembly 102 comprising optical isolator 132 and two lens array structures 130_{S2PP} formed in cavity 146, as, for example, in the embodiment shown in FIG. 2B, and further configured having alignment waveguides that, in conjunction with a loopback waveguide 160 of interposer 103, enable vertical alignment of the self-aligned features of the coupler 100 with the self-aligned features of the interposer 103 in the embodiment of the PIC assembly 101 configured having T&G alignment feature union 111.

In embodiments, the alignment waveguide cores 106_{align}-1, 106_{align}-2 of alignment waveguides on coupler 100 are formed self-aligned with waveguide cores 106_{core}-1 to 106_{core}-4 and T&G alignment features 108. Lateral alignment, as in the embodiments shown in FIGS. 2A1-2C, is facilitated with the coupling of the T&G alignment features 108, formed self-aligned with the waveguide cores 106_{core}-1 to 106_{core}-4 of the coupler 100, and the T&G alignment features 109, formed self-aligned with the waveguide cores 107_{core}-1 to 107_{core}-4 of the interposer 103. Although other methods may be used, as further described herein, vertical alignment of the waveguide cores 106_{core}-1 to 106_{core}-4 of the coupler 100 and the waveguide cores 107_{core}-1 to 107_{core}-4 of interposer 103, may be facilitated with the inclusion of the first and second alignment waveguide cores 106_{align}-1, 106_{align}-2 of the alignment waveguides and loopback waveguide core 160_{core} of loopback waveguide 160.

In general, the core layer of a waveguide is the portion of a waveguide comprising the material formed from a higher refractive index than its surrounding cladding material. Waveguides, in general, comprise a waveguide core enveloped in cladding wherein the core layer has a higher refractive index than the surrounding cladding layer. Planar optical waveguides, as described herein in embodiments, comprising a core and cladding form a layered structure that confines and guides electromagnetic radiation largely within the core layer using the principle of total internal reflection (TIR) between regions of differing refractive indices.

In descriptions of embodiments disclosed herein, a waveguide core, 106_{core}, for example, of a planar waveguide on coupler 100 is the portion of the waveguide 106 to which alignment features may be formed self-aligned. It should be understood that although a significant portion of the electromagnetic radiation of which the optical signals are comprised may propagate in the core of the waveguide, the propagation may not be fully restricted to the waveguide cores. Similarly, an alignment waveguide core 106_{align} of an alignment waveguide, is the portion of the alignment waveguide to which alignment features may be formed self-aligned.

In the embodiment shown in FIGS. 4A and 4B, the coupler assembly 102 is configured having four optical fibers 154 mounted in FAU 156 on coupler 100 to receive optical signals propagating from waveguide cores 106_{core}-1 to 106_{core}-4, and is further configured having first and second alignment waveguides comprising alignment waveguide cores 106_{align}-1, 106_{align}-2 to facilitate alignment of the optical features of the coupler 100 with the optical features of the interposer 103.

Vertical alignment between the optical features of the coupler 100 and the optical features of the interposer 103 may be facilitated in the embodiment, for example, with the providing of an optical signal through first alignment optical fiber 154_{align}-1 mounted or otherwise formed on FAU 156 to the first alignment waveguide core 106_{align}-1 on coupler 100, the loopback waveguide core 160_{core} of the loopback waveguide 160 on interposer 103, the second alignment waveguide core 106_{align}-2, and the second alignment optical fiber 154_{align}-2. The optical signal emerging from the second alignment optical fiber 154_{align}-2 may be collected and measured, for example, as the vertical position on one or more of the coupler 100 and the interposer 103 is varied to enable the relative positions of the coupler 100 and the interposer 103 to be assessed using optical signal intensity, power, or other characteristic of the optical signal. The relative positions of the coupler 100 and the interposer 103 may be fixed in position upon the identification of a suitable relative positioning between the optical features of the coupler 100 and the optical features of the interposer 103. In an example, the optical signal power emerging from the second alignment optical fiber 154_{align}-2 may be measured as the vertical position of the coupler 100 is varied while maintaining a fixed elevation for the interposer 103. An optimal alignment position in such an assembly may be observed, for example, at the vertical elevation of the coupler 100 that provides the maximum power measured at the output of second alignment optical fiber 154_{align}-2 over the range of elevation of the coupler 100.

In the embodiment shown in FIGS. 4A and 4B, the FAU 156 is configured having four optical fibers 154 mounted or otherwise formed to align with four waveguide cores 106_{core} on the coupler 100. In other embodiments, the FAU 156 may be configured having one or more optical fiber 154 to align with one or more waveguide core 106_{core} on the coupler 100.

### Detailed Drawings of T&G Alignment Features in Embodiments of Assemblies

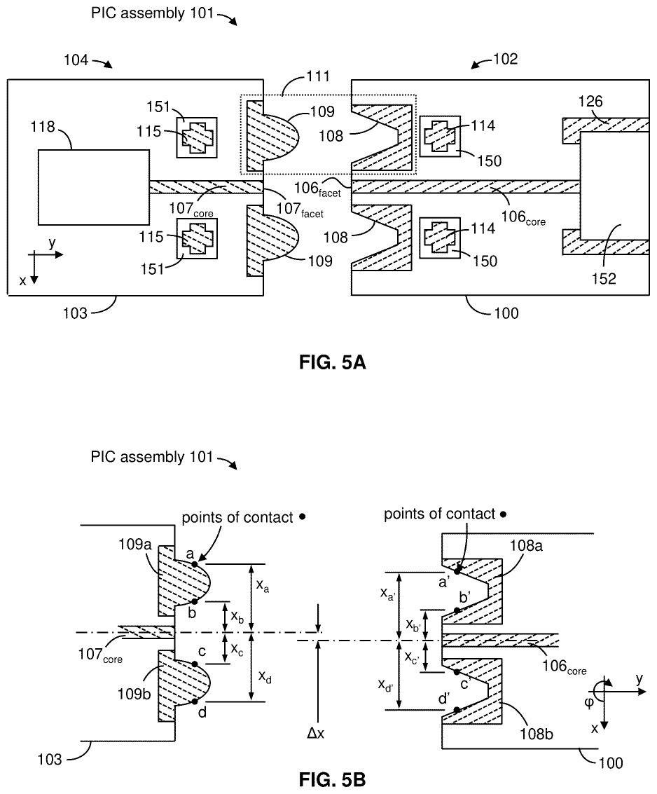

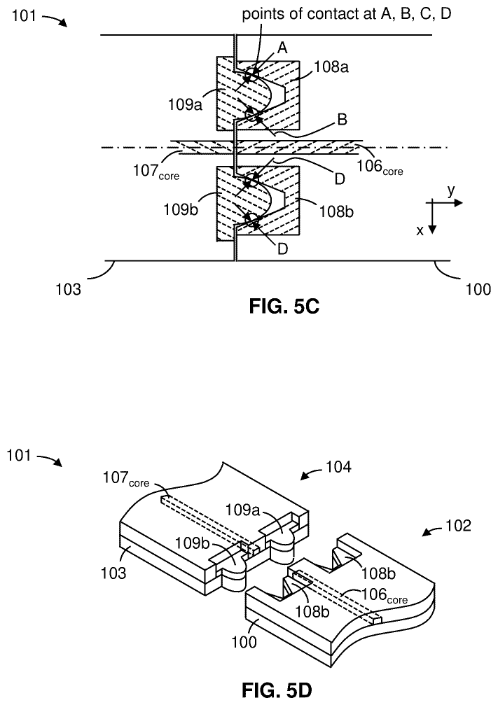

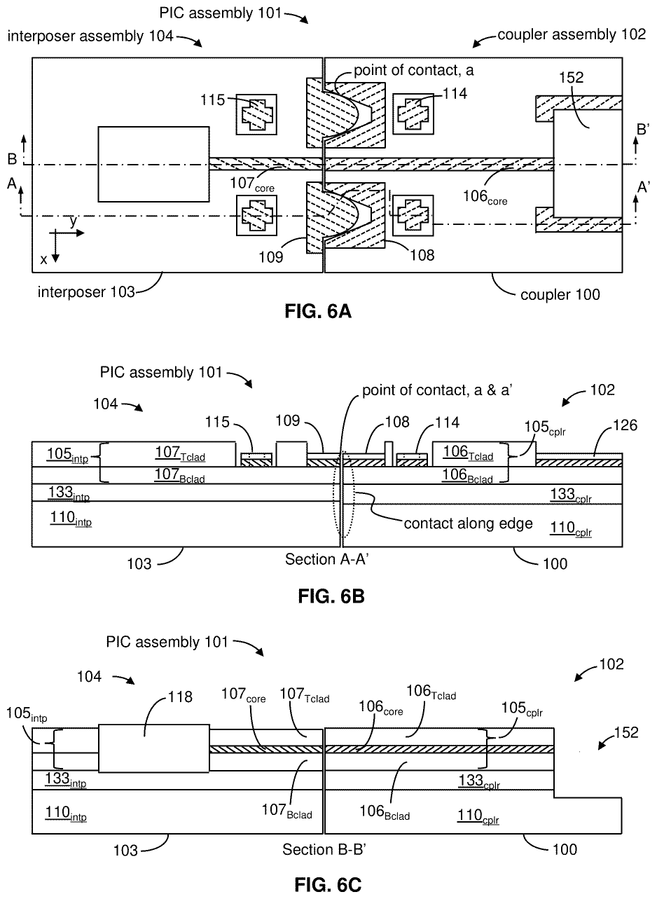

In FIGS. 5A-5D and 6A-6C, embodiments of PIC assemblies 101 are shown to illustrate key features of the T&G alignment aids formed on the coupler 100 and on interposers 103 having complementary T&G alignment features that may be used to facilitate alignment of waveguide cores 107_{core} or optical pathway on the interposer 103 to the waveguide cores 106_{core} or optical pathway on the coupler 100.

FIGS. 5A-5D and 6A-6C show various top-view and perspective schematic drawings of embodiments of PIC assembly 101 comprising an interposer 103 and coupler 100 wherein the coupler 100 is configured having an FAU mounting site 152 for mounting an FAU 156 configured having an optical fiber 154 to the coupler 100. FAU 156 provides a means for coupling an optical fiber 154 to a waveguide core 106_{core} on the coupler 100 in the embodiment. In the embodiments of FIGS. 5A-5D and 6A-6C, a single waveguide core 106_{core} is shown on the coupler 100 and a single waveguide core 107_{core} is shown on the interposer 103 for simplicity in illustrating key aspects of the embodiments, although assemblies 101 may be configured having one or more waveguide core 106_{core} on the coupler 100 and one or more waveguide core 107_{core} formed on the interposer 103 in other embodiments. Detailed drawings of example points of physical contact of the T&G alignment feature union 111 are provided in FIGS. 5B and 5C for the embodiment shown in FIG. 5A to illustrate aspects of the T&G alignment features. Cross-section drawings of the PIC assembly 101 shown in the top-view drawing of FIG. 6A are provided in FIGS. 6B and 6C that further illustrate the key aspects of the T&G alignment features.

FIG. 5A shows an exploded top-view schematic drawing of an embodiment of a PIC assembly 101 comprising an interposer 103 and a coupler 100, wherein tongue-shaped T&G alignment feature 109 of T&G alignment features 111 and fiducial features 115 are formed self-aligned to the waveguide core 107_{core} on the interposer 103, and wherein groove-shaped alignment features 108 of T&G alignment features 111, fiducial features 114, and FAU alignment feature 126 are formed self-aligned to the waveguide core 106_{core} on the coupler 100. Self-alignment, as further described in detail herein, is a technique for forming multiple features in an integrated circuit using a same lithographic patterning layer. Use of a same lithographic patterning layer ensures lithography-level resolution between the features. In the formation of an alignment aid formed self-aligned with a waveguide core of a waveguide, the alignment aid may be used to provide mechanical alignment of optical fibers and other optical devices, for example, with the waveguide core. In embodiments described herein, having T&G alignment features 108 formed self-aligned with the waveguide cores 106_{core} of the coupler 100, the mechanical alignment aids 108 may be used to align the waveguide cores 107_{core} of an interposer 103 having complementary mechanical alignment aids 109 to the waveguide cores 106_{core} of the coupler 100, which may then be used to align the waveguide cores 107_{core} with the optical axis of optical fibers 154 mounted on the coupler 100.

FIG. 5B shows an exploded top-view schematic drawing of a portion of the embodiment of the PIC assembly 101 shown in FIG. 5A that illustrates example points of mechanical contact between the tongue-shaped alignment features 109a, 109b of the interposer 103 and the groove-shaped alignment features 108a, 108b of the coupler 100 in the embodiment.

In the embodiment of the PIC assembly 101 shown in FIG. 5B, four points of contact, a to d, are identified on the interposer 103 with four corresponding points of contact a′ to d′, on the coupler 100.

In the embodiment, a first point of contact at point, a, of the interposer 103 is shown a distance, Xa, from the centerline of the waveguide core 107_{core} of the interposer 103. A complementary first point of contact of the coupler 100 at point, a′, is shown a distance, Xa′, from the centerline of the waveguide core 106_{core} on the T&G alignment feature 108 of coupler 100. A second point of contact at point, b, of the T&G alignment feature 109 of the interposer 103 is shown a distance, x_{b}, from the centerline of the waveguide core 107_{core}. A complementary second point of contact on the complementary T&G alignment feature 108 of the coupler 100 at point, b′, is shown a distance, x_{b}′, from the centerline of the waveguide core 106_{core}. A third point of contact at point, c, of the interposer 103 is shown a distance, x_{c}, from the centerline of the waveguide core 107_{core} of the interposer 103. A complementary third point of contact of the coupler at point, c′, is shown a distance, x_{c}′, from the centerline of the waveguide core 106_{core} on the coupler 100. A fourth point of contact at point, d, of the interposer 103 is shown a distance, x_{d}, from the centerline of the waveguide core 107_{core} of the interposer 103. A complementary fourth point of contact of the coupler 100 at point, d′, is shown a distance, x_{d}′, from the centerline of the waveguide core 106_{core} on the T&G alignment feature 108 of coupler 100.

Irregularities and non-idealized processes used in the formation of the structures, in practice may limit the actual contact locations to two of the four points of contact identified in the configuration shown in FIG. 5B. It should be noted that one or more of the identified points of contact, therefore, may not be in actual contact in some embodiments.

FIG. 5C shows a top-view schematic drawing of a portion of the embodiment of the PIC assembly 101 shown in FIG. 5A that illustrates example points of mechanical contact between the tongue-shaped T&G alignment feature of the interposer 103 and the groove-shaped T&G alignment feature of the coupler 100, identified in FIG. 5B, in the embodiment, after the interposer 103 and the coupler 100 have been brought into physical contact. In the embodiment shown in FIG. 5C, two or more of the contact points, a to d of the interposer 103, are brought into mechanical contact with two or more of the contact points, a′ to d′ of the coupler 100. As the two or more contact points of the tongue features 109a, 109b of the interposer 103 are brought into physical contact with the groove features 108a, 108b of the coupler 100, the waveguide core 107_{core} of the interposer 103 is brought into alignment with the waveguide core 106_{core} of the coupler 100 in the embodiment of the PIC assembly 101.

In the embodiment of the PIC assembly 101 shown in FIG. 5C, one waveguide core 107_{core} is shown on the interposer 103 and one waveguide core 106_{core} is shown on the coupler 100. In other embodiments, one or more waveguide cores 107_{core} may be formed on the interposer 103 and brought into alignment with one or more waveguide cores 106_{core} formed on the coupler 100 using the T&G alignment features that are formed self-aligned with the waveguide cores.

In some embodiments, one or more of the coupler 100 and the interposer 103 of the PIC assembly 101 may be configured without waveguide cores. In some embodiments, one or more T&G alignment feature 108 of the coupler 100 may be used in conjunction with one or more T&G alignment feature 109 of the interposer 103 to align optical pathways that do not include waveguide cores through all or a portion of one or more of interposer 103 and the coupler 100. In some embodiments, optical signals may be, for example, coupled through free-space. In such embodiments, the T&G alignment aids may be used to facilitate alignment of the optical axes of optical propagation pathways that do not have waveguide cores along all or a portion of the optical pathways traversing the interposer 103 and coupler 100.

In some embodiments in which the T&G alignment features 108a, 108b of coupler 100 are brought into physical contact with the complementary T&G alignment features 109a, 109b of interposer 103, one or more waveguide cores 106_{core} of the coupler 100 may be brought into alignment with optical pathways that do not include waveguide cores 107_{core} of the interposer 103.

FIG. 5D shows an exploded three-dimensional perspective drawing of a portion of the embodiment of the PIC assembly 101 shown in FIG. 5A. The embodiment shows tongue-shaped T&G alignment features 109a, 109b formed self-aligned with the waveguide core 107_{core} on the interposer 103, and groove-shaped T&G alignment features 108a, 108b formed self-aligned with the waveguide core 106_{core} on the coupler 100 in the drawing. In an assembly, the tongue-shaped T&G alignment features 109a, 109b of the interposer 103 may be brought into contact with the groove-shaped T&G alignment features 108a, 108b, respectively, of the coupler 100 to facilitate alignment of the waveguide core 107_{core} of the interposer 103 with the waveguide core 106_{core} of the coupler 100.

In other embodiments, coupler 100 may be configured having two or more waveguide cores 106_{core} that are brought into contact with two or more waveguides cores 107_{core} of interposer 103 or with two or more optical pathways that do not include the waveguide cores 107_{core} on the interposer 103. In such embodiments in which optical pathways that do not include waveguide cores on one or more of the coupler 100 and interposer 103, the T&G alignment features 108, 109, may be formed in self-alignment with all or a portion of the optical pathways, or to alignment features that facilitate alignment of devices that contribute to all or a portion of the optical pathways.

FIG. 6A shows a top-view schematic drawing of the embodiment of the PIC assembly 101 having the interposer 103 and coupler 100 of FIG. 5A. In the embodiment of the PIC assembly 101 shown in FIG. 6A, the waveguide core 107_{core} on the interposer 103 and the waveguide core 106_{core} on the coupler 100 are shown in lateral alignment that results from the coupling of the T&G alignment features 109 of the interposer 103 and the T&G alignment features 108 of the coupler 100.

FIGS. 6B and 6C show cross-section schematic drawings from Section A-A′ and Section B-B′ of FIG. 6A, respectively.

FIG. 6B shows the cross-sectional schematic drawing of the embodiment of the PIC assembly 101 of FIG. 6A taken at Section A-A′ and shows contact point, a, of the T&G alignment feature 109 of interposer 103 in contact with a corresponding point, a′, of the T&G alignment feature 108 of coupler 100 in the cross-sectional drawing.

FIG. 6C shows the cross-sectional schematic drawing of the embodiment of the PIC assembly 101 of FIG. 6A taken at Section B-B′, and in the cross-section, shows the aligned waveguide cores 106_{core}, 107_{core} of the coupler 100 and the interposer 103, respectively, in the PIC assembly 101.

The cross-sections FIGS. 6B and 6C show an example configuration for an embodiment of a layered structure that may be utilized in forming the interposer 103 and the coupler 100. In the embodiment, interposer 103 comprises a substrate 110ᵢₙₜₚ, an optional electrical interconnect layer 133ᵢₙₜₚ formed on the substrate 110ᵢₙₜₚ, and a planar waveguide layer 105 intp formed on the substrate 110ᵢₙₜₚ or electrical interconnect layer 133ᵢₙₜₚ, if present. In the embodiment, coupler 100 comprises a substrate 110_{cplr}, an optional electrical interconnect layer 133_{cplr}, and a planar waveguide layer 105 cplr formed on the substrate 110_{cplr} or optional electrical interconnect layer 133_{cplr}, if present.

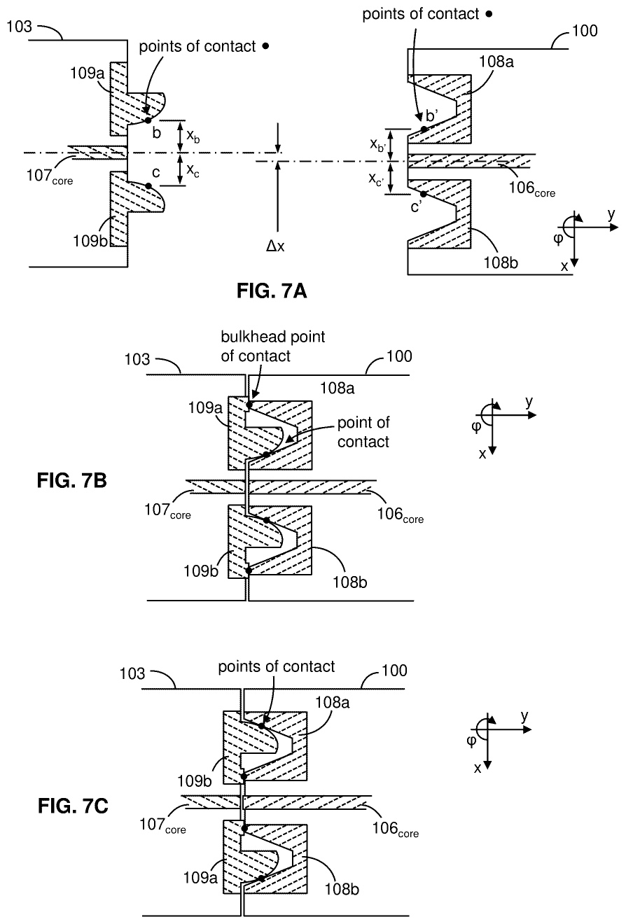

FIG. 7A shows an exploded top-view schematic drawing of a portion of another embodiment of a PIC assembly 101 wherein two points of contact are provided between the tongue-shaped alignment features 109a, 109b of the interposer 103 and the groove-shaped alignment feature 108a, 108b of the coupler 100 to facilitate lateral alignment between the waveguide core 107_{core} of the interposer 103 and the waveguide core 106_{core} of the coupler 100 in the embodiment. In the embodiment shown in FIG. 7A, the redundancy in the number of points is eliminated in comparison to embodiments such as the embodiment shown in FIG. 5A.

FIG. 7B shows a portion of an embodiment of a PIC assembly 101 configured having T&G alignment aids similar in shape to those of FIG. 7A with the addition of a bulkhead contacting feature, as noted in FIG. 7B. The addition of one or more bulkhead contacting features enables the bulkheads of the interposer 103 and coupler 100 to engage in direct physical contact and may provide improved positional reliability and alignment integrity in some embodiments.

FIG. 7C shows a portion of another embodiment of a PIC assembly 101 configured having T&G alignment features for which the contact points between the T&G alignment feature 108 of the coupler 100 and the T&G alignment feature 109 of the interposer 103 are positioned a greater distance from the centerline of the waveguide cores. The increase in the spacing between contact points may also provide improved positional reliability and alignment integrity in some embodiments.

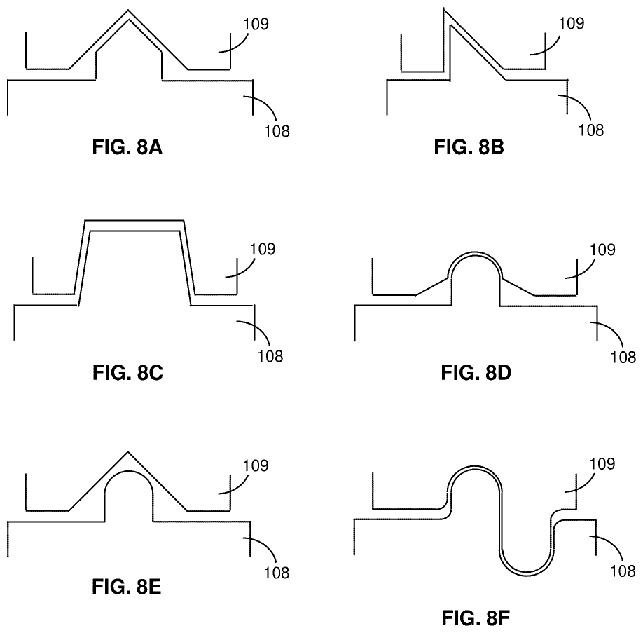

FIGS. 8A-8F show some examples of additional T&G alignment features 108,109 that may be used in the formation of T&G alignment features 111. In some embodiments, such as in FIGS. 8A to 8D, alignment between the coupler 100 and the interposer 103 in the PIC assembly 101 may be distributed over one or more linear or circumferential portions of the alignment feature 108, for example, in contact with the alignment feature 109. In practice, distributing the alignment feature over a common overlapping portion of the alignment aids 108,109 may be sufficient and preferrable in comparison to the idealized alignment features shown, for example, in FIGS. 5A-5D and in FIGS. 7A-7C wherein the contact between an alignment feature 108 on the coupler 100 and the alignment feature 109 of the interposer 103 is limited to one, two, or a limited number of contact points. In some embodiments, one or more aspect of the features shown in FIGS. 5A-5D and in FIGS. 7A-7C may be combined with one or more aspect of the features shown in FIGS. 8A-8F. In yet other embodiments, alignment features having other shapes and configurations on one or more contact edge may be used to facilitate contact at one or more contact point between alignment aid 108 on coupler 100 and alignment aid 109 on interposer 103.

FIGS. 8A and 8B show T&G alignment features 108,109 configured having triangular-shaped wall features. FIG. 8C shows T&G alignment features 108,109 having trapezoidal-shaped wall features. FIG. 8D shows T&G alignment features 108,109 having semicircular-shaped alignment features. And FIG. 8E shows T&G alignment features in which an alignment feature 108 of the coupler is semi-circular and the alignment feature 109 of the interposer 103 is triangular. The shapes described pertain to the top-view of the alignment features 108,109. FIG. 8F shows an embodiment of T&G alignment features 108,109 for which the T&G alignment feature 108 of the coupler, for example, and the T&G alignment feature 109 of the interposer, for example, are each configured having a tongue-shaped alignment feature portion and a groove-shaped alignment feature portion. Other embodiments configured having other alignment aid configurations may also be used.

In some embodiments, lateral alignment features may be formed on the interposer 103, for example, having a groove-shaped T&G alignment feature of a T&G alignment aid union 111 that is formed self-aligned with one or more waveguide core 107_{core} of the interposer 103. A complementary alignment aid having a tongue-shaped T&G alignment feature of a T&G alignment feature union 111 may be formed on the coupler 100 that is formed self-aligned with one or more waveguide core 106_{core} of the coupler 100. In an embodiment of a PIC assembly 101 comprising interposer 103 and coupler 100, the groove-shaped T&G alignment feature 109 of the interposer 103 is receptive to the tongue-shaped T&G alignment feature 108 of the coupler 100 such that when coupled together to form the PIC assembly 101, one or more waveguide core 107_{core} of the interposer 103 is aligned with one or more waveguide core 106_{core} of the coupler 100. The use of a same patterned mask layer in the formation of one or more T&G alignment aid 109 in self-alignment with the waveguide cores 107_{core} on the interposer 103, and the use of a same patterned mask layer in the formation of one or more T&G alignment aid 108 in self-alignment with the waveguide cores 106_{core} on the coupler 100, enables the use of the complementary alignment aids to align the waveguides of the interposer 103 and the coupler 100 through the mechanical contact provided with the T&G alignment aids 108,109.

In some embodiments, interposer 103 is formed having one or more groove-shaped T&G alignment feature 109 of one or more T&G alignment feature union 111 that are formed self-aligned with one or more waveguide core 107_{core} of the interposer 103, and the coupler 100 is formed having one or more tongue-shaped T&G alignment feature 108 of one or more T&G alignment aid that is formed self-aligned with one or more planar waveguide core of the coupler. In an embodiment of PIC assembly 101 comprising interposer 103 and coupler 100, the one or more self-aligned tongue-shaped T&G alignment feature 108 of the coupler 100 is receptive to the one or more self-aligned groove-shaped T&G alignment feature 109 of the interposer 103 such that when coupled together, one or more waveguide core 106_{core} of the coupler 100 is aligned with one or more waveguide core 107_{core} of the interposer 103.

In some embodiments, interposer 103 is formed having a tongue-shaped T&G alignment feature 109 of a T&G alignment feature union 111 that is formed self-aligned with one or more waveguide core 107_{core} of the interposer 103, and the coupler 100 is formed having a groove-shaped T&G alignment feature 108 of a T&G alignment feature union 111 that is formed self-aligned with one or more waveguide core 106_{core} of the coupler 100. In an embodiment of a PIC assembly formed using the interposer 103 and the coupler 100, the self-aligned groove feature of the coupler 100 is receptive to the self-aligned tongue feature of the interposer 103 such that when coupled together, one or more waveguide core 106_{core} of the coupler 100 is aligned with one or more waveguide core 107_{core} of the interposer 103.

In some embodiments, interposer 103 is formed having one or more tongue-shaped T&G alignment feature 109 of one or more T&G alignment feature union 111 that are formed self-aligned with one or more waveguide core 107_{core} of the interposer 103, and coupler 100 is formed having one or more groove-shaped T&G alignment feature 108 of one or more T&G alignment feature union 111 that is formed self-aligned with one or more waveguide core 106_{core} of the coupler 100. In an embodiment of PIC assembly 101 comprising interposer 103 and coupler 100, the one or more self-aligned groove feature of the coupler 100 is receptive to the one or more self-aligned tongue feature of the interposer 103 such that when coupled together, one or more waveguide core 106_{core} of the coupler 100 is aligned with one or more waveguide core 107_{core} of the interposer 103.

And in some embodiments, interposer 103 is formed having one or more tongue-shaped T&G alignment feature 109 of one or more T&G alignment feature union 111 and one or more groove-shaped T&G alignment feature 109 of one or more T&G alignment feature union 111 that are formed self-aligned with one or more waveguide core 107_{core} of the interposer 103, and coupler 100 is formed having one or more groove-shaped T&G alignment feature 108 of one or more T&G alignment feature union 111 and having one or more tongue-shaped T&G alignment feature 108 of one or more T&G alignment feature union 111 that are formed self-aligned with one or more waveguide core 106_{core} of the coupler 100. In an embodiment of an PIC assembly 101 comprising the interposer 103 and the coupler 100, the one or more self-aligned groove-shaped feature and the one or more tongue-shaped of the coupler 100 are receptive to the one or more self-aligned tongue feature and the one or more groove-shaped feature of the interposer 103 such that when coupled together, the one or more waveguide core 106_{core} of the coupler 100 is aligned with the one or more waveguide core 107_{core} of the interposer 103.

In some embodiments of assemblies comprising an interposer 103 and coupler 100 each having one or more T&G alignment feature, one or more alignment other aids may also be formed on one or more of the interposer 103 and the coupler 100 that include a fiducial, a lateral alignment aid that facilitates alignment of a device, a lateral alignment aid that facilitates alignment of a means for coupling one or more optical fibers, an alignment pillar formed in a cavity, among other forms of alignment aids, as further disclosed herein. One or more of these alignment aids, among others, may be formed self-aligned with one or more T&G alignment feature 109 and one or more waveguide core 107_{core} of the interposer 103. Additionally, one or more of these alignment aids, among others, may be formed self-aligned with one or more T&G alignment feature 108 and one or more waveguide core 106_{core} of the coupler 100.

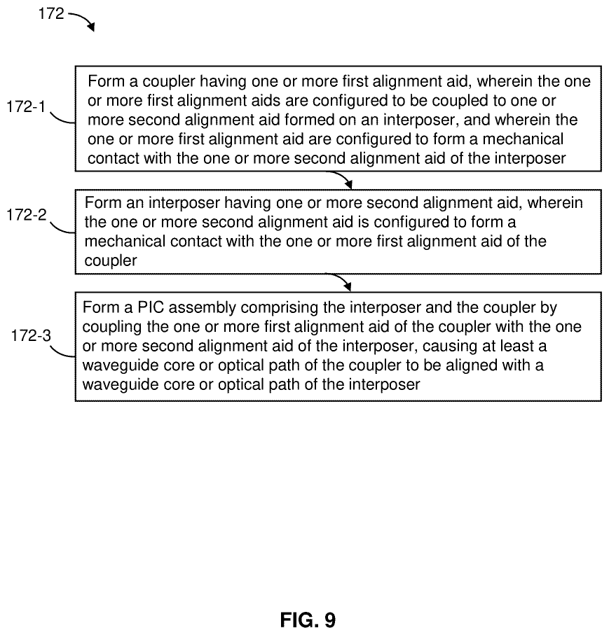

FIG. 9 shows a flowchart for a method 172 of forming embodiments of PIC assembly 101 comprising coupler 100 and interposer 103, wherein the coupler 100 is configured having one or more alignment aids 108 formed self-aligned with one or more waveguide core 106_{core} of the coupler 100 and having one or more contacting locations, and wherein the interposer 103 is configured having one or more alignment aids 109 formed self-aligned with one or more waveguide core 107_{core} of the interposer 103 and having one or more contacting locations, wherein the alignment aids 108 and contacting locations of the coupler 100 are complementary to the alignment aids 109 and contacting locations of the interposer 103 such that bringing the contact points of the alignment aids 108 of the coupler 100 into contact with the contact points of the alignment aids 109 of the interposer 103, facilitates alignment of the one or more waveguide cores 106_{core} of the coupler 100 with the one or more waveguide cores 107_{core} of the interposer 103.

In an embodiment of method 172 of forming a PIC assembly 101 comprising a coupler 100 and an interposer 103, coupler 100 is configured having one or more contacting locations on a lateral alignment aid such as the groove-shaped alignment aid 108 of the T&G alignment feature union 111 shown in FIG. 5A, and interposer 103 is configured having one or more complementary lateral alignment aids to the alignment aid of the coupler 100, such as the tongue-shaped alignment aid 109 of FIG. 5A. In the embodiment of the PIC assembly 101, the coupler 100 is configured having contact points on the alignment aid 108 of coupler 100 that when brought into contact with corresponding contact points of the interposer 103, the waveguide cores 106_{core} of the coupler 100 are brought into alignment with the waveguide cores 107_{core} of the interposer 103.

Step 172-1 of method 172 is a forming step in which a coupler 100 is formed having one or more first alignment aids 108 of a complementary pair of alignment aids 111, wherein the one or more first alignment aids 108 of the coupler 100 are configured to be coupled to one or more second alignment aid 109 formed on an interposer 103, and wherein the one or more first alignment aid 108 are configured to form a mechanical contact with the one or more second alignment aid 109 of the interposer 103.

Step 172-2 of method 172 is a forming step in which an interposer 103 having one or more second alignment aid 109 is formed, wherein the one or more second alignment aid 109 of the interposer 103 is configured to enable formation of a mechanical contact with the one or more first alignment aid 108 of the coupler 100. In embodiments of PIC assembly 101 comprising coupler 100 and interposer 103 configured having alignment aids 108,109, respectively, one or more waveguide cores 106_{core} or optical pathway formed on the coupler 100 is brought into alignment with one or more waveguide cores 107_{core} or optical pathway on the interposer 103 as the one or more alignment aids 108 of the coupler 100 are brought into contact with the one or more alignment aid 109 of the interposer 103. In embodiments that are not configured having waveguides, such as couplers 100 comprising cavities 146 that enable free-space coupling of optical signals to the interposer 103, for example, other optical pathways that are configured for self-alignment to the alignment aids 108 on the coupler 100 may be brought into alignment with corresponding optical pathways on the interposer 103. In some embodiments, the one or more alignment aid 109 of the interposer 103 may be brought into contact with the one or more alignment aid 108 of the coupler 100.

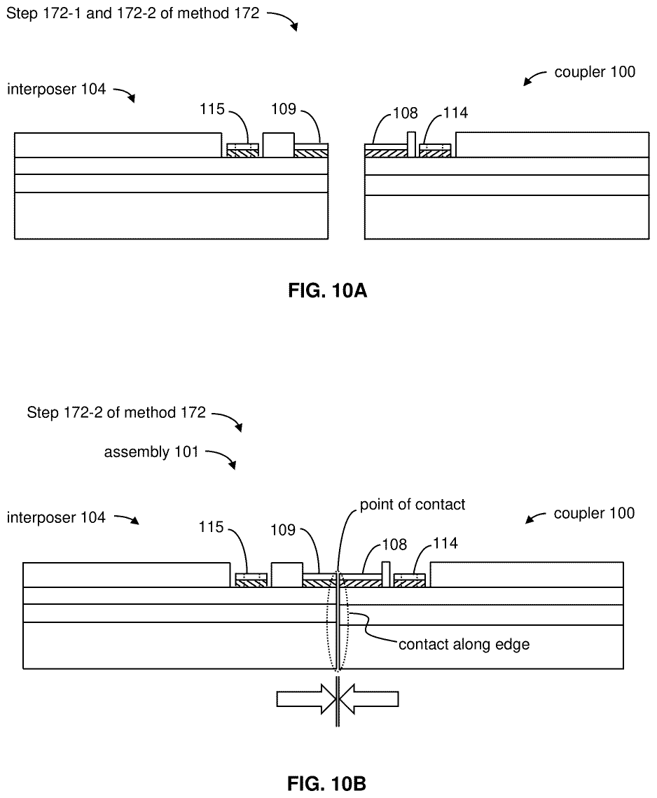

FIG. 10A shows an exploded cross-sectional schematic drawing of an embodiment of a PIC assembly 101 comprising coupler 100 and interposer 103 each having a T&G lateral alignment aid, 108,109, respectively. Fiducials 114,115, formed self-aligned with the T&G alignment aids 108,109, respectively, are also shown in the cross-section of FIG. 10A.

Step 172-3 of method 172 is a forming step in which a PIC assembly 101 comprising the coupler 100 formed in step 172-1 and the interposer 103 formed in step 172-2 is formed by coupling the one or more first alignment aid 108 of coupler 100 with the one or more second alignment aid 109 of the interposer 103, causing at least a waveguide core 106_{core} or optical path of coupler 100 to be aligned with a waveguide core 107_{core} or optical path of the interposer 103.

The PIC assembly 101 comprising interposer 103 and coupler 100, in the embodiment, are formed by coupling the one or more first alignment aid 108 of coupler 100 with the one or more second alignment aid 109 of the interposer 103. Coupling of the lateral alignment aids of coupler 100 and interposer 103 at the contact points, facilitates the alignment of one or more waveguide cores 106_{core} formed on the coupler 100 with one or more waveguide core 107_{core} formed on the interposer 103. Alignment of the waveguide cores 106_{core} on the coupler 100 with the waveguide cores 107_{core} on the interposer 103 can be achieved with high accuracy as a result of the lateral alignment aid 108 of the coupler 100 being formed self-aligned with the waveguide core 106_{core} of the coupler 100 and the lateral alignment aid 109 of the interposer 103 being formed self-aligned with the waveguide core 107_{core} of the interposer 103.

In embodiments that do not have waveguides formed on one or more of coupler 100 and interposer 103, the lateral alignment aids 108,109 may be used to facilitate alignment of optical pathways that are referenced to the lateral alignment aids formed on one or more of the coupler 100 and the interposer 103. In an example, a device having a characteristic optical axis may be aligned and mounted on coupler 100 using a lateral alignment aid that is formed self-aligned with a T&G alignment aid 108 formed on the coupler 100. The optical axis of the mounted device may then be aligned with a waveguide core 107_{core} on the interposer 103 by coupling the T&G lateral alignment aid 108 of the coupler 100 with the T&G lateral alignment aid 109 of the interposer 103.

FIG. 10B shows a cross-sectional schematic drawing of an embodiment of a PIC assembly 101 comprising interposer 103 and coupler 100 wherein the T&G alignment aid 109 of the interposer 103 is brought into contact with T&G alignment aid 108 of the coupler 100 at a point of contact labeled “point of contact” in the embodiment. The open arrows in FIG. 10B show the direction of movement of the coupler 100 and the interposer 103 prior to contacting of the lateral alignment aids 108,109.

### Self-Aligned Feature Formation

The formation of T&G alignment features 109 and other alignment features of interposer 103 in self-alignment with waveguide cores 107_{core} formed on the interposer 103 facilitates the lithographic level resolution in the relative positioning of devices mounted on, or coupled to, the interposer.

The formation of alignment features such as fiducials 114 and T&G alignment features 108 of coupler 100, among other alignment features, in self-alignment with the waveguide cores 106_{core} of the coupler 100, enables the formation of PIC assemblies 101 in which the alignment features 108 of the coupler 100 may be used to facilitate the alignment of the waveguide cores 106_{core} of the coupler 100 with optical features formed on, for example, interposer 103. In embodiments, one or more alignment aid 108, formed self-aligned with the waveguide cores 106_{core}, may be coupled to one or more alignment aids 109 of interposer 103, that may too be formed self-aligned with waveguide cores 107_{core} formed on the interposer 103.

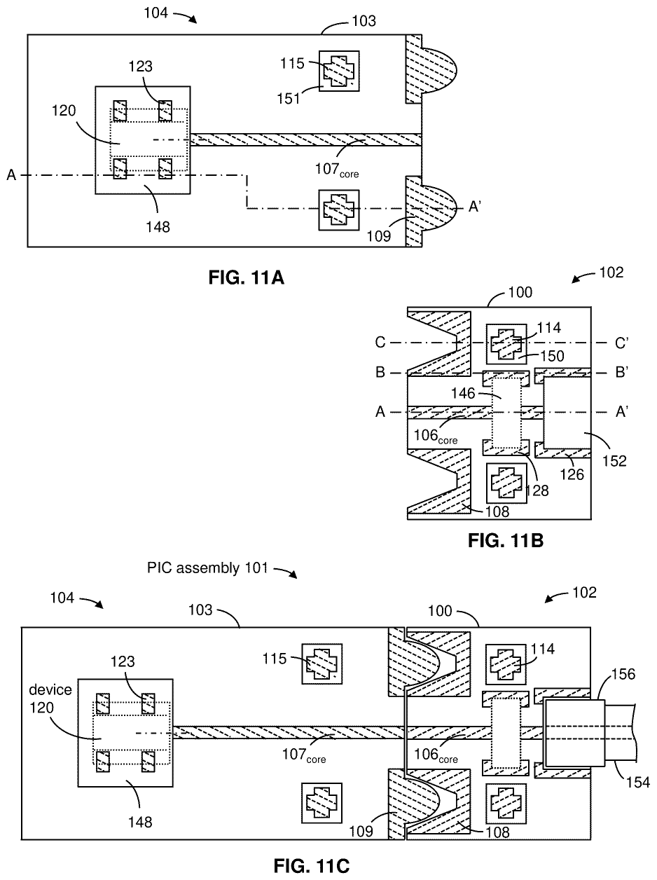

In FIGS. 11A-11C, 12, 13A-13F, 14, and 15A1-15F3, structures and methods for forming alignment features in self-alignment with waveguide cores 106_{core} on coupler 100 and for forming alignment features in self-alignment with waveguide cores 107_{core} on interposer 103 are shown.

FIG. 11A shows a top-view schematic drawing of interposer 103 of interposer assembly 104 configured having two T&G alignment features 109, two fiducials 115 each formed in a cavity 151, and alignment pillars 123 formed in cavity 148. An optoelectrical device 120 is shown mounted on alignment pillars 123 in the cavity 148 such that the optical axis of the optoelectrical device 120 is mounted in alignment with the optical axis of the waveguide core 107_{core} in the embodiment.

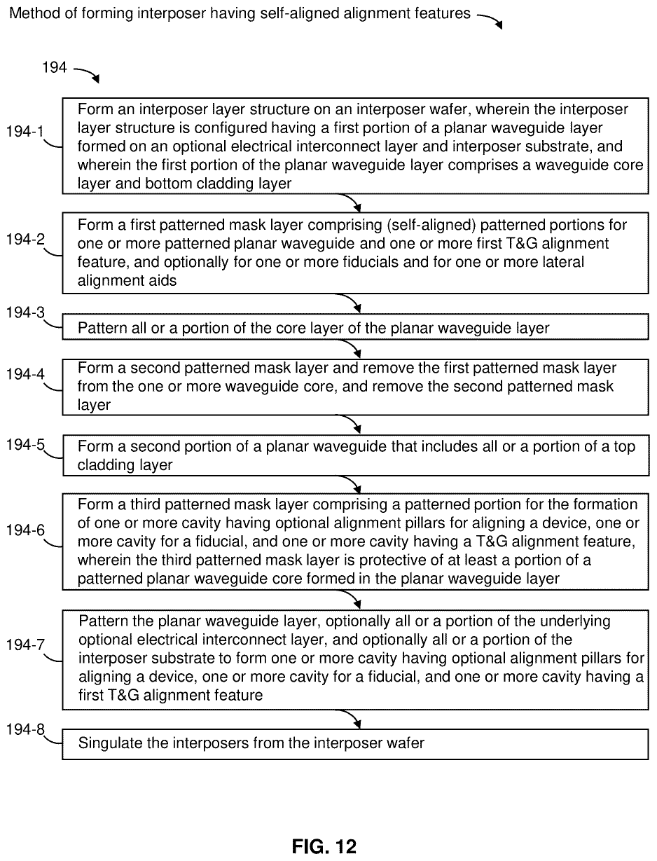

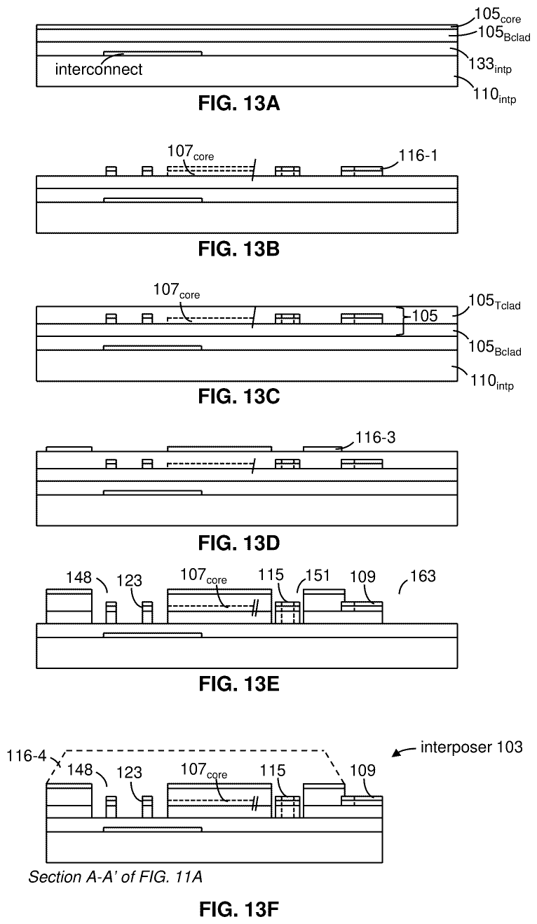

FIG. 12 shows a flowchart for a method 194 of forming embodiments of interposers 103 configured having alignment features formed self-aligned with a waveguide core 107_{core} as shown in the top-view schematic drawing of FIG. 11A. Steps in the method 194 of FIG. 12 are described in conjunction with the cross-sectional schematic drawings of FIGS. 13A-13F. The cross-sectional schematic drawings of FIGS. 13A-13F are taken through Section A-A′ of the top-view drawing of interposer 103 shown in FIG. 11A.

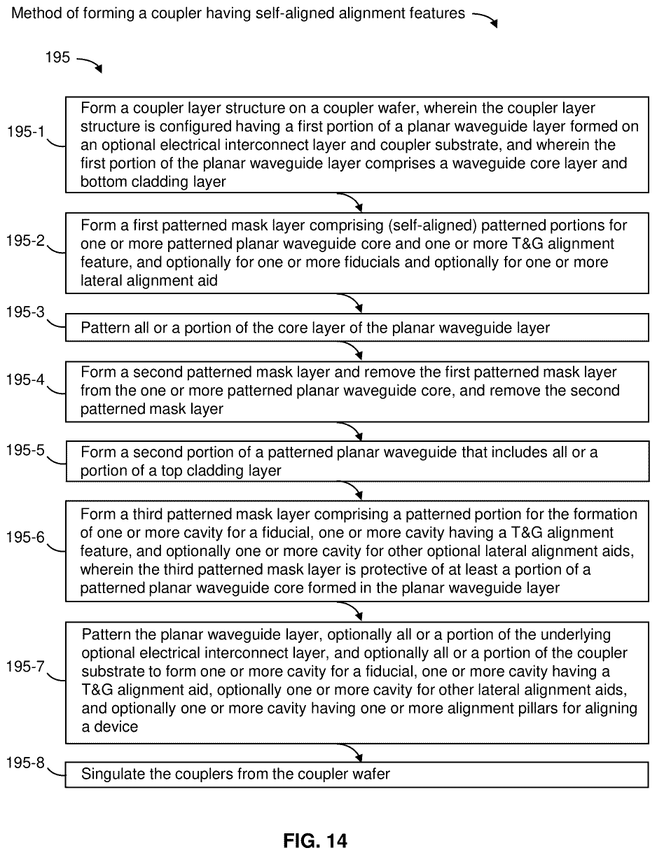

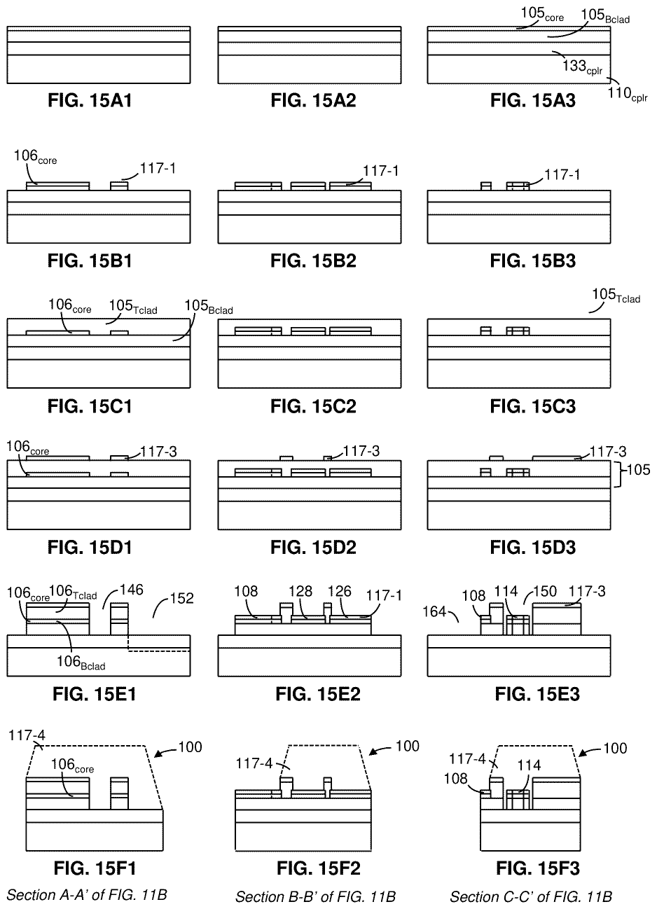

FIG. 14 shows a flowchart for a method 195 of forming embodiments of couplers 100 configured having alignment features formed self-aligned with a waveguide core 106_{core} as shown in the top-view schematic drawing of FIG. 11B. Steps in the method 195 of FIG. 14 are described in conjunction with the cross-sectional schematic drawings of FIGS. 15A1-15F3. The cross-sectional schematic drawings of FIGS. 15A1-15F1 show Section A-A′ of the top-view drawing of coupler 100 shown in FIG. 11B. The cross-sectional schematic drawings of FIGS. 15A2-15F2 show Section B-B′ of the top-view drawing of coupler 100 shown in FIG. 11B. The cross-sectional schematic drawings of FIGS. 15A3-15F3 show Section C-C′ of the top-view drawing of coupler 100 shown in FIG. 11B.

FIG. 11C shows a top-view schematic drawing of a PIC assembly 101 comprising the embodiment of interposer 103 of FIG. 11A and the embodiment of coupler 100 of FIG. 11B.

Method 194 shown in FIG. 12 and described herein in conjunction with cross-sectional schematic drawings in FIGS. 13A-13F, discloses a method of forming embodiments of interposer 103 having alignment features that are formed self-aligned with waveguide cores 107_{core} formed on the interposer 103, wherein the alignment features include T&G alignment aids 109, fiducials 115, and alignment pillars 123 formed in cavity 148. Other alignment features may also be formed in other embodiments.

Step 194-1 of method 194 is a forming step in which an interposer layer structure is formed on an interposer wafer, wherein the interposer layer structure is configured having a first portion of a planar waveguide layer formed on an optional electrical interconnect layer and interposer substrate, and wherein the first portion of the planar waveguide layer comprises a core layer and a bottom cladding layer.

FIG. 13A shows a cross-sectional schematic drawing of an embodiment of an interposer 103 after formation of a first portion of planar waveguide layer 105 comprising the planar waveguide core layer 105_{core} and bottom cladding layer 105_{Bclad}, wherein the first portion of the planar waveguide layer 105 is formed on optional electrical interconnect layer 133 intp and interposer substrate 110ᵢₙₜₚ.

In embodiments, planar waveguide core layer 105_{core} may be formed from one or more of silicon nitride, silicon, silicon oxynitride, silicon oxide, lithium niobate, among other materials used in the formation of optical waveguide cores. In some embodiments, a polymer may be used in the formation of planar waveguide core layer 105_{core}. In embodiments, bottom cladding layer 105_{Bclad} may be formed from one or more of silicon oxide, silicon oxynitride, silicon nitride, among other materials having an index of refraction less than that of the planar waveguide core layer. In some embodiments, a polymer may be used to form bottom cladding layer 105_{Bclad}.

In the embodiment shown in FIG. 13A, optional electrical interconnect layer 133ᵢₙₜₚ comprises a patterned conductive interconnect layer formed within an insulating dielectric. In some embodiments, a single layer of patterned conductive electrical interconnects may be formed in the electrical interconnect layer 133ᵢₙₜₚ. In other embodiments, more than a single layer of patterned conductive electrical interconnects may be formed. In embodiments, conductive electrical interconnects may include one or more of lateral interconnects and vertical interconnects. Electrical interconnects formed on the electrical interconnect layer may facilitate electrical connections formed below the substrate (as in the orientation shown in FIG. 13A) and may facilitate electrical interconnection formed above one or more planar waveguide layers. In some embodiments, interposer substrate 110ᵢₙₜₚ may be a silicon substrate. In other embodiments, interposer substrate may be formed from a compound semiconductor such as one or more of indium phosphide, gallium arsenide, germanium, among other semiconductor materials.

Step 194-2 of method 194 is a forming step in which a first patterned mask layer 116-1 is formed wherein the first patterned mask layer 116-1 comprises patterned portions for the formation of one or more waveguide core 107_{core} and one or more first T&G alignment feature, and optionally for one or more fiducial and optionally for one or more other lateral alignment aids such as alignment pillars 123. Patterned portions may be provided for the formation of other lateral alignment aids (not shown) that may also be optionally included such as alignment aids for the mounting of optical devices, such as an MLA, a photodiode, a waveguide, an optical isolator, a gain device, a laser diode, a semiconductor optical amplifier, a driver, a modulator, among other optical devices that may be aligned fully or in part using lateral alignment aids formed self-aligned with waveguide cores, optical pathways, or other alignment aids formed on the interposer 103.

Step 194-3 of method 194 is a patterning step in which all or a portion of the waveguide core layer 107_{core} is patterned. Patterning of the planar waveguide core layer 105_{core} may be achieved, for example, using a suitable plasma etching process to facilitate removal of the unmasked portions of the patterned waveguide core layer 105_{core}. Other methods of removal may also be used.

FIG. 13B shows a cross-sectional schematic drawing of an embodiment of interposer 103 after formation of a first patterned mask layer 116-1 formed on the planar waveguide core layer 105_{core} and patterning of the planar waveguide core layer 105_{core} to form the waveguide core 107_{core} in the embodiment. In the embodiment, first patterned mask layer 116-1 is configured having patterned portions for the formation of alignment pillars 123, waveguide cores 107_{core}, fiducials 115, and T&G alignment feature 109. In an embodiment, first patterned mask layer 116-1 may be formed, for example, from aluminum or an alloy of aluminum. Other materials may also be used in embodiments such as titanium, nickel, aluminum oxide, titanium oxide, silicon oxide, among others. Materials having a low etch rate in relation to the etch rate of the planar waveguide core layer 105_{core} for the patterning process used to pattern the waveguide core layer 105_{core} are preferred.

Because the waveguide core 107_{core} is not intersected by the Section A-A′ line of FIG. 11A, this waveguide core 107_{core} is shown as a dotted line projection in the cross-sectional drawings of FIGS. 13B-13F. An angled break line is shown at the rightmost portion of the waveguide core 107_{core} to maintain separation between the waveguide core 107_{core} and the fiducial 115.

Step 194-4 of method 194 is a forming and removing step in which a second patterned mask layer is formed, to facilitate removal of the first patterned mask layer 116-1 from the one or more waveguide core 107_{core}, and the first patterned mask layer 116-1 is removed from the one or more waveguide core 107_{core}. After removal of the first patterned mask layer 116-1 from the one or more waveguide core 107_{core}, the second patterned mask layer is also removed.

Step 194-5 of method 194 is a forming step in which a second portion of a planar waveguide layer 105 is formed on the first portion of the planar waveguide layer 105 and all or a portion of the alignment features that include alignment pillars 123, fiducials 115, and T&G alignment feature 109. In the embodiment shown, the first patterned mask layer 116-1 is removed only from the waveguide core 107_{core}. In other embodiments, the first patterned mask layer may be removed from one or more of these and other alignment features. The second portion of the planar waveguide layer 105 may include all or a portion of a top cladding layer, and all or a portion of a spacer layer, a buffer layer, among other layers. The top cladding layer 105_{Tclad} is typically formed from the same material as the bottom cladding layer 105_{Bclad}. In some embodiments, a top cladding layer may be formed from a different material than that used in the formation of the bottom cladding layer.

FIG. 13C shows a cross-sectional schematic drawing of an embodiment of interposer 103 after formation of a second patterned mask layer, removal of the first patterned mask layer 116-1 from the one or more waveguide core 107_{core}, removal of the second patterned mask layer, and formation of a second portion of planar waveguide layer 105. Waveguide core 107_{core} is shown without the first patterned mask layer 116-1.

Step 194-6 of method 194 is a forming step in which a third patterned mask layer is formed wherein the third patterned mask layer 116-3 comprises patterned portions for the formation of one or more cavities having optional alignment pillars 123 for aligning a device, one or more cavity for a fiducial, and one or more cavity having a T&G alignment feature, and wherein the third patterned mask layer is protective of at least a portion of a waveguide core formed in the planar waveguide layer 105.

FIG. 13D shows a cross-sectional schematic drawing of an embodiment of interposer 103 after formation of a third patterned mask layer 116-3 on the planar waveguide layer 105, wherein the third patterned mask layer 116-3 in the cross-sectional drawing comprises patterned portions for the formation of a cavity 146 having alignment pillars 123 for mounting optoelectrical device 120, a cavity 151 for one or more fiducial 115, and a cavity 163 having a first T&G alignment feature 109, and wherein the third patterned mask layer 116-3 is protective of the waveguide core 107_{core} formed from the planar waveguide layer 105.

Step 194-7 of method 194 is a patterning step in which the planar waveguide layer, and optionally all or a portion of the electrical interconnect layer and the interposer substrate of the interposer are patterned to form one or more cavities having optional alignment pillars for aligning a device, one or more cavity for a fiducial, and one or more cavity having a first T&G alignment feature.

FIG. 13E shows a cross-sectional schematic drawing of an embodiment of interposer 103 after patterning of the planar waveguide layer 105 of the interposer 103 to form a cavity 146 having alignment pillars 123 and receptive to an optical device, a cavity 151 having a fiducial 115, and a cavity 163 having a first T&G alignment feature 109. In the embodiment shown, the planar waveguide layer 105 has been patterned. In other embodiments, all or a portion of the electrical interconnect layer 133ᵢₙₜₚ underlying the planar waveguide layer 105 may also be patterned.

Step 194-8 of method 194 is a singulation step in which one or more interposers are singulated from the interposer wafer.

FIG. 13F shows a cross-sectional schematic drawing of an embodiment of interposer 103 after singulation of the interposer 103 from the interposer wafer 103_{wafer}. Fourth patterned mask layer 116-4 may be used, for example, to form a pattern on the interposer wafer 103_{wafer} having open areas to facilitate a deep etch process through all or a portion of the substrate 110ᵢₙₜₚ. In some portions of the interposer 103, such as for alignment feature 109 shown in FIG. 13F, the first patterned mask layer 116-1 may become re-exposed during the example patterning step.

As with the formation of T&G alignment features 109 and other alignment features of interposer 103 formed in self-alignment with waveguide cores 107_{core} formed on the interposer 103, similar structures having T&G alignment features 108 and other alignment features formed self-aligned with waveguide cores 106_{core} may be formed on the coupler 100. The formation of alignment aids on the coupler 100 in self-alignment with waveguide cores 106_{core} on coupler 100, facilitates lithographic level resolution in the relative positioning of devices mounted on, or coupled to the coupler 100. The use of the self-aligned features on the interposer 103 and the coupler 100 in the formation of assemblies 101 further extends the resolution in the relative positioning of the coupler 100 and interposer 103, and of optical devices mounted or otherwise formed on the coupler 100 and the interposer 103.

FIG. 14 shows a flowchart for a method 195 of forming embodiments of coupler 100. Steps in method 195 are described herein in conjunction with top-view schematic drawings in FIGS. 11B and 11C and cross-sectional schematic drawings in FIGS. 15A1-15F1, 15A2-15F2, and 15A3-15F3. Method 195 discloses a method of forming embodiments of coupler 100 having alignment features that are formed self-aligned with waveguide cores 106_{core} formed on the coupler 100.

FIG. 11B shows a top-view schematic drawing of coupler 100 in the embodiment having two T&G alignment features 108, two fiducials 114 each formed in a cavity 150, cavity alignment aids 128 to facilitate aligning one or more multi-lens array 130_{MLA} (not shown) and optical isolator 132 (not shown), and FAU alignment aids 126 to facilitate aligning all or a portion of an FAU 156. In other embodiments, other self-aligned alignment features such as alignment pillars 122 formed in a cavity on the coupler 100, for example, may also be included, among other alignment aids.

Step 195-1 of method 195 is a forming step in which a coupler layer structure is formed on a coupler wafer, wherein the coupler layer structure is configured having a first portion of a planar waveguide layer formed on an optional electrical interconnect layer and coupler substrate, and wherein the first portion of the planar waveguide layer comprises a core layer and a bottom cladding layer.

FIGS. 15A1-15A3 show cross-sectional schematic drawings of an embodiment of a coupler 100, through Sections A-A′, B-B′ and C-C′ of FIG. 11B, respectively, after formation of a first portion of planar waveguide layer 105 comprising the planar waveguide core layer 105_{core} and bottom cladding layer 105_{Bclad}, wherein the first portion of the planar waveguide layer 105 is formed on optional electrical interconnect layer 133_{cplr} and coupler substrate 110_{cplr}.

In embodiments, planar waveguide core layer 105_{core} may be formed from one or more of silicon nitride, silicon, silicon oxynitride, silicon oxide, among other materials used in the formation of optical waveguide cores. In some embodiments, a polymer may be used in the formation of planar waveguide core layer 105_{core}. In embodiments, bottom cladding layer 105_{Bclad} may be formed from one or more of silicon oxide, silicon oxynitride, silicon nitride, among other materials having an index of refraction less than that of the planar waveguide core layer. In some embodiments, a polymer may be used to form bottom cladding layer 105_{Bclad}.

In the embodiment shown, optional electrical interconnect layer 133_{cplr} comprises a patterned conductive interconnect layer formed within a dielectric layer. In some embodiments, a single layer of patterned conductive electrical interconnects may be formed in the electrical interconnect layer 133_{cplr}. In other embodiments, more than a single layer of patterned conductive electrical interconnects may be formed. In embodiments, conductive electrical interconnects may include one or more of lateral interconnects and vertical interconnects. In some embodiments, electrical interconnects formed in the electrical interconnect layer may facilitate electrical connections formed below the substrate (as oriented in FIG. 13A) and may facilitate electrical interconnection formed above one or more planar waveguide layers. In some embodiments, coupler substrate 110_{cplr} may be a silicon substrate. In other embodiments, interposer substrate may be formed from a compound semiconductor such as one or more of indium phosphide, gallium arsenide, germanium, among other semiconductor materials.

Step 195-2 of method 195 is a forming step in which a first patterned mask layer is formed wherein the first patterned mask layer comprises patterned portions for the formation of one or more waveguide core 106_{core} and one or more second T&G alignment feature, and optionally for one or more fiducial and optionally for one or more other lateral alignment aids. Patterned portions of first patterned mask layer may be provided for the formation of other lateral alignment aids (not shown) that may also be optionally included such as alignment aids for the mounting of optical devices, such as an MLA, a photodiode, a waveguide, a gain device, a laser diode, a semiconductor optical amplifier, a driver, a modulator, among other optical devices that may be aligned fully or in part using lateral alignment aids formed self-aligned with waveguide cores, optical pathways, or other alignment aids formed on the coupler 100.

Step 195-3 of method 195 is a patterning step in which all or a portion of the planar waveguide core layer 105_{core} is patterned. Patterning of the planar waveguide core layer 105_{core} may be achieved, for example, using a suitable plasma etching process to facilitate removal of the unmasked portions of the patterned waveguide core layer 105_{core}. Other methods of removal may also be used.

FIG. 15B1-15B3 show cross-sectional schematic drawings of an embodiment of coupler 100, through Sections A-A′, B-B′ and C-C′, respectively, of FIG. 11B after formation of a first patterned mask layer 117-1 formed on the planar waveguide core layer 105_{core} and patterning of the planar waveguide core layer 105_{core} to form the waveguide core 106_{core} in the embodiment. First patterned mask layer 117-1, in the embodiment, is configured having patterned portions for the formation of a waveguide core 106_{core}, fiducial 114, and T&G alignment feature 108. In other embodiments, patterned portions may be optionally provided for alignment pillars 122 and optionally for other alignment aids formed self-aligned with the waveguide core 106_{core}. In an embodiment, first patterned mask layer 117-1 may be formed, for example, from aluminum or an alloy of aluminum for a planar waveguide core layer 105_{core} formed from one or more of silicon oxynitride, silicon nitride, and silicon nitride. These core layer materials may be patterned, for example, using fluorine-containing dry etch processes that have a relatively high etch rate for the dielectric core layer and a low etch rate for an aluminum-based patterned mask layer. Other materials may also be used in embodiments such as titanium, nickel, aluminum oxide, titanium oxide, silicon oxide, among others. Materials having a low etch rate in relation to the etch rate of the planar waveguide core layer 105_{core} for the patterning process used to pattern the waveguide core layer 105_{core} are preferred.

FIG. 15B1 shows patterned mask layer and patterned core layer portions to facilitate formation of the waveguide core 106_{core} of the top-view drawing shown in FIG. 11B. The waveguide core 106_{core}, coupled with the top and bottom cladding layers, form a waveguide 106 on the coupler 100.

FIG. 15B2 shows portions of patterned mask layer 117-1 that may be used to facilitate formation of a portion of a T&G alignment feature 108, cavity alignment aid 128, and FAU alignment aid 126. Optional cavity alignment aid 128 is provided to facilitate alignment of one or more of an optical isolator 132 and multi-lens array in the embodiment. Optional FAU alignment aid 126 is provided to facilitate alignment of a fiber mount 102 in the embodiment. And FIG. 15B3 shows portions of patterned mask layer 117-1 that may be used to facilitate formation of a fiducial 114 and another portion of a T&G alignment feature 108.

Step 195-4 of method 195 is a forming and removing step in which a second patterned mask layer is formed, to facilitate removal of the first patterned mask layer 117-1 from the one or more waveguide core 106_{core}, and the first patterned mask layer 117-1 is removed from the one or more waveguide core 106_{core}. After removal of the first patterned mask layer 117-1 from the one or more waveguide core 106_{core}, the second patterned mask layer is also removed.

Step 195-5 of method 195 is a forming step in which a second portion of a planar waveguide layer 105 is formed on the first portion of the planar waveguide layer 105 and all or a portion of the alignment features that include fiducials 114, and T&G alignment feature 108, among other alignment features that may be present on the coupler.

In the embodiment shown, the first patterned mask layer 117-1 is removed only from the waveguide core 106_{core}. The second portion of the planar waveguide layer is formed over the patterned portions of the first patterned mask layer 117-1 to bury these patterned portions of the first patterned mask layer 117-1 below the second portion of the planar waveguide layer that includes the top cladding layer 105_{Tclad}. In other embodiments, other portions of the first patterned mask layer 117-1 may optionally be removed in addition to the removal of the portions of the first patterned mask layer 117-1 from the one or more waveguide core 106_{core}. In other embodiments, the first patterned mask layer 117-1 may be removed from one or more of the other alignment features. The second portion of the planar waveguide layer 105 may include all or a portion of a top cladding layer, and all or a portion of a spacer layer, a buffer layer, among other layers. The top cladding layer 105_{Tclad} is typically formed from the same material as the bottom cladding layer 105_{Bclad}. One or more of the top cladding layer and the bottom cladding layer may include the cladding on the sides of the waveguide cores 106_{core} and other patterned features. In the embodiment shown, the cladding coverage on the sides of the waveguide cores 106_{core} is provided by the top cladding layer 105_{Tclad}.

FIGS. 15C1-15C3 show cross-sectional schematic drawings of an embodiment of coupler 100, through Sections A-A′, B-B′ and C-C′, respectively of FIG. 11B after formation of a second patterned mask layer (not shown), removal of the first patterned mask layer 117-1 from the one or more waveguide core 106_{core}, removal of the second patterned mask layer, and formation of a second portion of planar waveguide layer 105 that includes all or a portion of a top cladding layer. In FIG. 15C1, waveguide core 106_{core} is shown without the first patterned mask layer 117-1. The alignment features in FIGS. 15C2 and 15C3 show portions of the first patterned mask layer 117-1 remaining on the alignment features and encapsulated within the second portion of the planar waveguide layer 105 that includes the top cladding layer 105_{Tclad}.

Step 195-6 of method 195 is a forming step in which a third patterned mask layer 117-3 is formed wherein the third patterned mask layer 117-3 comprises patterned portions for the formation of one or more cavity 150 for a fiducial 114, and one or more cavity 163 having a second T&G alignment feature 108, and optionally one or more cavity 146 for other optional alignment aids, wherein the third patterned mask layer 117-3 is protective of at least a portion of a waveguide core 106_{core} formed in the planar waveguide layer 105.

FIGS. 15D1-15D3 show cross-sectional schematic drawings of an embodiment of coupler 100, through Sections A-A′, B-B′ and C-C′, respectively of FIG. 11B after formation of a third patterned mask layer 117-3 on the planar waveguide layer 105, wherein the third patterned mask layer 117-3 in the cross-sectional drawings comprises patterned portions for the formation of a cavity 150 for the fiducial 114 and a cavity 164 having a T&G alignment feature 108. Patterned portions are also provided in third patterned mask layer 117-3 for the formation of cavities to be formed, in the embodiment, for cavity alignment aid 128 and FAU alignment aid 126. In embodiments, the third patterned mask layer 117-3 is protective of the waveguide core 106_{core} as shown in FIG. 15D1. Other patterned portions may be provided for other optional cavities, such as one or more cavity 146 having alignment pillars 122 for mounting one or more optoelectrical device 120.

Step 195-7 of method 195 is a patterning step in which the planar waveguide layer, and optionally all or a portion of the electrical interconnect layer and the coupler substrate of the coupler are patterned to form one or more cavity 150 for a fiducial 114 and one or more cavity 164 having a T&G alignment feature 108, and optionally one or more cavity for other lateral alignment aids, and optionally one or more cavity having one or more alignment pillars for aligning a device.

FIGS. 15E1-15E3 show cross-sectional schematic drawings of an embodiment of coupler 100, through Sections A-A′, B-B′ and C-C′, respectively of FIG. 11B after patterning of the planar waveguide layer 105 of the coupler 100 to form cavity 146, a cavity 150 having a fiducial 114, and a cavity 164 having a portion of T&G alignment feature 108 as shown in FIGS. 15E1, 15E2 and 15E3, respectively. Other cavities are also formed in the embodiment to facilitate formation of cavity alignment aids 128 and FAU alignment aids 126. In the embodiment shown, the planar waveguide layer 105 has been patterned. In other embodiments, all or a portion of the electrical interconnect layer 133_{cplr} underlying the planar waveguide layer 105 may also be patterned. An opening for the formation of a portion of an FAU mounting site 152 is also shown in FIG. 15E1. An additional step in the process comprising the forming of another patterned layer and the further patterning of the FAU mounting step may be required further form the FAU mounting site, shown in dashed lines in FIG. 15E1.

Step 195-8 of method 195 is a singulation step in which one or more coupler 100 are singulated from a coupler wafer.

FIGS. 15F1-15F3 show cross-sectional schematic drawings of an embodiment of coupler 100, through Sections A-A′, B-B′ and C-C′, respectively of FIG. 11B after singulation of the coupler 100 from a unsingulated coupler wafer 100_{wafer}. Fourth patterned layer 117-4, the outline of which is shown in dashed lines, may be used, for example, to form a pattern on the unsingulated coupler wafer 100_{wafer} having open areas to facilitate a deep etch process through all or a portion of the substrate 110_{cplr}. In some portions of the coupler 100, such as for alignment feature 108 shown in FIGS. 15F2 and 15F3, the first patterned mask layer 117-1 may become re-exposed during the example patterning step. Fourth patterned layer 117-4 may be removed after all or a portion of the singulation step.

The formation of T&G alignment features 108 and other alignment features of coupler 100 in self-alignment with waveguide cores 106_{core} formed on the coupler 100, facilitates lithographic level resolution in the relative positioning of devices mounted on, or coupled to the coupler 100 in the formation of coupler assemblies 102 comprising coupler 100 and one or more optical device mounted or otherwise formed on the coupler 100. Furthermore, the lithographic level resolution in the relative positioning of devices mounted on, or coupled to the coupler 100 may be extended to the relative positioning of devices formed on, mounted on, or otherwise coupled to an interposer 103 configured having the complementary alignment aids 109 to which alignment aids 108 of the coupler 100 may be coupled in the formation of PIC assemblies 101 comprising the coupler 100 and interposer 103.

Similarly, the formation of T&G alignment features 109 and other alignment features of interposer 103 in self-alignment with waveguide cores 107_{core} formed on the interposer 103, facilitates lithographic level resolution in the relative positioning of devices mounted on, or coupled to the interposer 103 in the formation of interposer assemblies 104 comprising interposer 103 and one or more optical device mounted or otherwise formed on the interposer 103. And furthermore, the lithographic level resolution in the relative positioning of devices mounted on, or coupled to the interposer 103 may be extended to the relative positioning of devices formed on, mounted on, or otherwise coupled to an coupler 100 configured having the complementary alignment aids 108 to which alignment aids 109 of the interposer 103 may be coupled in the formation of PIC assemblies 101 comprising the coupler 100 and interposer 103.

The extension of the lithographic resolution in the relative lateral positioning of optical devices mounted on, or otherwise coupled to, the coupler 100 or interposer 103 in the formation of PIC assemblies 101 is facilitated with the formation of the lateral alignment aids in self-alignment with the waveguide cores 106_{core}, 107_{core} of the coupler 100 and interposer 103, respectively.

### Details of MLAs and of Lenses Formed Using Two-Photon Polymerization

Some lenses used in embodiments of coupler assemblies 102 and interposer assemblies 104 may be configured as a multi-lens array 130_{MLA}. In other embodiments, lenses used in embodiments may be formed using two-photon polymerization. And in yet other embodiments, lens arrays may be formed using one or more ball lens. In this section, some details of lens arrays formed using MLAs and 2PP are provided.

In some embodiments of coupler assembly 102, multi-lens arrays are used to provide one or more MLA lens 138_{MLA} in cavity 146 of coupler 100. And in some embodiments of interposer assembly 104, MLAs are used to provide one or more lens in cavity 148 of the interposer 103.

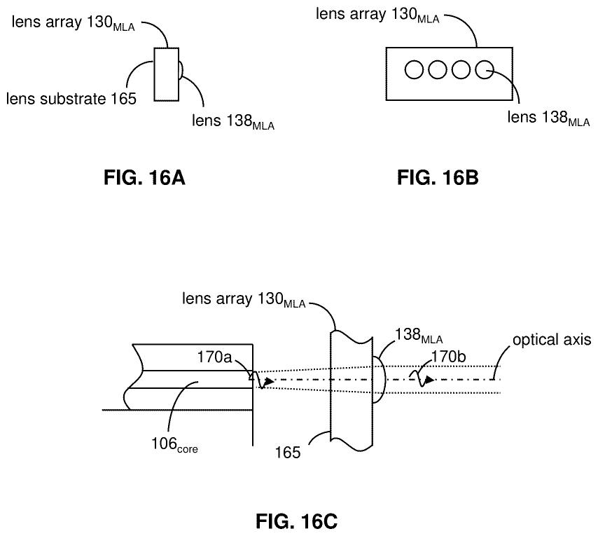

FIGS. 16A and 16B show schematic end view and side view drawings, respectively, of an example multi-lens array 130_{MLA} that may be used in embodiments. Multi-lens array 130_{MLA} is comprised of an array of MLA lenses 138_{MLA} formed on a lens substrate 165. In the example multi-lens array shown in FIGS. 16A and 16B, a single multi-lens array 130_{MLA} having four MLA lenses 138_{MLA} is shown formed in a linear arrangement. In other examples, multi-lens array 130_{MLA} may have less than four lenses 172. And in yet other examples of multi-lens arrays 130_{MLA} used in embodiments, the multi-lens arrays may be configured having more than four MLA lenses 138_{MLA}.

FIG. 16C shows a cross-section schematic drawing of an optical signal envelope emerging from a waveguide core 106_{core} and propagating through a multi-lens array substrate 165 and a half convex MLA lens 138_{MLA} formed on the multi-lens array substrate 165. The dotted lines show an example spot size or envelope for the optical signal 170a emerging from a terminal facet of the waveguide core 106_{core}. Upon emergence from the waveguide core 106_{core} in the example, some divergence of the optical signal 170a is anticipated as shown. As the optical signal propagates through MLA lens 138_{MLA} and the substantially or fully transparent substrate 165, the spot size of the optical signal 170b may be collimated or reduced in size. The optical signal envelope in FIG. 16C shows an example of a collimated optical envelope upon passing through the MLA lens 138_{MLA}. MLA lens 138_{MLA} positioned in the path of the diverging optical signal may enable the optical signal to be collimated or focused for improved coupling to terminal facets of waveguides, the terminal facets of optical fiber cores, and to optical features of other devices positioned to be receptive to the optical signal emerging from the MLA lens 138_{MLA}.

In some other embodiments of coupler assembly 102, lens arrays formed using two-photon polymerization may be used to provide one or more lens in cavity 146 of coupler 100. In some embodiments having lens arrays formed using two-photon polymerization, on-facet lenses 138_{F2PP} of on-facet lens arrays 130_{F2PP} may be formed on terminal facets of waveguide cores 106_{core} that are intersected by a wall of cavity 146. In other embodiments having lens arrays formed using two-photon polymerization, in-structure lenses 138_{S2PP} of lens array structures 130_{S2PP} may be formed as all or a portion of a lens array structure 130_{S2PP} formed using two-photon polymerization in the cavity 146 of the coupler 100.

Similarly with regard to the formation of interposer assemblies 104, in some embodiments of interposer assembly 104, lens arrays formed using two-photon polymerization may be used to provide one or more lens in cavity 148 of interposer 103. In some embodiments having lens arrays formed using two-photon polymerization, on-facet lenses 138_{F2PP} of on-facet lens arrays 130_{F2PP} may be formed on terminal facets of waveguide cores 107_{core} that are intersected by a wall of cavity 148. In other embodiments having lens arrays formed using two-photon polymerization, in-structure lenses 138_{S2PP} may be formed as all or a portion of a lens array structure 130_{S2PP} formed using two-photon polymerization in the cavity 148 of the interposer 103.

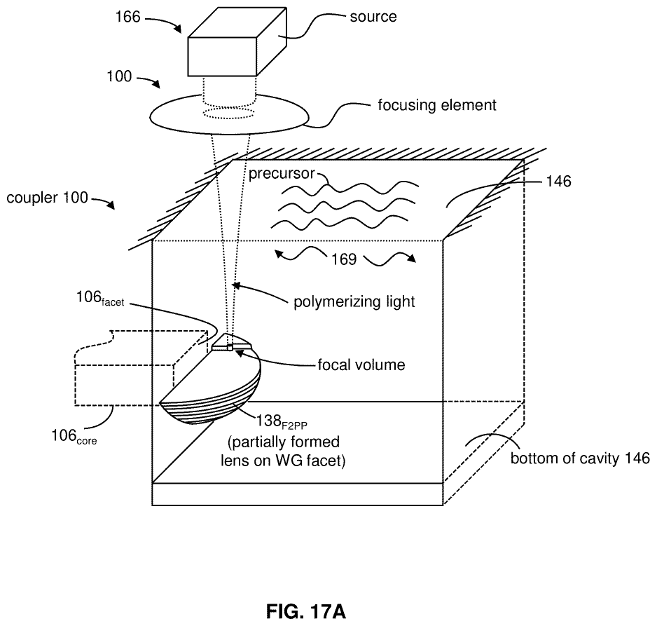

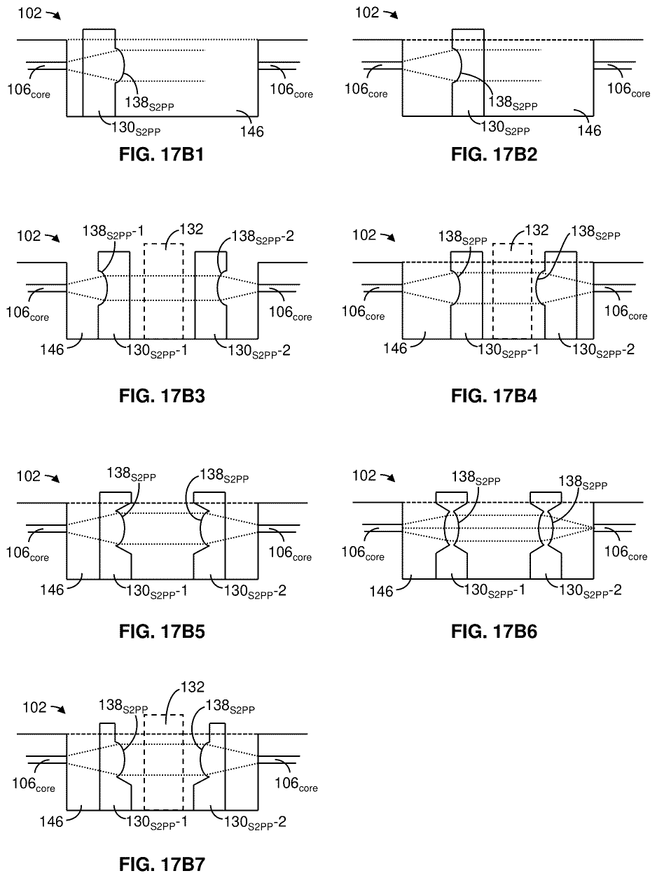

FIG. 17A shows a schematic perspective drawing of an example two-photon polymerization apparatus 166 forming an on-facet lens 138_{F2PP} on a terminal facet 106_{facet} of a waveguide core 106_{core} in an example cavity 146. Cavity 146 in coupler 100 of FIG. 17A is shown filled with two-photon polymerization precursor 169. The two-photon polymerization precursor 169 may be in a liquid form, for example, dispensed into cavity 146 using automated dispensing apparatus. In some embodiments, a solid or semi-solid form of two-photon polymerization precursor 169 may be used. Other means for providing two-photon polymerization precursor 169 may also be used. In the schematic perspective drawing of the example two-photon polymerization apparatus 166 shown in the illustration, the apparatus 166 comprises a source, a focusing element, and an electromagnetic beam incident on the two-photon polymerization precursor 169 in cavity 146. The incident beams of the two-photon polymerization apparatus 166 are focused using the focusing element to form a focal volume within the two-photon polymerization precursor 169. The focal volume provides a concentrated energy density sufficient to polymerize the precursor material to form polymerized precursor material. The polymerized precursor material is used to form all or a portion of the on-facet lens 138_{F2PP} by rastering of the focal volume within the polymer precursor 169. In embodiments, the rastering may be automated using automated two-photon polymerization apparatus. As the focal volume is rastered through the precursor, polymerized layers of the precursor are formed such as the on-facet lens 138_{F2PP} shown partially formed in FIG. 17A.

A key advantage of two-photon polymerization lies in its ability to achieve high spatial resolution. The nonlinear nature of two-photon absorption confines the polymerization reaction to a significantly smaller volume compared to single-photon processes, enabling the fabrication of features with sub-micrometer dimensions. The use of two-photon polymerization enables the capability to fabricate complex three-dimensional structures in a single exposure, eliminating the need for multiple processing steps often required in other microfabrication techniques.

The two-photon polymerization process typically employs a pulsed laser operating in the near-infrared spectrum, as the low photon energy minimizes linear absorption while maximizing the probability of two-photon absorption within the tightly confined focal volume. A photosensitive resin, herein referred to as two-photon polymerization precursor, comprising molecules that undergo a chemical transformation upon light exposure, is employed as the fabrication medium. As the laser beam is precisely scanned through the resin or precursor, two-photon absorption occurs exclusively at the focal point, initiating polymerization and forming a solid three-dimensional structure. By meticulously controlling the trajectory of the laser beam in three dimensions, intricate three-dimensional shapes can be generated with sub-micrometer resolution. In some embodiments, the resolution of the polymerization structures may be less than one micrometer. In some embodiments, the resolution of the polymerization may be in the range of 0.1 to 1 micrometer. And in some embodiments, the resolution may be less than 0.1 micrometer resolution.

Formation of on-facet lens 138_{F2PP}, using two-photon polymerization apparatus 166 as shown in the illustration in FIG. 17A, enables the formation of on-facet lenses 138_{F2PP} formed on the terminal facets 106_{facet} of waveguides intersected by the wall of cavity 146. Two-photon polymerization apparatus 166 may also be used in the formation of lens array structures 130_{S2PP} that include one or more in-structure lenses 138_{S2PP} in cavity 146 as described herein.

FIGS. 17B1-17B7 show cross-section schematic drawings of examples of lens array structures 130_{S2PP} that may be formed in cavity 146 using 2PP or other 3D printing method.

FIG. 17B1 shows a single lens array structure 130_{S2PP} configured having an in-structure lens 138_{S2PP} that protrudes from a main body of the lens array structure 130_{S2PP}. One or more in-structure lens 138_{S2PP} may be formed in the lens array structure 130_{S2PP} in alignment with the waveguide cores 106 core on either side of the cavity 146 in the embodiment. In embodiments of the coupler assembly 102 configured to enable free-space coupling of the optical signals from, for example, interposer assembly 104, the waveguide cores 106core may not be present as described in embodiments herein. In the example shown, the dotted lines shown an example diverging optical signal from waveguide core 106core incident on an in-structure lens 138_{S2PP} configured as a collimating lens. In another embodiment of the assembly having, for example, two lens array structures, a second lens array structure may be configured, for example, as a focusing lens to capture the collimated optical signal from the in-structure lens 138_{S2PP} of the lens array structure 130_{S2PP} shown and focus the optical signal to the terminal facet of the waveguide core 106core on the outgoing sidewall of the cavity 146 in the embodiment shown.

FIG. 17B2 shows a single lens array structure 130_{S2PP} configured having in-structure lens 138_{S2PP} formed from a recess in the main body of the lens array structure 130_{S2PP}. One or more in-structure lens 138_{S2PP} may be formed in the lens array structure 130_{S2PP} in alignment with the waveguide cores 106core on either side of the cavity 146 in the embodiment. In embodiments of the coupler assembly 102 configured to enable free-space coupling of the optical signals from, for example, interposer assembly 104, the waveguide cores 106core may not be present as described in embodiments herein. The collimating lenses 138_{S2PP} of the lens array structure 130_{S2PP} may be used in combination in some embodiments, with a focusing lens.

FIG. 17B3 shows cavity 146 of coupler assembly 102 configured having a first and second lens array structure 130_{S2PP}-1, 130_{S2PP}-2, respectively, wherein the in-structure lens 138_{S2PP} of the first lens array structure 130_{S2PP}-1 is configured as a collimating lens and the in-structure lens 138_{S2PP} of the second lens array structure 130_{S2PP}-2 is configured as a focusing lens. In the embodiment, recesses are formed in the main body of the first lens array structure 130_{S2PP}-1 configured as a collimating lens and in the main body of the second lens array structure 130_{S2PP}-2 configured as a focusing lens. Optical isolator 132 mounted or otherwise formed between the first and second lens array structures is shown in dashed lines in FIG. 17B3.

FIG. 17B4 shows cavity 146 of coupler assembly 104 configured having a first lens array structure 130_{S2PP}-1 configured as in FIG. 17B3 and a second lens array structure 130_{S2PP}-2 configured having in-structure lens 138_{S2PP} protruding from the main body of the lens array structure 130_{S2PP}-2.

FIG. 17B5 shows cavity 146 of coupler assembly 104 configured having a first lens array structure 130_{S2PP}-1 configured having recessed protruding lenses and a second lens array structure 130_{S2PP}-2 configured having in-structure lens 138_{S2PP} that are also recessed within the main body support structure of the lens array structure 130_{S2PP}-1 but that are protruding from within the recess within the main body of the lens array structure 130_{S2PP}-2.

FIG. 17B6 shows cavity 146 of coupler assembly 104 configured having first and second lens array structures 130_{S2PP}-1, 130_{S2PP}-2, respectively configured having convex lenses formed in the lens array structures. In the embodiment, the in-structure lens 138_{S2PP} of the first lens array structure may be configured, for example, as a collimating lens for the diverging signal source emerging from the waveguide core 106core and the in-structure lens 138_{S2PP} of the second lens array structure 130_{S2PP}-2 may be configured, for example, as a focusing lens receptive to the collimated optical signal from the first lens array structure 130_{S2PP}-1 in the embodiment.

FIG. 17B7 shows a variation of the main body of the first and second lens array structures 130_{S2PP}-1,130_{S2PP}-2 for the embodiment shown in FIG. 17B5.

In embodiments, the “main body” of the lens array structure, as used herein, refers to the 2PP or 3D printed support structure upon which, or within which, the in-structure lenses 138_{S2PP} are formed.

In the cross-section drawings of the embodiments shown in FIGS. 17B1-17B7, a single in-structure lens 138_{S2PP} is depicted in each of the lens array structures 130_{S2PP} shown. In these and other embodiments, one or more in-structure lenses 138_{S2PP} may be formed in the lens array structures 130_{S2PP}.

### Embodiments of Coupler Assemblies Configured Having Two Lens Arrays in a Coupler Cavity

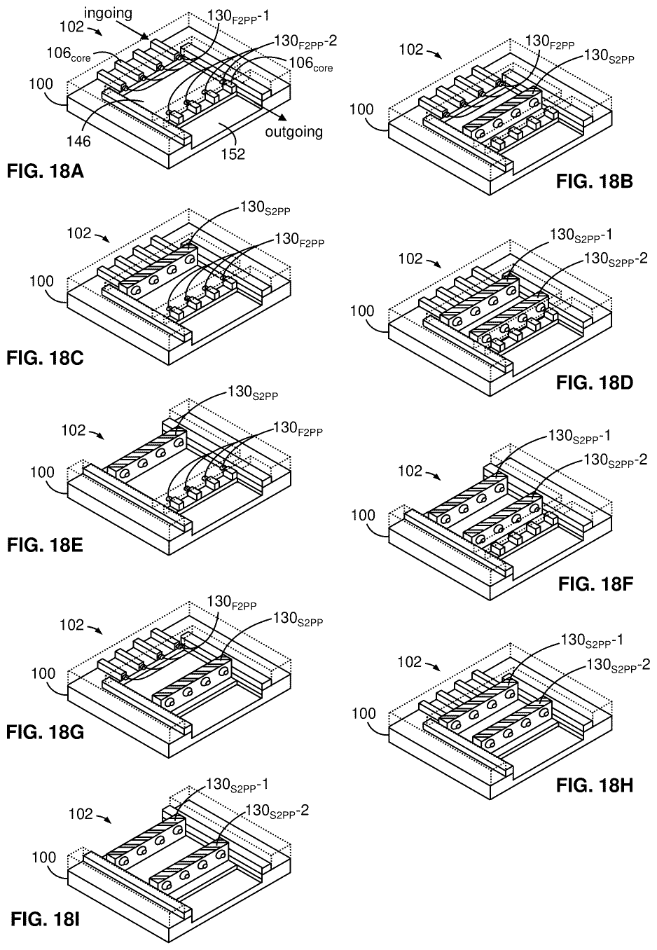

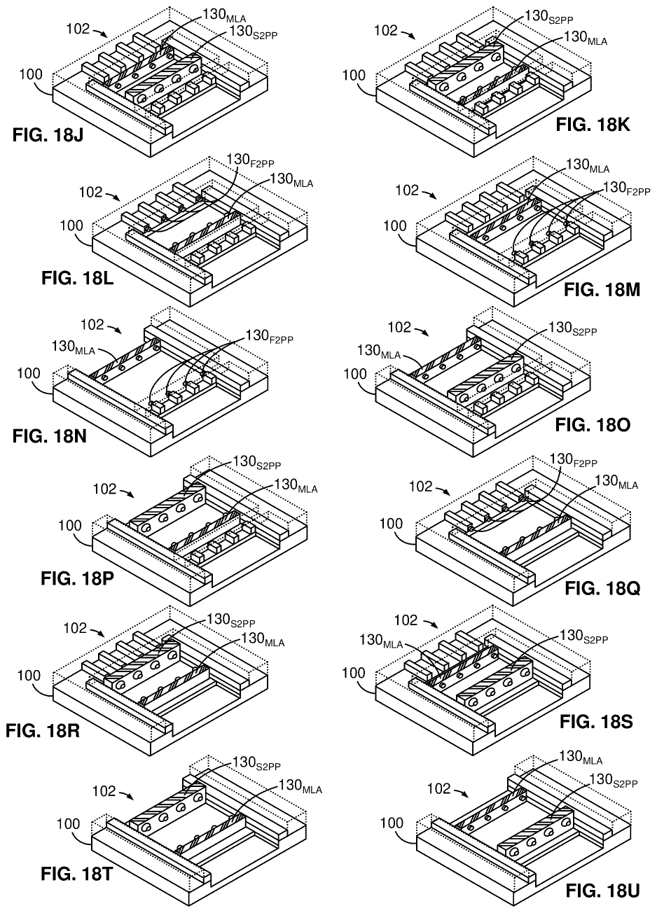

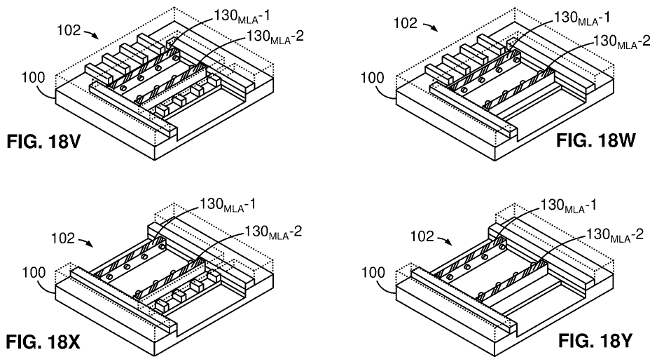

FIGS. 18A-18Y show embodiments of coupler assembly 102 comprising coupler 100 and two lens arrays wherein the lens arrays are one or more of a multi-lens array 130_{MLA} having four MLA lenses 138_{MLA}, on-facet lens array 130_{F2PP} of on-facet lenses 138_{F2PP} formed using two-photon polymerization on the terminal facets 106_{facet} of waveguides 106 intercepted by a wall of cavity 146, and a lens array structure 130_{S2PP} having in-structure lenses 138_{S2PP} formed using two-photon polymerization in cavity 146.

In the embodiments shown in FIGS. 18A-18Y, the top cladding 106_{Tclad} is shown as a transparent layer with dotted line periphery to provide greater clarity of the key features in the waveguides 106, waveguide cores 106_{core}, cavity 146, and other features as noted of the embodiments. In the embodiments shown in FIG. 18A, and in other embodiments configured having waveguides of the embodiments shown in FIGS. 18A-18Y, four waveguide cores 106_{core} are shown. In other embodiments not having waveguides cores 106_{core} formed on the coupler, the embodiments are configured having four optical pathways through the one or more lens arrays 130 to enable coupling of optical signals to an FAU 156 configured having four optical fibers 154.

FIG. 18A shows an embodiment of coupler 100 configured having two on-facet lens arrays 130_{F2PP}-1,130_{F2PP}-2 formed on the terminal facets 106_{facet} of waveguides 106. The terminal facets 106_{facet} are formed by the intersection of a wall of cavity 146 with the waveguides 106. On-facet lenses 138_{F2PP} are formed in the embodiment as described, for example, in the description of FIG. 17A herein. In embodiments, the optical axes of on-facet lenses 138_{F2PP} are formed in alignment with, or substantially in alignment with, the optical axes of the waveguide cores 106_{core} of the waveguides 106. In the embodiment of FIG. 18A, waveguides 106 having waveguide core 106_{core} are shown on two sides of the cavity 146. In some embodiments, such as the embodiment shown in FIG. 2A, waveguide cores 106_{core} are intersected by cavity 146 to form waveguide facets on two walls of cavity 146 as shown. In other embodiments, waveguide facets 106_{facet} may be formed on only one wall of the cavity 146. And in yet other embodiments, no waveguides cores may be intersected by a wall of the cavity 146 to facilitate free-space coupling of optical signals to lenses 138 mounted or otherwise formed in cavity 146 on the coupler 100. In embodiments configured to enable free-space coupling of optical signals through all or a portion of the cavity 146, waveguide cores 106_{core} may not be provided on the coupler 100 or may be limited to one side of the cavity 146 as further described in embodiments.

In embodiments disclosed herein and having labeled components such as 130_{F2PP}-1, the “−1” portion of the label refers to a first instance of the preceding portion of the label. An on-facet lens array 130_{F2PP}-1, for example, is a first on-facet lens array 130_{F2PP}. An on-facet lens array 130_{F2PP}-2, for example, is a second on-facet lens array 130_{F2PP}. This labeling scheme, in which a number follows a hyphen at the end of a component label in a drawing, is used herein to identify and distinguish between multiple instances of a component in a same drawing and embodiment.

The embodiments of coupler assembly 102 in FIGS. 18A-18Y are tabularized in Table 1. The column of Table 1, labeled “#”, shows an identification number for the embodiment. The column of Table 1, labeled “FIG. #”, shows the number of the FIG. containing a perspective drawing of the embodiment. The column of Table 1, under the header “WG or Open” and labeled “ingoing structure” shows the configuration of the ingoing portion of coupler 100 wherein the configuration listed under the “ingoing structure” column in Table 1, and shown in the corresponding embodiments of FIGS. 18A-18Y, is either “WG” or “Open”. In embodiments listed as “WG” in Table 1, the embodiments are configured having a waveguide intersected by the wall of cavity 146 on the ingoing side of the coupler 100. The ingoing side of coupler 100 is labeled in FIG. 18A. The ingoing side of the cavity 146, as used herein, refers to the side of an embodiment of coupler 100 that receives optical signals from an interposer 103, for example, coupled to coupler 100 as described in embodiments herein.

In embodiments listed as “Open” in the “ingoing structure” column of Table 1, the embodiments are configured having an open side of cavity 146 to enable free-space coupling of optical signals from a device to which the coupler 100 may be coupled and the lenses of a lens array or optical isolator 132 mounted or otherwise formed in the cavity 146. The ingoing side of coupler 100 is labeled in FIG. 18A. The ingoing side of the cavity 146, as used herein, refers to the side of an embodiment of coupler 100 that receives optical signals from an interposer 103, for example, coupled to coupler 100 as described in embodiments herein.

The column of Table 1, under the header “WG or Open” and labeled “outgoing structure” shows the configuration of the outgoing portion of coupler 100 as labeled in FIG. 18A, wherein the configuration listed under the “outgoing structure” column in Table 1, and shown in the corresponding embodiments of FIGS. 18A-18Y, is either “WG” or “Open”. In embodiments listed as “WG” in the “outgoing structure” column of Table 1, the embodiments are configured having a waveguide intersected by the wall of cavity 146 on the outgoing side of the coupler 100. The outgoing side of the cavity 146, as used herein, refers to the side of an embodiment of coupler 100 that faces the FAU mounting site 152. That is, the outgoing side of the cavity 146 refers to the side of the embodiment of coupler 100 from which optical signals exiting the cavity 146, after propagating through the one or more lens array 130 and optical isolator 132, are coupled to the terminal facets of waveguides 106 in embodiments configured having waveguides 106 between a wall of cavity 146 and the FAU mounting site 152 on coupler 100. The outgoing side of the coupler 100 is labeled in FIG. 18A.

In embodiments listed as “Open” in the “outgoing structure” column of Table 1, the embodiments are configured having an open side of cavity 146 to enable free-space coupling of optical signals from a lens array 138 mounted or otherwise formed in cavity 146 to the terminal facets of the cores of optical fibers 154 mounted in an FAU 156 in FAU mounting site 152 on coupler 100. The outgoing side of coupler 100 is labeled in FIG. 18A. The outgoing side of the cavity 146, as used herein, refers to the side of an embodiment of coupler 100 from which optical signals exiting the cavity 146 are coupled to the terminal facets of optical fibers 154 mounted in FAU 156 on coupler 100 as described in embodiments herein.

The column of Table 1, under the header “Lens Structure” and labeled “ingoing lenses” shows the configuration of the lens array formed on ingoing portion of coupler 100 wherein the embodiment listed under the “ingoing lenses” column in Table 1, and shown in the corresponding drawings in FIGS. 18A-18Y, is configured as either “2PP on facet”, “2PP structure”, or “MLA”.

In embodiments listed as “2PP on facet” in the “ingoing lenses” column of Table 1, the embodiments are configured having on-facet lenses 138_{F2PP} of an on-facet lens array 130_{F2PP} on waveguide facets formed by the intersection of the waveguides and the wall of cavity 146 on the ingoing side of the coupler 100. On-facet lenses 138_{F2PP} are formed using two-photon polymerization on the all or a portion of the waveguide facets intersected by the wall of cavity 146. The ingoing side of coupler 100 is labeled in FIG. 18A. The ingoing side of the cavity 146, as used herein, refers to the side of an embodiment of coupler 100 that receives optical signals from an interposer 103, for example, coupled to coupler 100 as described in embodiments herein.

In embodiments listed as “2PP structure” in the “ingoing lenses” column of Table 1, the embodiments are configured having in-structure lenses 138_{S2PP} of a lens array structure 130_{S2PP} formed using two-photon polymerization in cavity 146 on the ingoing side of the coupler 100. The ingoing side of coupler 100 is labeled in FIG. 18A. The ingoing side of the cavity 146, as used herein, refers to the side of an embodiment of coupler 100 that receives optical signals from an interposer 103, for example, coupled to coupler 100 as described in embodiments herein.

In embodiments listed as “MLA” in the “ingoing lenses” column of Table 1, the embodiments are configured having MLA lenses 138_{MLA} of a multi-lens array 130_{MLA} mounted or otherwise formed in cavity 146 on the ingoing side of the coupler 100.

The column of Table 1, under the header “Lens Structure” and labeled “outgoing lenses” shows the configuration of the lens array formed on outgoing portion of coupler 100 wherein the embodiment listed under the “outgoing lenses” column in Table 1, and shown in the corresponding drawings in FIGS. 18A-18Y, is configured as either “2PP on facet”, “2PP structure”, or “MLA”.

In embodiments listed as “2PP on facet” in the “outgoing lenses” column of Table 1, the embodiments are configured having on-facet lenses 138_{F2PP} of an on-facet lens array 130_{F2PP} on waveguide facets formed by the intersection of the waveguides by the wall of cavity 146 on the outgoing side of the coupler 100. On-facet lenses 138_{F2PP} are formed using two-photon polymerization on the all or a portion of the waveguide facets intersected by the wall of cavity 146. The outgoing side of coupler 100 is labeled in FIG. 18A. The outgoing side of the cavity 146, as used herein, refers to the side of an embodiment of coupler 100 from which optical signals are coupled from the cavity 146 to the terminal facets of the cores of optical fibers 154 mounted in an FAU 156 on FAU mounting site 152 on coupler 100.

In embodiments listed as “2PP structure” in the “outgoing lenses” column of Table 1, the embodiments are configured having in-structure lenses 138_{S2PP} of a lens array structure 130_{S2PP} formed using two-photon polymerization in cavity 146 on the outgoing side of the coupler 100 as labeled in FIG. 18A. The outgoing side of the cavity 146, as used herein, refers to the side of an embodiment of coupler 100 from which optical signals are coupled from the cavity 146 to the terminal facets of the cores of optical fibers 154 mounted in the FAU 156 on coupler 100 as shown in embodiments herein.

In embodiments listed as “MLA” in the “outgoing lenses” column of Table 1, the embodiments are configured having MLA lenses 138_{MLA} of a multi-lens array 130_{MLA} mounted or otherwise formed in cavity 146 on the outgoing side of the coupler 100.

TABLE 1
Configurations of ingoing cavity structure and lens, and of outgoing
cavity structure and lens for embodiments having two lens arrays.

| | | WG or Open | | Lens Structure | |
|---|---|---|---|---|---|
| | | ingoing | outgoing | ingoing | outgoing |
| # | FIG.# | structure | structure | lenses | lenses |
| 1 | 18A | WG | WG | 2PP on facet | 2PP on facet |
| 2 | 18B | WG | WG | 2PP on facet | 2PP structure |
| 3 | 18C | WG | WG | 2PP structure | 2PP on facet |
| 4 | 18D | WG | WG | 2PP structure | 2PP structure |
| 5 | 18E | open | WG | 2PP structure | 2PP on facet |
| 6 | 18F | open | WG | 2PP structure | 2PP structure |
| 7 | 18G | WG | open | 2PP on facet | 2PP structure |
| 8 | 18H | WG | open | 2PP structure | 2PP structure |
| 9 | 18I | open | open | 2PP structure | 2PP structure |
| 10 | 18J | WG | WG | MLA | 2PP structure |
| 11 | 18K | WG | WG | 2PP structure | MLA |
| 12 | 18L | WG | WG | 2PP on facet | MLA |
| 13 | 18M | WG | WG | MLA | 2PP on facet |
| 14 | 18N | open | WG | MLA | 2PP on facet |
| 15 | 18O | open | WG | MLA | 2PP structure |
| 16 | 18P | open | WG | 2PP structure | MLA |
| 17 | 18Q | WG | open | 2PP on facet | MLA |
| 18 | 18R | WG | open | 2PP structure | MLA |
| 19 | 18S | WG | open | MLA | 2PP structure |
| 20 | 18T | open | open | 2PP structure | MLA |
| 21 | 18U | open | open | MLA | 2PP structure |
| 22 | 18V | WG | WG | MLA | MLA |
| 23 | 18W | open | WG | MLA | MLA |
| 24 | 18X | WG | open | MLA | MLA |
| 25 | 18Y | open | open | MLA | MLA |

As listed in Table 1, FIGS. 18B-18Y provides the configurations of the coupler assembly 102 having (1) either a waveguide (WG) on the ingoing portion of the coupler 100 or an opening in the ingoing wall of cavity 146 to enable free-space coupling of optical signals to the lenses of a lens array mounted or otherwise formed in cavity 146; (2) having one or more of an on-facet lens array 130_{F2PP} formed using two-photon polymerization on waveguide facets intersected by the wall of cavity 146 on the ingoing side, a lens array structure 130_{S2PP} formed using two-photon polymerization in cavity 146, and a multi-lens array 130_{MLA} mounted or otherwise formed in cavity 146; and (3) having either a waveguide on the outgoing portion of the coupler 100 or an opening on the outgoing wall of cavity 146 of the coupler 100 to enable free-space coupling of optical signals from the lenses of the lens array mounted or otherwise formed in cavity 146 to the terminal facets of the cores of optical fibers 154 mounted or otherwise formed in an FAU 156 on the coupler 100.

As in the embodiment shown in FIG. 18A, the embodiments shown in FIGS. 18B-18D, 18J-18M, and 18V show embodiments configured having waveguides 106 at the ingoing portions and outgoing portions of the coupler 100. The waveguide cores 106_{core} are shown in the figures on both the ingoing portions and outgoing portions of coupler 100. The embodiments of couplers 100 shown in FIGS. 18A, 18B, and 18L are configured having on-facet lenses 138_{F2PP} of on-facet lens array 130_{F2PP} formed on the waveguide facets on the ingoing wall of cavity 146. For the embodiments shown in FIGS. 18C, 18D, and 18K, coupler assemblies 102 are configured having in-structure lenses 138_{S2PP} of lens array structure 130_{S2PP} coupled to the waveguides 106 in the ingoing wall of cavity 146 in the embodiments. For the embodiments shown in FIGS. 18J, 18M, and 18V, coupler assemblies 102 are configured having MLA lenses 138_{MLA} of multi-lens array 130_{MLA} coupled to the waveguides 106 of the ingoing wall of cavity 146 in the embodiments. On the outgoing side of the cavity 146 for coupler assemblies 102 configured having ingoing and outgoing waveguides 106, the embodiments in FIGS. 18A, 18C, and 18M are configured having on-facet lenses 138_{F2PP} of on-facet lens array 130_{F2PP} formed on the waveguide facets on the outgoing wall of cavity 146. For the embodiments shown in FIGS. 18B, 18D, and 18J, coupler assemblies 102 are configured having in-structure lenses 138_{S2PP} of lens array structure 130_{S2PP} coupled to the waveguides 106 in the outgoing wall of cavity 146 in the embodiments. And for the embodiments shown in FIGS. 18K, 18L, and 18V, coupler assemblies 102 are configured having MLA lenses 138_{MLA} of multi-lens array 130_{MLA} coupled to the waveguides 106 of the outgoing wall of cavity 146 in the embodiments.

Embodiments for which the cavity 146 of coupler 100 is configured to enable free-space coupling of optical signals to lenses 138 mounted or otherwise formed in cavity 146 are shown in FIGS. 18E, 18F, 18I, 18N, 18O, 18P, 18T, 18U, 18W, and 18Y. In these embodiments configured having an opening in one or more wall of cavity 146 to enable free-space coupling of optical signals on the ingoing side of the coupler, lens array configurations on the ingoing side of the cavity, listed in the table, are limited to either multi-lens arrays 130_{MLA} or lens array structures 130_{S2PP} formed using two-photon polymerization. The lack of waveguides 106 and the lack of terminal facets of waveguides at the ingoing portion of the wall of cavity 146 in these embodiments eliminates the option to form on-facet lenses 138_{F2PP} on the waveguide facets in these embodiments. Of the embodiments configured having an opening in the ingoing portion of cavity 146, the embodiments of FIGS. 18E, 18F, 18I, 18P, and 18T are further configured having a lens array structure 130_{S2PP} formed from two-photon polymerization and the embodiments of FIGS. 18N, 18O, 18U, 18W, and 18Y are further configured having multi-lens arrays 130_{MLA} to which optical signals may be free-space coupled.

Of the embodiments of the coupler 100 configured having an ingoing opening in cavity 146, the embodiments shown in FIGS. 18E and 18N are further configured having waveguides 106 formed at the outgoing portion of cavity 146. In the embodiments shown in FIGS. 18E and 18N, coupler assemblies 102 are configured having on-facet lenses 138_{F2PP} of on-facet lens array 130_{F2PP} formed on the waveguide facets on the outgoing wall of cavity 146. For the embodiments shown in FIGS. 18F and 18O, coupler assemblies 102 are configured having in-structure lenses 138_{S2PP} of lens array structure 130_{S2PP} coupled to the waveguides 106 in the outgoing wall of cavity 146 in the embodiments. For the embodiments shown in FIGS. 18P and 18W, coupler assemblies 102 are configured having MLA lenses 138_{MLA} of multi-lens array 130_{MLA} coupled to the waveguides 106 of the outgoing wall of cavity 146 in the embodiments.

Of the embodiments of the coupler 100 configured having an ingoing opening in cavity 146, the embodiments shown in FIGS. 18I, 18T, 18U, and 18Y are further configured having outgoing openings in cavity 146 that enable free-space coupling of optical signals from lenses 138 mounted or otherwise formed in cavity 146 to the terminal facets of the cores of optical fibers 154 mounted or otherwise formed in an FAU 156 in the FAU mounting site 152 on the coupler 100. In these embodiments configured having an opening to enable free-space coupling of optical signals on the outgoing side of the coupler 100, lens array configurations on the outgoing side of the cavity, listed in the table, are limited to either multi-lens arrays 130_{MLA} or lens array structures 130_{S2PP} formed using two-photon polymerization. The lack of waveguides 106 and the lack of terminal facets of waveguides at the outgoing portion of cavity 146 in these embodiments eliminates the option to form on-facet lenses 138_{F2PP} on waveguide facets in these embodiments.

Of the embodiments configured having an opening in the ingoing portion of cavity 146 and having an opening in the outgoing portion of cavity 146, the embodiments of FIGS. 18I and 18U are further configured having a lens array structure 130_{S2PP} formed using two-photon polymerization from which optical signals may be free-space coupled to the terminal facets of the cores of optical fibers 154 mounted or otherwise formed in an FAU 156 in the FAU mounting site 152 on the coupler 100, and the embodiments of FIGS. 18T and 18Y are further configured having multi-lens arrays 130_{MLA} from which optical signals may be free-space coupled to the terminal facets of the cores of optical fibers 154 mounted or otherwise formed in an FAU 156 in the FAU mounting site 152 on the coupler 100.

The embodiments of coupler assemblies 102 shown in FIGS. 18G, 18H, 18Q, 18R, 18S, and 18X are configured having waveguides 106 at the ingoing portions of the cavity 146, and are further configured having an outgoing opening in cavity 146. In these embodiments configured having an opening to enable free-space coupling of optical signals on the outgoing side of the coupler 100, lens array configurations on the outgoing side of the cavity, listed in the table, are also limited to either multi-lens arrays 130_{MLA} or lens array structures 130_{S2PP} formed using two-photon polymerization. The lack of waveguides 106 and the lack of terminal facets of waveguides at the outgoing portion of cavity 146 in these embodiments eliminates the option to form on-facet lenses 138_{F2PP} on the waveguide facets in these embodiments.

Of the embodiments configured having waveguides formed at the ingoing portion of coupler 100 to cavity 146 and having an opening in the outgoing portion of cavity 146, the embodiments of FIGS. 18G, 18H, and 18S are further configured having a lens array structure 130_{S2PP} formed from two-photon polymerization from which optical signals may be free-space coupled to the terminal facets of the cores of optical fibers 154 mounted or otherwise formed in an FAU 156 in the FAU mounting site 152 on the coupler 100, and the embodiments of FIGS. 18Q, 18R, and 18X are further configured having multi-lens arrays 130_{MLA} from which optical signals may be free-space coupled to the terminal facets of the cores of optical fibers 154 mounted or otherwise formed in an FAU 156 in the FAU mounting site 152 on the coupler 100.

In summary, the embodiments of coupler assembly 102 listed in Table 1 and shown in the perspective schematic drawings in FIGS. 18A-18Y show the ingoing portions of coupler 100 configured having waveguides 106 in some embodiments, and show ingoing portions of coupler 100 configured to enable free-space coupling of optical signals through an open-sided cavity 146 to a first lens array mounted or otherwise formed in cavity 146, wherein the first lens array in cavity 146 is configured as either a multi-lens array 130_{MLA}, a lens array structure 130_{S2PP} formed using two-photon polymerization, or an on-facet lens array 130_{F2PP} formed from two-photon polymerization on the terminal facets of waveguides 106 intersected by the wall of cavity 146 on the ingoing side of the cavity 146.

Embodiments of coupler assemblies 102 comprise two lens array structures configured in cavity 146 as a first lens array to facilitate coupling of optical signals from an ingoing portion of coupler 100 and a second lens array to facilitate coupling of optical signals to an outgoing portion of coupler 100. The first lens array enables either coupling of optical signals from one or more waveguides 106 in embodiments configured having waveguides 106 in the ingoing portion of the coupler 100, or the free-space coupling of optical signals from, for example, an emitting device mounted or otherwise formed on an interposer assembly 104 coupled to the coupler assembly 102. And the second lens array enables either coupling of optical signals to one or more waveguides in the outgoing portion of coupler 100, or the free-space coupling of optical signals to the terminal facets of the cores of optical fibers 154 mounted or otherwise formed in an FAU 156 in the FAU mounting site 152 on the coupler 100.

In further summary, the embodiments of coupler assembly 102 listed in Table 1 and shown in the perspective schematic drawings in FIGS. 18A-18Y show the outgoing portions of coupler 100 configured having waveguides 106 in some embodiments, and show outgoing portions of coupler 100 configured to enable free-space coupling of optical signals through an open-sided cavity 146 to the terminal facets of the cores of optical fibers 154 mounted or otherwise formed in an FAU 156 in the FAU mounting site 152 on the coupler 100, wherein the second lens array in cavity 146 is configured as either a multi-lens array 130_{MLA}, a lens array structure 130_{S2PP} formed using two-photon polymerization, or an on-facet lens array 130_{F2PP} formed from two-photon polymerization on the terminal facets of waveguides 106 intersected by the wall of cavity 146 on the outgoing side of the cavity 146.

### Embodiments of Coupler Assemblies Configured Having One Lens Array in a Coupler Cavity

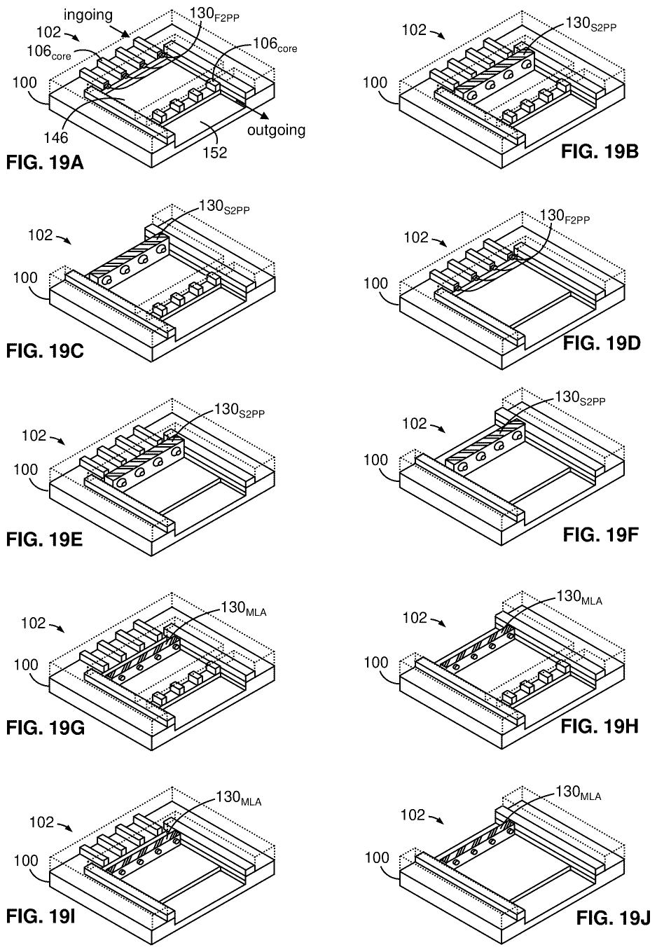

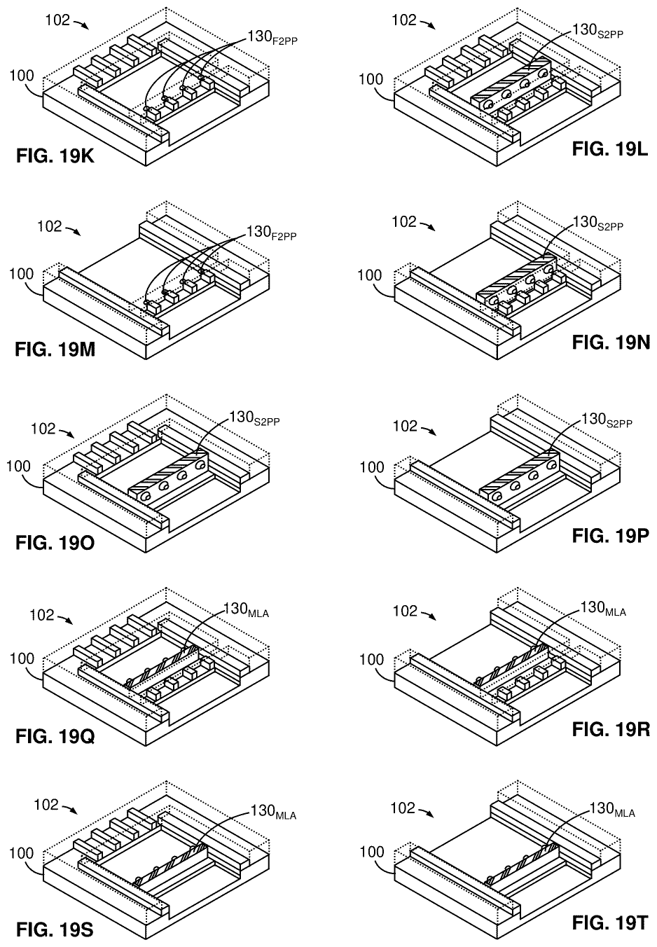

FIGS. 19A-19T show embodiments of coupler assembly 102 comprising coupler 100 and one lens array wherein the lens array is configured as a multi-lens array 130_{MLA} having MLA lenses 138_{MLA}, an on-facet lens array 130_{F2PP} of on-facet lenses 138_{F2PP} formed using two-photon polymerization on the terminal facets 106_{facet} of waveguides 106 intercepted by a wall of cavity 146, or a lens array structure 130_{S2PP} having in-structure lenses 138_{S2PP} formed using two-photon polymerization in cavity 146.

In the embodiments shown in FIGS. 19A-19T, the top cladding of the planar waveguide layer is shown as a transparent layer with dotted line periphery to provide greater clarity in the key features in the waveguides 106, waveguide cores 106_{core}, cavity 146, and other features as noted of the embodiments. In the embodiments shown in FIG. 19A, and in other embodiments configured having waveguides of the embodiments shown in FIGS. 19A-19T, four waveguide cores 106_{core} are shown. In other embodiments not having waveguides cores 106_{core} formed on the coupler, the embodiments are configured having four optical pathways through the one or more lens arrays 130 to enable coupling of optical signals to an FAU 156 configured having four optical fibers 154.

FIG. 19A shows an embodiment of coupler 100 configured having an on-facet lens array 130_{F2PP} formed on the terminal facets 106_{facet} of waveguides 106. The terminal facets 106_{facet} are formed by the intersection of a wall of cavity 146 with the waveguides 106. On-facet lenses 138_{F2PP} are formed in the embodiment as described, for example, in the description of FIG. 17A disclosed herein. In embodiments, the optical axes of on-facet lenses 138_{F2PP} are formed in alignment with, or substantially in alignment with, the optical axes of the waveguide cores 106_{core} of the waveguides 106. In the embodiment of FIG. 19A, waveguides 106 having waveguide core 106_{core} are shown on two sides of the cavity 146. In some embodiments, such as the embodiment shown in FIG. 19A, waveguide cores 106_{core} are intersected by cavity 146 to form waveguide facets on two walls of cavity 146 as shown. In other embodiments, waveguide facets 106_{facet} may be formed on only one wall of the cavity 146. And in yet other embodiments, no waveguides cores may be intersected by a wall of the cavity 146. In embodiments that do not have waveguide cores 106_{core} intersected by a wall of the cavity, coupler 100 may be configured, for example, to enable free-space coupling of optical signals to lenses mounted or otherwise formed in cavity 146. In embodiments configured to enable free-space coupling of optical signals through all or a portion of the cavity 146, waveguide cores 106_{core} may not be provided on the coupler 100 or may be limited to one side of the cavity 146 as further described in embodiments.

The embodiments of coupler assembly 102 in FIGS. 19A-19T are tabularized in Table 2. The column of Table 1, labeled “#”, shows an identification number for the embodiment. The column of Table 1, labeled “FIG. #”, shows the number of the figure containing a perspective drawing of the embodiment. The column of Table 2, under the header “WG or Open” and labeled “ingoing structure” shows the configuration of the ingoing portion of coupler 100 wherein the configuration listed under the “ingoing structure” column in Table 2, and shown in the corresponding embodiments of FIGS. 19A-19T, is either “WG” or “Open”. In embodiments listed as “WG” in Table 2, the embodiments are configured having a waveguide intersected by the wall of cavity 146 on the ingoing side of the coupler 100. The ingoing side of coupler 100 is labeled in FIG. 19A. The ingoing side of the cavity 146, as used herein, refers to the side of an embodiment of coupler 100 that receives optical signals from an interposer 103, for example, coupled to coupler 100 as described in embodiments herein.

In embodiments listed as “Open” in the “ingoing structure” column of Table 2, the embodiments are configured having an open side of cavity 146 to enable free-space coupling of optical signals from a device to which the coupler 100 may be coupled and the lenses of a lens array or optical isolator 132 mounted or otherwise formed in the cavity 146. The ingoing side of coupler 100 is labeled in FIG. 19A. The ingoing side of the cavity 146, as used herein, refers to the side of an embodiment of coupler 100 that receives optical signals from an interposer 103 coupled to coupler 100, for example, as described in embodiments herein.

The column of Table 2, under the header “WG or Open” and labeled “outgoing structure” shows the configuration of the outgoing portion of coupler 100 as labeled in FIG. 19A, wherein the configuration listed under the “outgoing structure” column in Table 2, and shown in the corresponding embodiments of FIGS. 19A-19T, is either “WG” or “Open”. In embodiments listed as “WG” in the “outgoing structure” column of Table 2, the embodiments are configured having a waveguide intersected by the wall of cavity 146 on the outgoing side of the coupler 100. The outgoing side of the cavity 146, as used herein, refers to the side of an embodiment of coupler 100 that faces the FAU mounting site 152. That is, the outgoing side of the cavity 146 refers to the side of the embodiment of coupler 100 from which optical signals exiting the cavity 146, after propagating through the lens array and optical isolator, are coupled to the terminal facets of waveguides 106 in embodiments configured having waveguides 106 between a wall of cavity 146 and the FAU mounting site 152 on coupler 100. The outgoing side of the coupler 100 is labeled in FIG. 19A.

In embodiments listed as “Open” in the “outgoing structure” column of Table 2, the embodiments are configured having an open side of cavity 146 to enable free-space coupling of optical signals from the lens array mounted or otherwise formed in cavity 146 to the terminal facets of the cores of optical fibers 154 mounted in an FAU 156 on FAU mounting site 152 on coupler 100. The outgoing side of coupler 100 is labeled in FIG. 19A. The outgoing side of the cavity 146, as used herein, refers to the side of an embodiment of coupler 100 from which optical signals exiting the cavity 146 may be coupled to the terminal facets of optical fibers 154 mounted in an FAU 156 on FAU mounting site 152 on coupler 100 as described in embodiments herein.

The column of Table 2, under the header “Lens Structure” and labeled “ingoing lenses” shows the configuration of the lens array formed between the ingoing portion of the coupler 100 and an optical isolator 132 mounted or otherwise formed in cavity wherein the lens array listed under the “ingoing lenses” column in Table 2, in the embodiment, and shown in the corresponding drawings in FIGS. 19A-19T, is configured as either “2PP on facet”, “2PP structure”, or “MLA”. In the embodiments listed in Table 2, cavity 146 of coupler 100 is configured having one lens array. For the embodiments of the coupler assembly 102 shown in FIGS. 19A-19J, the cavity 146 of coupler 100 is configured having “ingoing lenses” mounted or otherwise formed in cavity 146 between the ingoing portion of the cavity 146 and an optical isolator 132 mounted or otherwise formed in cavity 146. In the embodiments shown in FIGS. 19A-19J, a lens array is not present in cavity 146 between the optical isolator 132 and the outgoing portion of the cavity 146.

In embodiments listed as “2PP on facet” in the “ingoing lenses” column of Table 2, the embodiments are configured having on-facet lenses 138_{F2PP} of an on-facet lens array 130_{F2PP} on waveguide facets formed by the intersection of the waveguides by the wall of cavity 146 on the ingoing side of the coupler 100. On-facet lenses 138_{F2PP} are formed using two-photon polymerization on the all or a portion of the waveguide facets intersected by the wall of cavity 146. The ingoing side of coupler 100 is labeled in FIG. 19A. The ingoing side of the cavity 146, as used herein, refers to the side of an embodiment of coupler 100 that receives optical signals from an interposer 103, for example, coupled to coupler 100 as described in embodiments herein.

In embodiments listed as “2PP structure” in the “ingoing lenses” column of Table 2, the embodiments are configured having in-structure lenses 138_{S2PP} of a lens array structure 130_{S2PP} formed using two-photon polymerization in cavity 146 and positioned between the ingoing side of the coupler 100 and an optical isolator 132 mounted or otherwise formed in cavity 146. The ingoing side of coupler 100 is labeled in FIG. 19A. The ingoing side of the cavity 146, as used herein, refers to the side of an embodiment of coupler 100 that receives optical signals from an interposer 103, for example, coupled to coupler 100 as described in embodiments herein.

In embodiments listed as “MLA” in the “ingoing lenses” column of Table 2, the embodiments are configured having MLA lenses 138_{MLA} of a multi-lens array 130_{MLA} mounted or otherwise formed in cavity 146 and positioned between the ingoing side of the coupler 100 and an optical isolator 132 mounted or otherwise formed in cavity 146.

The column of Table 2, under the header “Lens Structure” and labeled “outgoing lenses” shows the configuration of the lens array formed on the outgoing portion of coupler 100 wherein the embodiment listed under the “outgoing lenses” column in Table 2, and shown in the corresponding drawings in FIGS. 19A-19T, is configured as either “2PP on facet”, “2PP structure”, or “MLA”.

For the embodiments of the coupler assembly 102 shown in FIGS. 19K-19T, the cavity 146 of coupler 100 is configured having “outgoing lenses” mounted or otherwise formed in cavity 146 between an optical isolator 132 mounted or otherwise formed in cavity 146 and the outgoing portion of the cavity 146. In the embodiments shown in FIGS. 19A-19J, a lens array is not present in cavity 146 between the optical isolator 132 and the outgoing portion of the cavity 146.

For clarity, the optical isolators 132 are not shown in the embodiments of the coupler assembly 102 shown in FIGS. 19A-19T. In the embodiments shown in FIGS. 19A-19J, the optical isolator 132 resides in the cavity 146 between the lens array shown closer to the ingoing side of the cavity 146 and the outgoing side of the cavity 146. In the embodiments shown in FIGS. 19K-19T, the optical isolator 132 resides in the cavity 146 between the ingoing side of cavity 146 and the lens array shown closer to the outgoing side of the cavity 146.

In embodiments listed as “2PP on facet” in the “outgoing lenses” column of Table 2, the embodiments are configured having on-facet lenses 138_{F2PP} of an on-facet lens array 130_{F2PP} on waveguide facets formed by the intersection of the wall of cavity 146 and the waveguides 106 on the outgoing side of the coupler 100. On-facet lenses 138_{F2PP} are formed using two-photon polymerization on the all or a portion of the waveguide facets intersected by the wall of cavity 146. The outgoing side of coupler 100 is labeled in FIG. 19A. The outgoing side of the cavity 146, as used herein, refers to the side of an embodiment of coupler 100 from which optical signals are coupled from the cavity 146 to the terminal facets of the waveguides 106 that intersect the outgoing wall of cavity 146 or to the terminal facets of the cores of optical fibers 154 mounted in an FAU 156 on FAU mounting site 152 on coupler 100.

In embodiments listed as “2PP structure” in the “outgoing lenses” column of Table 2, the embodiments are configured having in-structure lenses 138_{S2PP} of a lens array structure 130_{F2PP} formed using two-photon polymerization in cavity 146 between an optical isolator 132 mounted or otherwise formed in cavity 146 and the outgoing side of the coupler 100 as labeled in FIG. 19A. The outgoing side of the cavity 146, as used herein, refers to the side of an embodiment of coupler 100 from which optical signals are coupled from the cavity 146 to the terminal facets of the waveguides 106 that intersect the outgoing wall of cavity 146 or to the terminal facets of the cores of optical fibers 154 mounted in an FAU 156 on FAU mounting site 152 on coupler 100 as shown in embodiments herein.

TABLE 2
Configurations of ingoing cavity structure and lens, and of outgoing
cavity structure and lens for embodiments having one lens array.

| | | WG or Open | | Lens Structure | |
|---|---|---|---|---|---|
| | | ingoing | outgoing | ingoing | outgoing |
| # | FIG.# | structure | structure | lenses | lenses |
| 1 | 19A | WG | WG | 2PP on facet | |
| 2 | 19B | WG | WG | 2PP structure | |
| 3 | 19C | open | WG | 2PP structure | |
| 4 | 19D | WG | open | 2PP on facet | |
| 5 | 19E | WG | open | 2PP structure | |
| 6 | 19F | open | open | 2PP structure | |
| 7 | 19G | WG | WG | MLA | |
| 8 | 19H | open | WG | MLA | |
| 9 | 19I | WG | open | MLA | |
| 10 | 19J | open | open | MLA | |
| 11 | 19K | WG | WG | | 2PP on facet |
| 12 | 19L | WG | WG | | 2PP structure |
| 13 | 19M | open | WG | | 2PP on facet |
| 14 | 19N | open | WG | | 2PP structure |
| 15 | 19O | WG | open | | 2PP structure |
| 16 | 19P | open | open | | 2PP structure |
| 17 | 19Q | WG | WG | | MLA |
| 18 | 19R | open | WG | | MLA |
| 19 | 19S | WG | open | | MLA |
| 20 | 19T | open | open | | MLA |

In embodiments listed as “MLA” in the “outgoing lenses” column of Table 2, the embodiments are configured having MLA lenses 138_{MLA} of a multi-lens array 130_{MLA} mounted or otherwise formed in cavity 146 between an optical isolator 132 mounted or otherwise formed in cavity 146 and the outgoing side of the coupler 100 as labeled in FIG. 19A. The outgoing side of the cavity 146, as used herein, refers to the side of an embodiment of coupler 100 from which optical signals are coupled from the cavity 146 to the terminal facets of the waveguides 106 that intersect the outgoing wall of cavity 146 or to the terminal facets of the cores of optical fibers 154 mounted in an FAU 156 on FAU mounting site 152 on coupler 100 as shown in embodiments herein.

As listed in Table 2, FIGS. 19A-19T provides the configurations of the coupler assembly 102 having (1) either a waveguide (WG) on the ingoing portion of the coupler 100 or an opening in the ingoing wall of cavity 146 to enable free-space coupling of optical signals to the lenses of the lens array mounted or otherwise formed in cavity 146; (2) having an on-facet lens array 130_{F2PP} formed using two-photon polymerization on waveguide facets intersected by the wall of cavity 146 on the ingoing side or outgoing side of cavity 146, a lens array structure 130_{F2PP} formed using two-photon polymerization in cavity 146 either between the ingoing side of cavity 146 and an optical isolator 132 mounted or otherwise formed in cavity 146 or between the optical isolator 132 and the outgoing side of the cavity 146, or a multi-lens array 130_{MLA} mounted or otherwise formed in cavity 146 either between the ingoing side of cavity 146 and an optical isolator 132 mounted or otherwise formed in cavity 146 or between the optical isolator 132 and the outgoing side of the cavity 146; and (3) having either a waveguide on the outgoing portion of the coupler 100 or an opening on the outgoing side of cavity 146 of the coupler 100 to enable free-space coupling of optical signals from the lenses of the lens array mounted or otherwise formed in cavity 146 to the terminal facets of the cores of optical fibers 154 mounted or otherwise formed in an FAU 156 on FAU mounting site 152 on coupler 100.

As in the embodiment shown in FIG. 19A, the embodiments shown in FIGS. 19B, 19G, 19K, 19L, and 19Q show embodiments configured having waveguides 106 at the ingoing portions and outgoing portions of the coupler 100. The waveguide cores 106_{core} are shown in the figures on both the ingoing portions and outgoing portions of coupler 100. The embodiment of coupler assembly 102 shown in FIG. 19A is configured having on-facet lenses 138_{F2PP} of on-facet lens array 130_{F2PP} formed on the waveguide facets on the ingoing wall of cavity 146. For the embodiments shown in FIG. 19B, coupler assembly 102 is configured having in-structure lenses 138_{S2PP} of lens array structure 130_{F2PP} formed in cavity 146 between the ingoing wall of cavity 146 and an optical isolator 132 mounted or otherwise formed in cavity 146. For the embodiment shown in FIGS. 19A and 19B, coupler assemblies 102 are configured having on-facet lenses 138_{F2PP} and in-structure lenses 138_{S2PP}, respectively, of on-facet lens array 130_{F2PP} and lens array structure 130_{F2PP}, respectively more closely coupled to the waveguides 106 of the ingoing wall of cavity 146 in the embodiments. Optical signals propagating through the on-facet lenses 138_{F2PP} of the on-facet lens array 130_{F2PP}, for example, or the in-structure lenses 138_{S2PP} of lens array structure 130_{F2PP}, respectively, in the embodiments shown in FIGS. 19A and 19B, respectively, are also coupled to the waveguide facets 106_{facet} formed on the wall of the outgoing side of the cavity 146. That is, in embodiments of coupler assembly 102 configured having a single lens array such as the single on-facet lens array 130_{F2PP} shown in FIGS. 19A, optical signals propagating from the waveguide facets on the ingoing side of the cavity 146 and through the on-facet lenses 138_{F2PP} of the on-facet lens array 130_{F2PP} are typically re-focused to the waveguide facets formed on the outgoing side of the cavity 146. In embodiments having only a single lens in the optical pathways through the cavity 146, the single lens may be configured to both capture the divergent optical signals emerging from the waveguide facets on the ingoing wall of the cavity 146 and re-focus the optical signals to be re-captured by the waveguide facets formed on the wall of the outgoing side of the cavity 146.

For the embodiment shown in FIG. 19G, coupler assembly 102 is configured having MLA lenses 138_{MLA} of multi-lens array 130_{MLA} more closely coupled to the waveguide facet of the ingoing wall of cavity 146 in the embodiments. Optical signals propagating through the MLA lenses 138_{MLA} of multi-lens array 130_{MLA} in the embodiment shown in FIG. 19G are also coupled to the waveguide facets 106_{facet} formed on the wall of the outgoing side of the cavity 146. In embodiments of coupler assembly 102 configured having a single lens array such as the single multi-lens array 130_{MLA} of the embodiment shown in FIG. 19G, optical signals propagating from the waveguide facets on the ingoing side of the cavity 146 and through the MLA lenses 138_{MLA} of the multi-lens array 130_{MLA}, are typically re-focused to the waveguide facets formed on the outgoing side of the cavity 146. In embodiments having only a single lens in the optical pathways through the cavity 146, the single lens may be configured to both capture the divergent optical signals emerging from the waveguide facets on the ingoing wall of the cavity 146 and re-focus the optical signals to be re-captured by the waveguide facets formed on the wall of the outgoing side of the cavity 146.

On the outgoing side of the cavity 146 the embodiments of coupler assembly 102 shown in FIGS. 19K, 19L, and 19Q are configured having ingoing and outgoing waveguides 106. Of these, the embodiment in FIG. 19K is configured having on-facet lenses 138_{F2PP} of on-facet lens array 130_{F2PP} formed on the waveguide facets on the outgoing wall of cavity 146. For the embodiments shown in FIG. 19L, coupler assembly 102 is configured having in-structure lenses 138_{S2PP} of lens array structure 130_{F2PP} more closely coupled to the waveguides 106 in the outgoing wall of cavity 146. And for the embodiment shown in FIG. 19Q, coupler assembly 102 is configured having MLA lenses 138_{MLA} of multi-lens array 130_{MLA} more closely coupled to the waveguides 106 of the outgoing wall of cavity 146 in the embodiments. Having only a single lens places a greater burden on the design of the lenses to enable capturing of the divergent optical signals propagating from the waveguide facets at the ingoing side of cavity 146 but less burden on the design to refocus the optical signals on the waveguide facets on the outgoing side of the cavity 146.

Embodiments for which the cavity 146 of coupler 100 is configured to enable free-space coupling of optical signals to lenses 138 mounted or otherwise formed in cavity 146 between the ingoing side of cavity 146 and an optical isolator 132 mounted or otherwise formed in cavity 146 are shown in FIGS. 19C, 19F, 19H, and 19J. In these embodiments configured having an opening to enable free-space coupling of optical signals on the ingoing side of the coupler 100, lens array configurations more closely coupled to the ingoing side of the cavity 146, listed in Table 2, are limited to either multi-lens arrays 130_{MLA} or lens array structures 130_{F2PP} formed using two-photon polymerization. The lack of waveguides 106 and the lack of terminal facets of waveguides at the ingoing portion of the wall of cavity 146 in these embodiments eliminates the option to form on-facet lenses 138_{F2PP} on waveguide facets in these embodiments. Of the embodiments configured having an opening in the ingoing portion of cavity 146, the embodiments of FIGS. 19C and 19F are further configured having a lens array structure 130_{F2PP} formed from two-photon polymerization. In the embodiments shown in FIGS. 19C, optical signals are free-space coupled from the ingoing side of cavity 146 to the in-structure lenses 138_{S2PP} of the lens array structure 130_{F2PP} and are further coupled from the in-structure lenses 138_{S2PP} of the lens array structure 130_{F2PP} to waveguide facets on the outgoing side of cavity 146. In the embodiments shown in FIGS. 19F, optical signals are free-space coupled from the ingoing side of cavity 146 to the in-structure lenses 138_{S2PP} of the lens array structure 130_{F2PP} and are further coupled from the in-structure lenses 138_{S2PP} of the lens array structure 130_{F2PP} through the optical isolator 132 to the terminal facets of the cores of optical fibers 154 mounted or otherwise formed in an FAU 156 on FAU mounting site 152 on coupler 100.

Of the embodiments configured having an opening in the ingoing portion of cavity 146, the embodiments of FIGS. 19H and 19J are further configured having a multi-lens array 130_{MLA} mounted or otherwise formed in cavity 146 between the ingoing side of the cavity 146 and an optical isolator 132 mounted in cavity 146. In the embodiments shown in FIGS. 19H, optical signals are free-space coupled from the ingoing side of cavity 146 to the MLA lenses 138_{MLA} of the multi-lens array 130_{MLA} and are further coupled from the MLA lenses 138_{MLA} of the multi-lens array 130_{MLA} to waveguide facets on the outgoing side of cavity 146. In the embodiments shown in FIGS. 19J, optical signals are free-space coupled from the ingoing side of cavity 146 to the MLA lenses 138_{MLA} of multi-lens array 130_{MLA} and are further coupled from the MLA lenses 138_{MLA} of the multi-lens array 130_{MLA} through the optical isolator 132 to the terminal facets of the cores of optical fibers 154 mounted or otherwise formed in an FAU 156 on FAU mounting site 152 on coupler 100.

Of the embodiments of the coupler 100 configured having an ingoing opening in cavity 146, the embodiments shown in FIGS. 19M, 19N, and 19R are further configured having waveguides 106 formed at the outgoing portion of cavity 146. In the embodiments shown in FIG. 19M, coupler assembly 102 is configured having on-facet lenses 138_{F2PP} of on-facet lens array 130_{F2PP} formed on the waveguide facets on the outgoing wall of cavity 146. For the embodiment shown in FIG. 19N, coupler assembly 102 is configured having in-structure lenses 138_{S2PP} of lens array structure 130_{F2PP} formed using two-photon polymerization. In FIG. 19N, the coupler assembly 102 is configured such that lens array structure 130_{F2PP} resides between an optical isolator 132 mounted or otherwise formed in cavity 146 and the waveguide facets in the outgoing wall of cavity 146 in the embodiments. For the embodiments shown in FIG. 19R, coupler assembly 102 is configured having MLA lenses 138_{MLA} of multi-lens array 130_{MLA} mounted or otherwise formed between an optical isolator 132 and the waveguide facets in the outgoing wall of cavity 146 in the embodiments.

Embodiments for which the cavity 146 of coupler 100 is configured to enable free-space coupling of optical signals from lenses 138 mounted or otherwise formed in cavity 146 between an optical isolator 132 mounted or otherwise formed in cavity 146 and the outgoing side of cavity 146 are shown in FIGS. 19P and 19T. In these embodiments configured having an opening to enable free-space coupling of optical signals on the ingoing side of the coupler 100 and on the outgoing side of the coupler 100, lens array configurations on the outgoing side of the cavity, listed in Table 2, are limited to either multi-lens arrays 130_{MLA} or lens array structures 130_{F2PP} formed using two-photon polymerization. The lack of waveguides 106 and the lack of terminal facets of waveguides at the outgoing portion of the wall of cavity 146 in these embodiments eliminates the option to form on-facet lenses 138_{F2PP} on waveguide facets in these embodiments.

Of the embodiments configured having an opening in the ingoing and outgoing portions of cavity 146, the embodiment of the coupler assembly 102 shown in FIG. 19P is further configured having in-structure lenses 138_{S2PP} of lens array structure 130_{F2PP} formed from two-photon polymerization. In the embodiment of coupler assembly 102 shown in FIG. 19P, lens array structure 130_{F2PP} resides between optical isolator 132 and the terminal facets of the cores of optical fibers 154 mounted or otherwise formed in an FAU 156 on FAU mounting site 152 on coupler 100. And for the embodiment of the coupler assembly 102 shown in FIG. 19T, cavity 146 is further configured having MLA lenses 138_{MLA} of multi-lens array 130_{MLA}. In the embodiment shown in FIG. 19T, multi-lens array 130_{MLA} resides between an optical isolator 132 and the terminal facets of the cores of optical fibers 154 mounted or otherwise formed in an FAU 156 on FAU mounting site 152 on coupler 100. Free-space coupled optical signals entering the cavity 146 from an interposer assembly 104, for example, coupled to the coupler assembly 102 in the embodiment, propagate through the optical isolator 132 to the terminal facets of the cores of optical fibers 154 mounted or otherwise formed in an FAU 156 on FAU mounting site 152 on coupler 100 in the embodiments of FIGS. 19P and 19T.

The embodiments of coupler assembly 102 shown in FIGS. 19D, 19E, 19I, 19O, and 19S are configured having waveguides 106 at the ingoing portions of the cavity 146, and are further configured having an outgoing opening in cavity 146 to facilitate the free-space coupling of optical signals from a lens array 130 mounted or otherwise formed in cavity 146 and the terminal facets of the cores of optical fibers 154 mounted or otherwise formed in an FAU 156 on FAU mounting site 152 on coupler 100. In the embodiments shown in FIGS. 19D, 19E, and 19I, coupler assembly 102 is configured having waveguide facets on the ingoing side of cavity 146 and an opening in cavity 146 to enable free-space coupling of optical signals on the outgoing side of the coupler 100.

The embodiment of coupler assembly 102 shown in FIG. 19D is configured having on-facet lenses 138_{F2PP} of on-facet lens array 130_{F2PP} formed on the waveguide facets on the ingoing wall of cavity 146. For the embodiments shown in FIG. 19E, coupler assembly 102 is configured having in-structure lenses 138_{S2PP} of lens array structure 130_{F2PP} formed in cavity 146 between the ingoing wall of cavity 146 and an optical isolator 132 mounted or otherwise formed in cavity 146. For the embodiment shown in FIGS. 19D and 19E, coupler assemblies 102 are configured having on-facet lenses 138_{F2PP} of on-facet lens array 130_{F2PP} and in-structure lenses 138_{S2PP} of lens array structure 130_{F2PP}, respectively, more closely coupled to the waveguides 106 of the ingoing wall of cavity 146 in the embodiments. Optical signals propagating through the on-facet lenses 138_{F2PP} of on-facet lens array 130_{F2PP} in the embodiment shown in FIG. 19D, or through the in-structure lenses 138_{S2PP} of lens array structure 130_{F2PP} in the embodiment shown in FIG. 19E, respectively, are also coupled to the terminal facets of the cores of optical fibers 154 mounted or otherwise formed in an FAU 156 on FAU mounting site 152 on coupler 100. In embodiments of coupler assembly 102 configured having a single lens array 130 such as the single on-facet lens array 130_{F2PP} or the single lens array structure 130_{F2PP} of the embodiments shown in FIGS. 19D and 19E, respectively, optical signals propagating from the waveguide facets on the ingoing side of the cavity 146, and through the on-facet lenses 138_{F2PP} of the on-facet lens array 130_{F2PP}, or through the in-structure lenses 138_{S2PP} of the lens array structure 130_{F2PP}, respectively, are re-focused to the terminal facets of the cores of optical fibers 154 mounted or otherwise formed in an FAU 156 on FAU mounting site 152 on coupler 100. In embodiments having only a single lens in the optical pathways through the cavity 146, the single lens may be configured to both capture the divergent optical signals emerging from the waveguide facets on the ingoing wall of the cavity 146 and re-focus the optical signals to be re-captured by the terminal facets of the cores of optical fibers 154 mounted or otherwise formed in an FAU 156 on FAU mounting site 152 on coupler 100. The optical signals must pass through optical isolator 132 in this and other configurations of the coupler assembly 102 described herein.

For the embodiment shown in FIG. 19I, coupler assembly 102 is configured having MLA lenses 138_{MLA} of multi-lens array 130_{MLA} more closely coupled to the waveguide facets of the ingoing side of cavity 146 in the embodiments. Optical signals propagating through the MLA lenses 138_{MLA} of multi-lens array 130_{MLA} in the embodiment shown in FIG. 19I are also coupled to the terminal facets of the cores of optical fibers 154 mounted or otherwise formed in an FAU 156 on FAU mounting site 152 on coupler 100 after propagating through optical isolator 132 mounted or otherwise formed in the cavity 146. In embodiments of coupler assembly 102 configured having a single lens array such as the single multi-lens array 130_{MLA} of the embodiment shown in FIG. 19I, optical signals propagating from the waveguide facets on the ingoing side of the cavity 146 and through the MLA lenses 138_{MLA} of the multi-lens array 130_{MLA}, are re-focused to enable improved coupling to the terminal facets of the cores of optical fibers 154 mounted or otherwise formed in an FAU 156 on FAU mounting site 152 on coupler 100. In embodiments having only a single lens in the optical pathways through the cavity 146, the lenses of the single lens array may be configured to both capture the divergent optical signals emerging from the waveguide facets on the ingoing wall of the cavity 146 and re-focus the optical signals to be re-captured by the terminal facets of the cores of optical fibers 154 mounted or otherwise formed in an FAU 156 on FAU mounting site 152 on coupler 100.

In the embodiments shown in FIGS. 190 and 19S configured having waveguide facets on the ingoing side of cavity 146 and an opening in cavity 146 to enable free-space coupling of optical signals on the outgoing side of the coupler 100, the lens array configurations more closely coupled to the outgoing side of cavity 146 are limited to either multi-lens arrays 130_{MLA} or lens array structures 130_{F2PP} formed using two-photon polymerization. The lack of waveguides 106 and the lack of terminal facets of waveguides at the outgoing portion of cavity 146 in these embodiments eliminates the option to form on-facet lenses 138_{F2PP} on waveguide facets in these embodiments. Of the embodiments configured having waveguide facets formed at the ingoing side of cavity 146 and having an opening in the outgoing portion of cavity 146, the embodiment of FIG. 19O is further configured having in-structure lenses 138_{S2PP} of a lens array structure 130_{F2PP} formed using two-photon polymerization between an optical isolator 132 mounted or otherwise formed in cavity 146 and the terminal facets of the cores of optical fibers 154 mounted or otherwise formed in an FAU 156 on FAU mounting site 152 on coupler 100. And the embodiment of FIG. 19S is further configured having MLA lenses 138_{MLA} of a multi-lens array 130_{MLA} mounted or otherwise formed in cavity 146 between optical isolator 132 and the terminal facets of the cores of optical fibers 154 mounted or otherwise formed in an FAU 156 on FAU mounting site 152 on coupler 100.

In summary, the embodiments of coupler assembly 102 listed in Table 2 and shown in the perspective schematic drawings in FIGS. 19A-19T show the ingoing portions of coupler 100 configured having waveguides 106 in some embodiments, and show ingoing portions of coupler 100 configured to enable free-space coupling of optical signals through an open-sided cavity 146 to a lens array mounted or otherwise formed in cavity 146, wherein the lens array in cavity 146 is configured as either a multi-lens array 130_{MLA}, a lens array structure 130_{F2PP} formed using two-photon polymerization, or an on-facet lens array 130_{F2PP} formed from two-photon polymerization on the terminal facets of waveguides 106 on the ingoing side of the cavity 146.

Embodiments of coupler assemblies 102 comprise a lens array structure configured in cavity 146 to facilitate coupling of optical signals from an ingoing portion of coupler 100, through an optical isolator 132 mounted or otherwise formed in the cavity 146, and to an outgoing portion of coupler 100. The lens array mounted or otherwise formed in cavity 146 in some embodiments of coupler assembly 102 enables coupling of optical signals from one or more waveguides 106 in embodiments configured having waveguides 106 in the ingoing portion of the coupler 100 to one or more waveguides 106 in the outgoing portion of the coupler 100. In some embodiments, cavity 146 may be configured having an optical isolator 132 mounted or otherwise formed between the waveguide facets on the ingoing side of the cavity 146 and the lens array. In other embodiments, cavity 146 may be configured having an optical isolator 132 mounted or otherwise formed between the lens array and waveguide facets on the outgoing side of cavity 146.

In other embodiments of coupler assembly 102 configured having waveguides 106 in the ingoing portion of the coupler 100, optical signals may be coupled from the lens array mounted or otherwise formed in cavity 146 through an optical isolator 132 to the terminal facets of the cores of optical fibers 154 mounted or otherwise formed in an FAU 156 on FAU mounting site 152 on coupler 100. In some embodiments, cavity 146 may be configured having an optical isolator 132 mounted or otherwise formed between the waveguide facets on the ingoing side of the cavity 146 and the lens array. In other embodiments, cavity 146 may be configured having an optical isolator 132 mounted or otherwise formed between the lens array and the terminal facets of the cores of optical fibers 154 mounted or otherwise formed in an FAU 156 on FAU mounting site 152 on coupler 100.

In yet other embodiments of coupler assembly 102, coupler 100 in coupler assembly 102 is configured having an opening in the ingoing side of cavity 146 to enable free-space coupling of optical signals from an interposer assembly 104, for example, coupled to the coupler assembly 102, through a lens array mounted or otherwise formed in cavity 146 to waveguide facets formed on the outgoing side of cavity 146. In some embodiments, cavity 146 may be configured having an optical isolator 132 mounted or otherwise formed between the lens array and the terminal facets of the cores of optical fibers 154 mounted or otherwise formed in an FAU 156 on FAU mounting site 152 on coupler 100. In other embodiments, cavity 146 may be configured having an optical isolator 132 mounted or otherwise formed between the open ingoing side of cavity 146 and the lens array mounted or otherwise formed in cavity 146.

In yet other embodiments of coupler assembly 102, coupler 100 in coupler assembly 102 is configured having an opening in the ingoing side of cavity 146 to enable free-space coupling of optical signals from an interposer assembly 104, for example, coupled to the coupler assembly 102, through a lens array mounted or otherwise formed in cavity 146, and through an opening in the outgoing side of cavity 146 to the terminal facets of the cores of optical fibers 154 mounted or otherwise formed in an FAU 156 on FAU mounting site 152 on coupler 100. In some embodiments, cavity 146 may be configured having an optical isolator 132 mounted or otherwise formed between the lens array and the terminal facets of the cores of optical fibers 154 mounted or otherwise formed in an FAU 156 on FAU mounting site 152 on coupler 100. In other embodiments, cavity 146 may be configured having an optical isolator 132 mounted or otherwise formed between the open ingoing side of cavity 146 and the lens array mounted or otherwise formed in cavity 146.

In further summary, the lens array mounted or otherwise formed in cavity 146 in embodiments of coupler assembly 102 may be configured as either a multi-lens array 130_{MLA} or a lens array structure 130_{F2PP} formed using two-photon polymerization, or in embodiments having waveguide facets formed on one or more of the ingoing side and the outgoing side of cavity 146, an on-facet lens array 130_{F2PP} formed from two-photon polymerization on the terminal facets of waveguides 106 intersected by the wall of cavity 146.

Embodiments in Table 2 of coupler assembly 102 configured having a single lens array may provide more simplified assemblies in comparison to the embodiments of Table 1 in which two lens arrays are used to facilitate the capturing of the divergent optical signals and the refocusing of the captured optical signals.

### Methods of Forming Embodiments of PIC Assembly Comprising Coupler and Interposer

Methods of formation of embodiments of coupler assembly 102 can vary depending on the type and number of lens arrays used in cavity 146 of coupler 100, and on whether the cavity 146 on the coupler 100 is configured having waveguides 106 formed in the sidewalls leading to and from the cavity 146, or openings in one or more of the sidewalls leading to and from the cavity 146 that enable free-space coupling of optical signals to and from the cavity 146.

Regarding the type and number of lens arrays used in an embodiment, for example, a cavity 146 configured having two on-facet lens arrays 130_{F2PP} formed using two-photon polymerization and an optical isolator 132, steps in the method of formation of coupler assembly 102 must include the two-photon polymerization process and a subsequent process for placement and alignment of the optical isolator 132. In another embodiment, a cavity 146 configured having two lens arrays 130, for example, that are multi-lens arrays, the multi-lens arrays must be placed into the cavity, aligned, and bonded in place in the cavity 146 in alignment with the optical axes of waveguides or other optical pathways of the coupler assembly 102. In yet other embodiments, cavity 146 of the coupler assembly 102 may be configured having a first on-facet lens array 130_{F2PP}-1 formed on terminal waveguide facets in cavity 146 using two-photon polymerization and a second lens array 130-2 that is a multi-lens array 130_{MLA}-2 wherein the methods of formation require a two-photon polymerization step to form the 3D printed lens array and the placement, alignment, and bonding steps to configure the cavity with the multi-lens array 130_{MLA}. In the following section, the formation of these and other embodiments of coupler assembly 102 are disclosed.

With regard to the presence or absence of waveguides 106 and openings in the cavity on the ingoing side and the outgoing side of the cavity 146, the methods of formation of embodiments of coupler assemblies 102 and PIC assemblies 101 from couplers 100 can vary depending on whether an embodiment of the coupler is configured having either one or more waveguides 106 formed on one or more of the ingoing side and the outgoing side of the cavity 146, openings in the one or more of the ingoing side and the outgoing side of the cavity 146, or one or more waveguides 106 in the one or more of the ingoing side and the outgoing side of the cavity 146 and one or more openings in the one or more of the ingoing side and the outgoing side of the cavity 146. In the following section, the formation of these and other embodiments of coupler assembly 102 are disclosed.

### Methods of Forming PIC Assemblies Configured Having a Coupler Assembly Configured Having Two Lens Arrays

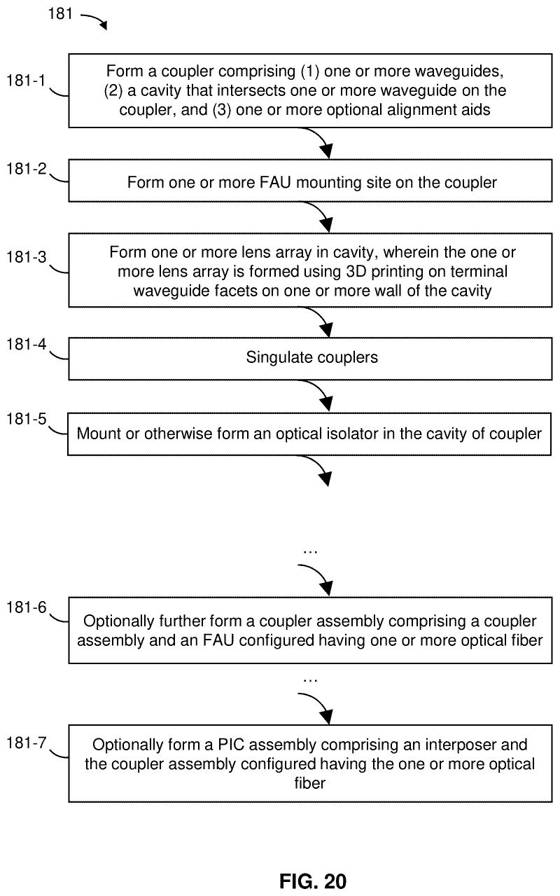

FIG. 20 shows a flowchart for a method 181 of forming embodiments of coupler 100, embodiments of coupler assembly 102, and embodiments of PIC assembly 101 comprising coupler assembly 102 and interposer assembly 104, wherein the embodiments of the coupler assembly 102 formed using method 181 are configured having first and second on-facet lens arrays 130_{F2PP}-1, 130_{F2PP}-2, respectively, comprising on-facet lenses 138_{F2PP} formed on waveguide facets in cavity 146 using two-photon polymerization. In the formation of the embodiments using method 181, the coupler 100 is configured having one or more waveguides 106 formed on the ingoing side of cavity 146 and one or more waveguides 106 formed on the outgoing side of cavity 146. Embodiments of couplers 100 configured having such waveguides 106 formed on the ingoing side of the cavity 146 and on the outgoing side of the cavity 146 are shown, for example, in FIGS. 3A1-3A3.

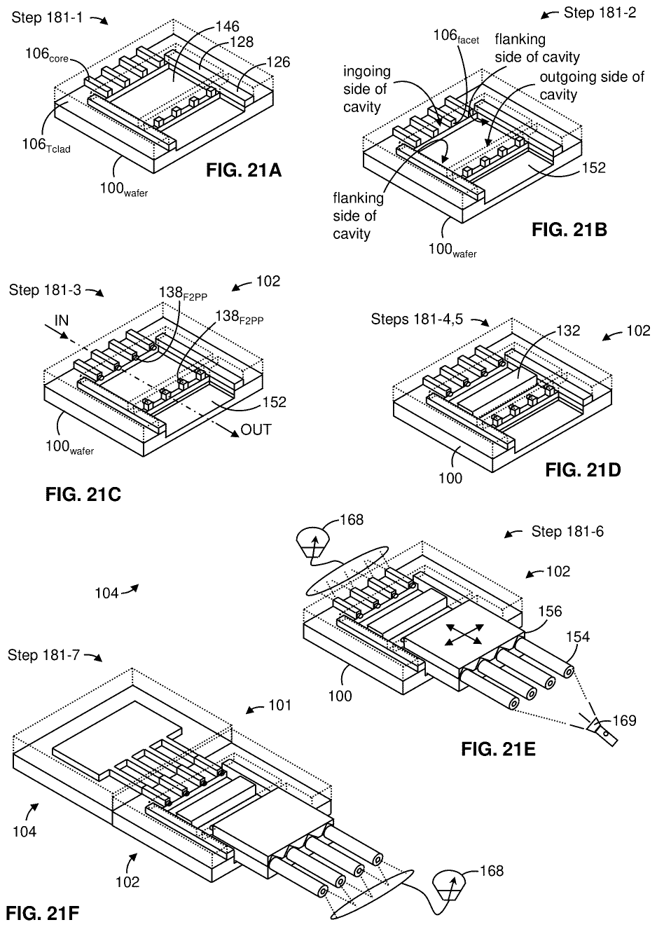

FIGS. 21A-21F show perspective schematic drawings of embodiments of the coupler 100, coupler assembly 102, and PIC assembly 101 at various steps in the process of formation using method 181. The steps in the method 181 of FIG. 20 are described in conjunction with the perspective schematic drawings in FIGS. 21A-21F.

Step 181-1 of method 181 shown in FIG. 20 is a forming step in which an embodiment of a coupler comprising a cavity and optional alignment aids is formed. Embodiments of coupler 100 may be formed, for example, using method 195 shown in FIG. 14 described herein in conjunction with FIGS. 15A1-15F3.

FIG. 21A shows a perspective schematic drawing of an embodiment of coupler 100_{wafer} after Step 181-1 of method 181. The embodiment of the coupler 100_{wafer} in FIG. 21A is shown configured having cavity 146 and optional alignment aids 126,128 wherein the ingoing side and the outgoing side of the cavity 146 are configured having waveguides 106, and waveguide facets formed on the walls of the cavity on the ingoing and outgoing sides of the cavity 146. The embodiment of the coupler 100_{wafer} shown in FIG. 21A is configured having FAU alignment aids 126 at the opening of the FAU mounting site 152 and cavity alignment aids 128 formed at the opening of the cavity 146 on the sidewalls flanking the optical pathways through the cavity 146.

In the embodiment of the coupler 100_{wafer} shown in FIG. 21A, the coupler 100_{wafer} is labeled “coupler 100_{wafer}”. The suffix “wafer” added to the label “100” as in “100_{wafer}”, indicates in this and other drawings herein that the coupler has not yet been singulated from a substrate wafer having a plurality of couplers. The plurality of couplers are partially formed using wafer level processing until a singulation step wherein one or more partially formed couplers are singulated from the substrate wafer. In the sequence of perspective drawings used in the formation of an embodiment of the singulated couplers 100, the exclusion of the suffix “wafer” indicates that the coupler 100 has been singulated from the substrate wafer comprising the plurality of couplers 100_{wafer}. That is, the suffix is not used in the perspective drawings of the coupler in the steps following the singulation step to indicate that the coupler 100 is a singulated coupler.

The embodiment of the unsingulated coupler 100_{wafer} is formed from a layered structure comprising a planar waveguide layer 105_{cplr} formed on a substrate 110_{cplr}. The layered structure may optionally include an electrical interconnect layer 133_{cplr} formed on the substrate 110_{cplr} wherein the planar waveguide layer 105 may be formed on the optional electrical interconnect layer 133_{cplr}. A top cladding layer 106_{Tclad} is shown as transparent in the perspective drawings in FIG. 21A-21F with dotted lines on the periphery to more clearly illustrate key features underlying the top cladding layer in the structure of the embodiments of the couplers shown in the drawings.

The embodiment of the coupler 100_{wafer} shown in FIG. 21A is configured having FAU alignment aids 126 at a portion of the periphery of the upper opening of FAU mounting site 152 that may facilitate, for example, the alignment of an FAU 156 configured having one or more optical fiber 154. The embodiments shown in FIG. 21A are also configured having cavity alignment aids 128 formed in the sidewalls in the flanking sides at the opening of the cavity 146 that may facilitate, for example, the alignment of one or more of an optical isolator 132.

FAU alignment aids 126 and cavity alignment aids 128, in the embodiment of the coupler 100_{wafer}, may be formed in self-alignment with the waveguide cores 106_{core}. Although not shown in FIG. 21A, other lateral alignment aids such as T&G lateral alignment aids 108 and fiducials 114, among other alignment features, may also be included in the formation of other embodiments. Because the lateral alignment aids and the waveguide cores 106_{core} are formed from the same patterned layer, the relative positioning between the lateral alignment aids and the waveguide cores 106_{core} are within the dimensional resolution of the lithographic patterning method and the resolution of the subsequent patterning method used to pattern the layer or layers underlying the patterned layer.

Lateral alignment aids that are formed in self-alignment with the waveguide cores 106_{core} may be used to align two devices or features that are brought together in the formation of an assembly. In some embodiments, the lateral alignment aids used to align a first device may be formed in a location on the coupler 100 that is a significant distance from a second device, for example, to which the first device is to be aligned in the formation of an assembly comprising the first and second device. In an embodiment, for example, in which a cavity alignment aid 128 is formed at one or more wall of cavity 146, the cavity alignment aid 128 may be used in the alignment of an optical isolator 132 with the waveguide cores 106_{core} formed at another wall of cavity 146 due to the self-alignment of the cavity alignment aids 128 and the waveguide cores 106_{core}. In another embodiment, for example, in which coupler 100 is configured having T&G alignment aids 108 formed self-aligned with, and a significant distance from, the waveguide cores 106_{core} of the coupler 100, the T&G alignment aids 108 of the coupler 100 may be used to align the waveguide cores 106_{core} of the coupler 100 with the waveguide cores 107_{core} of an interposer 103 configured having complementary T&G alignment aid 109.

Step 181-2 of method 181 shown in FIG. 20 is a forming step in which one or more FAU mounting site 152 is formed in the coupler 100_{wafer}. A method of forming FAU mounting site 152 is described, for example, in method 195 of FIG. 14, and in the cross-section drawings in FIGS. 15A1-15F1. In some embodiments, more than one FAU mounting site 152 may be formed on coupler 100 to facilitate the coupling of more than one FAU 156 onto embodiments of coupler 100 configured to be receptive to more than one FAU 156.

FIG. 21B shows a perspective schematic drawing of an embodiment of coupler 100_{wafer} after Step 181-1 of method 181, within which FAU mounting site 152 has been formed in the embodiment. Also shown in FIG. 21B are labels for the four sides of cavity 146 to distinguish between the ingoing side of the cavity 146, the outgoing side of the cavity 146, and the two flanking sides of the cavity 146 in this and other embodiments disclosed herein. Optical signals propagate from the ingoing side of the cavity 146, through the cavity 146 and through the outgoing side of the cavity 146 in alignment with optical pathways formed by the optical axes of the lenses 138 of the lens arrays 130 mounted or otherwise formed in the cavity 146. In the embodiment of the coupler 100_{wafer} shown, the ingoing side of the cavity 146 and the outgoing side of the cavity 146 are configured having waveguide cores 106_{core} of waveguides 106 through which optical signals may propagate. In other embodiments, the ingoing side of the cavity 146 may be configured having an opening to enable free-space coupling of optical signals, for example, from an interposer assembly 104 or other optical signal source. In yet some other embodiments, the outgoing side of the cavity 146 may be configured having an opening to enable free-space coupling of optical signals, for example, to the terminal facets of the cores of optical fibers 154 mounted in FAU 156 on the coupler 100 in contrast to the coupling of these optical signals through the waveguides 106 residing between the outgoing side of the cavity 146 and the FAU mounting site 152 in the embodiment shown in FIG. 21B.

Step 181-3 of method 181 shown in FIG. 20 is a forming step in which one or more lens array is formed in cavity 146 on coupler 100_{wafer}, wherein the one or more lens array is formed using two-photon polymerization or other 3D printing method and wherein the one or more lens array is formed on the facets of waveguides formed all or in part on one or more sidewall of the cavity 146 in the embodiment. Step 181-3, in the embodiment, yields a plurality of unsingulated coupler assemblies 102 each comprising a coupler 100_{wafer} and first and second on-facet lens arrays 130_{F2PP}-1, 130_{F2PP}-2, respectively, in cavity 146 of the coupler 100_{wafer}.

FIG. 21C shows a perspective schematic drawing of an embodiment of coupler 100_{wafer} after Step 181-3 of method 181, within which first and second on-facet lens arrays 130_{F2PP}-1, 130_{F2PP}-2, respectively, are formed in cavity 146 of the coupler 100_{wafer} in the embodiment. FIG. 21C shows on-facet lenses 138_{F2PP} of first on-facet lens array 130_{F2PP}-1 formed on the waveguide facets on the ingoing side of cavity 146 and on-facet lenses 138_{F2PP} of second on-facet lens array 130_{F2PP}-2 formed on the waveguide facets on the outgoing side of the cavity 146.

In the embodiment, the coupler 100_{wafer} is configured having waveguide facets on the ingoing side of the cavity 146 and in the outgoing side of the cavity 146. The presence of the facets, in the embodiment of the coupler 100_{wafer}, enables the use of the 3D printed lenses formed on the facets as described, for example, in conjunction with the description of the two-photon polymerization apparatus shown in FIG. 17A.

In an example of an optical signal propagating through the embodiment of a coupler assembly 102 configured having a first and a second on-facet lens array 130_{F2PP}-1, 130_{F2PP}-2, respectively, formed using two-photon polymerization on the facets of waveguide cores 106_{core} intersected by a wall of the cavity 146, an optical signal incident on an on-facet lens 138_{F2PP} of the first on-facet lens array 130_{F2PP}-1 is collimated as it propagates through the on-facet lens 138_{F2PP} of the first on-facet lens array 130_{F2PP} to an on-facet lens 138_{F2PP} of the second on-facet lens array 130_{F2PP}-2 in the cavity 146. In the example, the on-facet lenses 138_{F2PP} are configured to be collimating lenses and the collimating that results from the propagation through the lens of the first on-facet lens array 130_{F2PP}-1 leads to a reduction in spot size in comparison to an uncollimated optical signal, and the reduction in spot size leads to improved coupling of the optical signal to the on-facet lens 138_{F2PP} of the second on-facet lens array 130_{F2PP}-2. The on-facet lens 138_{F2PP} of the second on-facet lens array 130_{F2PP}-2 may be configured, for example, as a focusing lens, such that the collimated optical signal incident on the on-facet lens 138_{F2PP} configured as a focusing lens further reduces the spot size of the optical signal as it propagates through the on-facet lens 138_{F2PP} of the second on-facet lens array 130_{F2PP}-2 to the waveguide facet on the wall of cavity 146 upon which the on-facet lens 138_{F2PP} of the second on-facet lens array 130_{F2PP}-2 is formed.

The coupler assembly 102 shown in FIG. 21C may be further formed in steps following step 181-3 as further described. In embodiments, a plurality of coupler assemblies 102 may be formed on the substrate configured having a plurality of unsingulated couplers 100_{wafer}.

Step 181-4 of method 181 shown in FIG. 20 is a singulating step in which the unsingulated coupler wafer comprising a plurality of couplers 100_{wafer} is singulated into two or more singulated couplers 100. In some embodiments, an unsingulated coupler wafer is diced or otherwise singulated into individual couplers. In other embodiments, an unsingulated coupler wafer is diced or otherwise singulated into couplers having one or more coupler on a singulated chip. In some embodiments, for example, having two or more couplers that remain unsingulated may be preferable to singulating the couplers into fully singular devices. And in yet other embodiments, unsingulated coupler wafers may be singulated in chips having two or more couplers on a singulated chip.

Step 181-5 of method 181, shown in the flowchart in FIG. 20, is a mounting step in which an optical isolator 132 is mounted or otherwise formed in the cavity 146 of coupler 100 to further form coupler assembly 102. In some embodiments, mounting step 181-5 may include an aligning step wherein the positioning of the optical isolator 132 within the cavity 146 is optimized in some manner to ensure proper alignment for optimal signal transmission, for example, through the optical isolator 132. Other metrics may also be utilized and optimized, in some embodiments.

FIG. 21D shows a perspective schematic drawing of an embodiment of coupler 100_{wafer} after singulation step 181-4 and mounting step 181-5 of method 181, within which the couplers 100_{wafer} are singulated to form singulated couplers 100, and within which an optical isolator is mounted or otherwise formed between first and second on-facet lens arrays 130_{F2PP}-1, 130_{F2PP}-2, respectively, after singulation of the unsingulated coupler wafer to further form coupler assembly 102.

Step 181-6 of method 181, shown in the flowchart in FIG. 20, is an optional forming step in which an FAU configured having one or more optical fiber is coupled to the coupler assembly 102 to further form coupler assembly 102. In some embodiments, the coupler assembly 102 formed after step 181-5 may form a completed embodiment. In other embodiments, further formation of the coupler assembly to include an FAU 156 configured having one or more optical fiber 154 may be preferred.

FIG. 21E shows a perspective schematic drawing of an embodiment of coupler assembly 102 after optional forming step 181-6 wherein the embodiment of coupler assembly 102 after step 181-6 comprises coupler assembly 102 configured having an optical isolator is mounted or otherwise formed between first and second on-facet lens arrays 130_{F2PP}-1, 130_{F2PP}-2, respectively, and an FAU 156 configured having one or more optical fiber 154.

In some embodiments, an alignment apparatus comprising a detector and an optical parameter measurement device may be used to facilitate alignment of two or more optical components of a coupler assembly 101. FIG. 21E shows alignment apparatus 168 that may be used to facilitate alignment of the optical fibers 154 mounted or otherwise formed in the FAU 156 with the already aligned waveguide cores 106_{core} and lenses 138_{F2PP} formed in cavity 146. One or more emitting device 169 coupled to the one or more optical fiber 154 mounted or otherwise formed in the FAU 156 provides one or more optical signals through one or more waveguide core 106_{core} and corresponding lens 138_{F2PP} in the cavity 146. The one or more optical signal from the one or more emitting device 169 propagates through the coupler assembly 102 and, for an FAU 156 in a partially aligned position on FAU mounting site 152, at least a partial signal should be detectable on a detector of the alignment apparatus 168. In the example alignment step, the alignment apparatus 168 is configured to be receptive to all or a portion of the optical signals emerging from the terminal facets of the waveguides 106 as illustrated in FIG. 21E. Fine adjustments may then be made to optimize the positioning of the FAU 156, and the optical fibers 154 configured thereon. Determination of an optimized alignment position between the cores of the optical fibers 154 mounted or otherwise formed on FAU 156 may be achieved, for example, by measuring the power, signal intensity, or other parameter of the emitted optical signal and adjusting the position of the FAU 156 configured having the optical fibers 154 until the power, signal intensity, or other parameter indicates a desired level. After alignment, FAU 156 may be secured in position using an epoxy or other method of attachment.

Step 181-7 of method 181, shown in the flowchart in FIG. 20, is an optional forming step in which a PIC assembly 101 is optionally formed comprising the embodiment of the coupler assembly 102 shown in FIG. 21E and an interposer 103 or interposer assembly 104.

FIG. 21F shows a perspective schematic drawing of an embodiment of PIC assembly 101 after optional forming step 181-7. The perspective schematic drawing of the embodiment of PIC assembly 101 in FIG. 21F comprises an embodiment of interposer assembly 104 and the embodiment of coupler assembly 102 formed using steps 181-1 to 181-6 of method 181, wherein the coupler assembly 102 comprises coupler 100 configured having a cavity 146, two on-facet lens arrays 130_{F2PP}-1, 130_{F2PP}-2 formed using two-photon polymerization on waveguide facets formed on the wall of the cavity 146, optical isolator 132, and four optical fibers 154 mounted or otherwise formed in FAU 156 on coupler 100. Interposer assembly 104 of the PIC assembly 101 includes interposer 103 and optionally includes one or more optical emitting device, among other optional devices.

FIG. 21F shows alignment apparatus 168 that may be used to facilitate alignment of the waveguide cores 107_{core} of the interposer 103, with the already aligned components of coupler assembly 102 comprising the waveguide cores 106_{core}, the lenses 138_{F2PP} formed in the cavity 146, and the optical fibers 154 on FAU 156. In an example alignment process, one or more emitting device on or coupled to the interposer assembly 104 provides one or more optical signals through one or more waveguide core 107_{core} of the interposer 103 that propagate through the attached lenses on the facets of the waveguides 106 on the ingoing and outgoing sides of the cavity 146 to one or more waveguide core 106_{core} on the coupler 100, and to the cores of the optical fibers 154 positioned in the FAU 156 on the coupler 100. The alignment apparatus 168 is configured to be receptive to all or a portion of the optical signals emerging from the terminal facets of the optical fibers 154 as illustrated in FIG. 21F.

Alignment apparatus 168 may be used to detect one or more characteristics of the one or more optical signals propagating through the PIC assembly 101 enabling alterations to be made in the relative positioning of the interposer assembly 104, the coupler assembly 102, and one or more of the optical fibers 154, and enabling improvements in the alignment of the waveguide cores 106_{core} of the coupler 100 with the waveguide cores 107_{core} of the interposer 103, if needed. In some embodiments, steps 181-7 may be combined with step 181-6 to enable alignment of the coupler assembly 102 and the cores of the optical fibers 154 positioned in FAU 156. After alignment, the interposer assembly 104 and the coupler assembly 102, including the optical isolator 132, and the optical fibers 154 may be secured in an aligned position using, for example, using an epoxy or other securing medium. In an example alignment step using alignment apparatus 168, four optical emitting devices of PIC 118 on the interposer assembly 104 are electrically powered such that optical signals are emitted from the optical emitting devices to the waveguide cores 107_{core}. The coupler assembly 102 is positioned such that the waveguide cores 106_{core} of the coupler 100 are receptive to all or a portion of the optical signals from the waveguide cores 107_{core} of the interposer assembly 104, and such that a detector of alignment apparatus 168 is receptive to all or a portion of the optical signal power emerging from the one or more optical fibers 154 coupled to the detector of the alignment apparatus 168. In an embodiment, relative positions of the interposer assembly 104 and the coupler assembly 102 are varied to enable the detected optical signal power on a detector of alignment apparatus 168 to be optimized. A maximum measured power, for example, may be indicative of optimally aligned components in the PIC assembly 101. Other optical signal parameters may also be used to detect the quality of the alignment between the waveguide cores 107_{core} of the interposer 103, the optical isolator 132, the waveguide cores 106_{core} of the coupler 100, and the optical fibers 154.

In some embodiments, the optical signals emitted from two emitting devices are used in the alignment of the interposer assembly 104 and the coupler assembly 102 that includes the optical isolator 132, and two optical fibers 154 mounted or otherwise formed in the FAU 156 on the coupler 100. In other embodiments, one or more optical signals emitted from one or more emitting devices are used in the alignment of the interposer assembly 104 and the coupler assembly 102. In some embodiments, the optical isolator 132 may be aligned in conjunction with the interposer assembly 104 and the coupler assembly 102. In other embodiments, the interposer assembly 104 and a coupler assembly 102 configured without the optical isolator 132 may be firstly aligned, and followed by an alignment step in which the optical isolator 132 is subsequently mounted or otherwise formed in the cavity 146 and aligned.

In some embodiments of method 181, one or more of the positioning, aligning, and mounting of an optical isolator 132 may optionally be included in an earlier step of method 181. And in some embodiments of method 181, a partial PIC assembly may be firstly formed comprising the embodiment of coupler assembly 102 formed in step 181-4 of method 181, an interposer assembly 104, and FAU 156 configured having the one or more optical fibers 154, and the PIC assembly 101 may then be formed further comprising the partial PIC assembly and the optical isolator 132.

In some embodiments, FAU alignment aids 126 formed at the openings of the FAU mounting site 152 may be used to facilitate full or partial alignment of an FAU 156 configured having one or more optical fiber 154 with the one or more waveguide core 106_{core} of the coupler 100 in the PIC assembly 101. The upper openings of the FAU mounting sites 152, configured having FAU alignment aids 126, enable the positioning of FAU 156 between the vertical interior surfaces of the FAU alignment aids 126 that face the openings of the FAU mounting site 152 such that as the lateral position of the FAU 156 is maintained between the vertical surfaces of the FAU alignment aids 126 and the bottom surface of the FAU mounting site 152, the cores of the optical fibers 154 are brought into full or partial alignment with the waveguide cores 106_{core} or other optical axes on the coupler 100. In the embodiment shown in FIG. 21F, the FAU 156 is configured having four optical fibers 154 to facilitate the mounting and alignment of the four optical fibers 154 onto coupler 100 in the PIC assembly 101. In other embodiments, the FAU 156 may be configured having one or more optical fibers 154.

In some embodiments of PIC assembly 101, one or more T&G alignment aids 108 formed on the coupler 100 of the coupler assembly 102 may be coupled to one or more complementary T&G alignment aids 109 formed on the interposer 103 of an interposer assembly 104 to facilitate full or partial alignment of the waveguide cores 106_{core} of the coupler 100 with the waveguide cores 107_{core} of the interposer 103.

And in some embodiments, cavity alignment aids 128 formed at the flanking sidewalls may be used, for example, to align the optical isolator 132 within the cavity 146 of coupler 100 to facilitate efficient coupling of optical signals propagating through the optical isolator 132 to the on-facet lenses 138_{F2PP} formed on the facets of the waveguide cores 106_{core} on the outgoing side of the cavity 146.

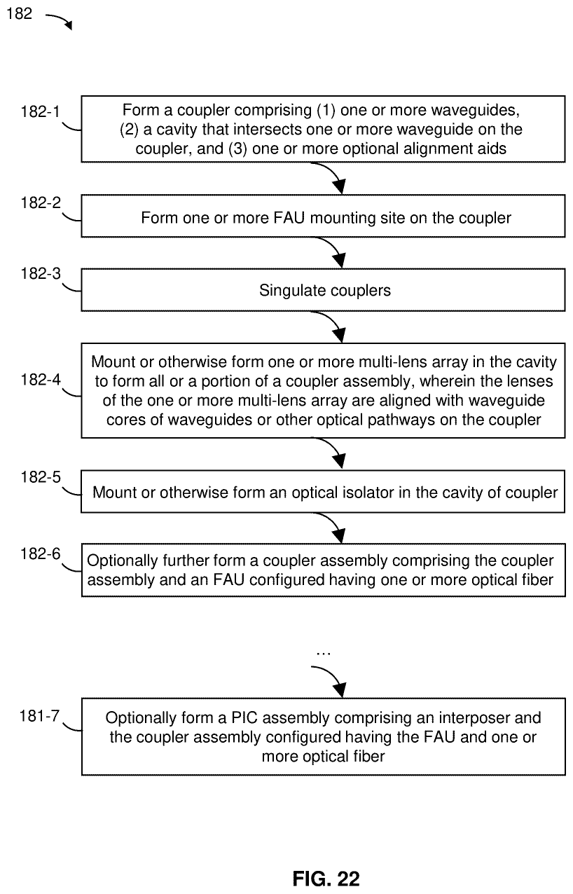

FIG. 22 shows a flowchart for a method 182 of forming other embodiments of coupler 100, other embodiments of coupler assembly 102, and other embodiments of PIC assembly 101 comprising coupler assembly 102 and interposer assembly 104 wherein coupler assembly 102 in these embodiments is configured having lenses 138 in first and second lens arrays 130-1,130-2, respectively, in cavity 146. In the formation of the embodiments using method 182, the coupler 100 is configured having an opening in the ingoing side of cavity 146 that enables, for example, free-space coupling of optical signals from an interposer 103 or other optical signal source to the MLA lenses 138_{MLA} of first multi-lens array 130_{MLA}-1 in cavity 146 of coupler 100. Embodiments of couplers 100 configured having such openings in the cavity 146 are shown, for example, in FIGS. 3B1 and 3B2.

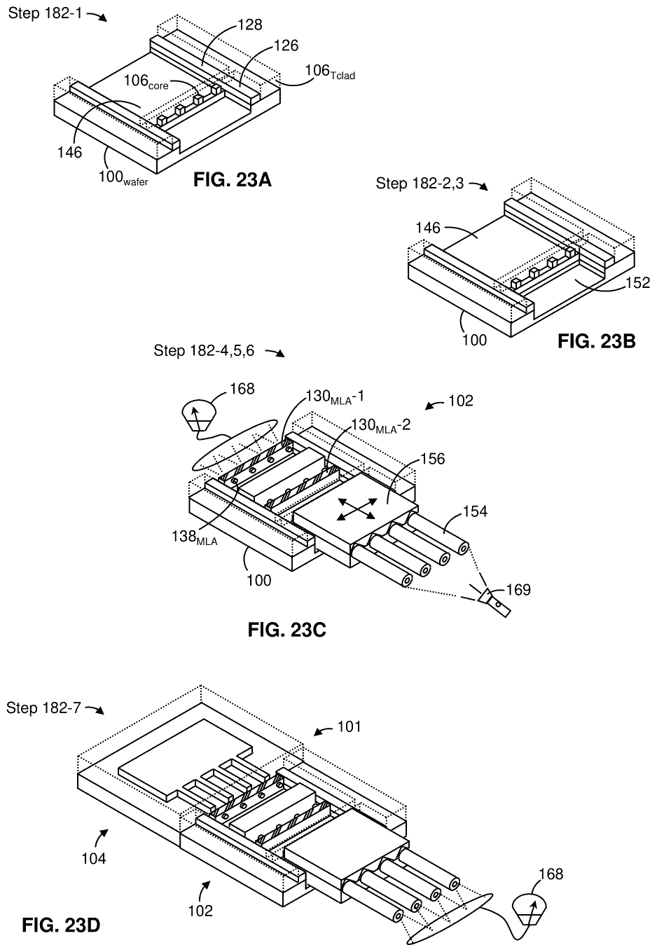

FIGS. 23A-23D show perspective schematic drawings of embodiments of the coupler 100, coupler assembly 102, and PIC assembly 101 at various steps in the process of formation using method 182. The steps in the method 182 of FIG. 22 are described in conjunction with the perspective schematic drawings in FIGS. 23A-23D.

Step 182-1 of method 182 shown in FIG. 22 is a forming step in which an embodiment of a coupler 100 comprising a cavity and optional alignment aids is formed. Embodiments of coupler 100 may be formed, for example, using method 195 shown in FIG. 14 described herein in conjunction with FIGS. 15A1-15F3.

FIG. 23A shows a perspective schematic drawing of an embodiment of coupler 100_{wafer} after Step 182-1 of method 182. The embodiment of coupler 100_{wafer} in FIG. 23A is shown configured having cavity 146 and optional alignment aids wherein the cavity 146 is configured having an opening in the ingoing side to facilitate free-space coupling of optical signals from an interposer 103 or other optical signal source to MLA lenses 138_{MLA} of a first multi-lens array 130_{MLA}-1 mounted or otherwise formed in the cavity 146. The outgoing side of cavity 146 is configured having waveguides 106 between the outgoing wall of cavity 146 and FAU mounting site 152. The embodiment of coupler 100_{wafer} shown in FIG. 21A is configured having FAU alignment aids 126 at the opening of the FAU mounting site 152 and cavity alignment aids 128 formed at the opening of the cavity 146 on the sidewalls flanking the optical pathways through the cavity 146 (the flanking sidewalls of cavity 146 are as identified in FIG. 21B).

In the embodiment of the coupler shown in FIG. 23A, the coupler shown is labeled having coupler 100_{wafer}. The suffix “wafer” added to the label “100” as in “100_{wafer}”, indicates that the coupler is a portion of an unsingulated coupler wafer having a plurality of couplers 100_{wafer} as further described herein. The suffix is not used in the perspective drawings of the coupler in the steps following the singulation step to indicate that the coupler 100 is a singulated coupler.

The embodiment of the coupler 100_{wafer} is formed from a layered structure comprising a planar waveguide layer 105_{cplr} formed on a substrate 110_{cplr}. The layered structure may optionally include an electrical interconnect layer 133_{cplr} formed on the substrate 110_{cplr} wherein the planar waveguide layer 105 may be formed on the optional electrical interconnect layer 133_{cplr}. A top cladding layer 106_{Tclad} is shown as transparent in the perspective drawings in FIG. 23A-23E with dotted lines on the periphery to more clearly illustrate key features underlying the top cladding layer in the structure of the embodiments of the couplers shown in the drawings.

The embodiment of the coupler 100_{wafer} shown in FIG. 23A is configured having FAU alignment aids 126 at a portion of the periphery of the upper opening of the FAU mounting site 152 and cavity alignment aids 128 formed in the sidewalls in the flanking sides at the upper opening of the cavity 146. FAU alignment aids 126 and cavity alignment aids 128, in the embodiment of the coupler 100_{wafer}, may be formed in self-alignment with the waveguide cores 106_{core}. Although not shown in FIG. 23A, other lateral alignment aids such as T&G lateral alignment aids 108 and fiducials 114, among other alignment features, may also be included in the formation of other embodiments. Because the lateral alignment aids and the waveguide cores 106_{core} are formed from the same patterned layer, the relative positioning between the lateral alignment aids and the waveguide cores 106_{core} are within the dimensional resolution of the lithographic patterning method and the resolution of the subsequent patterning method used to pattern the layer or layers underlying the patterned layer.

Lateral alignment aids that are formed in self-alignment with the waveguide cores 106_{core} may be used to align two devices or features that are brought together in the formation of an assembly. In an embodiment, for example, in which a cavity alignment aid 128 is formed at one or more wall of cavity 146, the cavity alignment aid 128 may be used in the alignment of an optical isolator 132 with the waveguide cores 106_{core} formed at another wall of cavity 146 due to the self-alignment of the cavity alignment aids 128 and the waveguide cores 106_{core}. In another embodiment, for example, in which coupler 100 is configured having T&G alignment aids 108 formed self-aligned with, and a significant distance from, the waveguide cores 106_{core} of the coupler 100, the T&G alignment aids 108 of the coupler 100 may be used to align the waveguide cores 106_{core} of the coupler 100 with the waveguide cores 107_{core} of an interposer 103 configured having complementary T&G alignment aid 109.

Step 182-2 of method 182 shown in FIG. 22 is a forming step in which one or more FAU mounting site 152 is formed on the coupler 100_{wafer}. A method of forming FAU mounting site 152 is described, for example, in method 195 of FIG. 14, and in the cross-section drawings in FIGS. 15A1-15F1. In embodiments, one or more FAU mounting site 152 may be formed on the coupler 100.

Step 182-3 of method 182 shown in FIG. 22 is a singulating step in which the unsingulated coupler wafer 100_{wafer} comprising a plurality of couplers 100 is singulated into two or more singulated couplers 100. In some embodiments, unsingulated coupler wafer 100_{wafer} is diced or otherwise singulated into individual couplers. In other embodiments, unsingulated coupler wafer 100_{wafer} is diced or otherwise singulated into couplers having one or more coupler on a singulated chip. In some embodiments, for example, having two or more couplers that remain unsingulated may be preferable to singulating the couplers into fully singular devices. And in yet other embodiments, unsingulated coupler wafer 100_{wafer} may be singulated in chips having two or more couplers on a singulated chip.

FIG. 23B shows a perspective schematic drawing of an embodiment of coupler 100 after Steps 182-2 and 182-3 of method 182. In the embodiment of coupler 100 shown in FIG. 23B, the ingoing side of the cavity 146 is shown configured having an opening to enable free-space coupling of optical signals, for example, from an interposer assembly 104 or other optical signal source, and in the embodiment, the outgoing side of the cavity 146 is configured having waveguide cores 106_{core} of waveguides 106.

Singulated couplers 100 may be used in the formation of coupler assemblies 102 comprising singulated coupler 100, one or more lens array 130, optical isolator 132, and optionally comprising FAU 156 configured having one or more optical fiber 154.

Step 182-4 of method 182 shown in FIG. 22 is a mounting step in which one or more multi-lens arrays 130_{MLA} are mounted or otherwise formed in cavity 146 of coupler 100 to form all or a portion of a coupler assembly 102 comprising the coupler 100 and the one or more multi-lens arrays 130_{MLA}, wherein the lenses of the one or more multi-lens array 130_{MLA} are aligned with waveguide cores 106_{core} of waveguides 106 or other optical pathways on the coupler 100.

Step 182-5 of method 182 shown in the flowchart in FIG. 22, is a mounting step in which an optical isolator 132 is mounted or otherwise formed in the cavity 146 of the coupler 100.

Step 182-6 of method 182 shown in FIG. 22 is a forming step in which the coupler assembly 102 is optionally further formed comprising an FAU 156 configured having one or more optical fiber 154, and comprising the coupler assembly 102 formed after step 184-5 configured having the coupler 100, two multi-lens arrays 130_{MLA}, and optical isolator 132.

FIG. 23C shows a perspective schematic drawing of an embodiment of the coupler assembly 102 after steps 182-4 to 182-6. The coupler assembly 102 of FIG. 23C shows the embodiment of coupler 100 of FIG. 23B, first and second multi-lens arrays 130_{MLA}-1, 130_{MLA}-2, respectively, and optical isolator 132 after mounting of the first and second multi-lens arrays 130_{MLA}-1,130_{MLA}-2 and the optical isolator 132 in cavity 146 and mounting of the FAU 156 configured having four optical fibers 154 onto FAU mounting site 152 on the coupler 100.

MLA lenses 138_{MLA}, mounted or otherwise formed in the cavity 146 in the embodiment, are receptive to optical signals that may be one or more of collected, narrowed, collimated, and focused, among other altering effects of propagating through the lens. MLA lenses 138_{MLA} of first multi-lens array 130_{MLA}-1 may facilitate, for example, improved coupling to the MLA lenses 138_{MLA} of second multi-lens array 130_{MLA}-2, and subsequently to the waveguide cores 106_{core} at the outgoing side of the cavity 146.

In an example of an optical signal propagating through the embodiment of a coupler assembly 102 configured having a first and a second multi-lens array 130_{MLA}-1,130_{MLA}-2, respectively, an optical signal incident on an MLA lens 138_{MLA} of the first multi-lens array 130_{MLA}-1 is collimated as it propagates through the MLA lens 138_{MLA} of the first multi-lens array 130_{MLA}-1 to an MLA lens 138_{MLA} of the second multi-lens array 130_{MLA}-2 in the cavity 146. In the example, the collimating that results from the propagation through the MLA lens of the first multi-lens array 130_{MLA}-1 leads to a reduction in spot size in comparison to an uncollimated optical signal, and the reduction in spot size leads to improved coupling of the optical signal to the MLA lens 138_{MLA} of the second multi-lens array 130_{MLA}-2. The MLA lens 138_{MLA} of the second multi-lens array 130_{MLA}-2 may be configured, for example, as a focusing lens, such that the collimated optical signal incident on the MLA lens 138_{MLA} configured as a focusing lens further reduces the spot size of the optical signal as it propagates through MLA lens 138_{MLA} of the second multi-lens array 130_{MLA}-2 to a waveguide facet on the wall of cavity 146.

In some embodiments, cavity alignment aids 128 may be used to facilitate the all or a portion of an alignment step to align the MLA lenses 138_{MLA} of the first and second multi-lens arrays 130_{MLA}-1,130_{MLA}-2, respectively, with one or more of waveguide cores 106_{core} on the coupler 100 and off-chip optical signal sources. In some embodiments, FAU alignment aids 126 may be used to facilitate the alignment of the FAU 156 and the cores of optical fibers 154 mounted on the FAU 156, with the one or more of waveguide cores 106_{core} on the coupler 100.

In other embodiments, an optical signal source such as optical signal source 169 shown in FIG. 23C, may be used in conjunction with alignment apparatus 168 to facilitate the alignment of one or more of the MLA lenses 138_{MLA} of the first and second multi-lens arrays 130_{MLA}-1,130_{MLA}-2, the optical isolator 132, and the cores of the optical fibers 154 in the FAU 156 in the coupler assembly 102. In the embodiment shown in FIG. 23C, optical signal source 169 provides an optical signal through one or more of the optical fibers 154 in FAU 156, and optionally through one or more of the first and second multi-lens arrays 130_{MLA}-1,130_{MLA}-2, and optionally through the optical isolator 132 to a detector of alignment apparatus 168.

In an example alignment, optical signals propagating through one or more optical fiber 154 in the FAU 156 are coupled through one or more of the waveguide cores 106_{core} of waveguides 106 on the coupler 100. These optical signals, emerging from the waveguide cores 106_{core} in cavity 146 to the lenses 138_{MLA} of the multi-lens arrays 138_{MLA}-1, 138_{MLA}-2 and coupled to an optical signal detector of alignment apparatus 168, are detected, for example, by a detector of alignment apparatus 168 allowing for adjustments to be made to the positions of one or more of the FAU 156 configured having the optical fibers 154, the second multi-lens array 130_{MLA}-2, and the first multi-lens array 130_{MLA}-1. In an aligned position in which the cores of the optical fibers 154 are satisfactorily aligned with the optical axes of the waveguide cores 106_{core}, and the lenses 138_{MLA} of the first and second multi-lens arrays 138_{MLA}-1, 138_{MLA}-2, respectively, the monitored optical signal on the detector of the alignment apparatus 168 reaches an acceptable value or level in the example approach. Upon alignment, the FAU 156, and the first and second multi-lens arrays may be secured in place using an epoxy or other bonding material. After the FAU 156 and the multi-lens arrays have been secured in position in the cavity 146, the optical isolator may then be positioned within the cavity 146 between the first and second lens arrays 138_{MLA}-1, 138_{MLA}-2, respectively, aligned using, for example, the alignment apparatus 168, and secured in an aligned position.

In some embodiments of method 182, the FAU 156, and the optical fibers 154 mounted thereon, may be firstly aligned with a first or second multi-lens array in the cavity 146 and then secured in position. The second of either the first or second multi-lens array in the cavity 146 may then be aligned and secured in position.

In some embodiments, the FAU 156 configured having the optical fibers 154 may be aligned and secured in position with one or more of the first and second multi-lens arrays 130_{MLA}-1,130_{MLA}-2. And in some embodiments, the FAU 156 configured having the optical fibers 154 may be firstly aligned and secured in position with one of the first and second multi-lens arrays 130_{MLA}-1,130_{MLA}-2 and secondly the other of the first and second multi-lens arrays may be then aligned and secured in an aligned position in cavity 146, and followed by aligning and securing of the optical isolator 132 in cavity 146. In some embodiments, the FAU configured having the optical fibers 154 may be aligned and secured in position, followed by the alignment and securing of a first multi-lens array 130_{MLA}-1, followed by the aligning and securing of a second multi-lens array 130_{MLA}-2, and followed by an aligning and securing of the optical isolator 132. In other embodiments, the FAU 156 configured having the optical fibers 154 may be aligned and secured in position, followed by the alignment and securing of a second multi-lens array 130_{MLA}-2, followed by the aligning and securing of a first multi-lens array 130_{MLA}-1, and followed by an aligning and securing of the optical isolator 132. In yet other embodiments, FAU 156 configured having the optical fibers 154 may be aligned and secured in position, followed by the alignment and securing of first and second multi-lens arrays 130_{MLA}-1,130_{MLA}-2, and followed by the aligning and securing of an optical isolator 132. Other sequences may also be utilized in the alignment of the FAU 156, the first and second multi-lens arrays 130_{MLA}-1,130_{MLA}-2, and the optical isolator 132 in embodiments of method 182.

Step 182-7 of method 182, shown in the flowchart in FIG. 22, is an optional forming step in which a PIC assembly 101 is optionally formed comprising the embodiment of the coupler assembly 102 of FIG. 23C and an interposer 103 or interposer assembly 104.

FIG. 23D shows a perspective schematic drawing of an embodiment of PIC assembly 101 after optional forming step 182-7. The embodiment of PIC assembly 101 shown in the perspective schematic drawing in FIG. 23D comprises an embodiment of interposer assembly 104 and the embodiment of coupler assembly 102 formed using steps 182-1 to 182-6 of method 182, wherein the coupler assembly 102 comprises coupler 100 configured having a cavity 146, first and second multi-lens arrays 130_{MLA}-1, 130_{MLA}-2, respectively, mounted or otherwise formed in cavity 146, optical isolator 132, and four optical fibers 154 mounted or otherwise formed in FAU 156 on coupler 100. Interposer assembly 104 of the PIC assembly 101 includes interposer 103 and optionally includes one or more optical emitting device, among other optional devices.

Alignment apparatus 168, shown in FIG. 23D, may be used to facilitate alignment of the waveguide cores 107_{core} of the interposer 103 with the MLA lenses 138_{MLA} of the first and second multi-lens arrays 130_{MLA}-1,130_{MLA}-2 and to the waveguide cores 106_{core} of the coupler 100 in the embodiment. In an example alignment process, one or more emitting device on or coupled to the interposer assembly 104 provides one or more optical signals through one or more waveguide core 107_{core} of the interposer 103 to one or more MLA lens 138_{MLA} of the first multi-lens array 130_{MLA}-1 in cavity 146 of the coupler 100. The opening in the cavity 146 facing the interposer 103 in the embodiment of the coupler 100, enables direct coupling of optical signals from the waveguides 107 on the interposer 103 to the MLA lenses 138_{MLA} of the first multi-lens array 130_{MLA}-1 without an intervening waveguide 106 in the embodiment.

The alignment apparatus 168 is configured to be receptive to the optical signals propagating through the first and second multi-lens arrays 130_{MLA}-1, 130_{MLA}-2 and optical isolator 132 in cavity 146, and the waveguide cores 106_{core} between the outgoing side of the cavity 146 of coupler 100 and the terminal facets of the cores of the optical fibers 154 in FAU 156. Alignment apparatus 168 may be used to detect one or more characteristics of the one or more optical signals propagating through the PIC assembly 101 enabling adjustments to be made in the relative positioning of the interposer assembly 104 and the coupler assembly 102 and enabling improvements in the alignment of the waveguide cores 107_{core} of the interposer 103 with the MLA lenses 138_{MLA} of the first multi-lens array 130_{MLA}-1 in cavity 146 of the coupler assembly 102. In an example alignment step using alignment apparatus 168, four optical emitting devices of PIC 118 on the interposer assembly 104 are electrically powered such that optical signals are emitted from the optical emitting devices to the waveguide cores 107_{core}. The coupler assembly 102 is positioned such that the MLA lenses 138_{MLA} of the first multi-lens array 130_{MLA}-1 in cavity 146 of the coupler assembly 102 are receptive to the optical signals from the interposer assembly 104, and such that all or a portion of the optical signal power propagating through the pre-aligned optical components in the coupler assembly 102, in the embodiment, are detectable by alignment apparatus 168. In an embodiment, the relative positions of the interposer assembly 104 and the coupler assembly 102 are varied to enable the detected optical signal power to be maximized. Other optical signal parameters may also be used to detect alignment between the waveguide cores 107_{core} of the interposer 103 and the optical components of the coupler assembly 102. In some embodiments, the optical signals emitted from two emitting devices are used in the alignment of the interposer assembly 104 and the coupler assembly 102. In other embodiments, one or more optical signals emitted from one or more emitting devices are used in the alignment of the interposer assembly 104 and the coupler assembly 102.

In some embodiments, optical isolator 132 may be aligned in conjunction with the alignment of the interposer assembly 104 and the coupler assembly 102.

In some embodiments, the alignment of the coupler assembly 102 and the interposer assembly 104 may be facilitated fully or in part with T&G alignment aids 108 formed on the coupler 100 and T&G alignment aids 109 formed on the interposer 103. In some embodiments, T&G alignment aids 108 formed on the coupler 100 may be coupled to complementary T&G alignment aids 109 formed on the interposer 103 to facilitate lateral alignment of the waveguide cores 106_{core} on the coupler 100 with the waveguide cores 107_{core} or other optical pathways of the interposer assembly 104. In some embodiments, T&G alignment aids 108 formed on the coupler 100 may be coupled to complementary T&G alignment aids 109 formed on the interposer 103 to facilitate lateral alignment of the waveguide cores 106_{core} of the coupler assembly 102 and the waveguide cores 107_{core} or other optical pathways of the interposer assembly 104, and alignment apparatus 168 may be used to vertically align the waveguide cores 106_{core} of the coupler 100 with the waveguide cores 107_{core} or other optical pathways of the interposer assembly 104.

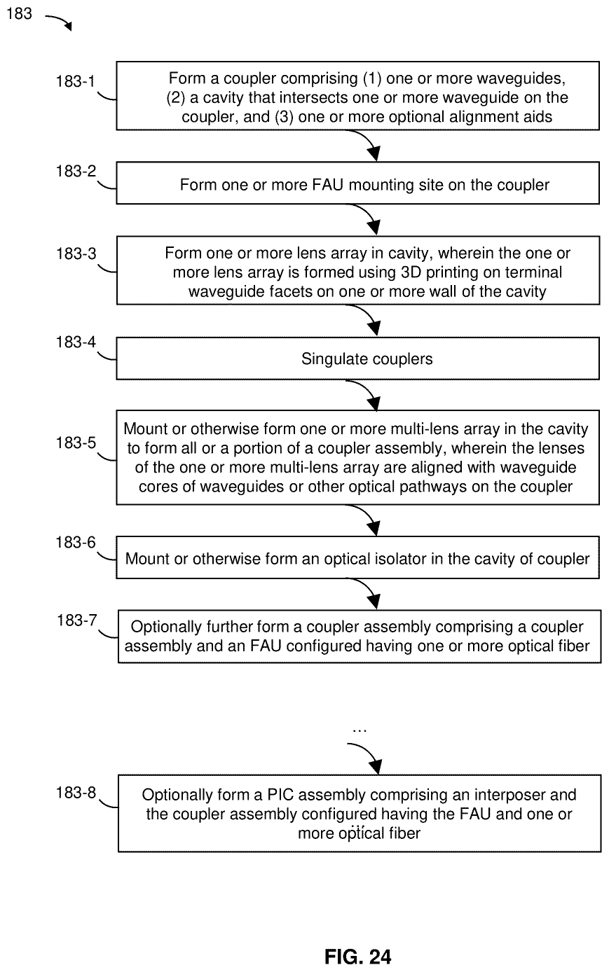

FIG. 24 shows a flowchart for a method 183 of forming yet other embodiments of coupler 100, yet other embodiments of coupler assembly 102, and yet other embodiments of PIC assembly 101 comprising coupler assembly 102 and interposer assembly 104, wherein coupler assembly 102 in these embodiments is configured having on-facet lenses 138_{F2PP} formed on ingoing waveguide facets in cavity 146 using two-photon polymerization in an on-facet lens array 130_{F2PP} formed on an ingoing side of cavity 146, and MLA lenses 138_{MLA} of a multi-lens array 130_{MLA} mounted or otherwise formed in cavity 146 of coupler 100. In the formation of the embodiments using method 183, the embodiment of coupler 100 is configured having one or more waveguides 106 formed on the ingoing side of cavity 146 and having an opening formed on the outgoing side of the cavity 146 that faces an FAU mounting site 152 formed on the coupler 100. An embodiment of a coupler 100 configured having waveguides 106 formed on the ingoing side of the cavity 146 and an opening in the outgoing side of cavity 146 that faces an FAU mounting site 152 formed on the coupler 100 is shown, for example, in FIGS. 3C1-3C2.

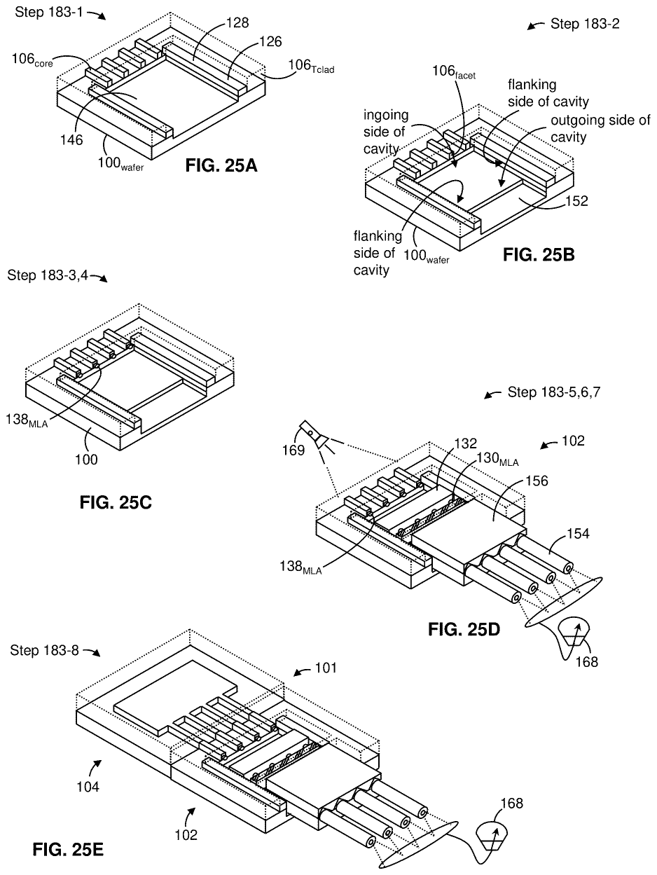

FIGS. 25A-25E show perspective schematic drawings of embodiments of the coupler 100, coupler assembly 102, and PIC assembly 101 at various steps in the process of formation using method 183. The steps in the method 183 of FIG. 24 are described in conjunction with the perspective schematic drawings in FIGS. 25A-25E.

Step 183-1 of method 183 shown in the flowchart of FIG. 24, is a forming step in which an embodiment of a coupler comprising a cavity and optional alignment aids is formed. Embodiments of coupler 100 may be formed, for example, using method 195 shown in FIG. 14 described herein in conjunction with FIGS. 15A1-15F3.

FIG. 25A shows a perspective schematic drawing of an embodiment of coupler 100_{wafer} after Step 183-1. The embodiment of the coupler 100_{wafer} in FIG. 25A is shown configured having cavity 146 and optional alignment aids 126,128, wherein the ingoing side of the cavity 146 is configured having terminal facets of the waveguide cores 106_{core} formed on the sidewalls on the ingoing side of the cavity 146, and wherein the outgoing side of the cavity 146 is configured having an opening to facilitate free-space coupling of optical signals from MLA lenses 138_{MLA} of a multi-lens array 130_{MLA} mounted or otherwise formed in the cavity 146 to the terminal facets of optical fibers 154 mounted or otherwise formed in FAU 156 mounted or otherwise formed on an FAU mounting site 152 on coupler 100. The terminal facets of the waveguide cores 106_{core} formed on the ingoing side of cavity 146, in the embodiment, facilitates coupling of ingoing optical signals emerging from the facets of the waveguide cores 106_{core} to on-facet lenses 138_{F2PP} formed on the facets. MLA lenses 138_{MLA} of the multi-lens 130_{MLA}, mounted or otherwise formed in the cavity 146 in the embodiment, are receptive to optical signals propagating through the on-facet lenses 138_{F2PP} formed on the ingoing facets that may be one or more of collected, narrowed, collimated, and focused, among other altering effects of propagating through the lenses. On-facet lenses 138_{F2PP} may facilitate, for example, improved coupling to the MLA lenses 138_{MLA} of the multi-lens array 130_{MLA}, and subsequently to the terminal facets of the cores of the optical fibers 154 mounted or otherwise formed in the FAU 156 in an FAU mounting site on coupler 100.

In the embodiment of the coupler shown in FIG. 25A, the coupler shown is labeled having coupler 100_{wafer}. The suffix “wafer” added to the label “100” as in “100_{wafer}”, indicates that the coupler is a portion of an unsingulated coupler wafer comprising a plurality of couplers 100_{wafer} as further described herein. In the sequence of perspective drawings used to illustrate the formation of embodiments of the singulated couplers 100, the suffix “wafer” is no longer used in the perspective drawings in the steps following the singulation step to distinguish wafer level processes on unsingulated couplers 100_{wafer} from the singulated couplers 100.

The embodiment of the coupler 100_{wafer} is formed from a layered structure comprising a planar waveguide layer 105_{cplr} formed on a substrate 110_{cplr}. The layered structure may optionally include an electrical interconnect layer 133_{cplr} formed on the substrate 110_{cplr} wherein the planar waveguide layer 105 may be formed on the optional electrical interconnect layer 133_{cplr}. A top cladding layer 106_{Tclad} is shown as transparent in the perspective drawings in FIG. 25A-25E with dotted lines on the periphery to more clearly illustrate key features underlying the top cladding layer in the structure of the coupler shown in the drawings.

The embodiment of the coupler 100_{wafer} is shown in FIG. 25A is configured having FAU alignment aids 126 formed at a portion of the periphery of the upper opening of the FAU mounting site 152 and cavity alignment aids 128 formed in the sidewalls in the flanking sides at the upper opening of the cavity 146. FAU alignment aids 126 and cavity alignment aids 128, in the embodiment of the coupler 100_{wafer}, may be formed in self-alignment with the waveguide cores 106_{core} to facilitate alignment of devices or features with other features formed in self-alignment with the alignment features and the waveguide cores 106_{core}. Although not shown in FIG. 25A, other lateral alignment aids such as T&G lateral alignment aids 108 and fiducials 114 may also be included in the formation of other embodiments. Because the lateral alignment aids and the waveguide cores 106_{core} are formed from the same patterned layer, the relative positioning between the lateral alignment aids and the waveguide cores 106_{core} are within the dimensional resolution of the lithographic patterning method and the resolution of the subsequent patterning method used to pattern the layer or layers underlying the patterned layer.

Lateral alignment aids that are formed in self-alignment with the waveguide cores 106_{core} may be used to align two devices or features in the formation of an assembly. In some embodiments, the lateral alignment aids used to align a first device or feature may be formed in a location on the coupler 100 that is a significant distance from a second device or feature on the coupler 100, for example, to which the first device or feature is to be aligned in the formation of an assembly comprising the first device or feature and the second device or feature. In an embodiment, for example, in which a cavity alignment aid 128 is formed at one or more wall of cavity 146, the cavity alignment aid 128 may be used in the alignment of an optical isolator 132 with the waveguide cores 106_{core} formed at another wall of cavity 146 due to the self-alignment of the cavity alignment aids 128 and the waveguide cores 106_{core}. In another embodiment, for example, in which coupler 100 is configured having T&G alignment aids 108 formed self-aligned with, and a significant distance from, the waveguide cores 106_{core} of the coupler 100, the T&G alignment aids 108 of the coupler 100 may be used to align the waveguide cores 106_{core} of the coupler 100 with the waveguide cores 107_{core} of an interposer 103 configured having complementary T&G alignment aids 109.

Step 183-2 of method 183 shown in FIG. 24 is a forming step in which one or more FAU mounting site 152 is formed in the coupler 100_{wafer}. A method of forming FAU mounting site 152 is described, for example, in method 195 of FIG. 14, and in the cross-section drawings in FIGS. 15A1-15F1.

FIG. 25B shows a perspective schematic drawing of an embodiment of coupler 100_{wafer} after formation of FAU mounting site 152 on coupler 100_{wafer}. Also shown in FIG. 25B are labels for the four sides of cavity 146 to identify the ingoing side of the cavity 146, the outgoing side of the cavity 146, and the two flanking sides of the cavity 146.

In the embodiment of coupler 100_{wafer} shown in FIG. 25B, the ingoing side of the cavity 146 is configured having waveguide cores 106_{core} of waveguides 106 through which optical signals may propagate to lenses formed in the cavity, and the outgoing side of the cavity 146 is shown configured having an opening to enable free-space coupling of optical signals from the MLA lenses 138_{MLA} of multi-lens array 130_{MLA} to the terminal facets of the cores of optical fibers 154 mounted or otherwise formed in FAU 156 in the embodiment.

Step 183-3 of method 183 shown in the flowchart in FIG. 24 is a forming step in which one or more lens array is formed in cavity 146, wherein the one or more lens array 130 is formed using 3D printing on terminal waveguide facets on one or more wall of the cavity 146. In an embodiment, on-facet lenses 138_{F2PP} of an on-facet lens array 130_{F2PP} are formed on the waveguide facets formed in the sidewall of the ingoing side of cavity 146 of coupler 100_{wafer}.

Step 183-4 of method 183 shown in FIG. 24 is a singulating step in which the unsingulated coupler wafer comprising a plurality of couplers 100_{wafer} is singulated into two or more singulated couplers 100. In some embodiments, an unsingulated coupler wafer is diced or otherwise singulated into individual couplers. In other embodiments, an unsingulated coupler wafer is diced or otherwise singulated into couplers having one or more coupler on a singulated chip. In some embodiments, for example, having two or more couplers that remain unsingulated, may be preferable to singulating the couplers into fully singular devices. And in yet other embodiments, an unsingulated coupler wafer may be singulated in chips having two or more couplers on a singulated chip.

FIG. 25C shows a perspective schematic drawing of an embodiment of coupler 100 after (1) formation of on-facet lenses 138_{F2PP} of on-facet lens array 130_{F2PP} on waveguide facets on the ingoing side of cavity 146 and (2) singulation of the coupler wafer. In the embodiment, coupler 100_{wafer} is configured having waveguide facets on the ingoing side of the cavity 146. The presence of the facets, in the embodiment of the coupler 100_{wafer}, enables the use of the 3D printed lenses formed on the facets as described, for example, in conjunction with the description of the two-photon polymerization apparatus shown in FIG. 17A. FIG. 25C shows the coupler 100 after singulation having the on-facet lens array 130_{F2PP} formed in cavity 146.

Step 183-5 of method 183 shown in FIG. 24 is a mounting step in which one or more multi-lens array 130_{MLA} is mounted or otherwise formed in the cavity 146 to form all or a portion of a coupler assembly 102, wherein the lenses 138_{MLA} of the one or more multi-lens array 130_{MLA} are aligned with waveguide cores 106_{core} of waveguides 106 or other optical pathways on the coupler 100. Following step 183-5, embodiments of coupler assembly 102 may be formed wherein the coupler assembly 102 comprises a coupler 100 configured having an on-facet lens array 130_{F2PP} formed using 3D printing on waveguide facets in cavity 146 and a multi-lens array 130_{MLA}.

Step 183-6 of method 183 shown in the flowchart in FIG. 24, is a mounting step in which an optical isolator 132 is mounted or otherwise formed cavity 146 of coupler 100. Following step 183-6, embodiments of coupler assembly 102 may be formed wherein the coupler assembly 102 comprises a coupler 100 configured having an on-facet lens array 130_{F2PP}, a multi-lens array 130_{MLA}, and an optical isolator 132 in cavity 146.

Step 183-7 of method 183 shown in the flowchart in FIG. 24, is an optional forming step in which embodiments of coupler assembly 102 may be further formed comprising the coupler assembly 102 formed in step 183-6 and an FAU 156 configured having one or more optical fiber 154 mounted or otherwise formed on coupler 100 of the coupler assembly 102. Following step 183-7, embodiments of coupler assembly 102 may be formed wherein the coupler assembly 102 comprises a coupler 100 configured having an on-facet lens array 130_{F2PP}, a multi-lens array 130_{MLA}, and an optical isolator 132 in cavity 146, and an FAU 156 configured having one or more optical fibers 154.

FIG. 25D shows a perspective schematic drawing of an embodiment of coupler assembly 102 after steps 183-5, 183-6, and 183-7. The perspective schematic drawing in FIG. 25D shows an embodiment of the coupler assembly 102 comprising coupler 100, on-facet lens array 130_{F2PP}, optical isolator 132, and multi-lens array 130_{MLA} after mounting of the multi-lens array 130_{MLA} and the optical isolator 132 in cavity 146 and mounting of FAU 156 configured having four optical fibers 154 on the coupler 100.

In some embodiments, cavity alignment aids 128 may be used to facilitate the alignment of the MLA lenses 138_{MLA} of the multi-lens array 130_{MLA} with one or more of waveguide cores 106_{core} on the coupler 100 and with the cores of the optical fibers 154 mounted in the FAU 156. In some embodiments, FAU alignment aids 126 may be used to facilitate alignment of the cores of the optical fibers 154 mounted or otherwise formed in the FAU 156 with the one or more of waveguide cores 106_{core} and on-facet lenses 138_{F2PP} formed on the facets of the waveguide cores 106_{core} on the coupler 100, and the MLA lenses 138_{MLA} of the multi-lens array 130_{MLA}.

In other embodiments, an optical signal source such as optical signal source 169 shown in FIG. 25D, may be used in conjunction with alignment apparatus 168 to facilitate the alignment of one or more of the MLA lenses 138_{MLA} of the multi-lens array 130_{MLA}, the optical isolator 132, and the cores of the optical fibers 154 in the FAU 156 with the waveguide cores 106_{core} and on-facet lenses 138_{F2PP} formed on the facets of these waveguide cores 106_{core} in cavity 146. No active alignment is required for the on-facet lenses 138_{F2PP} and the waveguide cores 106_{core}.

In the embodiment shown in FIG. 25D, optical signal source 169 may be used to provide an optical signal through one or more of the waveguides 106, one or more on-facet lenses 138_{F2PP} formed on the facets of the waveguide cores 106_{core} in cavity 146, one or more MLA lenses 138_{MLA} of multi-lens array 130_{MLA}, and one or more optical fibers 154 positioned in FAU 156 on the FAU mounting site 152 on coupler 100.

In an example of an optical signal propagating through the embodiment of a coupler assembly 102 configured having an on-facet lens array 130_{F2PP} formed on the facets of waveguide cores 106_{core} on the ingoing side of cavity 146 and a multi-lens array 130_{MLA}, an optical signal emerging from a waveguide core 106_{core} at the ingoing sidewall of cavity 146 and incident on an on-facet lens 138_{F2PP} of the first lens array 146-1, is collimated as it propagates through the on-facet lens 138_{F2PP} of the first on-facet lens array 130_{F2PP} to MLA lens 138_{MLA} of the multi-lens array 130_{MLA} in the cavity 146. In the example, the collimating that results from the propagation through the lens of the on-facet lens array 130_{F2PP} leads to a reduction in spot size in comparison to an uncollimated optical signal, and the reduction in spot size leads to improved coupling of the optical signal to the MLA lens 138_{MLA} of the multi-lens array 130_{MLA}. The MLA lenses 138_{MLA} of the multi-lens array 130_{MLA} may be configured, for example, as a focusing lens, such that the collimated optical signal incident on the MLA lens 138_{MLA} configured as a focusing lens further reduces the spot size of the optical signal as it propagates through MLA lens 138_{MLA} of the multi-lens array 130_{MLA} to a terminal facet of an optical fiber 154 mounted or otherwise formed in a FAU 156 in the embodiment.

In an example alignment process, the optical signal source 169 is coupled to the one or more waveguide cores 106_{core} and the optical signal power propagating through the one or more waveguide cores 106_{core} and the on-facet lenses 138_{F2PP} formed on the facets of these waveguide cores 106_{core} in cavity 146, the one or more MLA lenses 138_{MLA} of the multi-lens array 130_{MLA}, and the one or more optical fiber 154 is monitored using alignment apparatus 168. Adjustments may be made to the relative positions of the multi-lens array 130_{MLA} and the FAU 156 configured having the one or more optical fiber 154 while monitoring the optical power emerging from the optical fibers 154. In a position in which the cores of the optical fibers 154 are most aligned with the optical axis of the waveguide core 106_{core}, in the example, the on-facet lenses 138_{F2PP} formed on the facets of the waveguide cores 106_{core}, and the MLA lenses 138_{MLA} of the multi-lens array 130_{MLA}, the anticipated measured optical signal is a maximum in this example. Upon alignment, the multi-lens array 130_{MLA} and the FAU 156 in the example alignment process may be secured in place using an epoxy or other bonding material.

Unlike the embodiments of the coupler assembly 102 configured having only 3D printed lenses, embodiments of coupler assembly 102 configured having multi-lens array 130_{MLA} require that the array of lenses 138_{MLA} on the multi-lens array 130_{MLA} be aligned in a same alignment step. Alignment of the array of MLA lenses 138_{MLA} in the multi-lens arrays 130_{MLA} preferably uses two or more of the optical fibers 154 in the FAU 156.

In an example alignment step for the MLA lenses 138_{MLA} of the multi-lens array 130_{MLA} shown in FIG. 25D, optical signal power may be coupled to the two distal or outermost waveguide cores 106_{core} of the array of four waveguide cores 106_{core} on coupler 100, and monitored upon emergence from the terminal ends of the two optical fibers 154 coupled to these two distal waveguide cores 106_{core}. The relative positions of the coupler 100 and waveguide cores 106_{core} formed thereon, the multi-lens array 130_{MLA}, and the FAU 156 may be adjusted while monitoring the output power from the two distal or outermost optical fibers 154 in the FAU 156 until a maximum output power through the optical fibers 154 is measured at the detector of the alignment apparatus 168. The multi-lens array 130_{MLA} and the FAU 156 may then be secured in aligned positions with an epoxy or other bonding material or method of securing. Use of the two distal or outer lenses of the multi-lens array 130_{MLA} may be used to facilitate alignment of the entire array due to the matching of the spacing of the MLA lenses 138_{MLA} of the multi-lens array 130_{MLA}, the spacing of the waveguide cores 106_{core} on the coupler 100, and the spacing of the optical fibers 154 in the FAU 156.

In some embodiments of method 183, optical isolator 132 may be positioned in cavity 146, aligned, and secured in an aligned position in conjunction with the multi-lens array 130_{MLA}. In some embodiments of method 183, optical isolator 132 may be positioned in cavity 146, aligned, and secured in an aligned position after alignment of the multi-lens array 130_{MLA} and the FAU 156. In some embodiments of method 183, optical isolator 132 may be positioned in cavity 146, aligned, and secured in position with the positioning, aligning, and securing of interposer assembly 104 with coupler assembly 102 in the formation of the PIC assembly 101. The formation of an embodiment of PIC assembly 101 is described in conjunction with step 183-8 of method 183.

Step 183-8 of method 183 shown in FIG. 24 is an optional forming step in which a PIC assembly 101 is formed comprising an interposer 103 and the coupler assembly 102 formed in step 183-7 configured having the FAU 156 and one or more optical fiber 154. In some embodiments, the optical isolator 132 may be mounted or otherwise formed in step 183-8 after coupling of the interposer 103 and the coupler assembly 102 rather than in step 183-6. And in some embodiments, PIC assembly may be formed using an embodiment of interposer assembly 104 comprising the interposer 103.

In some embodiments that include step 183-8 of method 183, an embodiment of coupler assembly 102 such as the embodiment of coupler assembly 102 shown in FIG. 25D, is coupled with an interposer assembly 104 that includes an interposer 103.

FIG. 25E shows a perspective schematic drawing of an embodiment of a PIC assembly 101 after forming step 182-8. The embodiment of PIC assembly 101 shown in the perspective schematic drawing in FIG. 25E, comprises the coupler assembly 102 of FIG. 25D and an interposer assembly 104 wherein the coupler assembly 102 comprises coupler 100, on-facet lens array 130_{F2PP} formed on the facets of waveguide cores 106_{core} on the ingoing side of cavity 146, an optical isolator 132, and a multi-lens array 130_{MLA}, and wherein the interposer assembly 104 comprises interposer 103. Embodiments of interposer assembly 104 that may be used in the formation of PIC assemblies 101 are disclosed throughout herein.

FIG. 25E shows alignment apparatus 168 that may be used to facilitate alignment of the waveguide cores 107_{core} of the interposer with the waveguide cores 106_{core} in the embodiment. In an example alignment process, one or more emitting device on or coupled to the interposer assembly 104 provides one or more optical signals through one or more waveguide core 107_{core} of the interposer 103 to one or more waveguide core 106_{core} on the coupler 100, in the embodiment. The alignment apparatus 168 is configured to be receptive to the optical signals propagating through the waveguide cores 106_{core}, on-facet lenses 138_{F2PP}, the optical isolator 132, the MLA lenses 138_{MLA} of the multi-lens array 130_{MLA}, and the optical fibers 154 mounted in FAU 156 on the coupler 100. Alignment apparatus 168 may be used to detect one or more characteristics of the one or more optical signals propagating through the PIC assembly 101 enabling alterations to be made in the relative positioning of the interposer assembly 104 and the coupler assembly 102, and enabling improvements in the alignment of the waveguide cores 106_{core} of the coupler 100 with the waveguide cores 107_{core} of the interposer 103. In an example alignment step using alignment apparatus 168, four optical emitting devices of PIC 118 on the interposer assembly 104 are electrically powered such that optical signals are emitted from the optical emitting devices to the waveguide cores 107_{core}. The coupler assembly 102 is positioned such that the waveguide cores 106_{core} of the coupler 100 are receptive to the optical signals from the interposer assembly 104, and such that all or a portion of the optical signal power is detectable by alignment apparatus 168. In an embodiment, relative positions of the interposer assembly 104 and the coupler assembly 102 are varied to enable the detected optical signal power to be maximized in this example. Other optical signal parameters may also be used to detect alignment between the waveguide cores 107_{core} of the interposer 103 and the waveguide cores 107_{core} of the coupler 100. In some embodiments, the optical signals emitted from two emitting devices are used in the alignment of the interposer assembly 104 and the coupler assembly 102. In other embodiments, one or more optical signals emitted from one or more emitting devices are used in the alignment of the interposer assembly 104 and the coupler assembly 102.

In some embodiments, optical isolator 132 may be mounted and aligned in conjunction with the alignment of the interposer assembly 104 and the coupler assembly 102.

In the embodiment shown in FIGS. 25A-25E, optical isolator 132 is shown mounted or otherwise formed between the on-facet lens array 130_{F2PP} and the multi-lens array 130_{MLA}. In other embodiments, optical isolator 132 may be mounted or otherwise formed between the multi-lens array 130_{MLA} and the outgoing side of cavity 146.

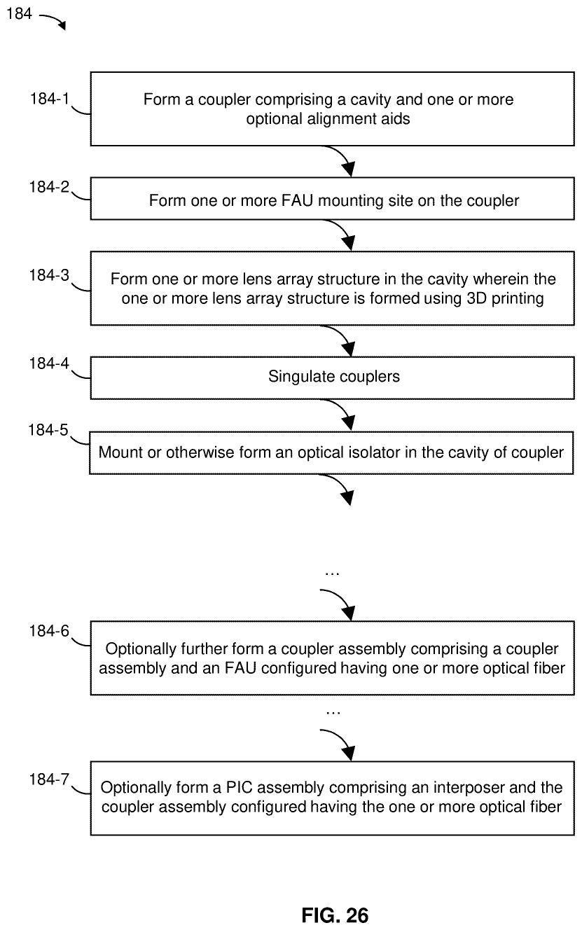

FIG. 26 shows a flowchart for a method 184 of forming yet other embodiments of coupler 100, yet other embodiments of coupler assembly 102, and yet other embodiments of PIC assembly 101 comprising coupler assembly 102 and interposer assembly 104, wherein coupler assembly 102 in these embodiments is configured having in-structure lenses 138_{S2PP} of first and second lens array structures 130_{S2PP}-1,130_{S2PP}-2, respectively, formed, for example, using two-photon polymerization or other method of 3D printing, in cavity 146 of coupler 100. In the formation of the embodiments using method 184, the embodiment of coupler 100 is configured having an opening formed on the ingoing side of cavity 146 that enables, for example, free-space coupling of optical signals from interposer assembly 104 or other optical signal source to in-structure lenses 138_{S2PP} of first lens array structure 130_{S2PP}-2 in cavity 146, and having an opening formed on the outgoing side of the cavity 146 that enables free-space coupling of optical signals from the in-structure lenses 138_{S2PP} of second lens array structure 130_{S2PP}-2 in cavity 146 to the terminal facets of the cores of optical fibers 154 mounted or otherwise formed in FAU 156 in FAU mounting site 152 on coupler 100. An embodiment of a coupler 100 configured having an opening in the ingoing side of cavity 146 and an opening in the outgoing side of cavity 146 is shown, for example, in FIGS. 3D1-3D2.

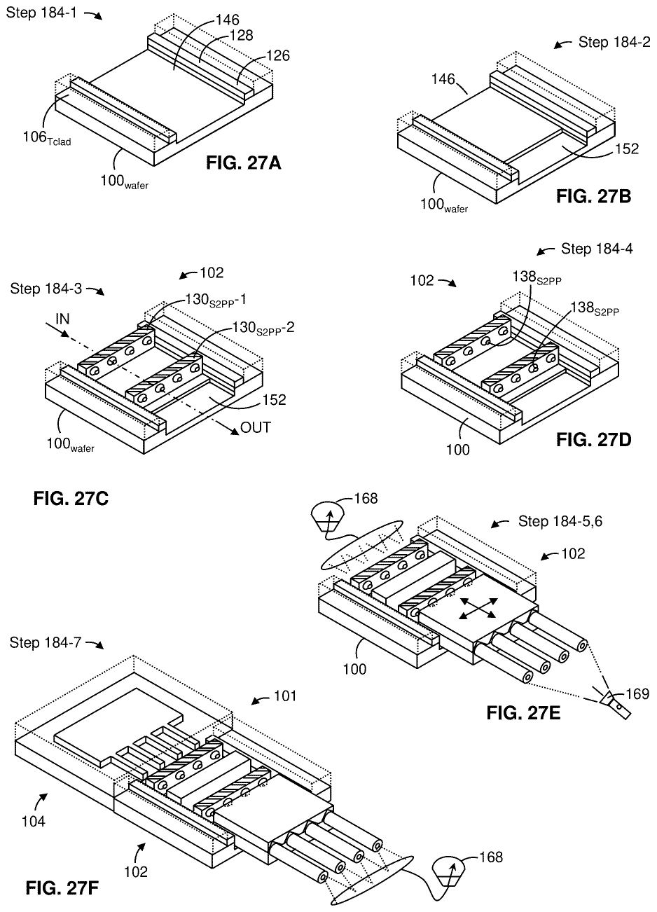

FIGS. 27A-27F show perspective schematic drawings of embodiments of the coupler 100, coupler assembly 102, and PIC assembly 101 at various steps in the process of formation using method 184. The steps in the method 184 of FIG. 26 are described in conjunction with the perspective schematic drawings in FIGS. 27A-27F.

Step 184-1 of method 184 shown in FIG. 26 is a forming step in which an embodiment of a coupler comprising a cavity 146 and optional alignment aids is formed. Embodiments of coupler 100 may be formed, for example, using method 195 shown in FIG. 14 described herein in conjunction with FIGS. 15A1-15F3. Cavity 146 is formed in all or a portion of the planar waveguide layer in this and other embodiments as further described herein.

FIG. 27A shows perspective schematic drawing of an embodiment of coupler 100_{wafer} after step 184-1 of method 184. The embodiment of the coupler 100_{wafer} in FIG. 27A is shown configured having cavity 146 and optional alignment aids 126,128, wherein the coupler 100 is configured having an opening in the ingoing side or cavity 146 to facilitate free-space coupling of optical signals from an interposer assembly 104, for example, to the in-structure lenses 138_{S2PP} of first lens array structure 130_{S2PP}-1, and an opening in the outgoing side of cavity 146 to facilitate free-space coupling of optical signals from the in-structure lenses 138_{S2PP} of second lens array structure 130_{S2PP}-2 formed in cavity 146 to the terminal facets of optical fibers 154 mounted or otherwise formed in FAU 156 on coupler 100. In-structure lenses 138_{S2PP} of the second lens array structure 130_{S2PP}-2 in the cavity 146, in the embodiment, are receptive to optical signals propagating from in-structure lenses 138_{S2PP} of first lens array structure 130_{S2PP}-1 that may be one or more of collected, narrowed, collimated, and focused, among other altering effects of propagating through the lenses. In-structure lenses 138_{S2PP} of first lens array structure 130_{S2PP}-1 may facilitate, for example, improved coupling of optical signals to the in-structure lenses 138_{S2PP} of second lens array structure 130_{S2PP}-2, and subsequently to the terminal facets of the cores of the optical fibers 154 mounted or otherwise formed in FAU 156 on coupler 100.

The embodiment of the coupler 100_{wafer} is shown in FIG. 27A configured having FAU alignment aids 126 on a portion of the periphery of the upper opening of the FAU mounting site 152 that may facilitate, for example, the alignment of an FAU 156. The embodiment in FIG. 27A further shows coupler 100_{wafer} configured having cavity alignment aids 128 formed in the sidewalls in the flanking sides of the upper opening of the cavity 146 that may facilitate, for example, the alignment of the one or more optical isolator 132. Cavity alignment aids 128 may be further used to provide reference locations from which the lens array structures 130_{S2PP} may be formed. Lenses 138_{S2PP}, for example, are preferably formed in reference to waveguides and other alignment features formed in self-alignment from the core layer of the planar waveguide layer. In the absence of waveguide cores 106_{core}, as in the embodiment of the coupler shown in FIG. 27, alignment features such as cavity alignment aids 128 and other alignment features formed in self-alignment from the core layer of the planar waveguide layer 105, may be used to provide reference locations on the coupler structure from which 3D printed structures may be formed. The benefit of having waveguide cores and alignment features formed in self-alignment may be extended to features formed using 3D printing, for example, in structures formed in reference to a waveguide core or alignment feature formed in self-alignment. That is, a lens 138_{S2PP}, for example, configured having an optical axis that is formed in reference to a feature formed in self-alignment with other alignment features, may benefit from the same level of lithographic precision in spatial positioning as features formed directly from the core layer of the planar waveguide layer from which the self-aligned features are formed.

In the embodiment of the coupler shown in FIG. 27A, the coupler shown is labeled having coupler 100_{wafer}. The suffix “wafer” added to the label “100” as in “100_{wafer}”, indicates that the coupler is a portion of an unsingulated coupler wafer having a plurality of couplers 100_{wafer} as further described herein. The suffix is not used in embodiments of the coupler in the perspective drawings for the steps following the singulation step.

The embodiment of the coupler 100_{wafer} is formed from a layered structure comprising a planar waveguide layer 105_{cplr} formed on a substrate 110_{cplr}. The layered structure may optionally include an electrical interconnect layer 133_{cplr} formed on the substrate 110_{cplr} wherein the planar waveguide layer 105 may be formed on the optional electrical interconnect layer 133_{cplr}. A top cladding layer 106_{Tclad} is shown as transparent in the drawing with dotted lines on the periphery to more clearly illustrate key features underlying the top cladding layer in the structures shown in FIGS. 27A-27F.

In the absence of waveguide cores 106_{core} in the embodiment shown in FIG. 27A, FAU alignment aids 126 and cavity alignment aids 128 may be formed in self-alignment with optical axes of optical pathways through the cavity 146. Optical pathways may be established, for example, with the formation of the 3D printed lens array structures 130_{S2PP} formed in reference to an alignment aid such as cavity alignment aid 128. By referencing the in-structure lenses 138_{S2PP} of the lens array structures 130_{F2PP} with the cavity alignment aids 128 formed self-aligned with fiducial 114 and other alignment features formed self-aligned on the coupler 100, the in-structure lenses 138_{S2PP}, and the optical axes of the in-structure lenses 138_{S2PP} will be referenced to other features formed in self-alignment on the coupler 100_{wafer}.

Lateral alignment aids that are formed in self-alignment with the waveguide cores 106_{core} may be used to align two or more devices or features in the formation of a PIC assembly 101. In some embodiments, the lateral alignment aids used to align a first device or feature may be formed in a location on the coupler 100 that is a significant distance from a second device or feature on the coupler 100, for example, to which the first device or feature is to be aligned in the formation of an assembly comprising the first device or feature and the second device or feature. In an embodiment, for example, in which a cavity alignment aid 128 is formed at one or more wall of cavity 146, the alignment aid 128 may be used in the alignment of an optical isolator 132 and the optical pathways formed in reference to a self-aligned feature formed at another wall of cavity 146 due to the self-alignment of the alignment aids 128 and other feature to which the optical pathway is formed. In another embodiment, for example, in which coupler 100 is configured having T&G alignment aids 108 formed self-aligned with, and a significant distance from, the optical pathways formed in reference to a self-aligned feature, the T&G alignment aids 108 of the coupler 100 may be used to align the optical pathways formed in reference to a self-aligned feature with the waveguide cores 107_{core} of an interposer 103 configured having complementary T&G alignment aids 109.

Although not shown in FIG. 27A, other lateral alignment aids such as T&G lateral alignment aids 108 and fiducials 114 may also be included in the formation of other embodiments. Formation of the in-structure lenses 138_{S2PP} in self-alignment with the T&G alignment features 108 on the coupler 100, facilitates the alignment of the optical axes of the in-structure lenses 138_{S2PP} with other optical devices such as interposer 103 having complementary T&G alignment features 109 to the T&G alignment features 108 of the coupler 100 by coupling of the T&G alignment features of the coupler 100 with the T&G alignment features 109 of the interposer 103 or other optical device. Because the lateral alignment aids are formed from the same patterned layer, the relative positioning between the lateral alignment aids and the optical axes of optical pathways formed in self-alignment with the lateral alignment aids are within the dimensional resolution of the lithographic patterning method used to pattern this same layer. Lateral alignment aids formed in self-alignment with the optical axes of optical pathways on the coupler 100, by 3D printing the in-structure lenses 138_{S2PP} in reference to self-aligned features such as the cavity alignment aids 128, for example, having self-aligned optical axes in the embodiment, enables alignment aids that are positioned some distance from two features that require alignment to be used to provide a mechanism for the alignment.

Step 184-2 of method 184 shown in the flowchart of FIG. 26, is a forming step in which one or more FAU mounting site 152 is formed in the coupler 100_{wafer}. A method of forming FAU mounting site 152 is described, for example, in method 195 of FIG. 14, and in the cross-section drawings in FIGS. 15A1-15F1.

FIG. 27B shows a perspective schematic drawing of an embodiment of coupler 100_{wafer} after formation of FAU mounting site 152. Labels for the four sides of cavity 146 to distinguish between the ingoing side of the cavity 146, the outgoing side of the cavity 146, and the two flanking sides of the cavity 146 are provided, for example, in FIG. 25B, and elsewhere herein. In the embodiment of coupler 100_{wafer} shown in FIG. 27B, the ingoing side of the cavity 146 is configured having an opening to enable free-space coupling of optical signals from an interposer assembly 104, for example, or other optical signal source to lenses 138 of a first lens array 130-1 and an opening in the outgoing side of the cavity 146 to enable free-space coupling of optical signals from the lenses 138 of a second lens array 130-2 to the terminal facets of the cores of optical fibers 154 mounted or otherwise formed in an FAU 156 mounted or otherwise formed on the FAU mounting site 152 on coupler 100 in the embodiment.

Step 184-3 of method 184 shown in the flowchart of FIG. 26 is a forming step in which one or more lens array structure is formed in the cavity 146, wherein the one or more lens array is formed using 3D printing.

FIG. 27C shows a perspective schematic drawing of an embodiment of coupler 100wafer after step 184-3 of method 184. The embodiment of the coupler 100wafer in the perspective drawing of FIG. 27C shows a coupler assembly 102 comprising coupler 100 and first and second lens array structures 130_{S2PP}-1,130_{S2PP}-2, respectively. First and second lens array structures 130_{S2PP}-1, 130_{S2PP}-2 may be formed, for example, in cavity 146 of coupler 100 using two-photon polymerization or other 3D printing method.

In the embodiment of coupler 100_{wafer} shown in FIG. 27C, the ingoing side of the cavity 146 is configured having an opening to enable free-space coupling of optical signals from an interposer assembly 104, for example, or other optical signal source to the in-structure lenses 138_{S2PP} of the first lens array structure 130_{S2PP}-1 and an opening in the outgoing side of the cavity 146 to enable free-space coupling of optical signals from the in-structure lenses 138_{S2PP} of the second lens array structure 130_{S2PP}-2 to the terminal facets of the cores of optical fibers 154 mounted or otherwise formed in an FAU 126 mounted or otherwise formed on the FAU mounting site 152 on coupler 100 in the embodiment.

FIG. 27C shows in-structure lenses 1382PP of first lens array structure 130_{F2PP}-1 formed, for example, using two-photon polymerization on the ingoing side of cavity 146 and in-structure lenses 138_{S2PP} of second lens array structure 130_{S2PP}-2 also formed, for example, using two-photon polymerization on the outgoing side of the cavity 146 of the unsingulated coupler 100_{wafer}. In embodiments, a lens array structure 130_{S2PP} formed using two-photon polymerization is a lens array comprising one or more in-structure lenses 138_{S2PP} in which the in-structure lenses 138_{S2PP} of the lens array are all or a portion of a structure formed using a two-photon polymerization process in cavity 146. In contrast to the 3D printed on-facet lenses 130_{F2PP} printed on the facets of waveguide cores 106_{core} intersected by a wall of cavity 146, such as the embodiments shown in FIGS. 21A-21F, a lens array structure 130_{S2PP} is formed fully or in part within the cavity 146 in contact with one or more of the floor of the cavity 146 and one or more wall of the cavity 146. In an example, a lens array structure 130_{S2PP} in an embodiment of a coupler assembly 102, is a 3D printed structure that extends from the floor of cavity 146 to the top of the top cladding 106_{Tclad} of the cavity 146 and from flanking sidewall to flanking sidewall as illustrated, for example, in the embodiment of the coupler assembly 102 shown in FIG. 27C. In-structure lenses 138_{S2PP} are formed in the structure such that the optical axis of an in-structure lens 138_{S2PP} is in line with an optical pathway through the cavity 146 to facilitate one or more of collecting, collimated, and focusing of optical signals propagating from the ingoing side of the cavity 146 to the outgoing side of the cavity 146.

In another example embodiment, a lens array structure 130_{S2PP} in an embodiment of a coupler assembly 102, is a 3D printed structure that makes limited contact with the floor of the cavity 146 and extends from the floor of cavity 146 to the top of the top cladding 106_{Tclad} of the cavity 146 and from flanking sidewall to flanking sidewall perpendicular to the optical pathways through the cavity 146. In-structure lenses 138_{S2PP} are formed in the lens array structure in line with the optical pathways through the cavity 146 to facilitate one or more of collecting, collimated, and focusing of optical signals propagating from the ingoing side of the cavity 146 to the outgoing side of the cavity 146. In some embodiments, a solid structure is formed to support the in-structure lenses 138_{S2PP}. In other embodiments, a trussed structure is formed in which the support for the in-structure lenses 138_{S2PP} is not a solid structure formed of polymerized material but rather a webbed structure that provides support for the in-structure lenses 138_{S2PP}. In some embodiments, the lens array structure 130_{S2PP} is supported in contact with the flanking sidewalls of cavity 146. In embodiments, lens array structure 130_{S2PP} may be formed having contact with one or more of the floor of cavity 146, a wall of the cavity 146, and a surface of an alignment aid formed in self-alignment with one or more alignment aid, fiducial, and waveguide formed from the core layer of the planar waveguide layer on the coupler 100wafer.

First lens array structure 130_{S2PP}-1 and a second lens array structure 130_{S2PP}-2 are formed, for example, using two-photon polymerization in the embodiment in reference to the cavity alignment aids 128 formed in self-alignment with other alignment features such as FAU alignment aids 126 shown in FIG. 27C, T&G alignment aids 108 (not shown in FIG. 27C but referenced throughout herein), and other alignment aids formed self-aligned with the FAU alignment aids 126 on the coupler 100. 3D printing of the first and second lens array structures 130_{S2PP}-1,130_{S2PP}-2 in reference to a self-aligned alignment aid such as cavity alignment aid 128, enables alignment of the optical axes of the in-structure lenses 138_{S2PP} and the optical axes of the cores of optical fibers 154 mounted or otherwise formed in FAU 152 mounted or otherwise formed in FAU mounting site 152 using FAU alignment aids 126.

Step 184-4 of method 184 shown in FIG. 26 is a singulating step in which the unsingulated coupler wafer comprising a plurality of couplers 100_{wafer} is singulated into two or more singulated couplers 100.

FIG. 27D shows a perspective schematic drawing of an embodiment of coupler assembly 102 after steps 184-4. The embodiment of the coupler assembly 102 in the perspective drawing in FIG. 27D comprises a singulated coupler 100 and first and second lens array structures 130_{S2PP}-1, 130_{S2PP}-2, respectively, after singulation of the unsingulated coupler wafer comprising the plurality of couplers 100_{wafer} into singulated couplers 100. FIG. 27D shows in-structure lenses 138_{S2PP} of lens array structures 130_{S2PP} in cavity 146 of the singulated couplers 100.

Step 184-5 of method 184 shown in the flowchart of FIG. 26 is a mounting step in which an optical isolator 132 is mounted or otherwise formed in cavity 146 of coupler 100.

Step 184-6 of method 184 shown in the flowchart of FIG. 26 is an optional forming step in which coupler assembly 102 is further formed comprising the coupler assembly of step 184-5 and an FAU 156 configured having one or more optical fiber 154.

FIG. 27E shows a perspective schematic drawing of an embodiment of coupler assembly 102 after steps 184-5 and 184-6. The embodiment of the coupler assembly 102 in the perspective drawing in FIG. 27E comprises the coupler assembly 102 formed after step 184-4 of method 184 configured having singulated coupler 100 and first and second lens array structures 130_{S2PP}-1, 130_{S2PP}-2, respectively, and further comprises optical isolator 132 and FAU 156 configured having four optical fibers 154 and mounted or otherwise formed on FAU mounting site 152 on coupler 100.

In some embodiments, the mounting and alignment of an optical isolator 132 may optionally be included in an earlier step of method 184. And in yet other embodiments, the mounting and alignment of optical isolator 132 may be included in step 184-7.

Alignment apparatus 168, shown in FIG. 27E, may be used to facilitate alignment of the cores of optical fibers 154 mounted or otherwise formed in FAU 152 with the in-structure lenses 138_{S2PP} of the first and second lens array structures 130_{S2PP}-1, 130_{S2PP}-2 in the embodiment. In an example alignment process, one or more emitting device 169 coupled to one or more optical fiber 154 mounted or otherwise formed on the FAU 156 provides one or more optical signals through the optical fibers 154 to the in-structure lenses 138_{S2PP} of the second lens array structure 130_{S2PP}-2, through the optical isolator 132 to the in-structure lenses 138_{S2PP} of the first lens array structure 130_{S2PP}-1 and to a detector of the alignment apparatus 168 to form an aligned position as described, for example, in methods 181-183. After alignment of the cores of the optical fibers 154 with the lenses 138_{S2PP} of the first and second in-structure lens arrays 130_{S2PP}-1, 130_{S2PP}-2, the FAU 156 may be secured in place using an epoxy or other attachment medium. The optical isolator 132 may also be secured in an aligned position after alignment using an epoxy or other attachment medium.

Step 184-7 of method 184 shown in the flowchart in FIG. 26 is an optional forming step in which a PIC assembly 101 is formed comprising an interposer 103 and the coupler assembly formed in step 184-6 configured having the one or more optical fiber 154 mounted in FAU 156 on the coupler 100.

FIG. 27F shows a perspective schematic drawing of an embodiment of PIC assembly 101 comprising the coupler assembly 102 of FIG. 27E, and an interposer assembly 104. The coupler assembly 102 comprises the coupler 100, first lens array structure 130_{S2PP}-1, optical isolator 132, second lens array structure 130_{S2PP}-2, and four optical fibers 154 mounted in FAU 156 on the coupler 100 in the embodiment. The interposer assembly 104 comprises interposer 103 and optionally includes one or more optical emitting device.

Also shown in FIG. 27E is an alignment apparatus 168 that may be used to facilitate alignment of the waveguide cores 107_{core} of the interposer assembly 104 with the in-structure lenses 138_{S2PP} of lens array structures 130_{S2PP}-1, 130_{S2PP}-2 in the embodiment. In an example alignment process, one or more emitting device on or coupled to the interposer assembly 104 provides one or more optical signals through the waveguide cores 107_{core} on the interposer 103 to the in-structure lenses 138_{S2PP} of the first lens array structure 130_{S2PP}-1, through the optical isolator 132 to the in-structure lenses 138_{S2PP} of the second lens array structure 130_{S2PP}-2, and through the cores of the optical fibers to the detector of the alignment apparatus 168.

The alignment apparatus 168 is configured to be receptive to the optical signals emerging from the optical fibers 154. Alignment apparatus 168 is used to detect one or more characteristics of the one or more optical signals propagating through the PIC assembly 101 enabling alterations to be made in the relative positioning of the interposer assembly 104 and the coupler assembly 102 that includes the optical isolator 132, and enabling improvements in the alignment of the waveguide cores 107_{core} of the interposer 103 with the in-structure lenses 138_{S2PP} of the first and second lens array structure 130_{S2PP}-1,130_{S2PP}-2, and in the alignment of the optical isolator 132. In an example alignment step using alignment apparatus 168, four optical emitting devices of PIC 118 on the interposer assembly 104 are electrically powered such that optical signals are emitted from the optical emitting devices to the waveguide cores 107_{core}. The coupler assembly 102 is positioned such that the in-structure lenses 138_{S2PP} in cavity 146 of coupler 100 are receptive to the optical signals from the interposer assembly 104, and such that all or a portion of the optical signal power is detectable at alignment apparatus 168. In an embodiment, relative positions of the interposer assembly 104 and the coupler assembly 102 are varied to enable the detected optical signal power to be maximized, for example. Other optical signal parameters may also be used to detect alignment between the waveguide cores 107_{core} of the interposer 103, and the in-structure lenses 138_{S2PP} of the first and second lens array structures 130_{S2PP}-1,130_{S2PP}-2, the optical isolator 132, and the optical fibers 154 of the coupler assembly 102. In some embodiments, the optical signals emitted from two emitting devices are used in the alignment of the interposer assembly 104 and the coupler assembly 102. In other embodiments, one or more optical signals emitted from one or more emitting devices are used in the alignment of the interposer assembly 104 and the coupler assembly 102.

In some embodiments, optical isolator 132 may be aligned in conjunction with the alignment of the interposer assembly 104 and the coupler assembly 102. In other embodiments, the interposer assembly 104 and the coupler assembly including the optical fibers 154 may be aligned initially and after which the optical isolator 132 may subsequently be positioned into the cavity 146 and aligned.

In some embodiments, FAU alignment aids 126 formed on a portion of the periphery of the upper opening of the FAU mounting site 152 may be used to facilitate alignment of the FAU 156 and the optical fibers mounted or otherwise formed on the FAU 156 with the in-structure lenses 138_{S2PP} of the coupler assembly 102 in the PIC assembly 101. The upper openings of the FAU mounting site 152, configured having FAU alignment aids 126, enable the positioning of the FAU 156 between the vertical surfaces of the FAU alignment aids 126 facing the FAU mounting site 152 such that the FAU 156 is positioned between the vertical alignment surfaces of the FAU alignment aids 126 and on the bottom surface of the FAU mounting site 152, and the cores of the optical fibers 154 in the FAU 156 are brought into alignment with the in-structure lenses 138_{S2PP} in the cavity 146 of the coupler 100.

In some embodiments, optical isolator 132 may be aligned in cavity 132 using cavity alignment aids 128 formed at all or a portion of the periphery of the cavity 146. In embodiments, one or both of the ends of the optical isolator 132 may form a contact with the cavity alignment aid 128 on one or both of the flanking sidewalls of cavity 146 to fully or in part align the optical isolator 132 within the cavity 146.

### Methods of Forming PIC Assemblies Configured Having a Coupler Assembly Configured Having One Lens Array

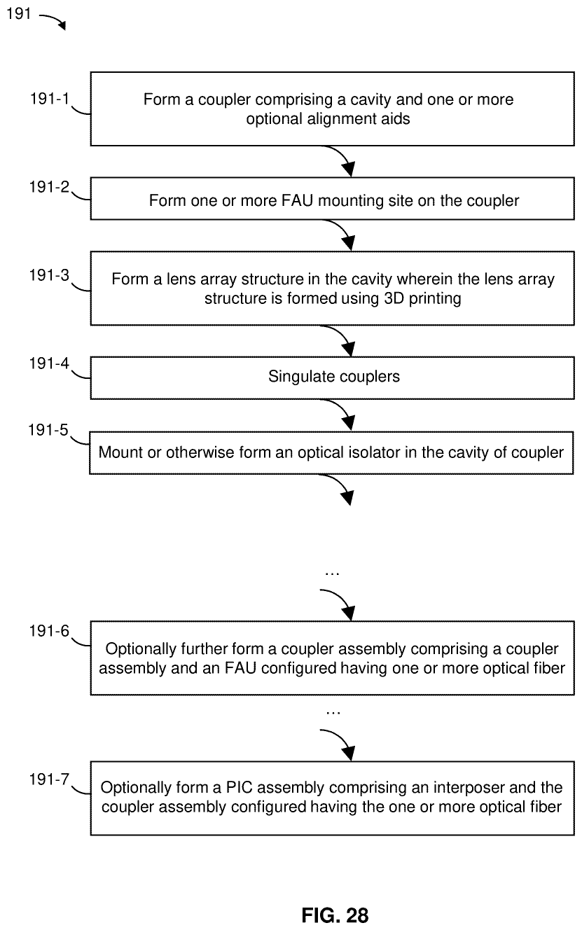

FIG. 28 shows a flowchart for a method 191 of forming embodiments of coupler 100, embodiments of coupler assembly 102, and embodiments of PIC assembly 101 comprising coupler assembly 102 and interposer assembly 104 wherein coupler assembly 102 is configured having in-structure lenses 138_{S2PP} of a lens array structure 130_{S2PP} formed using two-photon polymerization in cavity 146. The use a single lens array can simplify methods of fabrication and reduce fabrication costs. As in the embodiments of coupler 100 shown, for example, in FIGS. 3D1 and 3D2, and in the embodiments of coupler 100 shown in FIGS. 27A-27B and described in conjunction with method 184, the embodiments of coupler 100 formed using method 191, are configured having an opening formed on the ingoing side of cavity 146 and an opening on the outgoing side of cavity 146. The opening on the ingoing side of cavity 146 enables, for example, free-space coupling of optical signals from an interposer 103 or other optical signal source to the lenses 138 of a lens array 130 in cavity 146, and the opening on the outgoing side of the cavity 146 enables free-space coupling of optical signals from the lenses 138 of the lens array 130 in cavity 146 to the terminal facets of the cores of optical fibers 154 mounted or otherwise formed in an FAU 156 mounted or otherwise formed on the FAU mounting site 152 of coupler 100.

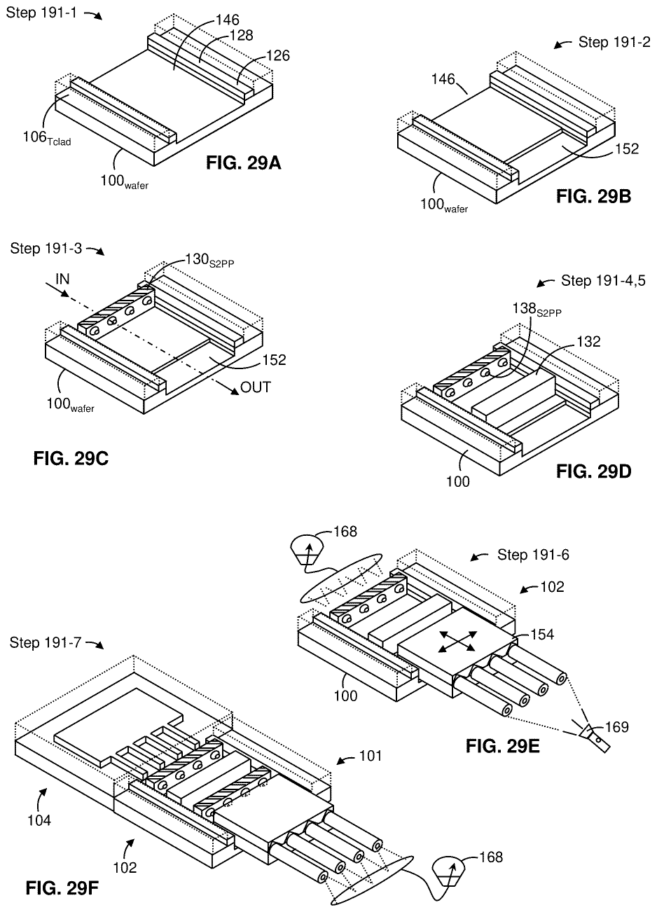

FIGS. 29A-29F show perspective schematic drawings of embodiments of the coupler 100, coupler assembly 102, and PIC assembly 101 at various steps in the process of formation using method 191. The steps in the method 191 of FIG. 28 are described in conjunction with the perspective schematic drawings in FIGS. 29A-29F.

Step 191-1 of method 191 shown in FIG. 28 is a forming step in which an embodiment of a coupler comprising cavity and optional alignment aids is formed. Embodiments of coupler 100 may be formed, for example, using method 195 shown in FIG. 14 described herein in conjunction with FIGS. 15A1-15F3.

FIG. 29A shows an embodiment of coupler 100_{wafer} configured having cavity 146 and optional alignment aids 126,128, wherein the coupler 100_{wafer} is configured having an opening in the ingoing side or cavity 146 to facilitate free-space coupling of optical signals from an interposer 103, for example, to the in-structure lenses 138_{S2PP} of a lens array structure 130_{S2PP}, and an opening in the outgoing side of cavity 146 to facilitate free-space coupling of optical signals from the in-structure lenses 138_{S2PP} of the lens array structure 130_{S2PP} in cavity 146 to the terminal facets of optical fibers 154 mounted or otherwise formed in FAU 156 mounted or otherwise formed on an FAU mounting site 152 on coupler 100 in the embodiment.

In-structure lenses 138_{S2PP} of the lens array structure 130_{S2PP} in the cavity 146, in the embodiment, are receptive to optical signals from an optical signal source of an interposer assembly 104, for example, or other optical signal source coupled to the in-structure lenses 138_{S2PP} through an opening in the ingoing side of cavity 146. In the embodiment, the optical signals propagating through the in-structure lenses 138_{S2PP} of the lens array structure 130_{S2PP} may be one or more of collected, narrowed, collimated, and focused, among other altering effects of propagating through the lenses. The in-structure lenses 138_{S2PP} of the lens array structure 130_{S2PP} may facilitate, for example, improved coupling of optical signals through the opening on the outgoing side of the cavity 146 to the terminal facets of the cores of the optical fibers 154 mounted or otherwise formed in FAU 156.

The embodiment of the coupler 100_{wafer} is shown in FIG. 29A configured having FAU alignment aids 126 formed at a portion of the periphery of the upper opening of the FAU mounting site 152 and cavity alignment aids 128 formed at the upper opening of the cavity 146. In the embodiment of the coupler shown in FIG. 29A, the coupler shown is labeled having coupler 100_{wafer}. The suffix “wafer” added to the label “100” as in “100_{wafer}”, indicates that the coupler is a portion of an unsingulated coupler wafer having a plurality of couplers 100 as further described herein.

The embodiment of the coupler 100_{wafer} is formed from a layered structure comprising a planar waveguide layer 105_{cplr} formed on a substrate 110_{cplr}. The layered structure may optionally include an electrical interconnect layer 133_{cplr} formed on the substrate 110_{cplr} wherein the planar waveguide layer 105 may be formed on the optional electrical interconnect layer 133_{cplr}. A top cladding layer is shown as transparent in the drawing with dotted lines on the periphery to more clearly illustrate key features underlying the top cladding layer in the structures in FIGS. 29A-29F.

In the absence of waveguide cores 106_{core} in the embodiment shown in FIG. 29A, FAU alignment aids 126 and cavity alignment aids 128 may be formed in self-alignment with optical axes of optical pathways through the cavity 146. Optical pathways may be established, for example, with the formation of the 3D printed lens array structures 130_{S2PP}. By referencing the in-structure lenses 138_{S2PP} of the lens array structures 130_{S2PP} with alignment aids such as, for example, cavity alignment aids 128 formed self-aligned with fiducial 114 and other alignment features formed self-aligned on the coupler 100, the in-structure lenses 138_{S2PP}, and the optical axes of the in-structure lenses 138_{S2PP} will be referenced to other features formed in self-alignment on the coupler 100.

Lateral alignment aids that are formed in self-alignment with the waveguide cores 106_{core} may be used to align two devices or features in the formation of an assembly. In some embodiments, the lateral alignment aids used to align a first device or feature may be formed in a location on the coupler 100 that is a significant distance from a second device or feature on the coupler 100, for example, to which the first device or feature is to be aligned in the formation of an assembly comprising the first device or feature and the second device or feature. In an embodiment, for example, in which an alignment aid 128 is formed at one or more wall of cavity 146, the alignment aid 128 may be used in the alignment of an optical isolator 132 and the optical pathways formed in reference to a self-aligned feature formed at another wall of cavity 146 due to the self-alignment of the alignment aids 128 and other feature to which the optical pathway is formed. In another embodiment, for example, in which coupler 100 is configured having T&G alignment aids 108 formed self-aligned with, and a significant distance from, the optical pathways formed in reference to a self-aligned feature, the T&G alignment aids 108 of the coupler 100 may be used to align the optical pathways formed in reference to a self-aligned feature with the waveguide cores 107_{core} of an interposer 103 configured having complementary T&G alignment aids 109.

Although not shown in FIG. 29A, other lateral alignment aids such as T&G lateral alignment aids 108 and fiducials 114 may also be included in the formation of other embodiments. Formation of the in-structure lenses 138_{S2PP} in self-alignment with the T&G alignment features 108 on the coupler 100, facilitates the alignment of the optical axes of the in-structure lenses 138_{S2PP} with other optical devices such as interposer 103 having complementary T&G alignment features 109 to the T&G alignment features 108 of the coupler 100 by coupling of the T&G alignment features of the coupler 100 with the T&G alignment features 109 of the interposer 103 or other optical device. Because the lateral alignment aids are formed from the same patterned layer, the relative positioning between the lateral alignment aids and the optical axes of optical pathways formed in self-alignment with the lateral alignment aids are within the dimensional resolution of the lithographic patterning method used to pattern this same layer, and resolution of the etch or removal method used to pattern this layer. Lateral alignment aids formed in self-alignment with the optical axes of optical pathways on the coupler 100, by 3D printing the in-structure lenses 138_{S2PP} in reference to self-aligned features such as the cavity alignment aids 128, for example, having the self-aligned optical axes in the embodiment, enables alignment aids that are positioned some distance from two features that require alignment to be used to provide a mechanism for the alignment.

Step 191-2 of method 191 shown in FIG. 28 is a forming step in which one or more FAU mounting site 152 is formed in the coupler 100_{wafer}. A method of forming FAU mounting site 152 is described, for example, in method 195 of FIG. 14, and in the cross-section drawings in FIGS. 15A1-15F1.

FIG. 29B shows an embodiment of coupler 100_{wafer} after formation of FAU mounting site 152. In the embodiment of coupler 100_{wafer} shown in FIG. 29B, the ingoing side of the cavity 146 is configured having an opening to enable free-space coupling of optical signals from an interposer assembly 104, for example, or other optical signal source to the in-structure lenses 138_{S2PP} of a lens array structure 130_{S2PP} and an opening in the outgoing side of the cavity 146 to enable free-space coupling of optical signals from the in-structure lenses 1382PP of the lens array structure 130_{S2PP} to the terminal facets of the cores of optical fibers 154 mounted or otherwise formed in an FAU 156 on FAU mounting site 152 in the embodiment.

Step 191-3 of method 191 shown in FIG. 28 is a forming step in which a lens array structure 130_{S2PP} is formed in the cavity 146 wherein the lens array structure 130_{S2PP} is formed using 3D printing.

FIG. 29C shows a perspective schematic drawing of an embodiment of coupler assembly 102 after step 191-3 of method 191. The embodiment of the coupler assembly 102 shown in the perspective drawing of FIG. 29C comprises coupler 100_{wafer} and a lens array structure 130_{S2PP} formed using two-photon polymerization, for example, in cavity 146 of coupler 100.

FIG. 29C further shows the in-structure lenses 138_{S2PP} of the lens array structure 130_{S2PP} formed using two-photon polymerization in cavity 146 of the unsingulated coupler 100_{wafer}. In embodiments, a lens array structure 130_{S2PP} formed using two-photon polymerization is a lens array comprising one or more in-structure lenses 138_{S2PP} in which the in-structure lenses 138_{S2PP} of the lens array are all or a portion of a structure formed using two-photon polymerization. In-structure lenses 138_{S2PP} are formed in the lens array structure 130_{S2PP} such that the optical axes of the in-structure lenses 138_{S2PP} of the lens array structure 130_{S2PP} are aligned with optical pathways through the cavity 146 to facilitate one or more of collecting, collimating, and focusing of optical signals propagating from the ingoing side of the cavity 146 to the cores of the optical fibers 154 mounted in an FAU 156 on the FAU mounting site 152.

In-structure lenses 138_{S2PP} are formed in the structure such that the optical axes of the lenses are substantially aligned with the optical pathways through the cavity 146 to facilitate one or more of collecting, collimating, and focusing of optical signals propagating from the ingoing side of the cavity 146 to the outgoing side of the cavity 146. In some embodiments, a solid structure is formed to support the in-structure lenses 138_{S2PP}. In other embodiments, a trussed structure is formed in which the support for the in-structure lenses 138_{S2PP} is not a solid structure formed of polymerized material but rather a webbed structure that provides support for the in-structure lenses 138_{S2PP}.

The lens array structure 130_{S2PP} in the embodiment shown in FIG. 29C is formed, for example, using two-photon polymerization in the embodiment in positional reference to the cavity alignment aids 128 formed in self-alignment with other alignment features such as FAU alignment aids 126 shown in FIG. 29C, T&G alignment aids 108 (not shown in FIG. 29C but referenced throughout herein), fiducials 114, and other alignment aids formed self-aligned with the cavity alignment aids 128 on the coupler 100. 3D printing of the lens array structure 130_{S2PP}, formed in reference to a self-aligned alignment aid such as cavity alignment aid 128, forms optical axes through the in-structure lenses 138_{S2PP} to which the optical axes of the cores of optical fibers 154 mounted or otherwise formed in FAU 156 may be aligned using other self-aligned alignment aids, such as FAU alignment aid 126.

Step 191-4 of method 191 shown in FIG. 28 is a singulating step in which the unsingulated coupler wafer comprising a plurality of couplers 100_{wafer} is singulated into two or more singulated couplers 100.

Step 191-5 of method 191 shown in FIG. 28 is a mounting step in which an optical isolator 132 is mounted or otherwise formed in the cavity 146 of coupler 100.

FIG. 29D shows a perspective schematic drawing of an embodiment of coupler assembly 102 comprising a singulated coupler 100 configured having a lens array structure 130_{S2PP} and optical isolator 132. FIG. 29D further shows the in-structure lenses 138_{S2PP} of lens array structure 130_{S2PP} in cavity 146 of the singulated couplers 100.

Step 191-6 of method 191 shown in the flowchart of FIG. 28 is an optional forming step in which coupler assembly 102 of FIG. 29D is further formed to include an FAU 156 configured having one or more optical fiber 154.

FIG. 29E shows a perspective schematic drawing of an embodiment of coupler assembly 102 comprising the coupler assembly 102 of FIG. 29D and further comprising FAU 156 configured having four optical fibers 154. FAU 156 is shown in FAU mounting site 152 on coupler 100 of the coupler assembly 102 in the embodiment. FAU 156, and the optical fibers 154 mounted or otherwise formed thereon, may be aligned, for example, using an alignment apparatus such as alignment apparatus 168 and the alignment procedures described in conjunction with the method 184.

Step 191-7 of method 191 is an optional forming step in which an embodiment of a PIC assembly is formed comprising an interposer assembly 104 and the coupler assembly 102 formed in step 191-6 of method 191 and configured having the one or more optical fiber.

FIG. 29F shows a perspective schematic drawing of an embodiment of PIC assembly 101 comprising an interposer assembly 104 and the coupler assembly 102 shown in FIG. 29E. The waveguide cores 107_{core} of the interposer assembly 104 and the optical pathways through the lenses 138_{S2PP} of the lens array 130_{S2PP} may be aligned, for example, using alignment apparatus 168 and the alignment procedures described in conjunction with the method 184.

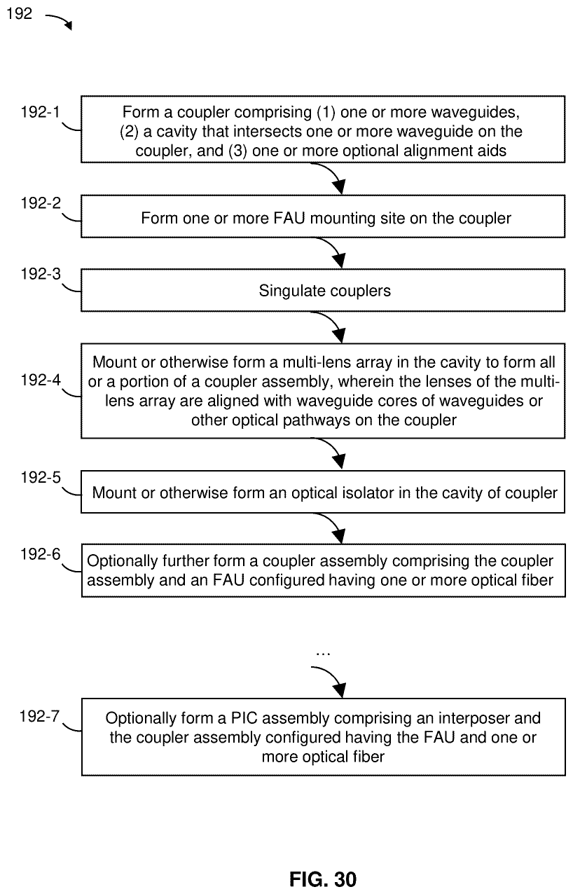

FIG. 30 shows a flowchart for a method 192 of forming other embodiments of coupler 100, other embodiments of coupler assembly 102, and other embodiments of PIC assembly 101 comprising coupler assembly 102 and interposer assembly 104 wherein coupler assembly 102 is configured having MLA lenses 138_{MLA} of a multi-lens array 130_{MLA} in cavity 146. As in the embodiments of coupler 100 shown, for example, in FIGS. 3A1-3A3, the embodiments of coupler 100 formed using method 192 are configured having one or more waveguides 106 formed on the ingoing side of cavity 146 and one or more waveguides 106 formed on the outgoing side of cavity 146.

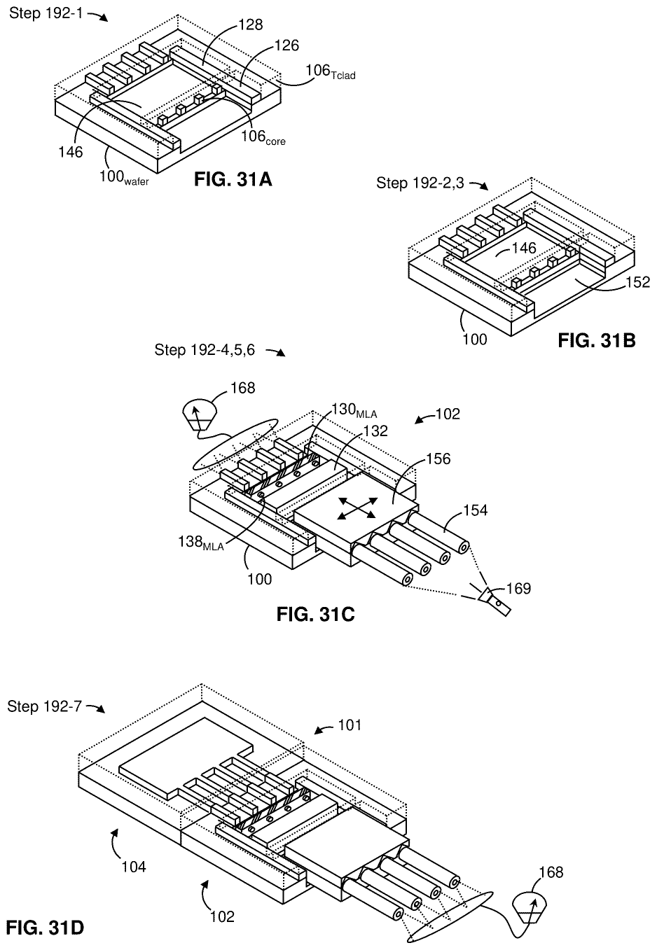

FIGS. 31A-31D show perspective schematic drawings of embodiments of the coupler 100, coupler assembly 102, and PIC assembly 101 at various steps in the process of formation of embodiments using method 192. The steps in the method 192 of FIG. 30 are described in conjunction with the perspective schematic drawings in FIGS. 31A-31D.

Step 192-1 of method 192 shown in FIG. 30 is a forming step in which an embodiment of a coupler comprising one or more waveguides, a cavity that intersects one or more waveguide on the coupler, and one or more optional alignment aids is formed. Embodiments of coupler 100 may be formed, for example, using method 195 shown in FIG. 14 described herein in conjunction with FIGS. 15A1-15F3.

FIG. 31A shows an embodiment of coupler 100_{wafer} configured having cavity 146 and optional alignment aids 126,128 wherein the coupler 100 is configured having four waveguides 106 formed on the ingoing side of cavity 146 and configured having four waveguides 106 formed on the outgoing side of cavity 146. In embodiments formed using coupler 100 and method 192, MLA lenses 138_{MLA} of a multi-lens array 130_{MLA}, mounted or otherwise formed in the cavity 146, are receptive to optical signals from the waveguide cores 106_{core} that terminate at the ingoing wall of cavity 146 and may be one or more of collected, narrowed, collimated, and focused, among other altering effects of propagating through the lens. MLA lenses 138_{MLA} of multi-lens array 130_{MLA} may facilitate, for example, improved coupling of optical signals to the terminal facets of the waveguide cores 106_{core} at the outgoing side of the cavity 146.

In an example of an optical signal propagating through the embodiment of a coupler assembly 102 configured having a multi-lens array 130_{MLA}, an optical signal emerging from a waveguide facet at the ingoing side of the cavity 146 is incident on an MLA lens 138_{MLA} of the multi-lens array 130_{MLA} and is one or more of collected, collimated, and re-focused as it propagates through the MLA lens 138_{MLA} of the multi-lens array 130_{MLA} to the terminal facet of a waveguide core 106_{core} at the outgoing side of the cavity 146. In the example, the collimating or re-focusing that results from the propagation through the MLA lens 138_{MLA} of the multi-lens array 130_{MLA} leads to a reduction in spot size in comparison to an uncollimated or unfocused optical signal, and the reduction in spot size leads to improved coupling of the optical signal to terminal facet of a waveguide core 106_{core} at the outgoing side of the cavity 146. The terminal facet of the waveguide core 106_{core} at the outgoing side of the cavity 146 may be configured having a spot size converter to further improve coupling of optical signals incident on the terminal facet on the wall of cavity 146. In embodiments having a single lens array, such as the single multi-lens array 130_{MLA} in embodiments formed using method 192, lenses configured having a greater collection area and a larger focal distance may be required in comparison to embodiments configured have two lens arrays.

In the embodiment of the coupler shown in FIG. 31A, the coupler shown is labeled having coupler 100_{wafer}. The suffix “wafer” added to the label “100” as in “100_{wafer}”, indicates that the coupler is a portion of an unsingulated coupler wafer having a plurality of couplers 100_{wafer} as further described herein.

The embodiment of the coupler 100_{wafer} is formed from a layered structure comprising a planar waveguide layer 105_{cplr} formed on a substrate 110_{cplr}. The layered structure may optionally include an electrical interconnect layer 133_{cplr} formed on the substrate 110_{cplr} wherein the planar waveguide layer 105 may be formed on the optional electrical interconnect layer 133_{cplr}. A top cladding layer 106_{Tclad} is shown as transparent in the perspective drawings in FIG. 31A-31D with dotted lines on the periphery to more clearly illustrate key features underlying the top cladding layer in the structure of the coupler shown in the drawings.

The embodiment of the coupler 100_{wafer} shown in FIG. 31A is configured having FAU alignment aids 126 formed on a portion of the periphery of the upper opening of the FAU mounting site 152 and cavity alignment aids 128 formed in the sidewalls in the flanking sides at the upper opening of the cavity 146. FAU alignment aids 126 and cavity alignment aids 128, in the embodiment of the coupler 100_{wafer}, may be formed in self-alignment with the waveguide cores 106_{core}. Although not shown in FIG. 31A, other lateral alignment aids such as T&G lateral alignment aids 108 and fiducials 114 may also be included in the formation of other embodiments.

Step 192-2 of method 192 shown in FIG. 30 is a forming step in which one or more FAU mounting site 152 is formed in the coupler 100_{wafer}. A method of forming FAU mounting site 152 is described, for example, in method 195 of FIG. 14, and in the cross-section drawings in FIGS. 15A1-15F1.

Step 192-3 of method 192 shown in FIG. 30 is a singulating step in which the unsingulated coupler wafer comprising a plurality of couplers 100_{wafer} is singulated into two or more singulated couplers 100.

FIG. 31B shows perspective schematic drawing of an embodiment of coupler 100 after steps 192-2 and 192-3 of method 192. In the embodiment of the coupler 100 in FIG. 31C, coupler 100 is shown after formation of FAU mounting site 152 and singulation of the unsingulated coupler wafer comprising the plurality of couplers 100_{wafer}. FIG. 31B shows cavity 146 configured having four waveguides 106 terminating on the ingoing wall of cavity 146 and configured having four waveguides 106 terminating on the outgoing side of cavity 146.

Step 192-4 of method 192 shown in FIG. 30 is a mounting step in which a multi-lens array is mounted or otherwise formed in the cavity 146 to form all or a portion of a coupler assembly 102, wherein the lenses 138_{MLA} of the multi-lens array 130_{MLA} are aligned with waveguide cores 106_{core} of waveguides 106 or other optical pathways formed on the coupler 100.

Step 192-5 of method 192 shown in the flowchart of FIG. 30 is a mounting step in which an optical isolator is mounted or otherwise formed in the cavity of coupler.

Step 192-6 of method 192 is an optional forming step in which the coupler assembly formed in step 192-5 of method 192 is further formed comprising the coupler assembly formed in step 192-5 of method 192 and an FAU configured having one or more optical fiber.

FIG. 31C shows a perspective schematic drawing of an embodiment of coupler assembly 102 formed following steps 192-4, 192-5, and 192-6. The perspective drawing of FIG. 31C shows an embodiment of coupler assembly 102 comprising the embodiment of coupler 100 of FIG. 31B configured having the FAU mounting site 152, multi-lens array 130_{MLA}, and optical isolator 132 after mounting of the multi-lens array 130_{MLA} and the optical isolator 132 in cavity 146 and the mounting of FAU 156 into the FAU mounting site 152 on the coupler 100.

FAU 156, and the optical fibers 154 mounted or otherwise formed thereon, may be aligned, for example, using an alignment apparatus such as alignment apparatus 168 and the alignment procedures described in conjunction with the methods 182 and 183.

Step 192-7 of method 192 is an optional forming step in which a PIC assembly is formed comprising an interposer and the embodiment of the coupler assembly shown in FIG. 31C configured having the FAU and one or more optical fiber.

FIG. 31D shows a perspective schematic drawing of an embodiment of PIC assembly 101 comprising interposer assembly 104 and coupler assembly 102 formed after steps 192-7 of method 192. The waveguide cores 107_{core} of the interposer assembly 104 may be aligned with the waveguide cores 106_{core} of the coupler assembly 102 in the embodiment, using alignment apparatus 168 and the alignment procedures described in conjunction with the methods 181-183 disclosed herein.

In some embodiments, cavity alignment aids 128 may be used to facilitate the all or a portion of an alignment procedure to align the MLA lenses 138_{MLA} of the multi-lens array 130_{MLA} with one or more waveguide core 106_{core} on the coupler 100 and off-chip optical signal sources. In some embodiments, FAU alignment aids 126 may be used to align, fully or in part, the FAU 156 to facilitate the alignment of the optical fiber cores 154_{core} of optical fibers 154 with the one or more of waveguide cores 106_{core} on the coupler 100.

In other embodiments, an optical signal source such as optical signal source 169 shown in FIG. 31C and in FIG. 31D, may be used in conjunction with alignment apparatus 168 to facilitate the alignment of one or more of the MLA lenses 138_{MLA} of the multi-lens array 130_{MLA}, the optical isolator 132, and the cores of the optical fibers 154 in the coupler assembly 102.

### Table 3: Listing of Embodiments Configured Having Two Lens Arrays

The embodiments of the coupler assemblies 102 shown in FIGS. 21A-21E, 23A-23E, 25A-25E, and 27A-27E provide examples of configurations that may be formed of coupler assemblies 102 configured having two lens arrays mounted or otherwise formed in cavity 146 of coupler 100. In some embodiments, the cavity 146 of the coupler 100 is configured having waveguides that terminate at the ingoing side of the cavity 146, and in some embodiments, the cavity 146 of the coupler 100 is configured having an opening in the ingoing side of the cavity 146 to enable free-space coupling of optical signals to the lenses of the lens arrays mounted or otherwise formed in the cavity 146. And in some embodiments, the cavity 146 of the coupler 100 is configured having waveguides that terminate at the outgoing side of the cavity 146, and in some embodiments, the cavity 146 of the coupler 100 is configured having an opening in the outgoing side of the cavity 146 to enable free-space coupling to the terminal facets of optical fibers mounted or otherwise formed in FAU 156 on coupler 100.

Methods 181-184 shown in the flowcharts of FIGS. 14, 22, 24, and 26, respectively, show examples of methods of formation of the embodiments of coupler assemblies 102 of FIGS. 21A-21E, 23A-23E, 25A-25E, and 27A-27E wherein the embodiments are configured having two lens arrays and a cavity configured having either one or more waveguides 106 terminating on the sidewall on the ingoing side of the cavity or an opening in the ingoing side of the cavity 146, and either one or more waveguides 106 terminating on the sidewall on the outgoing side of the cavity or an opening in the ingoing side of the cavity 146.

Table 3 lists the embodiments of FIGS. 21A-21E, 23A-23E, 25A-25E, and 27A-27E and other embodiments configured having either one or more waveguides 106 terminating on the sidewall on the ingoing side of the cavity or an opening in the ingoing side of the cavity 146, and either one or more waveguides 106 terminating on the sidewall on the outgoing side of the cavity or an opening in the ingoing side of the cavity 146 for embodiments configured having two lens arrays in cavity 100.

Rows numbered 1-25, under the heading “#” show configurations of embodiments of coupler assemblies 102 comprising a coupler 100 configured having two lens arrays and a cavity configured having either one or more waveguides 106 terminating on the sidewall on the ingoing side of the cavity or an opening in the ingoing side of the cavity 146, and either one or more waveguides 106 terminating on the sidewall on the outgoing side of the cavity or an opening in the ingoing side of the cavity 146.

In the column labeled “ingoing structure” under the header “WG or Open”, the configurations of the ingoing sidewall for embodiments of the coupler 100 of the coupler assembly 102 are listed as either “WG” or “Open”. Embodiments configured having the one or more waveguides 106 terminating on the sidewall on the ingoing side of the cavity show “WG” in the “ingoing structure” column of Table 3, and embodiments configured having an opening in the ingoing side of the cavity 146 show “open” in the “ingoing structure” column of Table 3.

In the column labeled “outgoing structure” under the header “WG or Open”, the configurations of the outgoing sidewall for embodiments of the coupler 100 of the coupler assembly 102 are listed as either “WG” or “Open”. Embodiments configured having the one or more waveguides 106 terminating on the sidewall on the outgoing side of the cavity show “WG” in the “outgoing structure” column of Table 3, and embodiments configured having an opening in the outgoing side of the cavity 146 show “open” in the “outgoing structure” column of Table 3.

In the embodiments of the coupler assembly 102 configured having two lens arrays, the lens array closer to the ingoing side of the cavity 146 is the lens array listed in Table 3 as the “ingoing lenses” and the lens array closer to the outgoing side of the cavity 146 is the lens array listed in Table 3 as the “outgoing lenses”.

In the column labeled “ingoing lenses” under the header “Lens structure”, the configurations of the lens array for embodiments of the coupler 100 of the coupler assembly 102 are listed as either “2PP on facet”, “2PP structure”, or “MLA”. Embodiments configured having one or more waveguides 106 terminating on the sidewall on the ingoing side of the cavity and 3D printed lenses formed on the facets of the waveguide cores show “2PP on facet” in the “ingoing lenses” column of Table 3. Only the embodiments configured having the one or more waveguides 106 terminating on the sidewall on the ingoing side of the cavity may be configured having the 3D printed lenses of the on-facet lens array 130_{F2PP} formed on the facets of the waveguide cores of the ingoing side of cavity 146.

Embodiments configured having a 3D printed lens structure having lens array structure 130_{S2PP} formed in the cavity 146 show “2PP structure” in the “ingoing lenses” column of Table 3. Embodiments configured having either the one or more waveguides 106 terminating on the sidewall on the ingoing side of the cavity or an opening in the ingoing side of the cavity 146 may be configured having a 3D printed lens array structure 130_{S2PP} formed in the cavity 146.

Embodiments configured having a multi-lens array 130_{MLA} formed in the cavity 146 show “MLA” in the “ingoing lenses” column of Table 3. Embodiments configured having either the one or more waveguides 106 terminating on the sidewall on the ingoing side of the cavity or an opening in the ingoing side of the cavity 146 may be configured having a multi-lens array 130_{MLA} mounted or otherwise formed in the cavity 146.

In the column labeled “outgoing lenses” under the header “Lens structure”, the configurations of the lens array for embodiments of the coupler 100 of the coupler assembly 102 are listed as either “2PP on facet”, “2PP structure”, or “MLA”. Embodiments configured having one or more waveguides 106 terminating on the sidewall on the outgoing side of the cavity and 3D printed lenses formed on the facets of the waveguide cores show “2PP on facet” in the “outgoing lenses” column of Table 3. Only the embodiments configured having the one or more waveguides 106 terminating on the sidewall on the outgoing side of the cavity may be configured having the 3D printed lenses of the on-facet lens array 130_{F2PP} formed on the facets of the waveguide cores of the outgoing side of cavity 146.

Embodiments configured having a 3D printed lens structure having lens array structure 130_{S2PP} formed in the cavity 146 show “2PP structure” in the “outgoing lenses” column of Table 3. Embodiments configured having either the one or more waveguides 106 terminating on the sidewall on the outgoing side of the cavity or an opening in the outgoing side of the cavity 146 may be configured having a 3D printed lens array structure 130_{S2PP} formed in the cavity 146.

Embodiments configured having a multi-lens array 130_{MLA} formed in the cavity 146 show “MLA” in the “outgoing lenses” column of Table 3. Embodiments configured having either the one or more waveguides 106 terminating on the sidewall on the outgoing side of the cavity or an opening in the outgoing side of the cavity 146 may be configured having a multi-lens array 130_{MLA} mounted or otherwise formed in the cavity 146.

In Table 3, the columns under the header “STEP in METHOD OF FORMATION”, the column show steps required in the formation of the embodiments listed in the column labeled “#”. Required steps in the formation of the embodiments listed are noted with an “X” in the corresponding column.

The first column under the header “STEP in METHOD OF FORMATION” is labeled, “FORM a substrate having a cavity”. This step is required for all embodiments shown in Table 3.

The second column under the header “STEP in METHOD OF FORMATION” is labeled, “FORM 1^{st} 2PP lenses in cavity”. This step shows an “X” in the rows showing embodiments that require the formation of a first lens array formed using two-photon polymerization or other 3D printing method.

The third column under the header “STEP in METHOD OF FORMATION” is labeled, “FORM 2^{nd} 2PP lenses in cavity”. This step shows an “X” in the rows showing embodiments that require the formation of a second lens array formed using two-photon polymerization or other 3D printing method.

The fourth column under the header “STEP in METHOD OF FORMATION” is labeled, “Mount/Align 1^{st} MLA”. This step shows an “X” in the rows showing embodiments that require the mounting and aligning of a first multi-lens array in cavity 146.

The fifth column under the header “STEP in METHOD OF FORMATION” is labeled, “Mount/Align 2^{nd} MLA”. This step shows an “X” in the rows showing embodiments that require the mounting and aligning of a second multi-lens array in cavity 146.

The sixth column under the header “STEP in METHOD OF FORMATION” is labeled, “MOUNT/ALIGN isolator”. This step shows an “X” in the rows showing embodiments that require the mounting and aligning of an optical isolator 132 in cavity 146. All embodiments of the coupler assembly 102 listed in Table 3 are configured having optical isolator 132 as noted.

The seventh column under the header “STEP in METHOD OF FORMATION” is labeled, “COUPLE/ALIGN one or more fibers”. This step shows an “X” in the rows showing steps in the formation of embodiments of coupler assemblies 102 comprising coupler 100, the two lens arrays, the optical isolator 132, and one or more optical fibers 154. In some embodiments, the optical fibers 154 are provided in coupler assembly 102. In some embodiments, however, the coupler assembly may be configured without optical fibers 154 and provided with the integration into another device or optical network.

The eighth column under the header “STEP in METHOD OF FORMATION” is labeled, “COUPLE/ALIGN interposer assembly”. This step shows an “X” in the rows showing embodiments of PIC assemblies 101 comprising the coupler assemblies 102 that require the mounting and aligning of an interposer to form the embodiments of PIC assembly 101. All embodiments of the PIC assembly 101 listed include the interposer assembly 104 with the coupler assemblies 102.

### Table 4: Listing of Embodiments Configured Having One Lens Array

The embodiments of the coupler assemblies 102 shown in FIGS. 29A-29E and 31A-31E provide examples of configurations that may be formed of coupler assemblies 102 configured having one lens array mounted or otherwise formed in cavity 146 of coupler 100. In some embodiments, the cavity 146 of the coupler 100 is configured having waveguides that terminate at the ingoing side of the cavity 146, and in some embodiments, the cavity 146 of the coupler 100 is configured having an opening in the ingoing side of the cavity 146 to enable free-space coupling of optical signals to the lenses of the lens arrays mounted or otherwise formed in the cavity 146. And in some embodiments, the cavity 146 of the coupler 100 is configured having waveguides that terminate at the outgoing side of the cavity 146, and in some embodiments, the cavity 146 of the coupler 100 is configured having an opening in the outgoing side of the cavity 146 to enable free-space coupling to the terminal facets of optical fibers mounted or otherwise formed in FAU 156 on coupler 100.

Method 191 and method 192 shown in the flowcharts of FIGS. 28 and 30, respectively, show examples of methods of formation of the embodiments of coupler assemblies 102 of FIGS. 29A-29E and 31A-31E wherein the embodiments are configured having one lens array and a cavity configured having either one or more waveguides 106 terminating on the sidewall on the ingoing side of the cavity or an opening in the ingoing side of the cavity 146, and either one or more waveguides 106 terminating on the sidewall on the outgoing side of the cavity or an opening in the ingoing side of the cavity 146.

Table 4 lists the embodiments of FIGS. 29A-29E and 31A-31E and other embodiments configured having either one or more waveguides 106 terminating on the sidewall on the ingoing side of the cavity or an opening in the ingoing side of the cavity 146, and either one or more waveguides 106 terminating on the sidewall on the outgoing side of the cavity 146 or an opening in the ingoing side of the cavity 146 for embodiments configured having one lens array in cavity 100.

Rows numbered 1-20, under the heading “#” show configurations of embodiments of coupler assemblies 102 comprising a coupler 100 configured having one lens array and a cavity configured having either one or more waveguides 106 terminating on the sidewall on the ingoing side of the cavity or an opening in the ingoing side of the cavity 146, and either one or more waveguides 106 terminating on the sidewall on the outgoing side of the cavity or an opening in the ingoing side of the cavity 146.

In the column labeled “ingoing structure” under the header “WG or Open”, the configurations of the ingoing sidewall for embodiments of the coupler 100 of the coupler assembly 102 are listed as either “WG” or “Open”. Embodiments configured having the one or more waveguides 106 terminating on the sidewall on the ingoing side of the cavity show “WG” in the “ingoing structure” column of Table 4, and embodiments configured having an opening in the ingoing side of the cavity 146 show “open” in the “ingoing structure” column of Table 4.

In the column labeled “outgoing structure” under the header “WG or Open”, the configurations of the outgoing sidewall for embodiments of the coupler 100 of the coupler assembly 102 are listed as either “WG” or “Open”. Embodiments configured having the one or more waveguides 106 terminating on the sidewall on the outgoing side of the cavity show “WG” in the “outgoing structure” column of Table 4, and embodiments configured having an opening in the outgoing side of the cavity 146 show “open” in the “outgoing structure” column of Table 4.

In embodiments of the coupler assembly 102 configured having one lens array, a lens array positioned between the ingoing side of the cavity 146 and the optical isolator 132 is listed in the column, “ingoing lenses”, and a lens array positioned between the optical isolator 132 and the outgoing side of the cavity 146 is listed in the column, “outgoing lenses”.

In the column labeled “ingoing lenses” under the header “Lens structure”, the configurations of the lens array for embodiments of the coupler 100 of the coupler assembly 102 are listed as either “2PP on facet”, “2PP structure”, or “MLA”. Embodiments configured having one or more waveguides 106 terminating on the sidewall on the ingoing side of the cavity and 3D printed lenses formed on the facets of the waveguide cores show “2PP on facet” in the “ingoing lenses” column of Table 4. Only the embodiments configured having the one or more waveguides 106 terminating on the sidewall on the ingoing side of the cavity may be configured having the 3D printed lenses of the on-facet lens array 130_{F2PP} formed on the facets of the waveguide cores of the ingoing side of cavity 146.

Embodiments configured having a 3D printed lens structure having lens array structure 130_{S2PP} formed in the cavity 146 show “2PP structure” in the “ingoing lenses” column of Table 4. Embodiments configured having either the one or more waveguides 106 terminating on the sidewall on the ingoing side of the cavity or an opening in the ingoing side of the cavity 146 may be configured having a 3D printed lens array structure 130_{S2PP} formed in the cavity 146.

Embodiments configured having a multi-lens array 130_{MLA} formed in the cavity 146 show “MLA” in the “ingoing lenses” column of Table 4. Embodiments configured having either the one or more waveguides 106 terminating on the sidewall on the ingoing side of the cavity or an opening in the ingoing side of the cavity 146 may be configured having a multi-lens array 130_{MLA} mounted or otherwise formed in the cavity 146.

In the column labeled “outgoing lenses” under the header “Lens structure”, the configurations of the lens array for embodiments of the coupler 100 of the coupler assembly 102 are listed as either “2PP on facet”, “2PP structure”, or “MLA”. Embodiments configured having one or more waveguides 106 terminating on the sidewall on the outgoing side of the cavity and 3D printed lenses formed on the facets of the waveguide cores show “2PP on facet” in the “outgoing lenses” column of Table 4. Only the embodiments configured having the one or more waveguides 106 terminating on the sidewall on the outgoing side of the cavity may be configured having the 3D printed lenses of the on-facet lens array 130_{F2PP} formed on the facets of the waveguide cores of the outgoing side of cavity 146.

Embodiments configured having a 3D printed lens structure having lens array structure 130_{S2PP} formed in the cavity 146 show “2PP structure” in the “outgoing lenses” column of Table 4. Embodiments configured having either the one or more waveguides 106 terminating on the sidewall on the outgoing side of the cavity or an opening in the outgoing side of the cavity 146 may be configured having a 3D printed lens array structure 130_{S2PP} formed in the cavity 146.

Embodiments configured having a multi-lens array 130_{MLA} formed in the cavity 146 show “MLA” in the “outgoing lenses” column of Table 4. Embodiments configured having either the one or more waveguides 106 terminating on the sidewall on the outgoing side of the cavity or an opening in the outgoing side of the cavity 146 may be configured having a multi-lens array 130_{MLA} mounted or otherwise formed in the cavity 146.

As for Table 3, the columns in Table 4 under the header “STEP in METHOD OF FORMATION”, show steps required in the formation of the embodiments listed in the column labeled “#”. Required steps in the formation of the embodiments listed are noted with an “X” in the corresponding column.

The first through eighth columns in Table 4 are as described for Table 3. Embodiments configured having one lens array in the coupler assemblies 102 in Table 4 show a reduced number of configurations and also a reduction in the number of steps required in the formation of the embodiments.

### PIC Assemblies Comprising Interposer Assemblies and Coupler Assemblies Wherein the Interposer Assemblies are Configured Having Optical Devices in an Interposer Cavity

Embodiments disclosed in this and the following section are example embodiments of PIC assemblies 101 comprising interposer assembly 104 and coupler assembly 102 wherein the interposer assembly 104 is configured having optoelectrical devices 120 configured as optical emitting devices, and wherein the coupler assembly 102 is configured with one or more lenses in cavity 146. Embodiments include interposer assemblies 104 configured having optical emitting devices such as lasers, hybrid laser assemblies, and lasers coupled to semiconductor optical amplifiers (SOAs) on either the interposer assembly 104 or on the coupler assembly 101, among other configurations. Other embodiments having one or more optoelectrical device 120 configured, for example, as a gain device, a light emitting diode, a laser, among other forms of light emitting device may also be used.

In some embodiments of PIC assemblies 101 comprising interposer assembly 104 and coupler assembly 102, the interposer assembly 104 may be configured having one or more optoelectrical devices 120 wherein the one or more optoelectrical devices 120 are configured as optical emitting devices. An optoelectrical device 120 configured as an optical emitting device may be, for example, all or a portion of a distributed feedback (DFB) laser, a ridge waveguide laser, a buried heterostructure laser, hybrid laser, a gain device, a semiconductor optical amplifier, a light emitting diode, among other optical emitting devices. An optoelectrical device 120 may be a single emission device and optoelectrical device 120 may comprise two or more optical emitting devices coupled or otherwise combined in an assembly having two or more optical emitting devices. In an example, optoelectrical device 120 may comprise an array of four DFB lasers on a common substrate that enables, for example, the simultaneous mounting and alignment of the array into a cavity 148 formed on the interposer 103.

TABLE 3
Configurations of ingoing side of cavity and lens array, and of outgoing side of cavity and lens array for
embodiments of coupl [symbol] assemblies having two lens arrays.

| | | | | | STEP in METHOD OF FORMATION | | | | | | | |
|---|---|---|---|---|---|---|---|---|---|---|---|---|
| | | | | | COUPLER ASSEMBLY | | | | | | | |
| | | | | | FORM | FORM | FORM | | | | COUPLE/ | |
| | | | | | sub- | 1^{st} 2PP | 2^{nd} 2PP | | | | ALIGN | C [symbol] / |
| | WG or Open | | Lens Structure | | strate | lenses | lenses | MOUNT/ | MOUNT/ | MOUNT/ | one or | A [symbol] |
| | ingoing | outgoing | ingoing | outgoing | having | in | in | ALIGN | ALIGN | ALIGN | more | int [symbol] |
| [symbol] | structure | structure | lenses | lenses | cavity | cavity | cavity | 1^{st} MLA | 2^{nd} MLA | isolator | fiber | as [symbol] |
| [symbol] | WG | WG | 2PP on facet | 2PP on facet | X | X | X | | | X | X | [symbol] |
| | WG | WG | 2PP on facet | 2PP structure | X | X | X | | | X | X | |
| | WG | WG | 2PP structure | 2PP on facet | X | X | X | | | X | X | |
| | WG | WG | 2PP structure | 2PP structure | X | X | X | | | X | X | |
| | open | WG | 2PP structure | 2PP on facet | X | X | X | | | X | X | |
| | open | WG | 2PP structure | 2PP structure | X | X | X | | | X | X | |
| | WG | open | 2PP on facet | 2PP structure | X | X | X | | | X | X | |
| | WG | open | 2PP structure | 2PP structure | X | X | X | | | X | X | |
| | open | open | 2PP structure | 2PP structure | X | X | X | | | X | X | |
| | WG | WG | MLA | 2PP structure | X | X | | X | | X | X | |
| | WG | WG | 2PP structure | MLA | X | X | | X | | X | X | |
| | WG | WG | 2PP on facet | MLA | X | X | | X | | X | X | |
| | WG | WG | MLA | 2PP on facet | X | X | | X | | X | X | |
| | open | WG | MLA | 2PP on facet | X | X | | X | | X | X | |
| | open | WG | MLA | 2PP structure | X | X | | X | | X | X | |
| | open | WG | 2PP structure | MLA | X | X | | X | | X | X | |
| | WG | open | 2PP on facet | MLA | X | X | | X | | X | X | |
| | WG | open | 2PP structure | MLA | X | X | | X | | X | X | |
| | WG | open | MLA | 2PP structure | X | X | | X | | X | X | |
| | open | open | 2PP structure | MLA | X | X | | X | | X | X | |
| | open | open | MLA | 2PP structure | X | X | | X | | X | X | |
| | WG | WG | MLA | MLA | X | | | X | X | X | X | |
| | open | WG | MLA | MLA | X | | | X | X | X | X | |
| | WG | open | MLA | MLA | X | | | X | X | X | X | |
| | open | open | MLA | MLA | X | | | X | X | X | X | |

[symbol]

indicates data missing or illegible when filed

TABLE 4
Configurations of ingoing side of cavity and lens array, and of outgoing side of cavity and lens array for en [symbol]
assemblies having one lens array.

| | | | | | STEP in METHOD OF FORMATI [symbol] | | | | | |
|---|---|---|---|---|---|---|---|---|---|---|
| | | | | | COUPLER ASSEMBLY | | | | | |
| | | | | | FORM | FORM | FORM | | | |
| | | | | | sub- | 2PP | 2PP | | | |
| | WG or Open | | Lens Structure | | strate | lenses | lenses | MOUNT/ | MOUNT/ | MOU [symbol] / |
| | ingoing | outgoing | ingoing | outgoing | having | in | in | ALIGN | ALIGN | ALIG [symbol] |
| # | structure | structure | lenses | lenses | cavity | cavity | cavity | MLA | MLA | isolat [symbol] |
| 1 | WG | WG | 2PP on facet | | X | X | | | | X |
| 2 | WG | WG | 2PP structure | | X | X | | | | X |
| 3 | open | WG | 2PP structure | | | X | | | | X |
| 4 | WG | open | 2PP on facet | | X | X | | | | X |
| 5 | WG | open | 2PP structure | | X | X | | | | X |
| 6 | open | open | 2PP structure | | X | X | | | | X |
| 7 | WG | WG | MLA | | X | | | X | | X |
| 8 | open | WC | MLA | | X | | | X | | X |
| 9 | WG | open | MLA | | X | | | X | | X |
| 10 | open | open | MLA | | X | | | X | | X |
| 11 | WG | WG | | 2PP on facet | X | | X | | | X |
| 12 | WG | WG | | 2PP structure | X | | X | | | X |
| 13 | open | WG | | 2PP on facet | X | | X | | | X |
| 14 | open | WG | | 2PP structure | X | | X | | | X |
| 15 | WG | open | | 2PP structure | X | | X | | | X |
| 16 | open | open | | 2PP structure | X | | X | | | X |
| 17 | WG | WG | | MLA | X | | | | X | X |
| 18 | open | WG | | MLA | X | | | | X | X |
| 19 | WG | open | | MLA | X | | | | X | X |
| 20 | open | open | | MLA | X | | | | X | X |

[symbol]

indicates data missing or illegible when filed

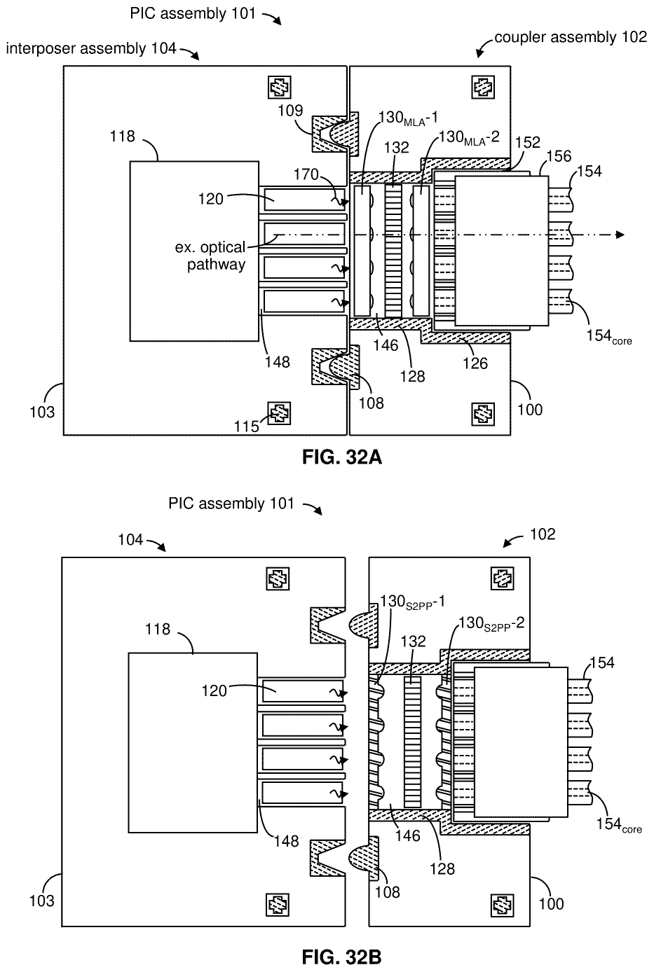

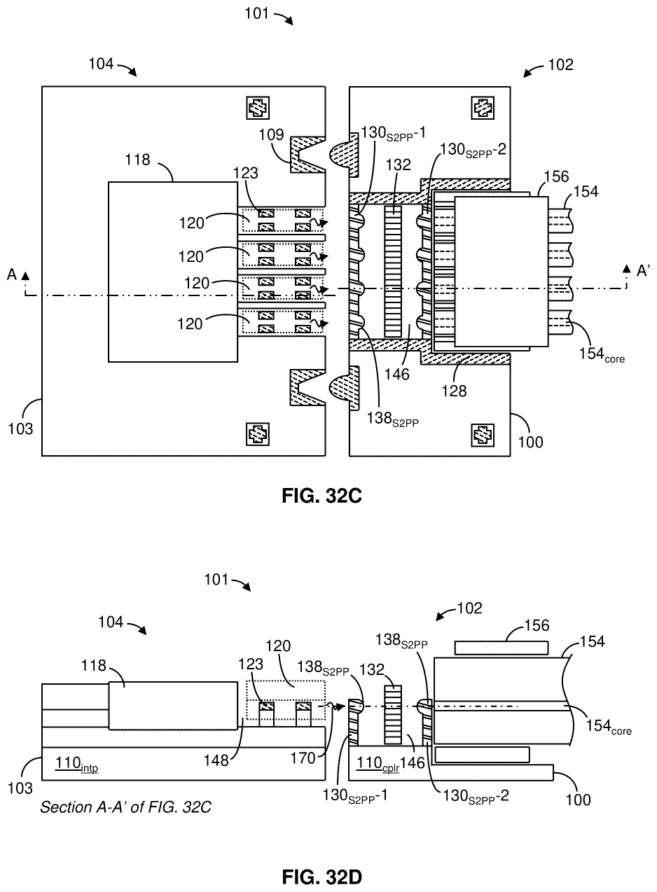

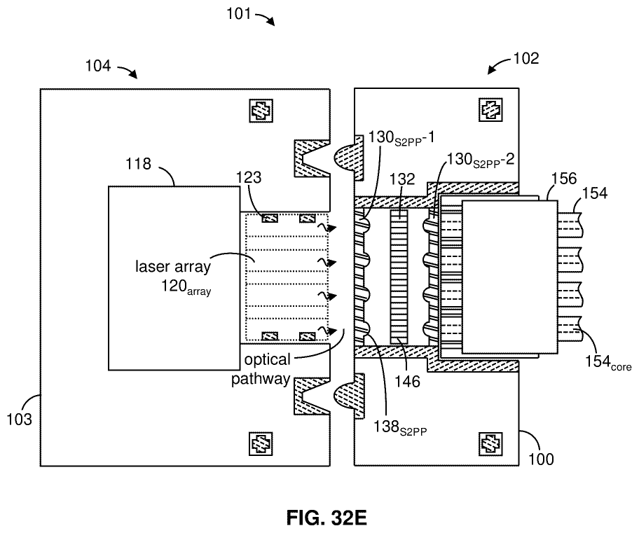

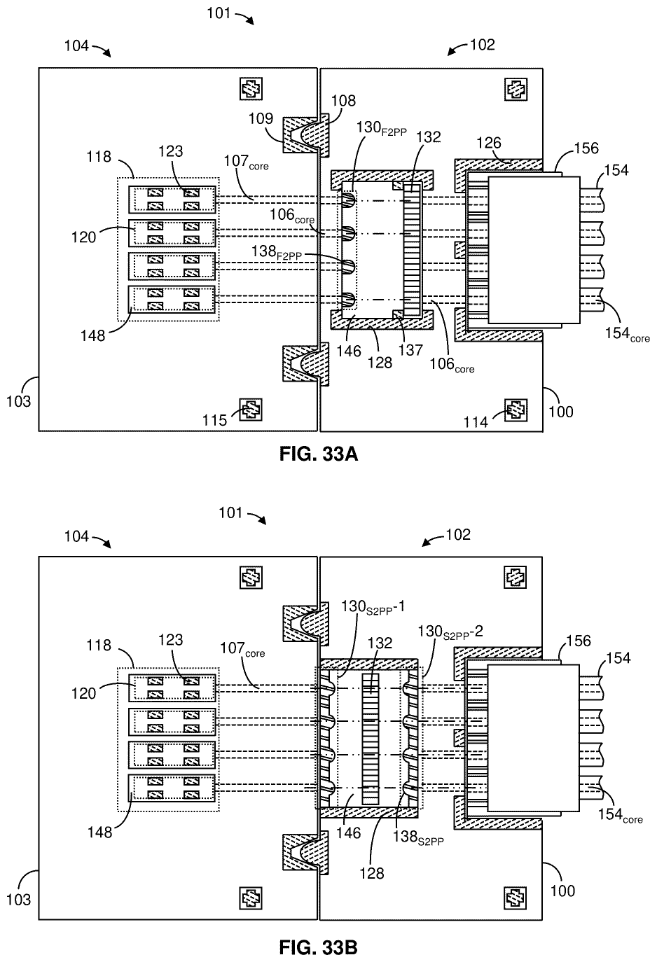

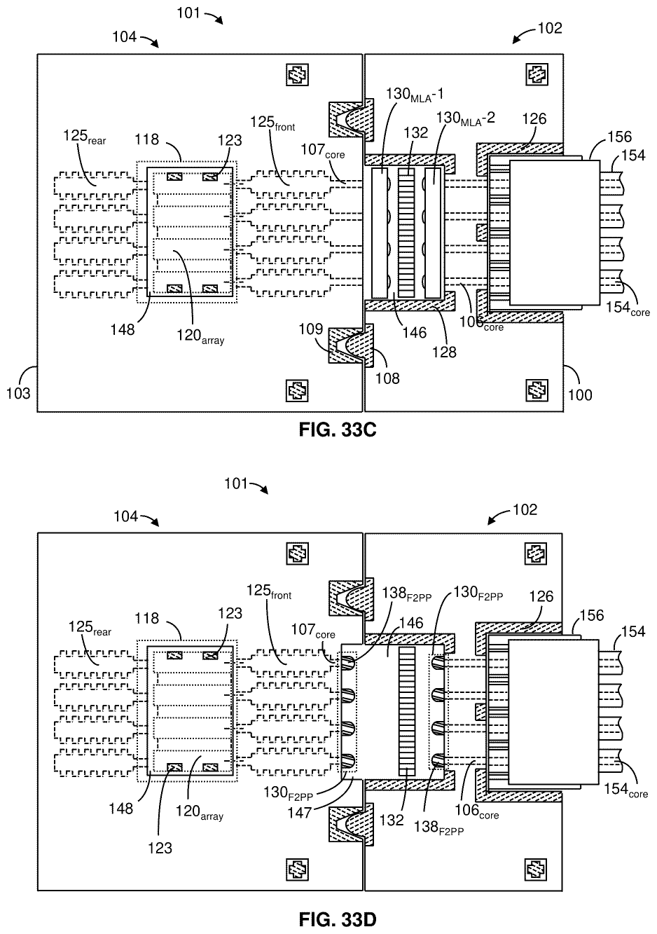

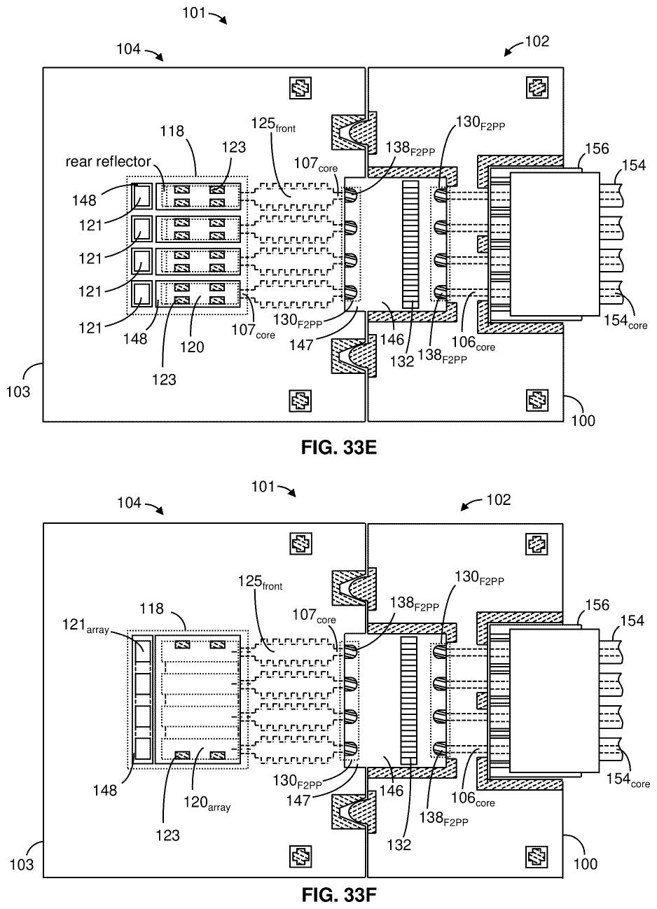

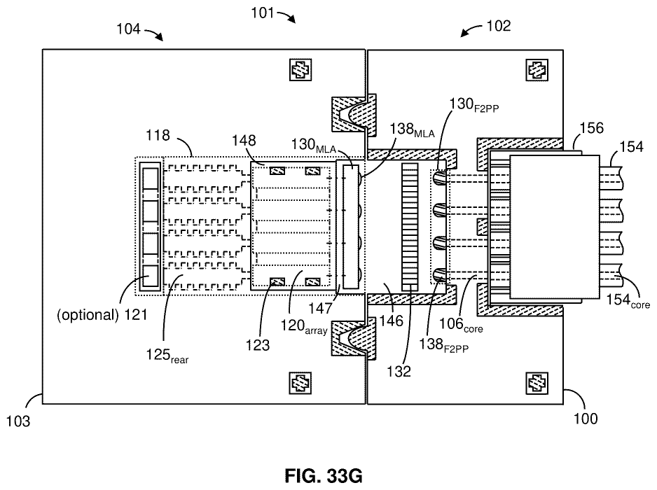

FIGS. 32A-32E and FIGS. 33A-33G show embodiments of interposer assembly 104 configured having one or more optoelectrical device 120 mounted in a cavity 148 formed on the interposer 103 of interposer assembly 104 wherein the optoelectrical device 120 is configured to provide optical signals to embodiments of coupler assembly 102 receptive to optical signals. In some embodiments, interposer 103 of interposer assembly 104 may be configured having T&G alignment aids 109 receptive to T&G alignment aids 108 formed on a coupler assembly 102 to facilitate the coupling and alignment of the interposer assembly 104 and coupler assembly 102 to form PIC assembly 101 wherein the coupling and alignment may include the coupling and alignment of waveguides or optical pathways on the interposer assembly 104 with waveguides or optical pathways on the coupler assembly 102 as further described herein.

FIGS. 32A-32E show embodiments of PIC assembly 101 configured to enable free-space coupling between optical emitting devices mounted or otherwise formed on interposer 103 and lenses formed or otherwise mounted in cavity 146 of coupler 100.

FIG. 32A shows an exploded top-view schematic drawing of an embodiment of a PIC assembly 101 comprising interposer assembly 104 and coupler assembly 102, wherein the interposer assembly 104 is configured having four optoelectrical devices 120 each mounted in a cavity 148 formed in interposer 103. In the embodiment, cavity 146 of coupler 100 is configured having an optical isolator 132 mounted or otherwise formed between a first multi-lens array 130_{MLA}-1 and second multi-lens array 130_{MLA}-2, respectively. The PIC assembly 101 is configured to enable free-space coupling of optical signals from the optoelectrical devices 120 mounted or otherwise formed in the cavities 148 on the interposer 103 and the MLA lenses 138_{MLA} of the first multi-lens array 130_{MLA}-1 mounted in cavity 146 of coupler 100 and further configured to enable free-space coupling of optical signals between the MLA lenses 138_{MLA} of second multi-lens array 130_{MLA}-2 also mounted in cavity 146 and the terminal facets 154_{facet} of the optical fibers 154 mounted or otherwise formed in FAU 156 on coupler 100.

In the embodiment shown in FIG. 32A, an example optical signal emerging from an optoelectrical device 120 configured as a DFB laser, for example, is incident on, and propagates through, MLA lens 138_{MLA} of the first multi-lens array 130_{MLA}-1 in cavity 146 of the coupler 100, the optical isolator 132, and an MLA lens 138_{MLA} of the second multi-lens array 130_{MLA}-2 before reaching the terminal facet 154_{facet} of an optical fiber 154 mounted or otherwise formed in FAU 156 on the coupler 100. FIG. 32A shows optional cavity alignment aids 128 in the embodiment that may be used to facilitate lateral alignment of one or more of the optical isolator 132 and one or more of the multi-lens arrays 130_{MLA} in the cavity 146.

In some embodiments, optoelectrical device 120 may be configured as a laser device. In other embodiments, optoelectrical device 120 may be configured as a gain device. In yet other embodiments, optoelectrical device 120 may be configured as an LED. And in yet other embodiments, optoelectrical device 120 may be configured as all or a portion of another optoelectrical device. In the embodiment shown in FIG. 32A, optoelectrical device 120 is configured as an optical emitting device.

FIG. 32B shows an exploded top-view schematic drawing of an embodiment of PIC assembly 101 comprising interposer assembly 104 and coupler assembly 102, wherein the interposer assembly 104 is configured having four optoelectrical devices 120 mounted in cavities 148 formed on the interposer 103, and wherein the coupler assembly 102 is configured having an optical isolator 132 and two 3D printed lens array structures 130_{S2PP}-1, 130_{S2PP}-2 formed in cavity 146 of coupler 100, and wherein the interposer assembly 104 and the coupler assembly 102 are configured to enable free-space coupling of optical signals from the cavity-mounted optoelectrical devices 120 mounted or otherwise formed on interposer 103 and in-structure lenses 138_{S2PP} of the first lens array structure 130_{S2PP}-1. In the embodiment, lens structures 130_{S2PP}-1, 130_{S2PP}-2 may be formed using two-photon polymerization of other 3D printing method. The coupler assembly 102, in the embodiment shown in FIG. 32B, is further configured to enable free-space coupling of optical signals between the in-structure lenses 138_{S2PP} of a second lens array structure 130_{S2PP}-2 and the terminal facets 154_{facet} of the optical fibers 154 mounted in FAU 156 of coupler 100. In the embodiment, the coupler assembly 102 is configured having an optical isolator 132 positioned between a first lens array structure 130_{S2PP}-1 formed in a lens array structure 130_{S2PP}, for example, using two-photon polymerization and a second lens array structure 130_{S2PP}-2 formed in a lens array structure 130_{S2PP} also formed, for example, using two-photon polymerization.

The cavity 146, in the embodiment of the coupler assembly 102 shown in FIG. 32B, is configured to enable free-space coupling of optical signals emitted from, or propagating through, an optoelectrical device 120, for example, and the in-structure lenses 138_{S2PP} of the first lens array structure 130_{S2PP}-1 in a lens array structure 130_{S2PP}. The cavity 146 in the embodiment of the coupler assembly 102 is further configured to enable free-space coupling of optical signals between the in-structure lenses 138_{S2PP} of the second lens array structure 130_{S2PP}-2 in a lens array structure 130_{S2PP} and the terminal facets 154_{facet} of optical fibers 154 mounted or otherwise formed in FAU 156 on coupler 100.

In the embodiment shown in FIG. 32B, an example optical signal 170 emerging from an optoelectrical device 120 mounted or otherwise formed on the interposer assembly 104, is incident on an in-structure lens 138_{S2PP} of the first lens array structure 130_{S2PP}-1 of lens array structure 130_{S2PP} in the embodiment, which then propagates through the in-structure lens 138_{S2PP} of lens array structure 130_{S2PP}, the optical isolator 132, and an in-structure lens 138_{S2PP} of lens array structure 130_{S2PP} before reaching a terminal facet 154_{facet} of an optical fiber 154 mounted or otherwise formed in a FAU 156 on coupler 100. FIG. 32B shows optional cavity alignment aids 128 in the embodiment that may be used to facilitate lateral alignment of the optical isolator 132. First lens array structure 130_{S2PP}-1 of a lens array structure 130_{S2PP} and second lens array structure 130_{S2PP}-2 of another lens array structure 130_{S2PP} may be formed using two-photon polymerization, for example, within the cavity 146 wherein the optical axes of the in-structure lenses 138_{S2PP} of the first lens array structure 130_{S2PP}-1 are formed in alignment with the in-structure lenses 138_{S2PP} of the second lens array structure 130_{S2PP}-2 in the embodiment.

FIGS. 32C-32E show embodiments of PIC assembly 101 wherein the cavities 148 on interposer assembly 104 are configured having alignment pillars 123 that are formed self-aligned with T&G lateral alignment aids 109 and fiducials 115 of interposer 103. Lateral alignment pillars 123 facilitate the alignment of one or more optical axis of device 120 mounted in the cavity with other features formed self-aligned with the alignment pillars 123.

FIG. 32C shows an embodiment of the PIC assembly 101 as in FIG. 32B with cavities 148 of interposer 103 further configured having alignment pillars 123 formed self-aligned with waveguide cores 107_{core}, and with T&G alignment features 109 and fiducials 115. Alignment pillars 123 facilitate alignment of an optical axis of an optoelectrical device 120 mounted in cavity 148 with one or more waveguide cores and other devices mounted or otherwise positioned on interposer 103 that are formed in self-alignment on interposer 103. Interposer 103 configured having alignment pillars 123 formed in self-alignment with T&G alignment features 109 further facilitates the alignment of the optical axis of an optoelectrical device 120 mounted on, or otherwise coupled to the alignment pillars 123 with the optical axis of one or more optical devices or features formed on coupler 100 that are formed in self-alignment with the one or more T&G alignment aids 108 on the coupler 100 by the coupling of the one or more T&G alignment features 109 of interposer 103 and the one or more T&G alignment features 108 of coupler 100. In the embodiment of the PIC assembly 101 shown in FIG. 32C, the coupler assembly 102 is configured having an optical isolator 132 and two 3D printed lens structures 130_{S2PP}-1, 130_{S2PP}-2 formed in cavity 146 of the coupler 100. Interposer assembly 104 and coupler assembly 102, in the embodiment, are configured to enable free-space coupling of optical signals from the optoelectrical devices 120 on the interposer assembly 104 to the lenses 138_{S2PP} of the lens array structures formed in cavity 146 of coupler 100. In FIG. 32C, the optoelectrical devices 120 are shown in dotted lines in the device-mounting cavities 148 on the interposer 103 for clarity.

FIG. 32D shows a cross-sectional exploded schematic drawing of the embodiment of PIC assembly 101 shown in FIG. 32C. Optoelectrical device 120 is shown in the cross-section on alignment pillars 123 in cavity 148 of interposer 103 in the embodiment. An example optical signal 170 shown emerging from the optoelectrical device 120 is free-space coupled to in-structure lens 138_{S2PP} of the first lens array structure 130_{S2PP}-1, propagates through the in-structure lens 138_{S2PP} of the lens array structure 130_{S2PP}-1 and the optical isolator 132 to the in-structure lens 138_{S2PP} of the second lens array structure 130_{S2PP}-2 to the terminal facets 154_{facet} of the optical fiber 154 in the FAU 156 on the coupler 100 in the embodiment. Additional circuitry may be provided in PIC 118 in the embodiment such as one or more of a driver circuit and a modulator circuit, among other devices and circuits.

FIG. 32E shows a top-view schematic drawing of yet another embodiment of PIC assembly 101 comprising interposer assembly 104 and coupler assembly 102 configured having the embodiment of the coupler assembly 102 as in the embodiment shown in FIG. 32B, wherein the interposer assembly 104 of the PIC assembly 101 is configured having an optoelectrical device array 120_{array} comprising four optoelectrical devices in an array format. In an array, four optoelectrical devices 120 may be formed on a same substrate, for example. Optoelectrical devices 120 such as optoelectrical device array 120_{array} shown in FIG. 32E enables a single device having a plurality of output optical signals, for example, to be mounted or otherwise coupled to interposer 103 in cavity 148. The cavity 148 in the embodiments, is shown configured having four alignment pillars 123 in cavity 148 to facilitate alignment of the four devices of optoelectrical device array 120_{array} in the embodiment. In some embodiments, cavity 148 may be configured having more than four alignment pillars 123. In other embodiments, cavity 148 may be configured having less than four alignment pillars 123. In embodiments, a cavity 148 of interposer 103 may be configured having one or more alignment pillars 123 formed self-aligned with waveguide cores 107_{core}, other alignment aids 126,128, T&G alignment aids 109, fiducials 115, other alignment pillars formed in other cavities 148 on interposer 103, and optical axes formed in reference to a self-aligned alignment aid. The one or more alignment pillars 123 may also be formed self-aligned with other alignment features formed on the interposer 103. In the embodiment, optoelectrical device array 120_{array} mounted or otherwise coupled to alignment pillars 123 is configured having four optical signal outputs as illustrated in FIG. 32E. In other embodiments, the cavity 148 and alignment pillars 123 may be configured for optoelectrical devices 120 having one or more optical outputs. Optoelectrical devices 120 formed having two or more optical outputs enable the coupling of a plurality of devices with a single alignment process in cavities 148 configured for the devices having the plurality of outputs.

Cavity 148 of interposer 103 shown in the embodiment of FIG. 32E is configured having alignment pillars 123 that are formed self-aligned with T&G alignment feature 109 and fiducials 115 to facilitate alignment of the plurality of optical axes of optoelectrical device array 120_{array} mounted in cavity 148 with the other self-aligned features formed on interposer 103 in the embodiment. Alignment of the optical axes of optoelectrical device array 120_{array} with alignment features 109 facilitates the alignment of the optical axes of the optoelectrical device array 120_{array} with the optical axes of in-structure lenses 138_{S2PP} formed on coupler 100 by the coupling of the one or more T&G alignment features 109 of interposer 103 and the one or more T&G alignment features 108 of coupler 100.

PIC Assemblies Comprising Interposer Assemblies and Coupler Assemblies Wherein the Interposer Assemblies are Configured Having Optoelectrical Devices in an Interposer Cavity Coupled to Waveguides and Wherein the Waveguides May Further Include Surface Gratings Used in the Formation of Hybrid Lasers

In some embodiments of PIC assemblies 101 comprising interposer assembly 104 and coupler assembly 102, the interposer assembly 104 may be configured having one or more waveguides coupled to one or more optoelectrical devices 120 configured, for example, as optical emitting devices and mounted or otherwise formed in cavity 148 on interposer 103. An optoelectrical device 120 configured as an optical emitting device may be, for example, all or a portion of a distributed feedback (DFB) laser, a ridge waveguide laser, a buried heterostructure laser, hybrid laser, a gain device, a semiconductor optical amplifier, a light emitting diode, among other emitting devices. An optoelectrical device 120 may be a single emission device and optoelectrical device 120 may comprise two or more optical emitting devices coupled or otherwise combined in an assembly having two or more optical emitting devices. In an example, optoelectrical device 120 may comprise an array of four DFB lasers on a common substrate that enables, for example, the simultaneous mounting and alignment of the array into a cavity 148 formed on the interposer 103.

FIGS. 33A-33G show top-view schematic drawings of embodiments of PIC assembly 101 wherein the interposer assembly 104 is configured having one or more optoelectrical device 120 mounted in a cavity 148 and wherein the one or more device 120 is coupled to a waveguide core 107_{core} formed on the interposer 103. Optoelectrical devices 120, in embodiments, are configured to provide optical signals to the one or more waveguide cores 107_{core} of waveguides 107 that are coupled to coupler assembly 102 in the embodiments shown in FIG. 33A-33G. Coupler assembly 102, in the embodiments, is configured to be receptive to the optical signals emitted from the optoelectrical devices 120 propagating through the one or more waveguide cores 107_{core} of the interposer 103. In some embodiments, interposer 103 of interposer assembly 104 may be configured having T&G alignment aids 109 receptive to T&G alignment aids 108 formed on a coupler assembly 102 to facilitate the coupling and alignment of the interposer assembly 104 and coupler assembly 102 to form PIC assembly 101 wherein the coupling and alignment may include the coupling and alignment of waveguides on the interposer assembly 104 with waveguides or optical pathways on the coupler assembly 102.

In some of the embodiments shown in the schematic drawings of FIGS. 33A-33G, the PIC assembly 101 is configured to enable free-space coupling between waveguides 107 of the interposer assembly 104 and lenses 138 formed or otherwise mounted in cavity 146 of coupler 100. And in some embodiments, an intervening lens array 130 between terminal facets of the waveguide cores 107_{core} of the interposer 103 and an optical isolator 132 or lens array 130 in cavity 146 of the coupler 100 is mounted or otherwise formed either in a cavity 147 on the interposer 103 or in the cavity 148 of the coupler 100. In the schematic drawings of

FIGS. 33A-33F, the embodiments of interposer assembly 104 of PIC assembly 101 are shown configured having waveguides 107 between the cavities 148, within which devices 120 are mounted, and the edge of interposer 103 facing coupler 100 in the PIC assembly 101. Optical signals, in the embodiments, are coupled between the terminal facets 107_{facet} of the waveguides 107 on interposer 103 and waveguides 106, lenses 138, or other devices on coupler 100. The embodiments shown in FIGS. 33C-33F are further configured having wavelength selection devices configured as front lateral gratings 125_{front} formed in the layers used in the formation of waveguides 107 between the cavities 148 of interposer 103 and the edge of interposer 103 facing coupler 100 in PIC assembly 101. The embodiment of the interposer assembly 104 shown in FIG. 33G is not configured having waveguide cores between the devices 120 and a first lens array 130, but rather the PIC assembly 101 is configured to enable free-space coupling of optical signals from optoelectrical devices 120 coupled to rear grating structures for comparison to the embodiments of the interposer assembly 104 configured having front grating structures as in, for example, FIGS. 33E and 33F.

FIG. 33A shows a top-view schematic drawing of an embodiment of PIC assembly 101 comprising interposer assembly 104 and coupler assembly 102, wherein the interposer assembly 104 is configured having four optoelectrical devices 120, mounted or otherwise formed in four cavities 148 on interposer 103, and coupled to waveguide cores 107_{core} formed on the interposer 103, and wherein the coupler assembly 102, in the embodiment, is configured having optical isolator 132 and on-facet lens array 130_{F2PP} formed on the ingoing side of cavity 146 on coupler 100.

The outlines of the four optoelectrical devices 120 are shown in dotted lines within cavity 148 of the interposer 103, in the embodiment of PIC assembly 101 in FIG. 33A wherein the cavities 148 are configured having alignment pillars 123 formed self-aligned with the waveguide cores 107_{core} formed on the interposer 103. Also formed self-aligned with the waveguide cores 107_{core} are T&G alignment features 109 and fiducials 115.

Coupler 100, in the embodiment of PIC assembly 101, is configured having a cavity 146 that includes an optical isolator 132 and on-facet lenses 138_{F2PP} of on-facet lens array 130_{F2PP} formed, for example, using two-photon polymerization on terminal facets 106_{facet} of waveguide cores 106_{core}. In the embodiment, the coupler assembly 102 is configured having on-facet lenses 138_{F2PP} in one on-facet lens array 130_{F2PP} formed using two-photon polymerization or other 3D printing method. In an embodiment, alignment feature 137 and other alignment features may be formed in cavity 146 using 3D printing to facilitate alignment of the optical isolator 132. Alignment feature 137, in some embodiments, may be included in cavity 146, for example, to limit the range of rotation of the optical isolator 132, in addition to the lateral positioning. Optical isolator 132, lacking a specific and narrowly defined optical axis, have significant latitude in lateral spacing but the effectiveness of these devices may be influenced significantly by the rotational alignment within the cavity. Alignment aids such as alignment aid 137, may be used to limit the available rotational range of optical isolator 137 prior to its being secured in a fixed position in the cavity 146. In some embodiments, alignment aid 137 may be formed using 3D printing. In other embodiments, alignment aid 137 may be formed fully or in part, with the cavity alignment aids 128. In other embodiments, coupler assembly 102 may be configured, for example, having in-structure lenses 138_{S2PP} in one lens array structure 130_{S2PP} formed using two-photon polymerization. And in yet other embodiments, coupler assembly 102 may be configured, for example, having MLA lenses 138_{MLA} of a lens array 130 configured as a multi-lens array 130_{MLA}. Embodiments of coupler assembly 102 configured having one lens array are described herein in conjunction with FIGS. 19A-19T, and are listed in Table 4. Alignment of the waveguide cores 107_{core} of the interposer 103 and the waveguide cores 106_{core} of the coupler 100 may be achieved all or in part by coupling the T&G alignment features 109 formed self-aligned with the waveguide cores 107_{core} of the interposer 103 with the complementary T&G alignment features 108 formed self-aligned with the waveguide cores 106_{core} on the coupler 100.

In the embodiment shown in FIG. 33A, waveguide cores 107_{core} on interposer 103 couple devices 120 mounted or otherwise formed on the alignment pillars 123 in the cavities 148 to the waveguide cores 106_{core} of the coupler 100 and to an on-facet lens array 130_{F2PP} formed on the terminal facets 106_{facet} of waveguide core 106_{core} on coupler 100. Alignment pillars 123 facilitate alignment of the optical axis of an optoelectrical device 120 mounted in cavity 148 with the waveguide cores 107_{core} formed on the interposer 103 and with other self-aligned features formed on interposer 103 in the embodiment. Alignment of the optical axis of an optoelectrical device 120 mounted or otherwise formed in a cavity 148 with the waveguide cores 107_{core} in the embodiment, facilitates the alignment of the optical axes of the optoelectrical devices 120 mounted on, or otherwise coupled to, the alignment pillars 123, with the optical axis of on-facet lenses 138_{F2PP} formed in the on-facet lens array 130_{F2PP} of the on-facet lens array 130_{F2PP} on the terminal facets of the waveguide cores 106_{core} on the ingoing side of cavity 146 in the embodiment of coupler assembly 102. Alignment of the waveguide cores 107_{core} of the interposer 103 is achieved, in embodiments, with the coupling of the self-aligned T&G alignment features 109 of the interposer 103 with the self-aligned T&G alignment features 108 of the coupler 100. In the embodiment, on-facet lenses 138_{F2PP} are configured to enable coupling of optical signals propagating through the waveguides 106 and the on-facet lenses 138_{F2PP} to the facets of the waveguides 106 on the outgoing side of cavity 146 in the embodiment. In embodiments such as the embodiment shown in FIG. 33A, the waveguide 106 on the outgoing side of the cavity 146 may include a spot size converter 141 formed fully or in part from the waveguide 106 coupled to the outgoing side of cavity 148. Spot size converters in this and other embodiments disclosed herein, may enable improved coupling by, for example, providing a larger facet than that of a waveguide core 106_{core} on the wall of the outgoing side of the cavity 146.

The coupler assembly 102 in the embodiment shown in FIG. 33A, is further configured having optical fibers 154 mounted in FAU 156 formed on the coupler 100.

FIG. 33B shows a top-view schematic drawing of an embodiment of PIC assembly 101 comprising interposer assembly 104 and coupler assembly 102, wherein the interposer assembly 104 is configured having four optoelectrical devices 120 each mounted in a cavity 148 and coupled to a waveguide core 107_{core} formed on the interposer 103, as in the embodiment shown in FIG. 33A, and wherein the coupler assembly 102, in the embodiment, is configured having an optical isolator 132 and two lens arrays 130. In the embodiment, the coupler assembly 102 is configured having in-structure lenses 138_{S2PP} in two lens array structures 130_{S2PP} formed using two-photon polymerization or other 3D printing method.

In the embodiment shown in FIG. 33B, coupler assembly 102 is configured having cavity 146 that includes an optical isolator 132 and in-structure lenses 138_{S2PP} formed, for example, using two-photon polymerization, wherein the in-structure lenses 138_{S2PP} of a first lens array structure 130_{S2PP}-1 are configured to enable one or more of closely-coupled and free-space coupling of optical signals from waveguide cores 107_{core} on the interposer 103 to the in-structure lenses 138_{S2PP} of the first lens array structure 130_{S2PP}-1 in the cavity 146 on the coupler 100. Alignment of the waveguide cores 107_{core} of the interposer 103 and the in-structure lenses 138_{S2PP} of the first lens array structure 130_{S2PP}-1 of the coupler 100 may be achieved, for example, by coupling the T&G alignment features 109 formed self-aligned with the waveguide cores 107_{core} on the interposer 103 with complementary T&G alignment features 108 formed self-aligned with the alignment features 128 at the wall of cavity 146 to which the first lens array structure 130_{S2PP}-1 may be spatially referenced during fabrication. A feature formed self-aligned with a T&G alignment aid 108 on the coupler 100, such as alignment feature 128 formed at the wall of the cavity 146, may be used as a reference in the positioning of the lenses 138_{S2PP} of the lens array structure 130_{S2PP}-1. Use of one or more alignment structure formed self-aligned to the waveguide cores 106_{core} of coupler 100 can extend the benefit of self-alignment achievable with self-aligned features to other features such as the in-structure lenses 138_{S2PP} of first lens array structure 130_{S2PP}-1 formed using two-photon polymerization formed in relation to the self-aligned cavity alignment aids 128.

The coupler assembly 102 in the embodiment shown in FIG. 33B, is further configured having optical fibers 154 mounted in FAU 156 formed on the coupler 100.

In other embodiments, coupler assembly 102, may be configured having on-facet lenses 138_{F2PP} in two on-facet lens arrays 130_{F2PP} formed using two-photon polymerization or other 3D printing method. And in yet other embodiments, coupler assembly 102, may be configured having MLA lenses 138_{MLA} in two lens arrays 130 of multi-lens arrays 130_{MLA}.

In yet other embodiments, the coupler assembly 102 may be configured having in-structure lenses 138_{S2PP} in one lens array structure 130_{S2PP} formed using two-photon polymerization or other 3D printing method and on-facet lenses 138_{F2PP} in another on-facet lens array 130_{F2PP} formed using two-photon polymerization on waveguide facets in cavity 146 or MLA lenses 138_{MLA} in another lens array 130 configured as a multi-lens array 130_{MLA}. And in yet other embodiments, the coupler assembly 102 may be configured having MLA lenses 138_{MLA} in one lens array 130 of multi-lens array 130_{MLA} and on-facet lenses 138_{F2PP} in another on-facet lens array 130_{F2PP} formed using two-photon polymerization on waveguide facets in cavity 146 or 138_{S2PP} in one lens array 130 formed using two-photon polymerization or other 3D printing method.

In the embodiment shown in FIG. 33C, cavities 148 on the interposer may be configured having alignment aids formed self-aligned to the waveguide cores 107_{core} and the T&G alignment aids 109 formed on the interposer 103.

In other embodiments, the interposer assembly 104 may be configured having one or more optoelectrical device 120 wherein the one or more optoelectrical device is mounted in one or more cavities 148 on the interposer 103 and coupled to one or more waveguide core 107_{core} on the interposer 103.

Embodiments of coupler assembly 102 configured having two lens arrays are described herein in conjunction with FIGS. 18A-18Y, and are listed in Table 3.

### Interposer Assemblies Configured Having Hybrid Laser Structures

FIG. 33C shows a top-view schematic drawing of an embodiment of PIC assembly 101 comprising an interposer assembly 104 and a coupler assembly 102, wherein the interposer assembly 104 is configured having optoelectrical devices 120 of an optoelectrical device array 120_{array}, each coupled to a front and rear grating structure and a waveguide core 107_{core} on the interposer 103 to a lens 138 mounted or otherwise formed in cavity 146 of coupler assembly 102. Optoelectrical devices 120 of the optoelectrical device array 120_{array} may be configured, for example, as gain devices that in combination with front lateral grating 125_{front} and rear lateral grating 125ᵣₑₐᵣ facilitate formation of hybrid laser structures in interposer assembly 104 in the embodiment. The cores of the front lateral gratings 125_{front} and rear lateral gratings 125ᵣₑₐᵣ may be formed, in embodiments, self-aligned with cores 107_{core} of waveguides 107 formed from planar waveguide layer 105 and T&G alignment aids 109 on the interposer 103, if present, and with other alignment aids also formed from the core layer of planar waveguide layer 105.

In other embodiments, interposer assembly 104 may be configured having one or more optoelectrical devices 120 configured, for example, as gain devices, and wherein the one or more gain devices are mounted in one or more cavity 148 and each coupled to a front lateral grating 125_{front} and rear lateral grating 125ᵣₑₐᵣ respectively, formed from planar waveguide layer 105 of the interposer 103 to facilitate wavelength selection from the broadband gain devices.

Front lateral grating 125_{front} and rear lateral grating 125ᵣₑₐᵣ are all or a portion of a wavelength selection devices that may be coupled to an optoelectrical devices 120 configured, for example, as a gain device mounted in cavity 146. In an embodiment, optoelectrical device 120 is configured as a gain device that when coupled to one or more lateral grating positioned at one or more wall of cavity 146, forms a hybrid laser structure. In this embodiment, lateral gratings form Bragg reflectors providing wavelength selection of the broadband optical output to enable lasing within the stopband of the Bragg reflectors.

The coupler assembly 102, for the embodiment shown in FIG. 33C, is configured having optical isolator 132 and two lens arrays 130 mounted in cavity 146 wherein the lens arrays 130 are configured as multi-lens arrays 130_{MLA}. In the embodiment, optical signals propagating from the terminal facets of the waveguide cores 107_{core} of the interposer assembly 104 are free-space coupled to MLA lenses 138_{MLA} of a first multi-lens array 130_{MLA}-1 in cavity 146, through optical isolator 132, through the MLA lenses 138_{MLA} of second multi-lens array 130_{MLA}-2 to the waveguide cores 106_{core} at the outgoing side of cavity 146, and to the cores of the optical fibers 154 mounted in FAU 156 on the coupler 100.

Alignment of the waveguide cores 107_{core} of the interposer 103 and the MLA lenses 138_{MLA} of the first multi-lens array 130_{MLA}-1 of the coupler 100 may be achieved using T&G alignment features 109 on the interposer 103 and complementary T&G alignment features 108 on the coupler 100 to enable lateral alignment of the waveguide cores 107_{core} of the interposer 103 with the optical axes of the MLA lenses 138_{MLA} of the multi-lens arrays 130_{MLA} in the embodiment. Alignment of the MLA lenses 138_{MLA} of the coupler assembly 102 may be achieved using alignment features 128 formed self-aligned with the T&G alignment features 108 and waveguide cores 106_{core} of the coupler 100 to which the multi-lens arrays 130_{MLA} are coupled. Alternatively, MLA lenses 138_{MLA} may be aligned using, for example, alignment apparatus 168.

Positioning of the multi-lens arrays 130_{MLA}, having known pitch between the optical axes of the MLA lenses 138_{MLA} of the multi-lens arrays 130_{MLA}, within the alignment aids 128, facilitates alignment of the optical axes of the MLA lenses 138_{MLA} of the multi-lens array 130_{MLA} with the waveguide cores 106_{core} of the coupler 100. Alternatively, multi-lens arrays 130_{MLA} may be aligned using active alignment methods, wherein optical signals emitted from the optoelectrical devices 120 may be coupled through the MLA lenses 138_{MLA}, through the waveguide cores 106_{core} of the coupler 100, and through the one or more optical fibers 154 of the fiber mount 102. Optimization of the magnitude, for example, of the optical signal emerging from the one or more optical fibers may be used to indicate the quality of the alignment between the MLA lenses 138_{MLA} of the multi-lens array 130_{MLA}, the waveguide cores 106_{core} of the coupler, and the optical fiber cores 154_{core} of the optical fibers 154 mounted or otherwise formed in the FAU 156 on coupler 100. Other methods of alignment may also be used.

FIG. 33D shows a top-view schematic drawing of an embodiment of a PIC assembly 101 comprising interposer assembly 104 and coupler assembly 102 wherein the interposer assembly 104 is configured having the optoelectrical device array 120_{array} and front and rear lateral gratings 125_{front}, 125ᵣₑₐᵣ, respectively, as in FIG. 33C, and is further configured having a 3D printed on-facet lens array 130_{F2PP} formed in cavity 147 on interposer 103, and wherein the coupler assembly 102 is configured having optical isolator 132 and 3D printed on-facet lens array 130_{F2PP} in cavity 146 on coupler 100.

In the embodiment of the PIC assembly 101, interposer assembly 104 is configured having four optoelectrical devices 120 configured as gain devices of hybrid laser structures and front and rear lateral gratings 125_{front}, 125ᵣₑₐᵣ, respectively, coupled to cavities 148. In the embodiment, front and rear lateral gratings 125_{front}, 125ᵣₑₐᵣ are further coupled through waveguide cores 107_{core} on the interposer 103 to on-facet lenses 138_{F2PP} of an on-facet lens array 130_{F2PP} formed in cavity 147 on the interposer 103, and an on-facet lens array 130_{F2PP} formed in cavity 146 on the coupler 100. The on-facet lenses 138_{F2PP} of the on-facet lens array 130_{F2PP} of the interposer 103 are formed, in the embodiment on terminal facets of waveguide cores 107_{core} in the cavity 147 of the interposer 103. Optical signals emerging from the on-facet lenses 138_{F2PP} are free-space coupled to the on-facet lenses 138_{F2PP} of the on-facet lens array 130_{F2PP} formed on terminal facets of waveguide cores 106_{core} through optical isolator 132 in cavity 146 of the coupler 100 in the embodiment of the PIC assembly 101.

Front and rear lateral gratings 125_{front}, 125ᵣₑₐᵣ, respectively, may be formed, in embodiments, from the same waveguide core layer 105_{core} as, and in self-alignment with, waveguide cores 107_{core} on the interposer 103 in the embodiment. One or more of front and rear lateral gratings 125_{front}, 125ᵣₑₐᵣ may be used to form a wavelength selection device that when coupled to an optoelectrical device 120 of the optoelectrical device array 120_{array} configured as an array of broadband optical emitting devices in cavity 148. In an embodiment, optoelectrical device 120 configured, for example, as an optical emitting device of the optoelectrical device array 120_{array} is configured as a gain device that when coupled to one or more grating structure positioned at one or more wall of cavity 148, forms a hybrid laser structure. In the embodiment shown in FIG. 33D, front and rear lateral gratings 125_{front}, 125ᵣₑₐᵣ may form Bragg reflectors providing wavelength selection, for example, from the broadband optical output and enable lasing within the stopband of the Bragg reflectors.

In the embodiment, coupler 100 is configured having a cavity 146 that includes optical isolator 132 and on-facet lenses 138_{F2PP} of on-facet lens array 130_{F2PP} wherein on-facet lenses 138_{F2PP} of the on-facet lens array 130_{F2PP} may be formed, for example, using two-photon polymerization or other 3D printing method, on facets 106_{facet} of waveguides 106 of coupler 100.

In some embodiments configured having one or more hybrid laser structure comprising optoelectrical devices 120 in one or more cavities 148 of interposer 103 and a wavelength selection device, the optoelectrical device 120 may be configured having a highly reflective rear reflector on the rear of the lasing cavity of the gain device and wavelength selection device may comprise a front lateral grating 125 front formed from the planar waveguide layer on the interposer 103 and coupled to cavity 148.

And in other embodiments configured having one or more hybrid laser structure comprising optoelectrical devices 120 in one or more cavities 148 of interposer 103 and a wavelength selection device, the optoelectrical device 120 configured as a gain device may be configured having a partially reflective front reflector on the front of the lasing cavity of the gain device and wavelength selection device may comprise a rear lateral grating 125ᵣₑₐᵣ formed from the planar waveguide layer on the interposer 103 and coupled to cavity 148. Interposer assemblies configured having hybrid laser structures may be further configured having power monitoring photodiodes mounted or otherwise formed in proximity to the rear grating or reflector of the hybrid laser as disclosed herein in the following paragraphs.

In some embodiments, the wavelength selection device may comprise a ring resonator, formed self-aligned with the alignment aids on the interposer 103 or coupler 100.

In the PIC assembly 101 shown in FIG. 33D, example optical signals originating in the gain devices on the interposer assembly 104 propagate through the waveguide cores 107_{core} and front lateral gratings 125_{front} to the on-facet lenses 138_{F2PP} of the on-facet lens array 130_{F2PP} on the interposer 103, are free-space coupled from the on-facet lenses 138_{F2PP} of the on-facet lens array 130_{F2PP} on the interposer 103 to the on-facet lenses 138_{F2PP} of the on-facet lens array 130_{F2PP} in the cavity 146 of the coupler assembly 102 through optical isolator 132, and to the optical fibers 154 mounted in the FAU 156 on the coupler 100.

FIG. 33E shows a top-view schematic drawing of an embodiment of PIC assembly 101 comprising interposer assembly 104 and coupler assembly 102 wherein the interposer assembly 104 is configured having four optoelectrical devices 120, each mounted in a cavity 148, each coupled to a power monitoring device 121, and each coupled to a front lateral grating 125_{front}, wherein the interposer assembly 104 is further configured having an on-facet lens array 130_{F2PP} formed in cavity 147 on interposer 103, and wherein coupler assembly 102 is configured having an optical isolator 132 and an on-facet lens array 138_{F2PP} in cavity 146 on the coupler 100. Interposer assembly 104 is further configured having receiving devices 121, configured, for example, as photodiodes, mounted in device mounting cavities 148 formed on the interposer 103. Cavities 148 for mounting or otherwise forming the receiving devices 121, may be separate from, or coupled to the cavities 148 within which the optoelectrical devices 120 are mounted or otherwise formed.

Receiving devices 121 may be used in embodiments, for example, to facilitate power monitoring of devices 120 configured as lasers, gain devices, or other optical emitting devices. The embodiment of interposer assembly 104 in FIG. 33E, may be configured having four optical emitting devices 120, wherein the four optoelectrical devices 120 are coupled through waveguide cores 107_{core} formed on the interposer 103 to the front lateral grating 125_{front}, in the embodiment. The front lateral gratings 125_{front} are coupled to waveguide cores 107_{core} to the cavities 147 of the interposer 103 within which the on-facet lens array 130_{F2PP} is formed.

Cavities 148 are configured in the embodiment of FIG. 33E having alignment pillars 123 to facilitate alignment of the optical axes of the optoelectrical devices 120 with the optical axes of waveguide cores 107_{core} to which the optical axes of the optoelectrical devices 120 may be aligned. In the embodiment, front Bragg reflector grating structures are formed from the planar waveguide core layer 105 to form the cores of the wavelength selection devices configured as a front lateral gratings 125_{front}. The structures of the lateral gratings are further configured having top and bottom cladding layers, in this and other embodiments using the top and bottom cladding layers, used for example in the formation of the waveguides 107. In other embodiments, other top and bottom cladding layers may be used.

In the embodiment shown in FIG. 33E, four cavities 148 having optical emitting devices 120 configured as gain devices are provided to form the four hybrid laser structures shown. In other embodiments, the interposer assembly 104 may be configured having one or more cavities 148 further configured having optical emitting devices 120 configured as gain devices. In some embodiments, optical emitting devices 120 configured as gain devices 120 may output a same wavelength. In other embodiments having a plurality of gain devices on interposer 103, the optical emitting devices 120 and wavelength selection devices to which the optical emitting devices 120 are coupled, such as for example, the front lateral gratings 125_{front}, may be configured to output two or more different wavelengths.

In other embodiments, interposer assembly 104 may be configured having one or more optoelectrical device 120 configured as a gain device of a hybrid laser structure, wherein the interposer 103 may further include one or more front lateral gratings 125_{front}, for wavelength selection, and one or more photodiodes 121 receptive to stray light from the rear facet of the gain device. The rear facets of the optoelectrical devices 120 configured, for example, as gain devices, in embodiments may be coated with a reflective layer to form a rear reflector of a laser cavity that when coupled with the front grating form a resonant cavity for the hybrid laser structure in embodiments such as the embodiment shown in FIG. 33E.

Front lateral grating 125_{front} is a wavelength selection device coupled to device 120 mounted in cavity 146. In an embodiment, optical emitting device 120 is configured as a gain device that when coupled to one or more grating structure positioned at one or more wall of cavity 146, forms a hybrid laser structure. In embodiments for which the interposer 103 is configured having one or more hybrid laser structure, the optical emitting device 120 coupled to the front lateral grating 125_{front} forms a Bragg reflector providing wavelength selection from the broadband optical output of the gain device 120 to enable lasing of one or more wavelengths of optical output within the stopband of the Bragg reflector. In the embodiment shown in FIG. 33E, the rear reflector of the hybrid laser cavity may be configured having a metal or other reflector layer formed on the rear facet of the gain device. Receiving devices 121 may be mounted in cavities 148 such that the receiving apertures of these devices are receptive to optical power leakage through the rear reflectors of the gain devices. Upon detection by a receiving device 121, the optical signal power may be converted to an electrical signal such as a voltage or current that is proportional to the power output by one or more of the gain device and the hybrid laser configured having a gain device.

In the embodiment of the interposer assembly 104, the interposer 103 is configured having cavity 147 wherein a wall of the cavity 147 intersects waveguide cores 107_{core} to form waveguide facets 107_{facet} on the wall of cavity 147. On-facet lenses 138_{F2PP} of an on-facet lens array 130_{F2PP} on the interposer 103 are shown in cavity 147 formed on waveguide facets 107_{facet}. Front lateral gratings 125_{front} are formed from the same waveguide core layer as waveguide cores 107_{core} on the interposer 103 in the embodiment.

In the embodiment, coupler assembly 102 is configured having a cavity 146 in coupler 100 that includes optical isolator 132 and on-facet lenses 138_{F2PP} of an on-facet lens array 130_{F2PP} in cavity 146 of coupler assembly 102. The on-facet lens arrays 130_{F2PP} on the interposer assembly 104 and on the coupler assembly 102 may be formed using two-photon polymerization of other 3D printing method.

Optical signals propagating through on-facet lenses 138_{F2PP} of the interposer assembly 104 may be free-space coupled to the on-facet lenses 138_{F2PP} formed on the terminal facets of waveguide cores 106_{core} of the coupler 100 through the optical isolator 132.

In the PIC assembly 101 of FIG. 33E, example optical signals originating in the optoelectrical devices 120 on the interposer assembly 104, propagate through the waveguide cores 107_{core} and front lateral gratings to the on-facet lenses 138_{F2PP} of the on-facet lens array 130_{F2PP} in cavity 147 of the interposer assembly 104, are free-space coupled from the on-facet lenses 138_{F2PP} of the on-facet lens array 130_{F2PP} on the interposer assembly 104 to the on-facet lenses 138_{F2PP} of the on-facet lens array 130_{F2PP} in the cavity 146 of the coupler assembly 102 through the optical isolator 132, and to the optical fibers 154 mounted in the FAU 156.

FIG. 33F shows a top-view schematic drawing of an embodiment of a PIC assembly 101 comprising interposer assembly 104 and coupler assembly 102 wherein the interposer assembly 104 is configured having an optoelectrical device array 120_{array} comprising four optoelectrical devices 120 configured as optical emitting devices, each coupled to a power monitoring device array configured as a receiving device array 121array. The four emitting devices of the optoelectrical device array 120_{array} are each coupled to a front lateral grating 125_{front}. In the embodiment of the interposer assembly 104 shown in FIG. 33F, cavity 147 and on-facet lens array 130_{F2PP} are configured as in FIG. 33E and the embodiment of coupler assembly 102 is configured having an optical isolator 132 and on-facet lens array 130_{F2PP} in cavity 146 on the coupler 100 as in the embodiment shown in FIG. 33E.

Arrayed devices such as optoelectrical device array 120_{array} and receiving device array 121array facilitate the simultaneous installation, alignment, and mounting of a plurality of devices. In other embodiments configured having one or more of an optoelectrical device array and a receiving device array, the optoelectrical device array may comprise two or more optoelectrical devices and the receiving device array may comprise two or more receiving devices. In embodiments, arrayed devices may be configured having two or more devices wherein the two or more devices are mechanically coupled.

In the embodiment shown in FIG. 33F, waveguide cores 107_{core} on interposer 103 couple the optoelectrical devices 120 of optoelectrical device array 120_{array} mounted in cavity 148 on the interposer 103 to an on-facet lens array 130_{F2PP} formed on the end facets 107_{facet} of the waveguide cores 107_{core} in cavity 147 of the interposer 103 through the front lateral grating 125_{front}. The on-facet lenses 138_{F2PP} facilitate coupling of optical signals originating from the optoelectrical device array 120_{array} to the on-facet lens array 130_{F2PP} in cavity 146 of the coupler 100 through optical isolator 132. Alignment pillars 123 in cavity 148 facilitate alignment of the optical axes of a plurality of optoelectrical devices 120 formed on a common substrate of the optoelectrical device array 120_{array} in a same alignment step or procedure. In the embodiment shown, optoelectrical device array 120_{array} is configured having four optoelectrical devices 120. In other embodiments, the optoelectrical device array may be configured having two or more optoelectrical devices 120 formed on a common substrate. The use of an optoelectrical device array 120_{array} enables the simultaneous alignment of the plurality of devices with the plurality of waveguide cores 107_{core}, for example, and the front lateral gratings 125_{front} of interposer 103 in the embodiment.

The optical axes of the plurality of optoelectrical devices 120 provided in optoelectrical device array 120_{array} facilitates alignment of the optical axes of each of the devices 120 with a terminal facet 107_{facet} of a waveguide 107 formed on the wall of cavity 148. Alignment of the optical axes of optoelectrical devices 120 of optoelectrical device array 120_{array} with the waveguide cores 107_{core} in the embodiment, facilitates the alignment of the optical axes of the optoelectrical devices 120 mounted on or otherwise coupled to the alignment pillars 123, with the optical axes of on-facet lenses 138_{F2PP} of the on-facet lens array 130_{F2PP} on the interposer 103. Alignment of the waveguide cores 107_{core} of the interposer 103 with the on-facet lenses 138_{F2PP} of the on-facet lens array 130_{F2PP} on the coupler 100 is achieved, in embodiments, with the coupling of the self-aligned T&G alignment features 109 of the interposer 103 with the self-aligned T&G alignment features 108 of the coupler 100.

The coupler assembly 102 in the embodiment shown in FIG. 33F, is further configured having optical fibers 154 mounted in FAU 156 on the coupler 100 as shown.

FIG. 33G shows a top-view schematic drawing of an embodiment of PIC assembly 101 comprising interposer assembly 104 and coupler assembly 102 wherein the interposer assembly 104 is configured having an optoelectrical device array 120_{array} configured as four emitting devices each coupled to a rear lateral grating 125ᵣₑₐᵣ and further coupled to a receiving device 121 configured as a power monitoring device, wherein the interposer assembly 104 is further configured having MLA lenses 138_{MLA} of a multi-lens array 130_{MLA} mounted or otherwise formed in cavity 147 on interposer 103, and wherein the coupler assembly 102 is configured having an optical isolator 132 and an on-facet lens array 130_{F2PP} formed in cavity 146 on the coupler 100.

In the embodiment of the PIC assembly 101, the interposer assembly 104 is configured having optoelectrical devices 120 of optoelectrical device array 120_{array} configured, for example, as gain devices of hybrid laser structures, and wherein the interposer 103 includes rear lateral gratings 125ᵣₑₐᵣ for wavelength selection. To facilitate coupling between the rear lateral grating 125ᵣₑₐᵣ and the rear facet of the gain device, the rear facet of the gain device may be configured having an antireflection coating. And to enable optical signals to exit the gain device from the front facet, the front facet of the gain device may be configured having a semi-transparent coating. In some embodiments, the semi-transparent coating may enable between 5% and 75% of the light generated in the cavity to exit through the front reflector coating.

In the embodiment shown in FIG. 33G, interposer assembly 104 is further configured having optional receiving devices 121 configured, for example, as photodiodes receptive to stray light from the rear facets of the gain devices. The receiving devices 121 shown in FIG. 33G are mounted or otherwise formed in device mounting cavities 148 formed in the interposer 103. The cavities 148 for mounting or otherwise forming the receiving devices 121, may be separate from, or may be coupled to cavities 148 within which the optoelectrical device array 120_{array} is mounted or otherwise formed.

Photodiodes, or other receiving device 121, may be used in embodiments, for example, to facilitate power monitoring, of optoelectrical devices 120 configured as lasers, gain devices, or other optical emitting devices. The embodiment of the interposer assembly 104 in FIG. 33G, is configured having four optoelectrical devices 120 on optoelectrical device array 120_{array}, wherein the four optoelectrical devices 120 are each coupled to waveguide cores 107_{core} formed on the interposer 103, and wherein the waveguide cores 107_{core} include rear lateral gratings 125ᵣₑₐᵣ coupled to the cavities 148 of the interposer 103 within which the optoelectrical device array 120_{array} is mounted or otherwise formed.

In the embodiment, the core layer of planar waveguide layer 105 may be used to form rear lateral grating 125ᵣₑₐᵣ on the interposer 103. The rear grating structures may be further configured having top and bottom cladding layers in this and other embodiments using the top and bottom cladding layers of the waveguides 107. In other embodiments, other top and bottom cladding layers may be used.

In the embodiment shown in FIG. 33G, optoelectrical device array 120_{array} in cavity 148 is configured having four optoelectrical devices 120 further configured as gain devices to form the four hybrid laser structures shown. In other embodiments, the interposer assembly 104 may be configured having one or more cavities 148 and one or more optoelectrical devices 120 mounted or otherwise formed in the cavities 148. In some embodiments, two or more optoelectrical devices 120 configured as gain devices may output optical signals having a same wavelength. In some embodiments, two or more optoelectrical devices 120 configured as gain devices may output optical signals having different wavelengths.

Rear lateral grating 125ᵣₑₐᵣ may be a wavelength selection device coupled to an optoelectrical device 120 configured as an emitting device and mounted in cavity 148. In an embodiment, an optoelectrical device 120 configured as a gain device, that when coupled to one or more grating structure, forms a hybrid laser structure having a rear reflector formed all or in part from the core layer 105_{core} of planar waveguide layer 105 formed on the interposer 103. In embodiments for which the interposer 103 is configured having one or more hybrid laser structure, the optoelectrical device 120 coupled to the rear grating structure forms a Bragg reflector providing wavelength selection from the broadband optical output of the gain device 120 to enable lasing of optical output, for example, within the stopband of the Bragg reflector. In the embodiment shown in FIG. 33G, the front reflector of the hybrid laser cavity may be configured having a semitransparent reflector layer formed on the front facet of the gain device.

Receiving devices 121, coupled to the rear lateral grating 125ᵣₑₐᵣ, may be mounted in cavities 148 such that the receiving devices 121 are mounted or otherwise formed in proximity to the rear lateral gratings 125ᵣₑₐᵣ or to waveguides 107 coupled to the rear lateral gratings 125ᵣₑₐᵣ, such that the apertures of the receiving devices 121 are receptive to optical signal leakage through the rear lateral grating 125ᵣₑₐᵣ. Upon detection by a receiving device 121, the optical signal power may be converted to an electrical signal, for example.

In the embodiment of the interposer assembly 104, interposer 103 is configured having MLA lenses 138_{MLA} of a multi-lens array 130_{MLA} mounted or otherwise formed in cavity 147.

In the embodiment, coupler assembly 102 is configured having optical isolator 132 and on-facet lenses 138_{F2PP} of an on-facet lens array 130_{F2PP} wherein the on-facet lenses 138_{F2PP} of the on-facet lens array 130_{F2PP} may be formed using two-photon polymerization or other 3d printing method on facets 106_{facet} of waveguides 106 of coupler 100 in the embodiment.

Optical signals propagating through MLA lenses 138_{MLA} of the interposer assembly 104 may be free-space coupled to the on-facet lenses 138_{F2PP} formed on the terminal facets of waveguide cores 106_{core} of the coupler 100 through the optical isolator 132.

In the embodiment of the PIC assembly 101 shown in FIG. 33G, example optical signals originating from optoelectrical devices 120 configured as gain devices on the interposer assembly 104, are coupled through free-space to the MLA lenses 138_{MLA} of the multi-lens array 130_{MLA} cavity 147 on the interposer assembly 104 to the on-facet lens array 130_{F2PP} through the optical isolator 132 in the cavity 146 of the coupler assembly 102, and through the waveguide cores 106_{core} on the coupler 100 to the terminal facets of the optical fibers 154 mounted in FAU 156 on the coupler 100 for propagation through the optical fibers 154.

### Coupler Assemblies Configured Having Semiconductor Optical Amplifiers and Other Optoelectrical Devices

Embodiments of coupler assemblies 102 may be configured having semiconductor optical amplifiers (SOAs) and other optoelectrical devices mounted or otherwise formed on the coupler 100. In some embodiments, SOAs and other optical devices may be mounted or otherwise formed in cavities on couplers 100. Alignment pillars may be formed in these cavities self-aligned with the waveguide cores 106_{core} on the coupler 100 to facilitate alignment of the optical axes of the optical devices mounted or otherwise formed in the cavities on the coupler 100 with the waveguide cores 106_{core} or other optical pathways on the coupler 100 as further disclosed.

Alignment pillars formed in device-mounting cavities in the coupler 100 facilitate the aligning and mounting of optical devices on coupler 100 wherein the alignment pillars may be formed self-aligned with waveguide cores 106_{core}, T&G alignment aids 108, fiducials 114, alignment aids 128 formed at the periphery of cavity 146, and FAU alignment aids 126 formed at the opening of FAU mounting site 152, among other features formed fully or in part from the core layer 105_{core} of the planar waveguide layer 105 of the coupler 100.

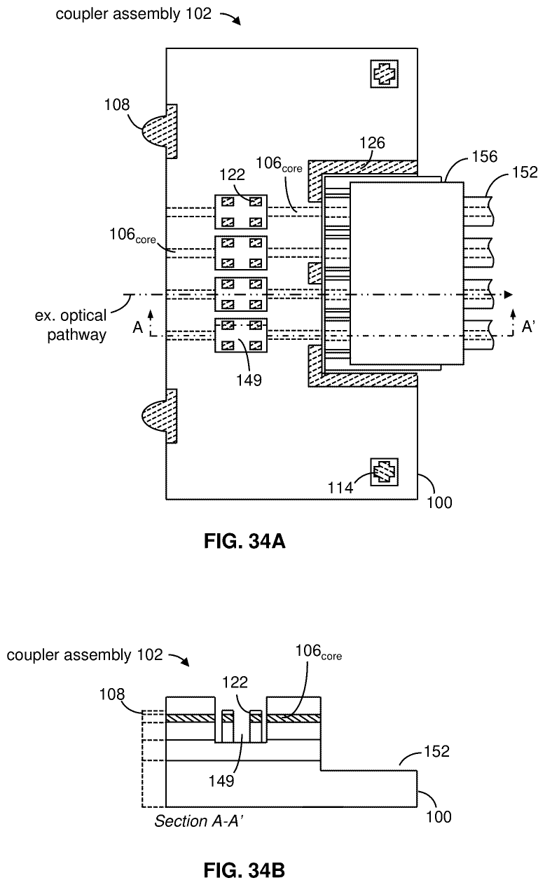

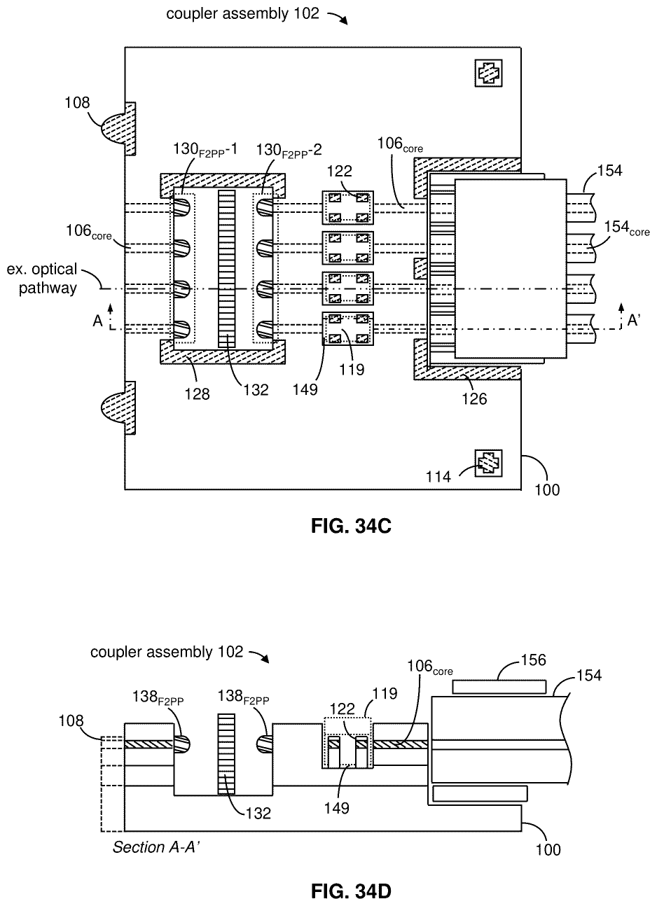

FIGS. 34A and 34B show top-view and cross-section drawings of an embodiment of a coupler 100 that may be used in the formation of embodiments of PIC assembly 101, wherein one or more cavities 149 formed on the coupler 100 may be configured having self-aligned alignment pillars 122.

The top-view schematic drawing in FIG. 34A shows coupler 100 configured having alignment pillars 122 formed in cavity 149. The alignment pillars 122 in the cavities 149 of the coupler 100 may be formed self-aligned with the waveguide cores 106_{core} on the coupler 100 and with T&G alignment features 108, fiducials 114, and other alignment features formed on coupler 100. Alignment pillars 122 facilitate the alignment of the optical axes of optoelectrical devices 119 (not shown) coupled to the alignment pillars 122 with the optical axes of, for example, the waveguide cores 106_{core} on the coupler 100. In an example embodiment, an optoelectrical device having a characteristic optical axis is mounted on one or more alignment pillars 122 in a cavity 149. In such an example embodiment, mounting of the optoelectrical device in contact with one or more vertical surface of the one or more alignment pillars 122 in a cavity 149 facilitates the lateral positioning and alignment of the optical axis of the mounted optoelectrical device 119 with the waveguide cores 106_{core} formed on the coupler 100 and with other alignment features that are formed self-aligned with the waveguide cores 106_{core} on the coupler 100 that include the T&G alignment features 108, the fiducials 114, and other alignment features formed self-aligned with the waveguide cores 106_{core} on the coupler 100.

FIG. 34B shows a cross-sectional schematic drawing through Section A-A′ of the embodiment in FIG. 34A. Cavity 149 formed in the planar waveguide layer is shown. Also shown in FIG. 34B are FAU mounting site 152 and a projection of T&G alignment aid 108 formed self-aligned with the alignment aids 122 formed in the cavity 149.

Embodiments of coupler assembly 102 configured having one or more cavities 149 receptive to optoelectrical devices 119, may be further configured having optical isolator 132 and one or more lens array 130 in cavity 146 of coupler 100.

FIG. 34C shows a top-view schematic drawing of an embodiment of coupler assembly 102 comprising four optoelectrical devices 119 each mounted in a device-mounting cavity 149, wherein the cavities 149 of the coupler 100 are configured having alignment pillars 122 formed self-aligned with waveguide cores 106_{core} on the coupler. The embodiment of the coupler assembly further comprises an optical isolator 132 and two on-facet lens arrays 130_{F2PP}-1, 130_{F2PP}-2 formed in cavity 146, and four optical fibers 154 mounted in FAU 156. Other self-aligned alignment features in the embodiment include T&G alignment features 108, lateral alignment features 128 for aligning an optical isolator 132 in cavity 146, and FAU alignment aids 126 for aligning an FAU 156. Optoelectrical devices 119, coupled to alignment pillars 122 in the embodiment, are shown in dotted lines in the device-mounting cavities 149 for clarity.

FIG. 34D shows a cross-section schematic drawing of the embodiment of coupler assembly 102 shown in FIG. 34C.

Embodiments of coupler assembly 102 configured having the semiconductor optical amplifiers, enable amplification of incoming optical signals on the coupler assembly 102, in addition to the isolation provided by the optical isolator 132, and the connectivity to the optical fibers 154 mounted in the FAU 156 on the coupler 100. Optoelectrical devices 119 configured as optical amplifiers in cavities 149 of coupler 100, enable the formation of coupler assemblies 102 having the optical amplifiers to have increased power output for coupler assemblies 102 coupled to interposer assemblies 101 configured having optical emitting devices 120 in cavities 148 formed in interposer 103.

Alignment pillars 122 in cavity 149 of the coupler 100 may be formed in self-alignment with the cores 106_{core} of waveguides 106, T&G alignment aids 108, and other alignment aids formed in self-alignment on the coupler 100. The self-aligned alignment pillars in cavity 149 facilitate the alignment of the optical axes of the semiconductor optical amplifiers or other optoelectrical devices 119 coupled to alignment pillars 122, with the waveguide cores 106_{core} and enable the optoelectrical devices 119 mounted in cavities 149 to be mounted in alignment with other aligned features on the coupler assemblies 102 and on interposer assemblies 104 using alignment features formed in self-alignment with the alignment pillars 122.

Coupler assembly 102 may be configured having other optoelectrical devices 119 in other embodiments.

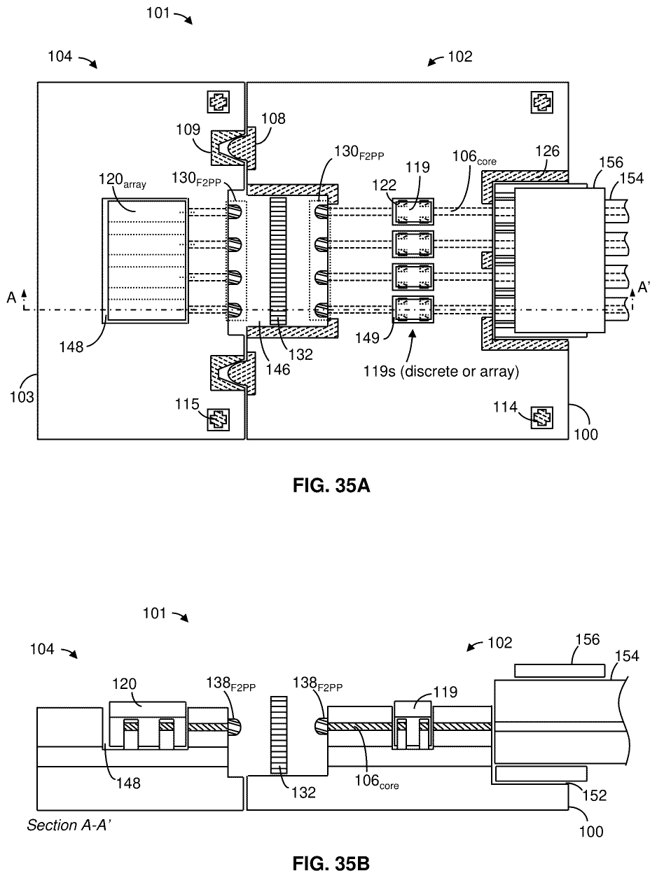

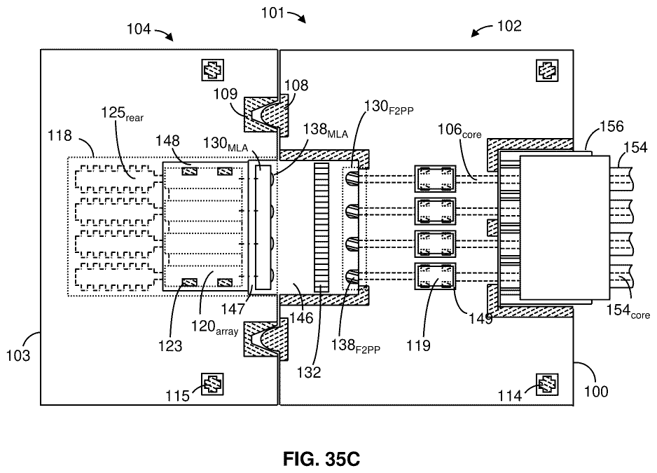

FIG. 35A shows a top-view schematic drawing of an embodiment of PIC assembly 101 configured having another embodiment of coupler assembly 102 and another embodiment of interposer assembly 104. In the embodiment, coupler assembly 102 is configured having an optical isolator 132 and an on-facet lens array 130_{F2PP} in a cavity 146 formed at an edge of the coupler 100 facing the interposer assembly 104, and having device mounting cavities 149 formed between the cavity 146 and FAU mounting site 152 on the coupler 100. The coupler assembly 102, in the embodiment, comprises four optoelectrical devices 119 each mounted or otherwise formed in a device mounting cavity 149. Coupler 100, in the embodiment, is further configured having optical isolator 132 and an on-facet lens array 130_{F2PP} configured having on-facet lenses 138_{F2PP} formed on the facets of waveguide cores 106_{core} in the cavity 146 of the coupler 100. The four cavities 149 are each configured having an optoelectrical device 119 coupled to alignment pillars 122. In the embodiment, cavities 149 are configured having four alignment pillars 122. Other embodiments of coupler 100 having one or more device-mounting cavity 149, may be configured having one or more alignment pillars 122.

The interposer assembly 104, in the embodiment of the PIC assembly 101 shown in FIG. 35A, comprises interposer 103, a cavity 148 in the interposer 103 that includes an optoelectrical device 120, and a cavity 147 in the interposer 103 that includes an on-facet lens array 130_{F2PP} configured having on-facet lenses 138_{F2PP} formed, for example, using two-photon polymerization on the facets of waveguide cores 107_{core} in the cavity 147. The on-facet lenses 138_{F2PP} of the on-facet lens array 130_{F2PP} of the interposer 103 enable free-space coupling of optical signals from the lenses 138_{F2PP} to the on-facet lenses 138_{F2PP} formed in cavity 146 on coupler 100.

In an example operation of the PIC assembly 101, an optical signal is generated in a device 120 of optoelectrical device array 120_{array} in cavity 148 of the interposer 103 and coupled to a waveguide core 107_{core} on the interposer 103 to an on-facet lens 138_{F2PP} formed on a terminal facet of the waveguide core 107_{core} on the wall of cavity 147. The example optical signal is free-space coupled from the on-facet lens 138_{F2PP} in cavity 147 to the on-facet lens 138_{F2PP} formed in cavity 146 through optical isolator 132 and to a waveguide core 106_{core} on the coupler 100. The optical signal in the example, propagating through a portion of waveguide core 106_{core}, reaches an optoelectrical device 119 in a cavity 149 wherein the optical signal is amplified in optoelectrical device 119 configured as an optical amplifier, coupled to another waveguide core 106_{core} on the outgoing side of the cavity 149, and further coupled through the waveguide core 106_{core} to the terminal facet of an optical fiber 154 mounted or otherwise formed in FAU 156 on coupler 100. Optical signals coupled to an optical fiber 154 may be coupled to other devices in an optical network, for example, to which the PIC assembly 101 is coupled.

FIG. 35B shows a cross-section schematic drawing through Section A-A′ of the embodiment of the PIC assembly 101 shown in FIG. 35A. Example optical signals, originating in the optoelectrical device 120, configured for example as a semiconductor laser, are coupled to the waveguide cores 107_{core} of the interposer 103, through an on-facet lens 138_{F2PP} of an on-facet lens array 130_{F2PP} in cavity 147 on the interposer 103, through optical isolator 132 and an on-facet lens 138_{F2PP} of an on-facet lens array 130_{F2PP} in cavity 146 of the coupler 100, through a waveguide 106 on the coupler 100, an optoelectrical device 119 configured, for example, as an optical amplifier in a cavity 149, and another waveguide 106 to the FAU mounting site 152.

FIG. 35C shows a top-view schematic drawing of yet another embodiment of PIC assembly 101 configured having an embodiment of coupler assembly 102 similarly configured having four optoelectrical devices 119 mounted in cavities 149 as in the embodiment shown in FIG. 35B, and another embodiment of interposer assembly 104. The interposer assembly 104, in the embodiment of FIG. 35C, comprises interposer 103, a cavity 148 in the interposer 103 that includes an optoelectrical device 120 configured as a gain device, and a lens array 130 configured as a multi-lens array 130_{MLA} having MLA lenses 138_{MLA} mounted or otherwise coupled in alignment to waveguide cores 107_{core} on the interposer 103. The interposer assembly 104 is further configured having rear lateral gratings 125ᵣₑₐᵣ formed all or in part from the planar waveguide layer 105 of the interposer 103 wherein each rear lateral grating 125ᵣₑₐᵣ in combination with an optical emitting device 120 of the optical emitting device array 120_{array} forms a hybrid laser structure. Rear lateral grating 125ᵣₑₐᵣ forms a wavelength selection device for the hybrid laser when coupled to an optical emitting device 120 of the optoelectrical device array 120_{array}, configured for example, as a gain device.

In an example operation, an optical signal is generated in one or more optoelectrical device 120 of an optoelectrical device array 120_{array}, configured as an array of gain devices mounted or otherwise formed in cavity 148 of the interposer 103. Wavelength selection from the broadband gain devices is determined fully or in part from the periodicity and length of the slices, among other properties of the rear lateral grating 125ᵣₑₐᵣ. The rear facet of the gain devices of the optoelectrical device array 120_{array}, in the embodiment, may be coupled to a rear lateral grating 125ᵣₑₐᵣ, for example, through an antireflection coating. Optical signals emitted or otherwise emergent from the front facets of the gain devices during operation, in the embodiment, are coupled through partially reflective coatings on the front facets of the gain devices in the array of gain devices in optoelectrical device array 120_{array} through free-space to the MLA lenses 138_{MLA} of the multi-lens array 130_{MLA} in cavity 147 of the interposer 103. Optical signals, in the example, propagating through the MLA lenses 138_{MLA} are coupled to the on-facet lenses 138_{F2PP} formed in cavity 146 through optical isolator 132 and to the waveguide cores 106_{core} having facets on the outgoing side of cavity 146 on the coupler 100. The optical signals, in the example, propagate from waveguide cores 106_{core} coupled to the outgoing side of cavity 146 to optoelectrical devices 119 mounted or otherwise formed in cavities 149 wherein the optical signals are amplified in the optoelectrical devices 119 configured as an optical amplifiers, coupled to another waveguide core 106_{core} and further coupled to the terminal facets of the optical fibers 154 mounted or otherwise formed in FAU 156 on coupler 100. Optical signals coupled to the optical fibers 154 may be coupled to other devices in an optical network, for example, to which the PIC assembly 101 is coupled.

Other embodiments of PIC assembly 101 may be configured having yet other embodiments of the coupler assembly 102 and yet other embodiments of interposer assembly 104.

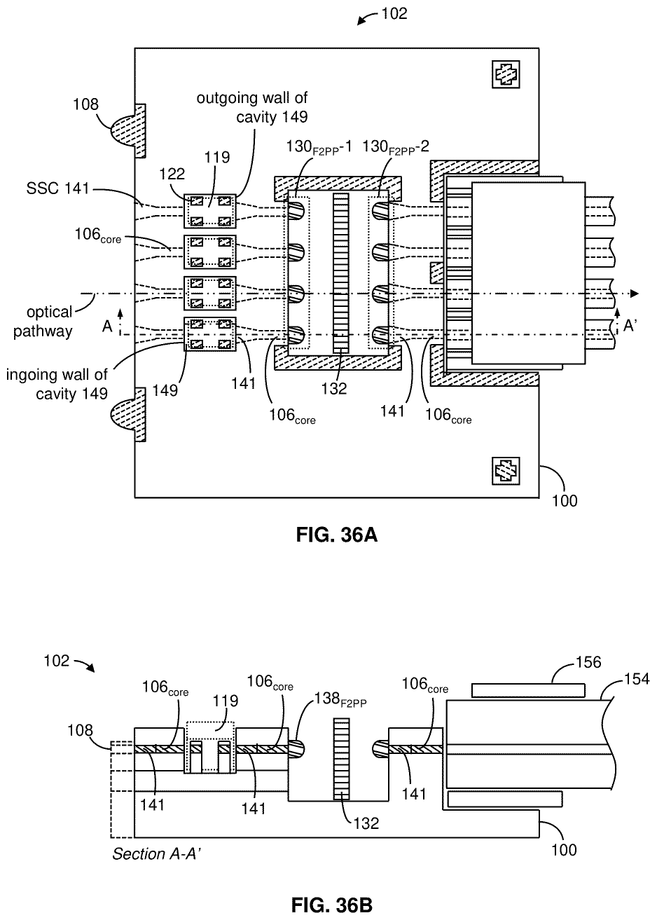

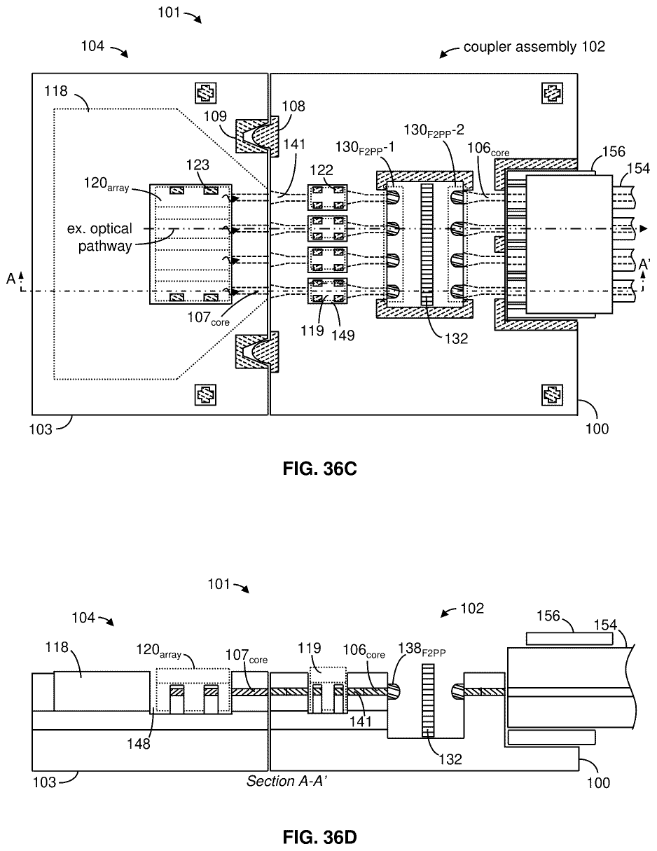

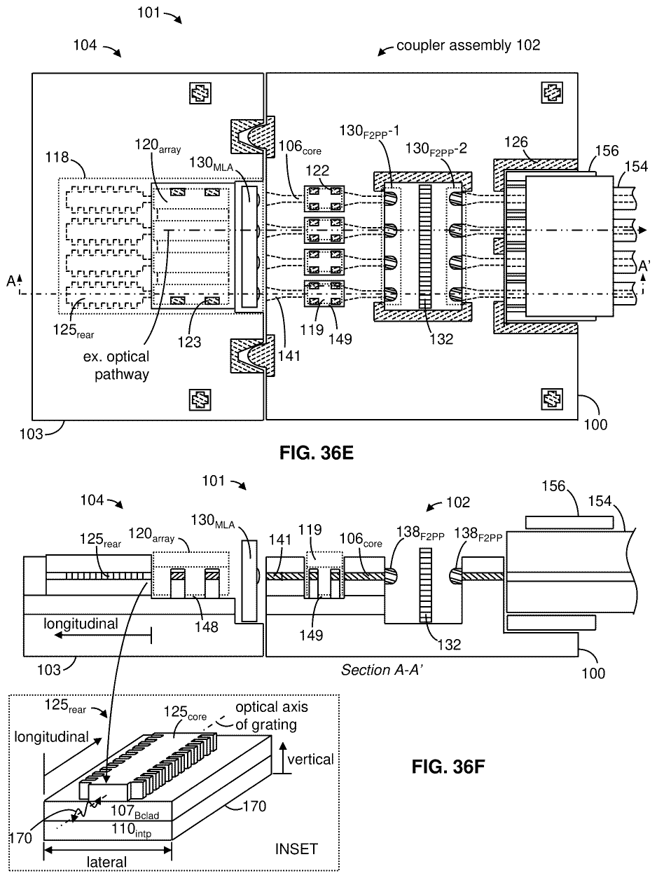

FIG. 36A shows a top-view schematic drawing of an embodiment of coupler assembly 102 comprising coupler 100, an optical isolator 132, and two on-facet lens arrays 130_{F2PP} formed in cavity 146 of coupler 100, wherein waveguides 106 on the coupler 100 are configured having spot size converters 141, and wherein the device-mounting cavities 149 on coupler 100 are formed between the cavity 146 having the optical isolator 132 and the edge of the coupler 100 that faces interposer assembly 104. The optoelectrical devices 119 in cavities 149 are shown in dotted lines on the coupler 100 for clarity.

In FIG. 36A, an embodiment of a coupler assembly 102 is shown wherein the coupler is configured having device-mounting cavities 149 formed between an edge of the coupler 100 facing an interposer 103, and the ingoing walls of cavities 149. Embodiments configured as shown in FIG. 36A enable the coupling of optical signals between waveguides 107 on interposer 103 to the optoelectrical devices 119 mounted or otherwise formed in cavities 149 through the waveguides 106 on the coupler 100, without the intervening optical isolator 132 and lens arrays 130 in cavity 146 as in the embodiments shown, for example, in FIGS. 34C-34D and FIGS. 35A-35C. Direct coupling of the optical signals from an interposer assembly 104 to the optoelectrical devices 119 mounted or otherwise formed in cavities 149 without the intervening optical isolator 132 and lens arrays 130 may facilitate improved coupling of optical signals from the interposer assembly 104 to the optoelectrical devices 119 in some embodiments.

FIG. 36B shows a cross-sectional schematic drawing of the embodiment of coupler 100 shown in FIG. 36A, wherein the coupler 100 is configured having cavity 149 formed between the edge of the coupler 100 having the T&G alignment aids 108, and the cavity 148 having the optical isolator 132. Cavity 149 is shown configured having an optoelectrical device 119 on alignment pillars 122. Optoelectrical device 119 in the device mounting cavity 149 is shown in dotted lines on the coupler 100 for clarity in distinguishing the alignment pillars 122 and the optoelectrical device 119.

In the embodiments shown in FIGS. 36A and 36B, waveguides 106 of the coupler 100 are configured having a spot size converter 141 at the wafer edge receptive to optical signals propagating from, for example, an interposer assembly 104 of an embodiment of PIC assembly 101. Spot size converters may facilitate improved coupling of optical signals to the terminal facets of waveguides formed in coupler 100 as shown in the embodiment of coupler 100 in FIG. 36A having spot size converters 141 coupled to waveguides 106 of the coupler 100. Spot size converters 141 may be used in embodiments disclosed herein on the terminal facets of waveguides 106 on the coupler 100 to facilitate coupling of optical signals propagating from the interposer 103, for example, or other optical signal source to a waveguide facet on the coupler 100. Spot size converters may be formed at an edge of the coupler 100, as shown, for example, in FIG. 36A and may be formed, for example, at the wall of a cavity such as, for example, cavity 146 and cavity 149 of coupler 100. Spot size converters 141 may also be used on interposer 103 to facilitate coupling of optical signals at a facet formed, for example, in cavity 148 and cavity 147 of the interposer 103.

FIG. 36C shows a top-view schematic drawing of an embodiment of PIC assembly 101 comprising an interposer assembly 104 and coupler assembly 102, wherein the coupler assembly 102 is configured as in FIG. 36A, and wherein the interposer assembly 104 is configured having an optoelectrical device array 120_{array} mounted in cavity 148 formed on the interposer 103 on alignment pillars formed self-aligned with waveguide cores 107_{core} on the interposer 103. The optoelectrical devices 119 in the device mounting cavities 149 on the coupler 100 and in the device-mounting cavities 148 on the interposer 103 are shown in dotted lines for clarity.

In the embodiment of PIC assembly 101 shown in FIG. 36C comprising interposer assembly 104 and coupler assembly 102, the coupler assembly 102 is configured as in the embodiment of the coupler assembly 102 of FIGS. 36A and 36B having a plurality of optoelectrical devices 119 mounted or otherwise formed in cavities 149, and wherein the optoelectrical devices 119 and cavities 149 are formed between the edge of the coupler 100 facing the interposer 103 and the cavity 148 configured having the optical isolator 132.

In the embodiment of the interposer assembly 104 shown coupled to the coupler assembly 102, a projection of the optoelectrical device array 120_{array} is shown in dotted lines, and shown with alignment pillars 123 formed in cavity 148 of the interposer 103. PIC 118 on interposer assembly 104 may include other devices in addition to the optoelectrical device array 120_{array} and waveguides 107 shown in FIGS. 36C and 36D and elsewhere herein. In the embodiment, coupler 100 may be configured having alignment features formed self-aligned with waveguide cores 106_{core} formed on the coupler 100, wherein the alignment features on the coupler may include T&G alignment features 108, lateral alignment features 128 for aligning optical isolator 132 in cavity 146, alignment pillars 122 formed in device-mounting cavities 149, and FAU alignment aids 126 for aligning FAU 156 in the FAU mounting site 152 on the coupler 100.

FIG. 36D shows a cross-sectional schematic drawing of the embodiment of coupler 100 shown in FIG. 36C, wherein the drawing further shows coupler 100 configured having cavity 149 formed between the edge of the coupler having the T&G alignment aids 108, and the cavity 148 having the optical isolator 132.

FIG. 36E shows a top-view schematic drawing of an embodiment of PIC assembly 101 comprising interposer assembly 104 and coupler assembly 102, wherein the interposer assembly 104 is configured having a plurality of rear lateral gratings 125ᵣₑₐᵣ coupled to the optoelectrical device array 120_{array} on interposer 103, and wherein the optoelectrical devices 120 of the optoelectrical device array 120_{array} are coupled to MLA lenses 138_{MLA} of a multi-lens array 130_{MLA} mounted or otherwise formed in cavity 147 on the interposer 103, and wherein the coupler assembly 102 is configured as in FIGS. 36A and 36B.

In the embodiment of the PIC assembly 101 shown in FIG. 36E, interposer assembly 104 is configured having hybrid laser structures, and coupler assembly 102 is configured having optoelectrical devices 119 formed in cavities 149 between the edge of the coupler 100 facing the interposer assembly 104 and the cavity 149 configured having the optical isolator 132. Optoelectrical devices 119 are receptive to optical signals from the optoelectrical devices 120 of the optoelectrical device array 120_{array} coupled through waveguides 106 on the coupler 100.

The embodiment of the interposer assembly 104 comprises interposer 103, optoelectrical device array 120_{array} configured having four optoelectrical devices 120, rear lateral gratings 125ᵣₑₐᵣ coupled to the four optoelectrical devices 120 of the optoelectrical device array 120_{array}, and a cavity 147 configured having MLA lenses 138_{MLA} of multi-lens array 130_{MLA}.

Embodiments of the PIC assembly 101 configured as shown in FIG. 36E enable the direct coupling of optical signals from the MLA lenses 138_{MLA} of the multi-lens array 130_{MLA} in cavity 147 of the interposer assembly 104 to the optoelectrical devices 119 mounted or otherwise formed in cavities 149 through spot size converters 141 and the waveguides 106 on the coupler 100, without an intervening optical isolator 132 in cavity 146 as in the embodiments shown, for example, in FIGS. 34C-34D. Direct coupling of the optical signals from an interposer assembly 104 to the optoelectrical devices 119 mounted or otherwise formed in cavities 149 may facilitate improved coupling of optical signals from the optoelectrical devices 120 of optoelectrical device array 120_{array} of the interposer assembly 104 to the optoelectrical devices 119 of the coupler 100 in some embodiments. Spot size converters 141 are shown receptive to optical signals free-space coupled from MLA lenses 138_{MLA} of the multi-lens array 130_{MLA} to facilitate improved coupling of optical signals from the interposer assembly 104 to the waveguides 106 of coupler 100. Spot size converters 141 may provide, for example, increased surface area of the facets to which the optical signals from the interposer assembly 104 are coupled in some embodiments.

FIG. 36F shows a cross-sectional schematic drawing of the embodiment of the PIC assembly 101 shown in FIG. 36E, wherein the coupler 100 is configured having cavity 149 formed between the coupler edge having the T&G alignment aids 108, and the cavity 148 having the optical isolator 132. In FIG. 36F, a cross-section of the rear lateral grating 125ᵣₑₐᵣ is shown. Grating structures such as rear lateral grating 125ᵣₑₐᵣ may be formed from all or a portion of the core layer 105_{core} of the planar waveguide layer 105 on the interposer 103, and may in some embodiments, be formed in self-alignment with one or more of the waveguide cores 107_{core} of waveguides 107, T&G alignment aids 109, alignment pillars 123, fiducials 115, and other alignment aids formed on the interposer 103 from the core layer 105_{core} of the planar waveguide layer 105.

The INSET of FIG. 36F shows a perspective drawing of an example patterned rear lateral grating core layer 125_{core} of a rear lateral grating structure 125ᵣₑₐᵣ. The rear lateral grating structure 125ᵣₑₐᵣ is shown without the top cladding layer 107_{Tclad} for clarity. In the INSET of FIG. 36F, the periodic structure forming in the sidewall of the lateral grating is shown. The primary axis of propagation of optical signals coupled to the grating structure is in the longitudinal direction as indicated in the figure. In the embodiment, slices configured having two different widths in the lateral direction as indicated in the figure provide the modulation of the effective refractive index in the longitudinal direction in the grating structure.

### Assemblies Having Loopback Waveguides Formed on the Interposer

In embodiments of PIC assembly 101, coupler assemblies 102 configured having one or more optical fibers 154 are coupled to interposer assemblies 104 to facilitate coupling of the one or more optical fibers 154 to the waveguide cores 107_{core} or other optical pathways of the interposer assembly 104 through waveguides 106 and optical pathways on the coupler 100. The efficiency in the coupling of the waveguide cores 107_{core} or other optical pathways of the interposer assembly 104 can be improved with effective alignment of the optical axes of the waveguide cores 107_{core} on the interposer 103 with the optical axes of the waveguides 106 and optical pathways on the coupler 100 that are coupled to the cores of the optical fibers 154 mounted or otherwise formed in the FAU 156 on the coupler 100.

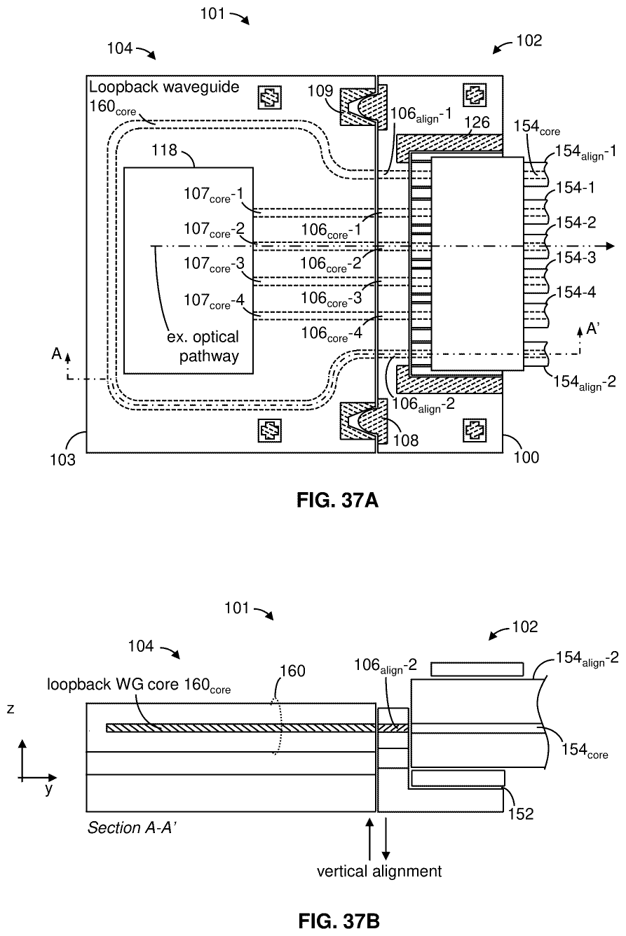

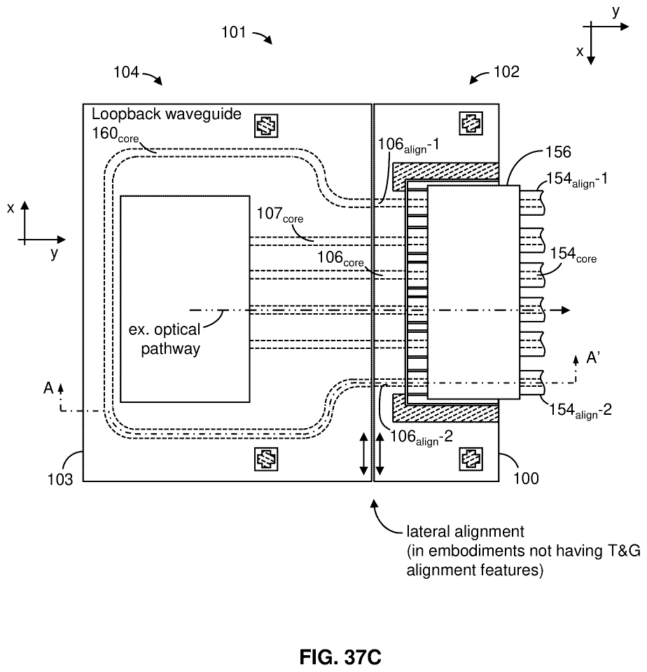

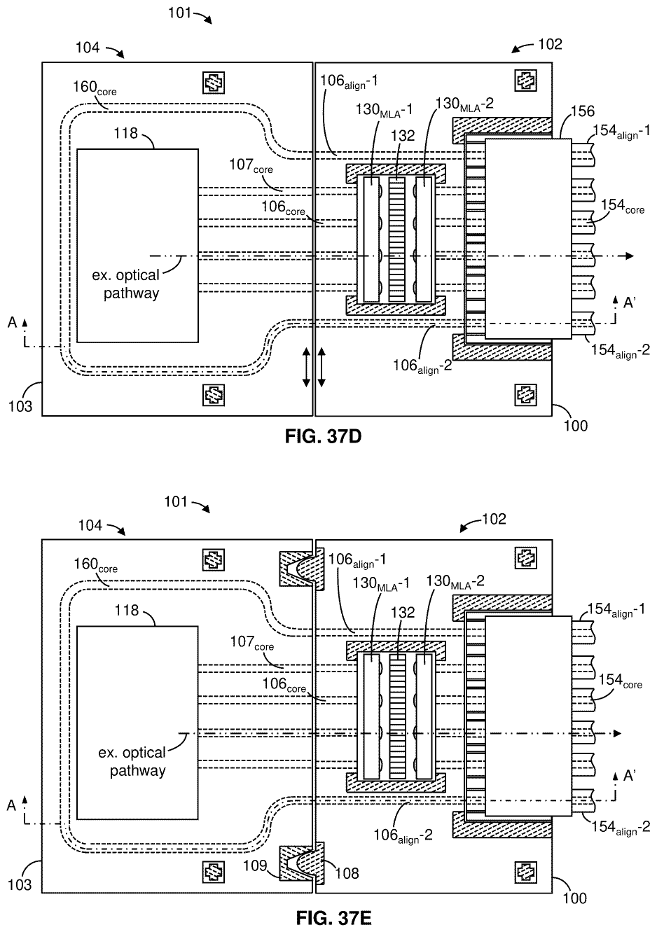

FIGS. 37A-37E show embodiments of PIC assemblies 101 that include loopback waveguides 160 wherein the loopback waveguides 160 facilitate alignment of waveguide cores 106_{core} of waveguides 106 or optical pathways on the coupler 100 that may be formed in alignment with the cores of optical fibers 154 mounted or otherwise formed in FAU 156 on the coupler 100, with waveguides 107 or optical pathways on the interposer assembly 104.

In some embodiments of PIC assemblies 101 configured having lateral T&G alignment aids 108 on coupler 100 and lateral T&G alignment aids 109 on interposer 103, loopback waveguides 160 may be provided on the interposer 103 to facilitate vertical alignment, for example, of waveguide cores 106_{core} on the coupler assembly 102 to which the optical fibers 154 mounted or otherwise formed on the coupler 100 are aligned, and the waveguide cores 107_{core} on the interposer assembly 104 formed self-aligned with the loopback waveguide core 160_{core} of the loopback waveguide 160.

In other embodiments of PIC assemblies 101 configured having T&G lateral alignment aids 108 on coupler 100 and T&G lateral alignment aids 109 on interposer 103, lateral alignment of optical pathways on coupler assembly 102 with optical pathways on interposer 103 is facilitated using the T&G lateral alignment features to laterally (in x-direction and γ-direction) position optical pathways of the coupler assembly 102 with lenses, waveguides 107, and other optical pathways of the interposer assembly 104.

In embodiments of assemblies 101 that are not configured having T&G lateral alignment aids 108 on coupler 100 and T&G alignment aids 109 on interposer 103, loopback waveguides cores 160_{core} that are formed self-aligned with one or more of waveguide cores 107_{core} and other alignment features formed on the interposer 103, may be used to facilitate active alignment of one or more of the waveguide cores 107_{core} and other optical pathways of interposer 103 with the waveguide cores 106_{core} and other optical pathways of the coupler 100.

FIG. 37A shows a top-view schematic drawing of an embodiment of PIC assembly 101 comprising interposer assembly 104 and coupler assembly 102, wherein the interposer assembly 104 is configured having loopback waveguide 160 comprising loopback waveguide core 160_{core} and top, bottom, and side cladding layers to facilitate vertical alignment of waveguides cores 106_{core} on the coupler 100 with waveguide cores 107_{core} on the interposer 103 of the interposer assembly 104. The PIC assembly 101 is further configured having T&G alignment aids 109 on the interposer 103 and T&G alignment aids 108 on the coupler 100 to facilitate lateral alignment of the waveguide cores 107_{core} and optical pathways of the interposer 103 with the waveguide cores 106_{core} and optical pathways of the coupler 100.

In the embodiment of the PIC assembly shown in FIG. 37A, the interposer 103 of the interposer assembly 104 is configured having loopback waveguide core 160_{core} formed self-aligned with the waveguide cores 107_{core} of waveguides 107, the T&G lateral alignment aids 109, and fiducials 115.

In the embodiment, the coupler assembly 102 is configured having first and second alignment optical fibers 154_{align}-1,154_{align}-2 mounted or otherwise formed in FAU 156 on the coupler 100 and coupled to first and second alignment waveguide cores 106_{align}-1,106_{align}-2, respectively, that are formed in self-alignment with the waveguide cores 106_{core} of waveguides 106 and in self-alignment with lateral alignment aids formed on the coupler 100 that include the T&G alignment aids 108, fiducials, 114, and the FAU alignment aids 126. In other embodiments, other lateral alignment features may also be formed such as, for example, alignment pillars and other lateral alignment aids formed on the coupler 100.

In the embodiment of the PIC assembly 101 shown in FIG. 37A, coupler assembly 102 is configured having four optical fibers 154 mounted or otherwise formed in FAU 156 on coupler 100, and further configured having T&G alignment aids 108 coupled to the T&G alignment aids 109 of the interposer 103 in interposer assembly 104 to facilitate lateral alignment of the optical fiber cores 154_{core} of the optical fibers 154 and the waveguide cores 106_{core} on the coupler 100 with the waveguide cores 107_{core} on the interposer 103.

In an embodiment of a method of alignment utilizing the T&G alignment features 108,109 of the coupler 100 and interposer 103, respectively, the cores of the optical fibers 154 mounted or otherwise formed in the FAU 156 on the coupler 100, are firstly aligned with the waveguide cores 106_{core} of the coupler 100 and the FAU 156 is then secured in an aligned position in the FAU mounting site 152 using, for example, an epoxy 165 or other adhering medium. Alignment of the optical fibers 154 mounted or otherwise formed on the FAU 156, with the waveguide cores 106_{core} of waveguides 106 on the coupler 100, may be achieved in a first alignment step by coupling an optical signal through two or more of the optical fibers 154 and monitoring the optical signal intensity emerging from the terminal ends of the waveguides 106 on the edge of the coupler 100 configured having the T&G alignment aids 108. In this first alignment step, the interposer assembly 104 is not present in the assembly to enable measurement or monitoring of the optical signal intensity emerging from the terminal facets of the waveguide cores 106_{core} on the edge of the coupler 100 opposite to that of the FAU.

Alignment of the optical fiber cores 154_{core} with the waveguide cores 106_{core} of the coupler 100 in a first alignment step, facilitates the alignment of the optical fiber cores 154_{core} with the waveguide cores 107_{core} of the interposer 103. In an alignment step subsequent to the first alignment step in the embodiment, the waveguide cores 106_{core} of the coupler 100, formed self-aligned with the first and second alignment waveguide cores 106_{align}-1,106_{align}-2 and the T&G alignment features 108 of the coupler 100, may be aligned to the waveguide cores 107_{core} of the interposer 103 that are formed self-aligned with the loopback waveguide core 160_{core} and the T&G alignment features 109 of the interposer 103, by coupling the T&G alignment features 108 of coupler 100 and the T&G alignment features 109 of interposer 103.

The T&G alignment features 108 formed in self-alignment with the waveguide cores 106_{core} and the first and second alignment waveguide cores 106_{align}-1,106_{align}-2, when coupled to the T&G alignment features 109 of the interposer 103, enables the simultaneous lateral alignment of the waveguide cores 106_{core} of the coupler 100 with the waveguide cores 107_{core} of the interposer 103, and the lateral alignment of the first and second alignment waveguide cores 106_{align}-1, 106_{align}-2 of the coupler 100 with the loopback waveguide core 160_{core}.

FIG. 37B shows a cross-sectional schematic drawing through Section A-A′ of the PIC assembly 101 of FIG. 37A. In FIG. 37B, the loopback waveguide core 160_{core} of the loopback waveguide on interposer 103 is shown in vertical alignment with the second alignment waveguide core 106_{align}-2 of the coupler 100 and the optical fiber core 154_{core} of an alignment optical fiber 154_{align}-2 mounted in FAU 156 in FAU mounting site 152 on the coupler 100. The alignment of the optical axes of the loopback waveguide core 160_{core} of the loopback waveguide and the cores of the alignment waveguides 106_{align}-1, 106_{align}-2 on the coupler 100, in the vertical (z) direction, may be achieved by varying the relative vertical position (as shown) of one or more of the interposer assembly 104 and the coupler assembly 102, such that an optical signal propagating through a first alignment optical fiber 154_{align}-1 to the first alignment waveguide core 106_{align}-1 on the coupler 100 and coupled to the loopback waveguide 160 through the first waveguide core 106_{align}-1 of coupler 100, is detected upon exiting the loopback waveguide, the second alignment waveguide core 106_{align}-2 on the coupler 100, and the second alignment optical fiber 154_{align}-2 mounted or otherwise formed in FAU 156 on the coupler 100.

The maximizing of the magnitude of a measured optical signal, for example, emerging from the second alignment optical fiber 154_{align}-2 may be used to indicate that vertical alignment of the optical fiber cores 154_{core} of the optical fibers 154 in the FAU 156 with the loopback waveguide 160 has been achieved. Upon achieving the alignment, the FAU 156 may be secured in place on the coupler using an epoxy or other bonding medium, for example, and the coupler 100 and interposer 103 may also be secured in place using an epoxy or other bonding medium to bond the assembly.

Other characteristics of the optical signal emerging from the second alignment optical fiber 154_{align}-2 may also be used to signal alignment, for example, of the first and second alignment waveguide cores 106_{align}-1,106_{align}-2 with the terminal facets of loopback waveguide core 160_{core} of the loopback waveguide 160.

Vertical alignment of the optical fiber cores 154_{core} of the alignment optical fibers 154_{align}-1, 154_{align}-2 with the loopback waveguide core 160_{core} of interposer 103 facilitates the alignment of the optical fibers 154-1 to 154-4 mounted or otherwise formed in FAU 156 on coupler 100 and the waveguide cores 106_{core}-1 to 106_{core}-4 to which the optical fibers 154-1 to 154-4 are coupled, and in alignment with corresponding waveguide cores 107_{core}-1 to 107_{core}-4 of the interposer assembly 104.

The formation of the loopback waveguide core 160_{core} in self-alignment with the waveguide cores 107_{core} of interposer 103 and the T&G alignment features 109, facilitates the lateral alignment of waveguide cores 107_{core} of interposer 103 with the waveguide cores 106_{core} on coupler 100 upon coupling of the T&G alignment features 109 of the interposer 103 and the T&G alignment features 108 of the coupler 100. In such embodiments of PIC assembly 101 having the T&G alignment aids 109 on the interposer 103 and T&G alignment aids 108 on the coupler 100, active alignment may only be necessary in the vertical direction after the T&G alignment features 109 of interposer 103 have been coupled to the T&G alignment features 108 of coupler 100 to facilitate lateral alignment.

Formation of the coupler 103 and the interposer 104 from a common substrate, a viable option given the common film and substrate structure for the coupler 103 and interposer 104, may ease the requirements for alignment in the vertical direction in embodiments in which the interposer 103 and coupler 103 are formed from a common substrate or same means for producing the coupler 100 and the interposer 103.

In the cross-section drawing of FIG. 37B, the optical fiber cores 154_{core} of second alignment optical fiber 154_{align}-2, second alignment waveguide core 106_{align}-2 of an alignment waveguide of coupler 100, and loopback waveguide core 160_{core} of the loopback waveguide 160 are shown in alignment. The loopback waveguide comprises loopback waveguide core 160_{core} and includes all or a portion of the cladding layers surrounding the loopback waveguide core 160_{core}.

In some embodiments, the vertical alignment of the optical fiber cores 154_{core} of optical fibers 154 with the waveguide cores 107_{core} of the interposer 103 may be achieved in an alignment step wherein the optical fiber cores 154_{core} of the first and second alignment optical fibers 154_{align}-1, 154_{align}-2 are aligned with the first and second alignment waveguide cores 106_{align}-1, 106_{align}-2, respectively, of coupler 100 and the corresponding terminal facets of the loopback waveguide core 160_{core} of the loopback waveguide, and once aligned, bonded or otherwise secured in aligned positions to form the PIC assembly 101 having aligned waveguide cores 106_{core} of the coupler assembly 102 and waveguide cores 107_{core} of interposer assembly 104.

The optical fiber cores 154_{core} of the second alignment optical fiber 154_{align}-2, the second alignment waveguide core 106_{align}-2 of coupler 100, and the loopback waveguide core 160_{core} of loopback waveguide 160 are shown in FIG. 37B in alignment. The loopback waveguide 160 comprises loopback waveguide core 160_{core} and includes all or a portion of the cladding layers surrounding the loopback waveguide core 160_{core}.

In some embodiments, alignment in more than vertical direction may be achieved using embodiments of interposer assembly 104 configured having loopback waveguide 160.

FIG. 37C shows an embodiment of PIC assembly 101 wherein the coupler 100 is not configured having T&G lateral alignment features 108 and interposer 103 is not configured having T&G lateral alignment features 109. In the embodiment shown in FIG. 37C, not having the T&G alignment features 108,109 may necessitate active alignment in both the lateral (x) and vertical (z) directions. Optimization of the magnitude of the optical signal, for example, emerging from the second alignment optical fiber 154_{align}-2 in the FAU 156 may be used to indicate that both lateral and vertical alignment of the optical fiber cores 154_{core} of the optical fibers 154-1 to 154-4 in the FAU 156 with the loopback waveguide core 160_{core} of the loopback waveguide 160 has been achieved.

FIGS. 37D and 37E show embodiments of PIC assembly 101 comprising interposer assembly 104, coupler assembly 102, and FAU 156 configured having four optical fibers 154, wherein the couplers 100 of coupler assembly 102 are configured having optical isolator 132 and one or more lens array provided, in the embodiment, as a multi-lens array 130_{MLA}. Other lens arrays as described herein may also be used in other embodiments.

FIG. 37D shows a top-view schematic drawing of an embodiment of a PIC assembly 101 configured without T&G alignment features 108 on coupler 100 and T&G alignment features 109 on the interposer 103 wherein the PIC assembly 101 comprises interposer assembly 104 and coupler assembly 102 and wherein the coupler assembly 102 is configured having an optical isolator 132 positioned between two lens arrays 130 configured as first and second multi-lens arrays 130_{MLA}-1,130_{MLA}-2, respectively. Lacking the T&G alignment features 108,109 on the coupler 100 and interposer 103, respectively, may necessitate active alignment in both the lateral (x) and vertical (z) directions to achieve alignment of the optical pathways of the interposer assembly 104 and the coupler assembly 102. Optical signals, coupled through first alignment optical fiber 154_{align}-1 to the loopback waveguide core 160_{core} and emerging from the second alignment optical fiber 154_{align}-2 in the embodiment shown in FIG. 37D, may be used to facilitate alignment of waveguides cores 107_{core} or other optical pathways of the interposer assembly 104 with waveguides cores 106_{core} or other optical pathways to which the optical fiber cores 154_{core} of the optical fibers 154 in FAU 156 are aligned.

Maximizing of the observed optical signal power propagating from the second alignment optical fiber 154_{align}-2 in the embodiment, for example, can be used to indicate that both lateral and vertical alignment of the waveguide cores 107_{core} and other optical pathways of the interposer assembly 104 with the waveguide cores 106_{core} and other optical pathways coupled to the optical fiber cores 154_{core} of the optical fibers 154 mounted or otherwise formed in the FAU 156 on the coupler 100.

Optional FAU alignment feature 126 may be used to facilitate lateral alignment of the optical fiber cores 154_{core} of the first alignment optical fiber 154_{align}-1 and the second alignment optical fiber 154_{align}-2 with the first alignment waveguide core 106_{align}-1 and second alignment waveguide core 106_{align}-2, respectively, in the embodiment.

In an embodiment of PIC assembly 101 configured having loopback waveguide 160 on interposer assembly 104, and configured having optical isolator 132 and one or more lens arrays 130 in cavity 146 of coupler assembly 102, active alignment of the optical fiber cores 154_{core} of the optical fibers 154 with the corresponding waveguides 107 of interposer 103 may be achieved for the embodiment configured as shown in FIG. 37D in multiple steps as disclosed herein in the following paragraphs.

In an example first alignment step, the optical fiber cores 154_{core} of the first and second alignment optical fibers 154_{align}-1, 154_{align}-2 are aligned with first and second alignment waveguide cores 106_{align}-1,106_{align}-2, respectively, by monitoring and maximizing the optical signals emerging from the terminal facets of the first and second alignment waveguide cores 106_{align}-1, 106_{align}-2 of the coupler 100, while varying the relative positions of the first and second alignment optical fibers 154_{align}-1, 154_{align}-2. In this example alignment, alignment of the optical fiber cores 154_{core} of the first and second alignment optical fibers 154_{align}-1, 154_{align}-2 with first and second alignment waveguide cores 106_{align}-1,106_{align}-2 of the coupler 100 may be determined, for example, at positions of the optical fibers and waveguide cores yielding a maximum signal strength observed on a monitoring apparatus 168. After alignment, in this example, the FAU configured having the first and second alignment optical fibers 154_{align}-1, 154_{align}-2 may be secured in an aligned position within all or a portion of the FAU mounting site 152 using, for example, an epoxy or other adhesive to secure the FAU 156 configured having first and second alignment optical fibers 154_{align}-1, 154_{align}-2 in position on the FAU mounting site 152 on the coupler 100.

In an example second alignment step, the first and second multi-lens arrays 130_{MLA}-1, 130_{MLA}-2 are positioned in cavity 146 of coupler 100 and aligned by coupling an optical signal through the four optical fiber cores 154_{core} of the four optical fibers 154 coupled to cavity 146 through the waveguide cores 106_{core} and altering the position of the multi-lens arrays 130 while measuring the magnitude of the optical signal emerging from the terminal facets of the waveguides 106 on the coupler 100. Measurement apparatus 168 may be positioned to be receptive to optical signals emerging from the terminal facets of the waveguide cores 106_{core} at the edge of the coupler 100 facing the interposer 103. In this second step, the interposer 103 and the coupler 100 are not yet coupled together. In this example, the first and second multi-lens arrays 130_{MLA}-1, 130_{MLA}-2, respectively may be secured in an aligned position using, for example, an epoxy or other adhesive to bond the multi-lens arrays in aligned positions in the cavity 146. Following the alignment of the MLA lenses of the first and second multi-lens arrays 130_{MLA}-1, 130_{MLA}-2, the optical isolator 132 may be positioned in the cavity 146 and aligned by coupling an optical signal to two or more of the optical fibers 154 and the MLA lenses 138_{MLA} to which the optical fibers 154 are coupled through the waveguides 106. Alignment may be achieved, for example, at positions of the first and second multi-lens arrays 130_{MLA}-1,130_{MLA}-2 yielding a maximum observed optical signal power emerging from the waveguides 106 on the edge of coupler 100.

In some embodiments, an optical signal may be coupled to each optical fiber core 154_{core}, of the four non-alignment optical fibers 154 that are mounted to the coupler 100 wherein the combined optical output from the waveguides 106 may be measured and optimized to identify an aligned position of the MLA lenses 138_{MLA} of the multi-lens arrays 130_{MLA} in the cavity 146.

In an example third alignment step, the optical signal power of optical signals coupled through first alignment optical fiber 154_{align}-1 to the loopback waveguide core 160_{core}, and emerging from the second alignment optical fiber 154_{align}-2 in the embodiment, may be measured or otherwise monitored while altering the position of one or more of the coupler assembly 102 and the interposer assembly 104. The maximum output power, for example, measured or otherwise monitored from the second alignment optical fiber 154_{align}-2, may be used to identify a suitably aligned position and to indicate that lateral and vertical alignment of the optical fiber cores 154_{core} of the optical fibers 154 with the loopback waveguide 160 has been achieved. In this example, the interposer assembly 104 and the coupler assembly 102 may be secured in an aligned position using, for example, an epoxy or other adhesive to bond the coupler 100 to the interposer 103.

In embodiments for which lens arrays 130 are formed from two-photon polymerization or other form of 3D printing, on-facet lenses 138_{F2PP} of on-facet lens arrays 130_{F2PP} and in-structure lenses 138_{S2PP} of lens array structures 130_{S2PP} may be formed in cavities 146 of the couplers prior to singulation of the couplers 100 from the host wafer from which the couplers 100 are formed. In such embodiments formed using 3D printed lenses, the on-facet lenses 138_{F2PP} and the in-structure lenses 138_{S2PP} will already be in alignment with the waveguide cores 106_{core} if present and the second step may not be required.

FIG. 37E shows a top-view schematic drawing of an embodiment of PIC assembly 101 comprising interposer assembly 104 and coupler assembly 102, wherein the interposer 103 and coupler 100 are configured having T&G alignment features 109,108, respectively, to facilitate lateral alignment of waveguides 107 or other optical pathways of the interposer 103, with the waveguides 106 or other optical pathways of the coupler 100. In such embodiments, active alignment may only be required in the vertical direction.

### Assemblies Having Fanout Waveguides Formed on the Coupler

In some embodiments of PIC assembly 101 comprising interposer assembly 104 and coupler assembly 102 configured having a plurality of optical fibers 154 mounted or otherwise formed in FAU 156 on coupler 100, the spacing of waveguides 107 on the interposer 103 and the spacing of the optical fibers 154 in the FAU 156 may differ. In such embodiments, the coupler 100 of the coupler assembly 102 may be configured having a fanout waveguide array to facilitate alignment of the waveguides 107 on the interposer 103 and the optical fibers 154 in the FAU 156.

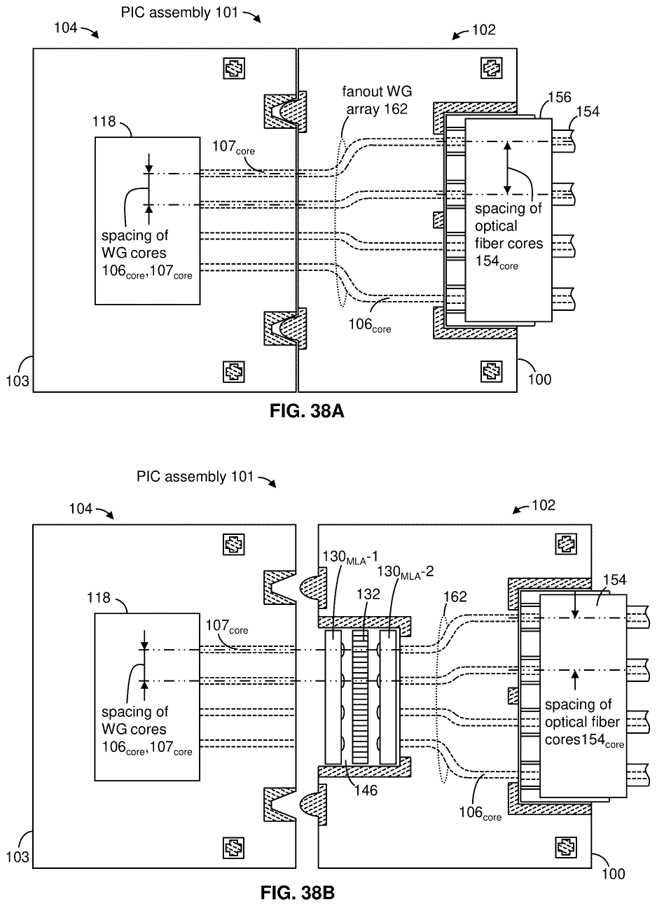

FIG. 38A shows a top-view schematic drawing of an embodiment of a PIC assembly 101 comprising interposer assembly 104 and coupler assembly 102, wherein the coupler 100 of the coupler assembly 102 is configured having a fanout waveguide array 162. Fanout waveguide array 162, in the embodiment, is an array of waveguides 106 formed on the coupler 100 that enables coupling of the waveguides 107 of interposer 103 having a first spacing, with the optical fiber cores 154_{core} of the optical fibers 154 mounted or otherwise formed in FAU 156 having a second spacing. The spacing of the waveguide cores 107_{core}, 106_{core} of the waveguides 107, 106 of the interposer 103 and coupler 100, respectively, is labeled, “spacing of WG cores 107_{core}, 106_{core}” in FIG. 38A. The spacing of the optical fiber cores 154_{core} in FAU 156 on the coupler 100 is labeled, “spacing of optical fiber cores 154_{core}” in FIG. 38A.

FIG. 38B shows an exploded top-view schematic drawing of an embodiment of PIC assembly 101 comprising interposer assembly 104 and coupler assembly 102, wherein the coupler 100 of the coupler assembly 102 is configured having a fanout waveguide array 162, and wherein the fanout waveguide array 162 is configured to facilitate alignment of the optical fiber cores 154_{core} of optical fibers 154 mounted or otherwise formed in FAU 156 on the coupler 100 with the MLA lenses 138_{MLA} of first and second multi-lens array 130_{MLA}-1,130_{MLA}-2, respectively mounted or otherwise formed in cavity 146 of the coupler assembly 102.

In the embodiment of the PIC assembly 101 shown in FIG. 38B, the waveguide cores 107_{core} on the interposer 103, the first and second multi-lens arrays 130_{MLA}-1,130_{MLA}-2, and the waveguide cores 106 on the coupler 100 are configured having a first spacing, and the optical fiber cores 154_{core} of the optical fibers 154 mounted or otherwise formed in the FAU 156 are configured having a second spacing, and in the embodiment of the coupler assembly 102, the coupler 100 is configured having a fanout waveguide array 162 that facilitates coupling of optical signals from the MLA lenses 138_{MLA} of the second multi-lens array 130_{MLA}-2 to the optical fiber cores 154_{core} of the optical fibers 154 mounted or otherwise formed in the FAU 156. Coupler 100 having the fanout waveguide 162 in the embodiment shown in FIG. 38B, is configured having an optical isolator 132 positioned between the first and second multi-lens arrays 130_{MLA}-1,130_{MLA}-2, respectively, in cavity 146.

In other embodiments, cavity 146 of coupler 146 may be configured having lenses formed using two-photon polymerization or other 3D printing method.

### Assemblies Having Ball Lenses

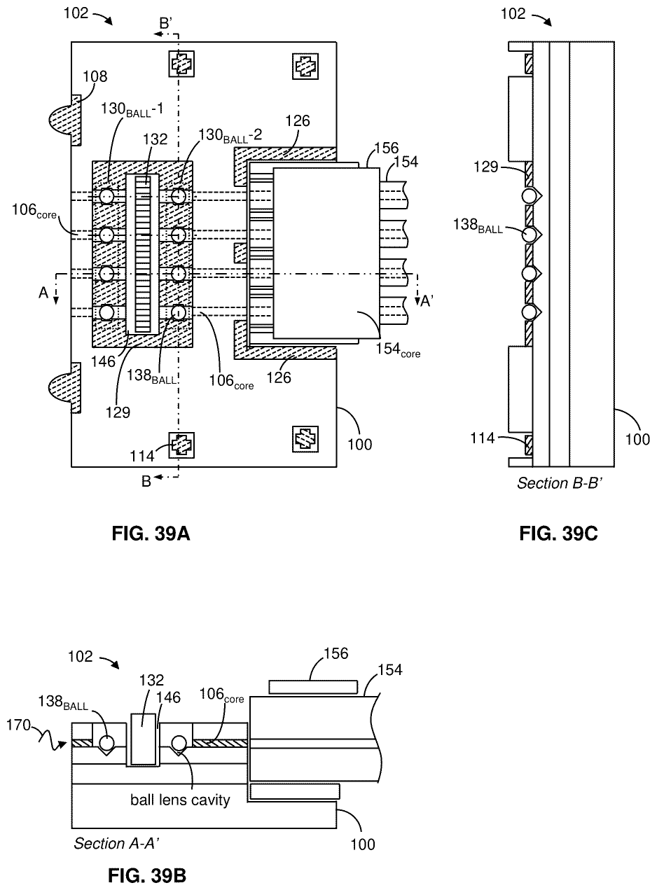

FIG. 39A shows a top-view schematic drawing of an embodiment of coupler assembly 102 configured having an optical isolator 132 mounted or otherwise formed in a cavity 146 and first and second ball lens arrays 130_{BALL} formed on the coupler 100, wherein ball lens alignment feature 129, in the embodiment, is formed self-aligned with the waveguide cores 106_{core} of the coupler 100. Formation of the ball lens alignment feature 129 in self-alignment with the waveguide cores 106_{core}, facilitates the alignment of the ball lenses 138_{BALL} in alignment with the terminal facets of the waveguide cores 106_{core} upon insertion of the ball lenses 138_{BALL} into the ball lens cavities on the coupler 100.

In the embodiment of the coupler assembly shown in FIG. 39A, the coupler 100 is configured having ball lenses 138_{BALL} mounted within lateral alignment aid 129. In embodiments, alignment aid 129 may be formed self-aligned with the waveguide cores 106_{core} of the coupler 100 to facilitate alignment of the ball lenses 138_{BALL} with the waveguide cores 106_{core} of the coupler 100.

FIG. 39B shows a cross-section schematic drawing through Section A-A′ of FIG. 39A and FIG. 39C shows a cross-section schematic drawing through Section B-B′ of FIG. 39A. In the embodiments, a v-shaped mount may be formed in the coupler 100 and used in combination with the alignment aid 129 to facilitate lateral alignment of the optical axes of the ball lenses 138_{BALL} with the optical axes of waveguide cores 106_{core} or other optical pathway on the coupler 100 that are formed self-aligned with the waveguide cores 106_{core} and other self-aligned alignment aids formed on the coupler 100.

Coupler assembly 102, in the embodiment shown in FIGS. 39A-39C, shows cavity 146 of coupler 100 configured having optical isolator 138 positioned in cavity 146 between the ball lenses 138_{BALL} of first ball lens array 130_{BALL}-1 and the ball lenses 138_{BALL} of second ball lens array 130_{BALL}-2. The alignment aid 129 of coupler 100 of the coupler assembly 102 facilitates alignment of optical isolator 132 positioned within the cavity 146 bounded at the cavity opening by lateral alignment aid 129 in the embodiment. Alignment aid 129 further facilitates alignment of the one or more ball lenses 138_{BALL} shown positioned within the portions of the lateral alignment aid 129 receptive to the ball lenses 138_{BALL}. The openings in lateral alignment aid 129 facilitate alignment of the axes of the ball lenses 138_{BALL} with optical axes of the waveguide cores 106_{core} that are coupled to the ball lenses 138_{BALL} in the embodiment. The vertical height of the ball lens 138_{BALL} may be determined, for example, by the depth of the cavity within which each of the ball lenses resides.

In some embodiments, the lateral alignment aid 129 at the opening of the cavity 146, formed self-aligned with waveguide cores 106_{core}, may be configured as shown to facilitate alignment of the optical isolator 132 in the cavity 146 with waveguide cores 106_{core}.

Cross-sections of fiducials 114, that may also be formed self-aligned with the waveguide cores 106_{core} and other alignment features formed from the planar waveguide core layer 105_{core} are also shown in FIG. 39C.

Other embodiments of coupler assembly 102 may be configured having a single ball lens array 130_{BALL} of ball lenses 138_{BALL} as in the coupler assemblies shown, for example, in FIGS. 19A-19T wherein the coupler assemblies 102 are configured having a single lens array 130 to enable coupling of optical signals from the lenses 138 of a lens array 130, through optical isolator 132, and into waveguide cores 106_{core} on the side of the cavity opposite the side having the ball lenses 138_{BALL}.

In yet other embodiments of coupler assembly 102, the coupler 100 may be configured such that optical signals emerging from the terminal facets of waveguide cores 106_{core}, for example, may be coupled through an optical isolator 132 to ball lenses 138_{BALL} mounted or otherwise formed on the coupler and coupled to waveguide cores 106_{core} or spot size converters on the outgoing side of the cavity 146.

### Bonded Assemblies

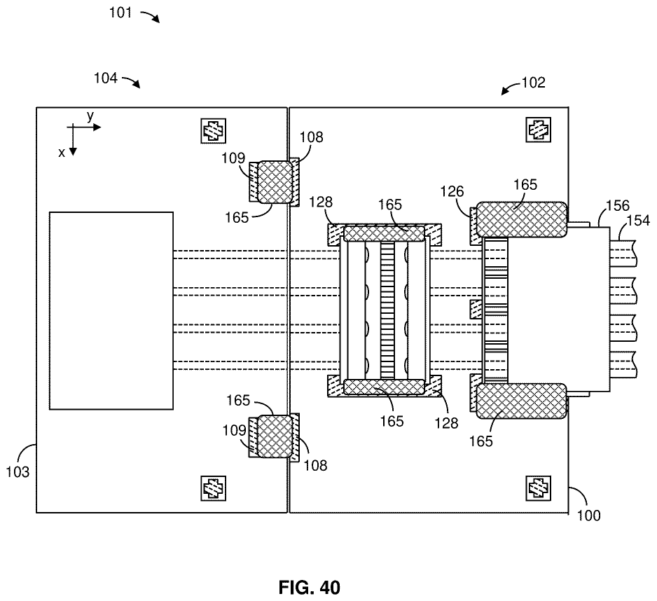

FIG. 40 shows a top-view schematic drawing of the embodiment of PIC assembly 101 of FIG. 2C wherein the coupler 100 and interposer 103 are bonded together using an epoxy or other bonding material. In the embodiment, the epoxy 165 or other bonding material may be applied to the T&G alignment features 109 of the interposer 103 and the T&G alignment features 108 of the coupler 100 to form PIC assembly 101 in the embodiment. Epoxy 165 may also be used, for example, to bond the multi-lens arrays 130_{MLA} and optical isolator 132 to the coupler 100, and to bond the four optical fibers 154 to the coupler 100 as shown.

The embodiment shows an example of the application of an epoxy 165 as a bonding agent to secure the various components in the PIC assembly 101. In other embodiments, other applications of epoxy 165 or other bonding agents may be used to secure the various components in the PIC assembly 101. Epoxy 165 may be, for example, a UV-curable epoxy that maintains viscosity while adjusting the position of, for example, FAU 156 in FAU mounting site 152 on coupler 100.

Method of Forming Assemblies Comprising Interposers and Couplers Wherein the Couplers are Configured Having Alignment Features Formed Self-Aligned with Waveguide Cores

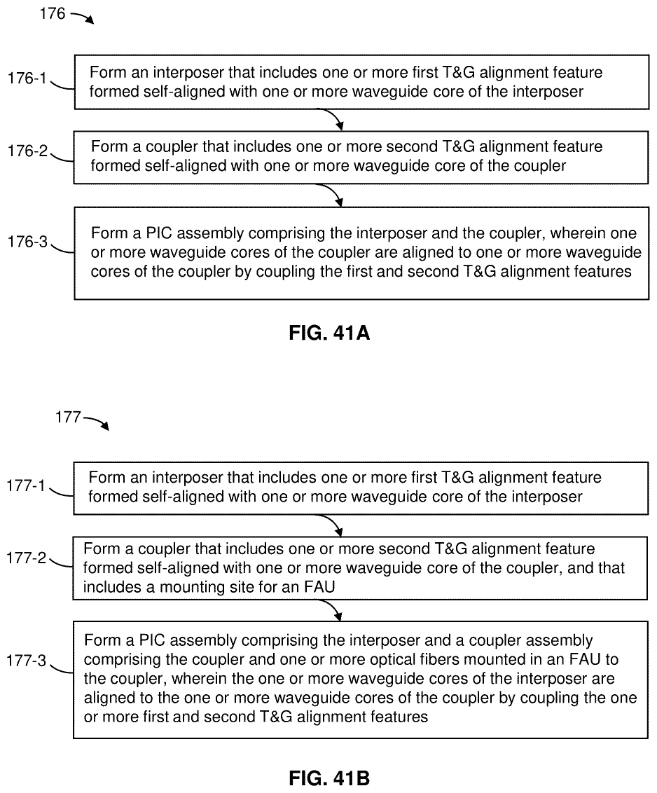

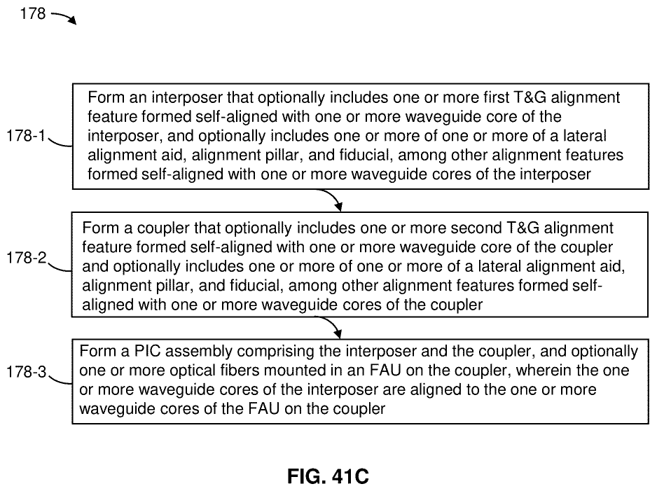

FIG. 41A shows a flowchart for a method 176 of forming embodiments of PIC assembly 101 wherein the PIC assembly 101 comprises an embodiment of interposer 103 configured having one or more first T&G alignment feature 109 formed self-aligned with a waveguide core 107_{core} on the interposer 103, and a coupler 100 configured having one or more second T&G alignment feature 108 formed self-aligned with a waveguide core 106_{core} formed on the coupler 100, wherein the one or more first T&G alignment feature 109 of the interposer is receptive to the second T&G alignment feature 108 of the coupler 100, such that coupling of the first T&G alignment feature 109 of the interposer 103 and the second T&G alignment feature 108 of the coupler 100 facilitates the alignment of at least a waveguide core 107_{core} of the interposer 103 with at least a waveguide core 106_{core} of the coupler 100 in the PIC assembly 101.

Formation of one more T&G alignment feature 109 self-aligned with the one or more waveguide cores 107_{core} of the interposer 103 provides a mechanical reference formed at lithographic resolution between the one or more T&G alignment feature 109 and the one or more waveguide cores 107_{core} that enables use of the one or more T&G alignment features 109 on the interposer 103 to facilitate alignment of the one or more waveguide cores 107_{core} with optical features formed on other structures to which the interposer 103 may be coupled, such as coupler 100. Couplers 100, for example, configured having T&G alignment features 108 formed in self-alignment with waveguide cores 106_{core}, enables alignment of features such as the waveguide cores 106_{core} of the coupler 100, with features such as waveguide cores 107_{core}, among others, of the interposer 103. The T&G alignment aids 109 of the interposer 103, formed in self-alignment with the waveguide cores 107_{core} of the interposer 103, enables alignment of the waveguide cores 107_{core} of the interposer 103 with the waveguide cores 106_{core} of the coupler 100 using the T&G alignment aids 108 formed in self-alignment with the waveguide cores 106_{core}. Alignment between the waveguide cores 106_{core} of the coupler 100 and the waveguide cores 107_{core} of the interposer 103, is achieved with the coupling of the T&G alignment aids 108 of the coupler 100 formed in self-alignment with the waveguide cores 106_{core}, and the T&G alignment aids 109 of the interposer 103 formed in self-alignment with the waveguide cores 107_{core} of the interposer 103. (See, for example, FIGS. 5A-5D.)

Step 176-1 of method 176 is a forming step in which an embodiment of interposer 103 is formed that includes one or more first T&G alignment feature 109 formed self-aligned with one or more waveguide core 107_{core} of the interposer 103. Self-alignment is achieved, in embodiments, using a common patterned mask layer in the patterning of the one or more first T&G alignment feature 109 and the one or more waveguide core 107_{core} formed from a planar waveguide layer of interposer 103.

Step 176-2 of method 176 is a forming step in which an embodiment of coupler 100 is formed that includes one or more second T&G alignment feature 108 formed self-aligned with one or more waveguide core 106_{core} of the coupler 100. Self-alignment is achieved, in embodiments, using a common patterned mask layer in the patterning of the one or more second T&G alignment feature 108 and the one or more waveguide core 106_{core} formed from a planar waveguide layer of coupler 100.

Step 176-3 of method 176 is a forming step in which an embodiment of PIC assembly 101 is formed comprising interposer 103 and coupler 100, wherein the one or more waveguide cores 107_{core} of the interposer 103 are aligned to the one or more waveguide cores 106_{core} of the coupler 100 by coupling the first and second T&G alignment features 109,108 of the interposer 103 and coupler 100, respectively. In embodiments, interposer assembly 104 comprising interposer 103 may be used in the formation of embodiments of PIC assembly 101 using method 176. And in embodiments, coupler assembly 102 comprising coupler 100 may be used in the formation of embodiments of PIC assembly 101 using method 176.

An embodiment of PIC assembly 101 comprising interposer 103 and coupler 100 is shown, for example, in FIG. 1A. The embodiment of PIC assembly 101 in FIG. 1A shows interposer assembly 104 comprising interposer 103, T&G alignment aids 109, and waveguide cores 107_{core}-1 to 107_{core}-4 wherein the T&G alignment aids 109 are formed self-aligned with waveguide cores 107_{core}-1 to 107_{core}-4 on the interposer 103. The embodiment of PIC assembly 101 in FIG. 1A further shows coupler assembly 102 comprising coupler 100, T&G alignment aids 108, and waveguide cores 106_{core}-1 to 106_{core}-4 wherein the T&G alignment aids 108 are formed self-aligned with waveguide cores 106_{core}-1 to 106_{core}-4 on the coupler 100. Coupling of the two T&G alignment aids 109 of the interposer 103 with the two T&G alignment aids 108 of the coupler 100 facilitates alignment of the waveguide cores 107_{core}-1 to 107_{core}-4 on the interposer 103 with the waveguide cores 106_{core}-1 to 106_{core}-4 on the coupler 100 in the embodiment of the PIC assembly 101. In the embodiment of the PIC assembly 101 shown in FIG. 1A, the waveguide cores 107_{core}-1 to 107_{core}-4 of the interposer 103 are shown in alignment with the waveguide cores 106_{core}-1 to 106_{core}-4 of the coupler 100.

In some embodiments, interposer 103 may be configured having optical pathways that do not include waveguide cores 107_{core} on all or a portion of the propagation path for optical signals through the interposer 103, as in, for example, the embodiment of the PIC assembly 101 shown in FIG. 33G. In this and other embodiments that are configured without waveguide cores 107_{core}, T&G alignment features 109,108 may be utilized in method 176 to align other optical pathways or reference points that require alignment. In the embodiment shown in FIGS. 33G, MLA lenses 138_{MLA} of multi-lens array 130_{MLA} in cavity 147 of interposer 103 are coupled to on-facet lenses 138_{F2PP} in cavity 146 on coupler 100 wherein the on-facet lenses 138_{F2PP} of the on-facet lens array 130_{F2PP} in the cavity 146 are configured to receive optical signals propagating through the MLA lenses 138_{MLA} of the multi-lens array 130_{MLA} in cavity 147 of the interposer 103. In the embodiment of the PIC assembly 101, T&G alignment features 109 of the interposer 103, coupled to the T&G alignment features 108 of the coupler 100, facilitate alignment of the optical axes or other optical pathways through the MLA lenses 138_{MLA} of the interposer 103 with the optical axes or other optical pathways through the on-facet lenses 138_{F2PP} of the coupler 100. Alignment of the MLA lenses 138_{MLA} of the multi-lens array 130_{MLA} with a optoelectrical device array 120_{array} coupled to alignment pillars formed in self-alignment with the T&G alignment aids 109 on the interposer 103, with on-facet lenses 138_{F2PP} formed in reference to the alignment aid 128 at the periphery of the cavity 146, formed self-aligned with the T&G alignment aid 108 of the coupler 100, facilitates alignment of the optical axes or other optical pathways of the interposer 103 with the optical axes or other optical pathways of the coupler 100 when assembled into PIC assembly 101.

FIG. 41B shows a flowchart for a method 177 of forming embodiments of PIC assembly 101 as in method 176 of FIG. 41A comprising interposer 103 and coupler 100, and further comprising one or more optical fibers mounted or otherwise formed in FAU 156 on the coupler 100.

Step 177-1 of method 177 is a forming step in which an embodiment of an interposer 103 is formed that includes one or more first T&G alignment feature 109 formed self-aligned with one or more waveguide core 107_{core} of the interposer.

Step 177-2 of method 177 is a forming step in which an embodiment of a coupler 100 is formed that includes one or more second T&G alignment feature 108 formed self-aligned with one or more waveguide core 106_{core} of the coupler 100, and that includes an FAU mounting site 152.

Step 177-3 of method 177 is a forming step in which an embodiment of PIC assembly 101 is formed comprising interposer 103 and coupler assembly 102 wherein the coupler assembly 102 comprises coupler 100 and one or more optical fibers 154 mounted or otherwise formed in an FAU 156 on the coupler 100, and wherein the one or more waveguide cores 107_{core} of the interposer 103 are aligned with the one or more waveguide cores 106_{core} of the coupler 100 by coupling the one or more first T&G alignment features 109 of the interposer 103 with the one or more second T&G alignment features 108 of the coupler 100.

FIG. 41C shows a flowchart for a method 178 of forming embodiments of PIC assembly 101 as in method 177 of FIG. 41B comprising interposer 103, coupler 100, and optionally one or more optical fiber mounted or otherwise formed in an FAU 156 on the coupler 100, wherein the coupler 100 and interposer 103 optionally include one or more of one or more lateral alignment aid, alignment pillar, and fiducial, among other alignment aids formed self-aligned with one or more waveguide core 106_{core}, 107_{core}, of the coupler 100 and interposer 103, respectively.

Step 178-1 of method 178 is a forming step in which an embodiment of interposer 103 is formed that optionally includes one or more first T&G alignment feature 109 formed self-aligned with one or more waveguide core 107_{core} of the interposer 103, and optionally includes one or more of one or more of a lateral alignment aid, alignment pillar 123, and fiducial 115, among other alignment features formed self-aligned with one or more waveguide cores 107_{core} of the interposer 103.

In forming Step 178-1 of method 178, an embodiment of interposer 103 is formed that optionally includes one or more first T&G alignment feature 109 and one or more optional alignment feature formed self-aligned with one or more waveguide core 107_{core} of the interposer 103, wherein the optional alignment features formed self-aligned with the one or more waveguide core 107_{core} of the interposer 103 may include one or more of one or more T&G alignment aid 109, one or more fiducials 115, and one or more alignment pillars 123, among other lateral alignment aids and lateral alignment features that may optionally be included in the embodiment of the interposer 103. Self-alignment is achieved, in embodiments, using a common patterned mask layer in the patterning of the T&G alignment features 109 and other optional alignment features, and the one or more waveguide cores 107_{core} formed from the planar waveguide layer of interposer 103.

Step 178-2 of method 178 is a forming step in which an embodiment of coupler 100 is formed that optionally includes one or more second T&G alignment feature 108 formed self-aligned with one or more waveguide core 106_{core} of the coupler 100 and optionally includes one or more of one or more of a lateral alignment aid, alignment pillar, and fiducial, among other alignment features formed self-aligned with one or more waveguide cores 106_{core} of the coupler 100.

In forming Step 178-2 of method 178, an embodiment of coupler 100 is formed that optionally includes one or more second T&G alignment feature 108 and one or more optional alignment feature formed self-aligned with one or more waveguide core 106_{core} of the coupler 100, wherein the optional alignment features formed self-aligned with the one or more waveguide core 106_{core} of the coupler 100 may include one or more of one or more T&G alignment aid 108, one or more fiducial 114, and one or more alignment pillar 122, among other lateral alignment aids and lateral alignment features that may optionally be included in the embodiment of the coupler 100. Self-alignment is achieved, in embodiments, using a common patterned mask layer in the patterning of the T&G alignment feature 108 and other optional alignment features, and the one or more waveguide core 106_{core} formed from the planar waveguide layer of coupler 100.

Step 178-3 of method 178 is a forming step in which an embodiment of PIC assembly 101 is formed comprising the interposer 103 and the coupler 100, and optionally one or more optical fibers 154 mounted in FAU 156 on the coupler 100, wherein the one or more waveguide cores 107_{core} of the interposer 103 are aligned to the one or more waveguide cores 106_{core} of the coupler 100.

Step 178-3 of method 178 is a forming step in which an embodiment of PIC assembly 101 is formed comprising interposer 103 and coupler 100, and optionally, one or more optical fibers 154 mounted or otherwise formed in FAU 156 on the coupler 100, wherein the one or more waveguide cores 107_{core} of the interposer 103 are aligned with the one or more waveguide cores 106_{core} of the coupler 100.

In some embodiments of PIC assembly 101 formed using method 178, alignment of the one or more waveguide cores 107_{core} of the interposer 103 with the one or more waveguide cores 106_{core} of the coupler 100 is performed using optional T&G alignment features 109,108 formed on the interposer 103 and coupler 100, respectively. In other embodiments of PIC assembly 101, alignment of the one or more waveguide cores 107_{core} of the interposer 103 with the one or more waveguide cores 106_{core} of the coupler 100 is performed using active alignment methods.

In some embodiments of coupler 100, optional alignment features described in method 178 may include, for example, FAU alignment features 126 to facilitate alignment of the cores 154_{core} of the one or more optical fibers mounted or otherwise formed in FAU 156 with, for example, waveguide cores 106_{core} of coupler 100. In some embodiments of coupler 100, optional alignment features described in method 178 may include, for example, cavity alignment features 128 to facilitate alignment of the MLA lenses 138_{MLA} of multi-lens arrays 130_{MLA} mounted or otherwise formed in cavities 146 with the optical axes of waveguide cores or other optical pathways of one or more of interposer 103 and coupler 100 in PIC assembly 101.

In some embodiments, optional alignment features described in method 178 may include, for example, loopback waveguide cores 160_{core} that facilitate alignment, for example, of the optical fiber cores 154_{core} of alignment optical fibers 154_{align} on the coupler 100 to facilitate alignment, and that further facilitate alignment of other optical fiber cores 154_{core} mounted in other FAU 156 with waveguide cores 106_{core}, for example, on coupler 100.

Other optional alignment features are disclosed herein.

Methods of formation of embodiments of PIC assembly 101 comprising interposer assembly 104 and coupler assembly 102, may include additional steps in the formation of interposer assembly 104 from interposer 103, and in the formation of coupler assembly 102 from coupler 100. Embodiments of interposer assemblies 104, for example, may comprise interposer 103 configured having one or more cavity 148 for mounting one or more optoelectrical device 120, and one or more cavity 147 for mounting or otherwise forming one or more lens array. Embodiments of coupler assemblies 102, for example, may comprise coupler 100 configured having cavity 146 for mounting of otherwise forming one or more lens array and optical isolator 132, one or more cavity 149 for mounting one or more optoelectrical device 119, and one or more FAU mounting site 152 for mounting one or more FAU 156 configured having one or more optical fiber 154.

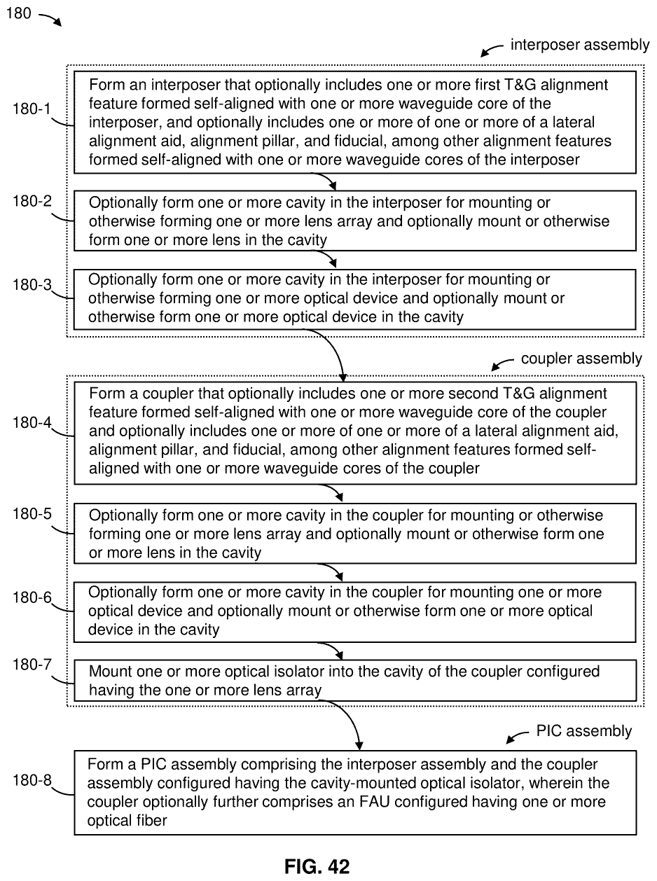

FIG. 42 shows a flowchart for a method 180 of forming a PIC assembly 101 comprising an interposer assembly 104 and a coupler assembly 102, wherein the interposer assembly 104 comprises one or more optoelectrical device 120, and may further comprise a lens array 130, and wherein the coupler assembly 102 comprises an optical isolator 132 and one or more lens array 130 and may further comprise one or more optoelectrical device 119, and one or more optical fiber 154 mounted or otherwise formed in one or more FAU 156.

Steps 180-1 to 180-3 of method 180 comprise steps used in the formation of embodiments of interposer assembly 104.

Step 180-1 of method 180 is a forming step in which an interposer 103 is formed that optionally includes one or more first T&G alignment feature 109 formed self-aligned with one or more waveguide core 107_{core} of the interposer 103 and that optionally includes one or more of one or more of an alignment pillar 123, fiducial 115, among other alignment features formed self-aligned with one or more waveguide cores 107_{core} of the interposer 103.

Step 180-2 of method 180 is a forming step in which one or more cavity 147 for mounting or otherwise forming a lens array 130 is optionally formed in the interposer 130, and one or more lens array 130 is optionally mounted or formed in the one or more cavities 147. In embodiments of interposer 103 configured having a cavity 147, one or more lens array 130 may be mounted or otherwise formed in cavity 147 to facilitate coupling of optical signals, for example, from the interposer 103 to the coupler 100. The one or more lens array 130 may be, for example, one or more multi-lens array 130_{MLA}, one or more on-facet lens array 130_{F2PP}, one or more lens array structure 130_{S2PP}, or one or more ball lens array 130_{BALL}, among other types of lens arrays that may be mounted or otherwise formed in cavity 147 on the interposer 103. Alternatively, a multi-lens array 130_{MLA}, an on-facet lens array 130_{F2PP}, a lens array structure 130_{S2PP}, or a ball lens array 130_{BALL}, among other types of lens arrays, may be mounted or otherwise formed in cavity 147

Step 180-3 of method 180 is a forming step in which one or more cavity 148 for mounting or otherwise forming one or more optoelectrical device 120 is optionally formed in the interposer 103, and one or more optoelectrical device 120 is optionally mounted or otherwise formed in the one or more cavities 148. In some embodiments, the formation of the cavities 148 may be performed in combination with the formation of the cavities in Step 180-2.

Steps 180-4 to 180-7 of method 180 comprise steps used in the formation of embodiments of coupler assembly 102.

Step 180-4 of method 180 is a forming step in which a coupler 100 is formed that optionally includes one or more second T&G alignment feature 108 formed self-aligned with one or more waveguide core 106_{core} of the coupler 100 and optionally includes one or more of one or more of a lateral alignment aid, alignment pillar 122, and fiducial 114, among other alignment features formed self-aligned with one or more waveguide cores 106_{core} of the coupler 100.

Step 180-5 of method 180 is a forming step in which one or more cavity 146 for mounting or otherwise forming a lens array 130 is optionally formed in the coupler 100, and one or more lens array 130 is optionally mounted or formed in the one or more cavities 146. In embodiments of coupler 100 configured having a cavity 146, one or more lens array 130 may be mounted or otherwise formed in cavity 146 to facilitate coupling of optical signals from an ingoing side of the cavity 146 to an outgoing side of the cavity, wherein the coupling from the ingoing side of the cavity 146 to the outgoing side of the cavity 146 propagates through an optical isolator 132 mounted or otherwise formed in the cavity 146. The one or more lens array 130 may be, for example, one or more multi-lens array 130_{MLA}, one or more on-facet lens array 130_{F2PP}, one or more lens array structure 130_{S2PP}, or one or more ball lens array 130_{BALL}, among other types of lens arrays that may be mounted or otherwise formed in cavity 146 on the coupler 100. In some embodiments, cavity 146 may be configured having a combination of these types of lens arrays 130 as described herein, for example, in some of the embodiments shown in FIGS. 18A-18Y and in FIGS. 19A-19T.

Step 180-6 of method 180 is a forming step in which one or more cavity 149 for mounting or otherwise forming one or more optoelectrical device 119 is optionally formed in the coupler 100, and one or more optoelectrical device 119 is optionally mounted or otherwise formed in the one or more cavities 149.

Step 180-7 of method 180 is a mounting step in which one or more optical isolator 132 is mounted or otherwise formed in cavity 146 of coupler 100 configured having the one or more lens array 130.

Steps 180-8 of method 180 comprises steps used in the formation of embodiments of PIC assembly 101 comprising interposer assembly 104 and coupler assembly 102.

Step 180-8 of method 180 is a forming step in which an embodiment of a PIC assembly 101 is formed comprising the interposer assembly 104 formed in steps 180-1 to 180-3 of method 180, the coupler assembly 102 comprising the optical isolator 132 and one or more lens array 130, and optionally further comprising one or more optical fibers 154.

In the flowchart of FIG. 42, a dotted line rectangle labeled “interposer assembly” is shown that encloses Steps 180-1 to 180-3 to delineate the steps in the method 180 pertaining to the formation of the interposer assembly 104. Another dotted line rectangle labeled “coupler assembly” is shown in the flowchart of FIG. 42 that encloses Steps 180-4 to 180-7 to delineate the steps in the method 180 pertaining to the formation of the coupler assembly 102. Step 180-8, pertaining to the formation of embodiments of PIC assembly 101, is labeled “PIC assembly”.

Embodiments of interposers 103 and couplers 100 may be formed at the wafer level. And embodiments of interposer assemblies 104 and coupler assemblies 102 may also be formed, in part, at the wafer level. Wafer level processing, as used herein, refers to methods of formation in which a plurality of devices is made on a substrate configured for fabricating or otherwise forming a plurality of devices. The formation of the on-facet lens arrays 130_{F2PP} and lens array structures 130_{S2PP} using two-photon polymerization may also be performed, for example, using wafer level processing.

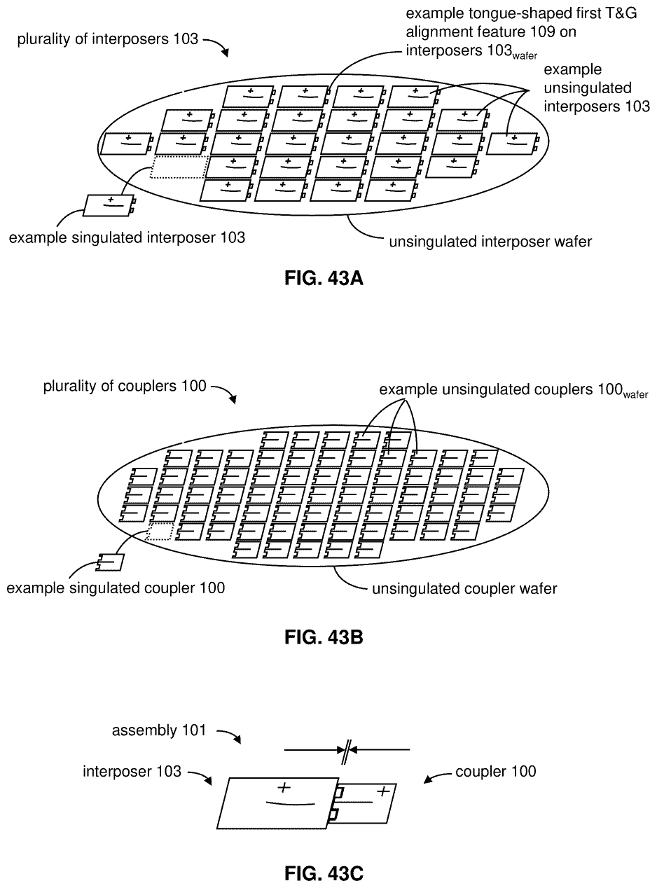

FIG. 43A shows a schematic perspective drawing of an embodiment of an unsingulated interposer wafer comprising a plurality of interposers 103 wafer configured having optional tongue-shaped first T&G alignment features 109. An example singulated interposer 103 is also shown in FIG. 43A as labeled, “example singulated interposer 103”. Substrates such as unsingulated interposer wafer that facilitate the simultaneous processing of a plurality of devices can provide significant economic benefits in comparison to processes limited to a single device.

FIG. 43B shows a schematic perspective drawing of an embodiment of an unsingulated coupler wafer comprising a plurality of couplers 100_{wafer} configured having groove-shaped second T&G alignment features 108. An example singulated coupler 100 labeled “example singulated coupler 100” is shown in FIG. 43B.

FIG. 43C shows a schematic perspective drawing of an embodiment of PIC assembly 101 having an interposer 103 and a coupler 100 formed, for example, from a singulated interposer 103 of the interposer wafer 103_{wafer} after singulation and a singulated coupler 100 of the unsingulated coupler wafer, respectively, after singulation. Interposer 103 from the plurality of interposers 103 of unsingulated interposer wafer 103_{wafer} after singulation is configured, in the embodiment, having tongue-shaped alignment features 109, receptive to the groove-shaped alignment features 108 of coupler 100 from the plurality of couplers 100 of the coupler wafer after singulation.

The capability to combine discrete interposers 103 and couplers 100 in the formation of PIC assemblies 101 is facilitated with the inclusion and use of T&G alignment features that are formed self-aligned with waveguide cores and that facilitate the alignment of the waveguide cores 107_{core} of interposer 103 with waveguide cores 106_{core} on coupler 100.

In some embodiments, interposers 103 of unsingulated interposer wafer may be formed having one or more cavity to facilitate the inclusion of one or more device, such as a laser, a gain device, a lens, a lens array, among other devices, into the interposers 103 to form interposer assemblies 104 using wafer level processing.

In some embodiments, couplers 100 of unsingulated coupler wafer may be formed having one or more cavity to facilitate the inclusion of one or more device, such as an optical isolator, a lens, a lens array, among other devices, into the coupler 100 to form coupler assemblies 102 using wafer level processing.

The foregoing descriptions of embodiments have been presented for purposes of illustration and description and are not intended to be exhaustive or to limit embodiments to the forms disclosed. Modifications to, and variations of, the disclosed embodiments will be readily apparent to those skilled in the art, and the general principles defined herein may be applied to other embodiments without departing from the spirit and scope of the embodiments disclosed herein. Thus, embodiments should not be limited to those specifically described herein but rather are to be accorded the widest scope consistent with the principles and features disclosed herein.

Figures provided herein are not drawn to scale but rather are intended to include and convey the various features comprising the embodiments described. The various layers and regions illustrated in the figures are illustrated schematically.

Embodiments of PIC assemblies 101 comprising interposer assembly 104 and coupler assembly 102 disclosed herein in many of the drawings are configured having four optical channels. Four optical channels is a commonly used configuration and enabled key features of embodiments to be described with clarity. In some embodiments, a single optical channel is shown in the drawings. It should be noted that other embodiments may be configured having one or more optical channels.

It should be noted that the accompanying drawings may not be drawn to scale given the ranges in dimensions for the various features described in embodiments. The physical dimensions of a substrate having a photonic integrated circuit as described herein, for example, may be on the order of 1-10 millimeters in length and width and formed on a substrate that may, for example, be on the order of 0.2 to 1 millimeters in thickness. In comparison, the dimensions of a typical optical fiber cable are approximately 900 microns for the jacket, 250 microns for the cladding coating, 125 microns for the cladding, and 10 microns for the core. Other optical fibers having other dimensions may also be used in embodiments. In further comparison, the film thicknesses of a planar waveguide layer on a substrate may be, but are not limited to, 0.5 to 20 microns. Although the actual dimensions may differ significantly from these approximations, they indicate the broad differences in dimensions of key features described in embodiments. As such, efforts have been made to include and describe the features of the embodiments without undue concern for maintaining dimensional scale for these features in relation to other features.

Embodiments disclosed herein specifically describe optical fiber mount configurations that utilize an FAU but these embodiments may also be used for other forms of fiber mounting configurations such as v-grooves and ferrules. The invention is not so limited to the FAU features but may be applicable to these and other forms of fiber mounting, such as fiber mounting in v-grooves as described in OPE-127 and such as ferrule fiber mounting as described in OPE-129.

TABLE 5
List of Reference numbers and
components/features in embodiments.

| Reference | |
|---|---|
| Numeral | Component/Feature Description |
| 100 | Coupler |
| 101 | PIC Assembly |
| 102 | Coupler Assembly |
| 103 | Interposer |
| 104 | Interposer Assembly |
| 106 | Waveguide (on Coupler) |
| 107 | Waveguide (on Interposer) |
| 108 | Tongue & Groove (T\&G) |
| | Alignment Feature (on Coupler) |
| 109 | Tongue & Groove (T\&G) |
| | Alignment Feature (on Interposer) |
| 110 | Substrate |
| 114 | Fiducial (on Coupler) |
| 115 | Fiducial (on Interposer) |
| 118 | Photonic Integrated Circuit (PIC) |
| 120 | Optoelectrical Device |
| 122 | Alignment Pillar (on Coupler) |
| 123 | Alignment Pillar (on Interposer) |
| 126 | FAU Alignment Aid (e.g., for FAU |
| | having optical fibers) |
| 128 | Cavity Alignment Aid (e.g., |
| | for optical isolator, lenses) |
| 129 | Lateral Alignment Aid (for ball lenses) |
| 130 | Lens Array |
| 132 | Optical Isolator |
| 138 | Lens |
| 141 | Spot Size Converter |
| 146 | (Optical Isolator & Lens mounting) |
| | Cavity (on Coupler) |
| 147 | (Lens mounting) Cavity (on Interposer) |
| 148 | Device Mounting Cavity (on Interposer) |
| 149 | Device Mounting Cavity (on Coupler) |
| 150 | Fiducial Cavity on coupler |
| 151 | Fiducial cavity on interposer |
| 152 | FAU Mounting Site |
| 154 | Optical Fiber |
| 156 | FAU (fiber attachment unit) |
| 160 | Loopback Waveguide |
| 162 | Fanout Waveguide |
| 165 | Epoxy or Bonding Material |
| 168 | Alignment Apparatus |
| 169 | Optical Signal Source |
| | (on alignment apparatus) |
| 170 | Optical Signal |

What is claimed is:

1. An assembly comprising:
a first component comprising a loop back waveguide and an emitter,
wherein the emitter is configured to provide a first optical signal in a first optical direction,
a second component comprising first and second waveguides and a fiber mount,
wherein the fiber mount comprises one of
three v-grooves configured to accept three optical fibers,
a mounting feature for accept a fiber attachment unit with the fiber attachment unit comprising the three optical fibers coupled to the fiber attachment unit, or
one or more guide pin recesses for accepting guide pins for coupling to a ferrule with the ferrule comprising the three optical fibers coupled to the ferrule,
wherein a first optical fiber and a second optical fiber of the three optical fibers are configured to couple with two ends of the loop back waveguide, respectively, to provide a communication path with the loop back waveguide,
wherein a third optical fiber of the three optical fibers are configured to accept a second optical signal in a second optical direction,
wherein the coupling of the first and second optical fibers with the loop back waveguide, is configured to provide an alignment between the first and second optical fibers with the loop back waveguide by a communication of a third optical signal through the first optical fiber, the loop back waveguide, and the second optical fiber,
wherein the first and second optical fibers, when coupled and aligned with the loop back waveguide, are configured to provide an alignment between the first and second optical directions,
wherein the second component is assembled to the first component with the first and second optical fibers coupled and aligned with the loop back waveguide.

2. An assembly as in claim 1,
wherein at least one of a first distance or a first orientation between the loop back waveguide and the first optical direction and at least one of a second distance or a second orientation between the first or second waveguide and the second optical direction each is within an alignment accuracy value or within less than 0.2 micron difference to a design value to enable the alignment of the first and second optical directions when the first and second waveguides are coupled and aligned with the loop back waveguide,
wherein the alignment accuracy value is characterized by an optical loss of less than 10% or less than 1 dB through the alignment between the first and the second optical directions,

3. An assembly as in claim 1,
wherein the alignment between the first and second optical fibers with the loop back waveguide is characterized by an optical loss of less than 10% or less than 1 dB of the third optical signal through the first optical fiber, the loop back waveguide, and the second optical fiber.

4. An assembly comprising
a first component comprising a loop back waveguide and a grating structure coupled to a first side of a first cavity,
wherein the first cavity is configured to accept a gain device aligning to the grating structure,
wherein the gain device, when assembled to the first cavity, is configured to form a hybrid laser structure for providing a first optical signal in a first optical direction,
a second component comprising first and second waveguides and a fiber mount,
wherein the fiber mount comprises one of
three v-grooves configured to accept three optical fibers,
a mounting feature for accept a fiber attachment unit with the fiber attachment unit comprising the three optical fibers coupled to the fiber attachment unit, or
one or more guide pin recesses for accepting guide pins for coupling to a ferrule with the ferrule comprising the three optical fibers coupled to the ferrule,
wherein a first optical fiber and a second optical fiber of the three optical fibers are configured to couple with two ends of the loop back waveguide, respectively, to provide a communication path with the loop back waveguide,
wherein a third optical fiber of the three optical fibers are configured to accept a second optical signal in a second optical direction,
wherein the coupling of the first and second optical fibers with the loop back waveguide, is configured to provide an alignment between the first and second optical fibers with the loop back waveguide by a communication of a third optical signal through the first optical fiber, the loop back waveguide, and the second optical fiber,
wherein the first and second optical fibers, when coupled and aligned with the loop back waveguide, are configured to provide an alignment between the first and second optical directions,
wherein at least one of a first distance or a first orientation between the loop back waveguide and the first optical direction to at least one of a second distance or a second orientation between the first or second waveguide and the second optical direction is within an alignment accuracy value or within less than 0.2 micron difference to a design value to enable the alignment of the first and second optical directions when the first and second waveguides are coupled and aligned with the loop back waveguide,
wherein the alignment accuracy value is characterized by an optical loss of less than 10% or less than 1 dB through the alignment between the first and the second optical directions,
wherein the second component is assembled to the first component with the first and second optical fibers coupled and aligned with the loop back waveguide.

5. An assembly as in claim 4,
wherein the first component comprises a first alignment aid disposed on a first side of the first component,
wherein the second component comprising a second alignment aid disposed on a second side of the second component,
wherein the first and second alignment aids are configured to be mated to each other,
wherein at least one of a first distance or a first orientation between the first alignment aid and the first optical direction or at least one of a second distance or a second orientation between the second alignment aid and the second optical direction is within an alignment accuracy value or within less than 0.2 micron difference to a second design value,
wherein the first side is coupled to the second side with the first alignment aid mates to the second alignment aid.

6. An assembly as in claim 4,
wherein the second component comprises additional multiple third waveguides each comprising a first facet at a first side of the second component,
wherein the second component comprises additional multiple fourth waveguides each comprising a second facet at a second side of the second component opposite the first side,
wherein at least two fourth waveguides of the additional multiple fourth waveguides comprise a separation greater than at least two third waveguides of the multiple third waveguides.

7. An assembly as in claim 4,
wherein the first cavity comprises a third alignment aid configured to assist in aligning the gain device.

8. An assembly as in claim 4,
wherein the first or second component comprises a fiducial disposed at a same elevation as the first or second alignment aid, respectively

9. An assembly as in claim 4,
wherein the first component comprises a power monitor device coupled to a second side of a first cavity.

10. An assembly as in claim 4,
wherein the first component comprises a power monitor device coupled to a second side of a first cavity,
wherein the grating structure is coupled to a 3D printed lens formed on a facet of the grating structure or to a multi-lens array.

11. An assembly as in claim 4,
wherein the first component comprises a second grating structure coupled to a second side of a first cavity.

12. An assembly as in claim 4,
wherein the grating structure is coupled to a 3D printed lens formed on a facet of the grating structure or to a multi-lens array.

13. An assembly as in claim 4,
wherein the first cavity is configured to accept an individual gain device or an array of gain devices with the individual gain device or a gain device of the array of gain devices aligning to the grating structure.

14. An assembly as in claim 4,
wherein the second component comprises a second cavity disposed between a second and a third waveguides,
wherein the second waveguide comprises a first facet disposed at the second side of the second component and a second facet disposed at a first wall of the second cavity,
wherein the third waveguide comprises a third facet disposed at a second wall of the second cavity and a fourth facet disposed at a wall of the fiber mount,
wherein the second cavity is configured to receive at least one of an isolator, one or more multi-lens arrays, one or more on-facet lenses formed by a 3D printing process, or one or more in-structure lenses formed by a 3D printing process, or any combination thereof in any order.

15. An assembly as in claim 4,
wherein the second component comprises a second cavity disposed next to a second waveguide,
wherein the second waveguide comprises a first facet disposed at the second side of the second component and a second facet disposed at a first wall of the second cavity,
wherein the second cavity is adjacent to the fiber mount and communicated with the fiber mount,
wherein the second cavity is configured to receive at least one of an isolator, one or more multi-lens arrays, one or more on-facet lenses formed by a 3D printing process, or one or more in-structure lenses formed by a 3D printing process, or any combination thereof in any order.

16. An assembly as in claim 4,
wherein the second component comprises a third cavity disposed next to a third waveguide,
wherein the second cavity is adjacent to the second side of the second component and forms an opening in the second side,
wherein the third waveguide comprises a third facet disposed at a second wall of the second cavity and a fourth facet disposed at a wall of the fiber mount,
wherein the second cavity is configured to receive at least one of an isolator, one or more multi-lens arrays, one or more on-facet lenses formed by a 3D printing process, or one or more in-structure lenses formed by a 3D printing process, or any combination thereof in any order.

17. An assembly as in claim 4,
wherein the second component comprises a second cavity,
wherein the second cavity is adjacent to the second side of the second component and forms an opening in the second side,
wherein the second cavity is adjacent to the fiber mount and communicated with the fiber mount,
wherein the second cavity is configured to receive at least one of an isolator, one or more multi-lens arrays, one or more on-facet lenses formed by a 3D printing process, or one or more in-structure lenses formed by a 3D printing process, or any combination thereof in any order.

18. An assembly comprising
a first component comprising a loop back waveguide and two grating structures coupled to two opposite sides of a first cavity,
wherein the first cavity comprises an alignment aid configured to assist in aligning a gain device with the two grating structures,
wherein a grating structure of the two grating structures is coupled to a 3D printed lens formed on a facet of the grating structure or to a multi-lens array,
wherein the gain device, when assembled to the first cavity, is configured to form a hybrid laser structure for providing a first optical signal in a first optical direction,
a second component comprising a first waveguide, a second cavity, and a fiber mount,
wherein the first waveguide comprises a first facet disposed at the first wall of the second cavity,
wherein the second cavity is configured to receive at least one of an isolator, one or more multi-lens arrays, one or more on-facet lenses formed by a 3D printing process, or one or more in-structure lenses formed by a 3D printing process, or any combination thereof in any order,
wherein the fiber mount comprises one of
three v-grooves configured to accept three optical fibers,
a mounting feature for accept a fiber attachment unit with the fiber attachment unit comprising the three optical fibers coupled to the fiber attachment unit, or
one or more guide pin recesses for accepting guide pins for coupling to a ferrule with the ferrule comprising the three optical fibers coupled to the ferrule,
wherein a first optical fiber and a second optical fiber of the three optical fibers are configured to couple with two ends of the loop back waveguide, respectively, to provide a communication path with the loop back waveguide,
wherein a third optical fiber of the three optical fibers are configured to accept a second optical signal in a second optical direction,
wherein the coupling of the first and second optical fibers with the loop back waveguide, is configured to provide an alignment between the first and second optical fibers with the loop back waveguide by a communication of a third optical signal through the first optical fiber, the loop back waveguide, and the second optical fiber,
wherein the first and second optical fibers, when coupled and aligned with the loop back waveguide, are configured to provide an alignment between the first and second optical directions,
wherein at least one of a first distance or a first orientation between the loop back waveguide and the first optical direction or at least one of a second distance or a second orientation between the first or second waveguide and the second optical direction is within an alignment accuracy value or within less than 0.2 micron difference to a design value to enable the alignment of the first and second optical directions when the first and second waveguides are coupled and aligned with the loop back waveguide,
wherein the alignment accuracy value is characterized by an optical loss of less than 10% or less than 1 dB through the alignment between the first and the second optical directions,
wherein the second component is assembled to the first component with the first and second optical fibers coupled and aligned with the loop back waveguide.

19. An assembly as in claim 18,
wherein at least one of
the first waveguide comprises a second facet disposed at the second side of the second component, the second cavity comprises a second wall opposite the first wall, with the second wall adjacent to the fiber mount and communicated with the fiber mount, or
the second cavity is adjacent to the second side of the second component and forms an opening in the second side, wherein the first waveguide comprises a second facet adjacent to the fiber mount and communicated with the fiber mount.

20. An assembly as in claim 18,
wherein the first waveguide comprises a second facet disposed at the second side of the second component,
wherein the second component comprises a second waveguide,
wherein the second waveguide comprises a third facet disposed at a second wall of the second cavity opposite the first wall and a fourth facet disposed at a wall of the fiber mount.
